(19) United States
(12) Patent Application Publication
(10) Pub. No.: US 2013/0159081 A1
(43) Pub. Date: Jun. 20, 2013

(54) BIDIRECTIONAL BANDWIDTH REDUCING NOTIFICATIONS AND TARGETED INCENTIVE PLATFORM APPARATUSES, METHODS AND SYSTEMS

(71) Applicants: Vishwanath Shastry, Mountain View, CA (US); Marc Blum, San Mateo, CA (US); Thomas Purves, San Francisco, CA (US); Ayman Hammad, Pleasanton, CA (US)

(72) Inventors: Vishwanath Shastry, Mountain View, CA (US); Marc Blum, San Mateo, CA (US); Thomas Purves, San Francisco, CA (US); Ayman Hammad, Pleasanton, CA (US)

(21) Appl. No.: 13/543,825

(22) Filed: Jul. 7, 2012

Related U.S. Application Data
(63) Continuation-in-part of application No. 13/542,443, filed on Jul. 5, 2012.
Application No. 13/542,443 is a continuation-in-part of application No. 13/520,481.
Application No. 13/520,481 is a continuation-in-part of application No. 13/398,817, filed on Feb. 16, 2012.
Application No. 13/398,817 is a continuation-in-part of application No. 13/348,634, filed on Jan. 11, 2012.
(60) Provisional application No. 61/505,597, filed on Jul. 8, 2011.
(60) Provisional application No. 61/620,431, filed on Apr. 4, 2012.
(60) Provisional application No. 61/594,063, filed on Feb. 2, 2012.
(60) Provisional application No. 61/545,971, filed on Oct. 11, 2011.
(60) Provisional application No. 61/538,761, filed on Sep. 23, 2011.
(60) Provisional application No. 61/539,969, filed on Sep. 27, 2011.

(51) Int. Cl. G06Q 30/02

(52) U.S. Cl. CPC G06Q 30/0274
USPC 705/14.23

(57) ABSTRACT

The BIDIRECTIONAL BANDWIDTH REDUCING NOTIFICATIONS AND TARGETED INCENTIVE PLATFORM APPARATUSES, METHODS AND SYSTEMS (“Ad-Track”) transform consumer activity data via Ad-Track components into ad revenue sharing payment transactions. In one implementation, a method of improving network data transmission efficiency and reducing network bandwidth usage is disclosed, comprising: instantiating a remote tracking component on a user device; receiving a consumer trigger event with regard to a product via the remote tracking component; determining a related merchant based on the trigger event, the merchant providing the product; and providing an advertisement component advertising the merchant via the remote tracking component to the consumer.

This application for letters patent discloses and describes various novel innovations and inventive aspects of BIDIRECTIONAL BANDWIDTH REDUCING NOTIFICATIONS AND TARGETED INCENTIVE PLATFORM technology (hereinafter “disclosure”) and contains material that is subject to copyright, mask work, and/or other intellectual property protection. The respective owners of such intellectual property have no objection to the facsimile reproduction of the disclosure by anyone as it appears in published Patent Office file/records, but otherwise reserve all rights.

### PRIORITY CLAIM

This application claims priority under 35 USC §119 to U.S. provisional patent application Ser. No. 61/505,597 filed Jul. 8, 2011, entitled “Advertising Incentive Apparatuses, Methods And Systems” (attorney docket no. P-42157PRV|20270-141PV), U.S. provisional patent application Ser. No. 61/620,431 filed Apr. 4, 2012, entitled “Store E-Wallet Injection Apparatuses, Methods And Systems” (attorney docket no. 234US01|20270-229PV), and U.S. provisional patent application Ser. No. 61/594,063 filed Feb. 2, 2012, entitled “Centralized Personal Information Platform Apparatuses, Methods And Systems” (attorney docket no. P-42185PRV|20270-150V).

This application claims priority under 35 USC §120 to U.S. patent application Ser. No. 13/542,443 filed Jul. 5, 2012, entitled “Electronic Wallet Checkout Platform Apparatuses, Methods And Systems” (attorney docket no. 11US02|20270-177US).

This application claims priority under 35 USC §120 to U.S. patent application Ser. No. 13/520,481, filed Jul. 3, 2012, entitled “Universal Electronic Payment Apparatuses, Methods and Systems” (attorney docket no. P-42051US02|20270-136US), which is a National Stage Entry entitled to, and hereby claims priority under 35 U.S.C. §§365, 371 corresponding to, PCT application no. PCT/US12/26205, filed Feb. 22, 2012, entitled “Universal Electronic Payment Apparatuses, Methods And Systems,” attorney docket no. P-42051WO01|20270-136PC, which in turn claims priority under 35 USC §119 to: U.S. provisional patent application Ser. No. 61/545,971 filed Oct. 11, 2011, entitled “Universal Electronic Payment Apparatuses, Methods And Systems,” attorney docket no. P-42051US01|20270-136PV1, U.S. provisional patent application Ser. No. 61/538,761 filed Sep. 23, 2011, entitled “Electronic Wallet Transaction Consumer Leash Apparatuses, Methods And Systems,” attorney docket no. 93US01|20270-194PV; and U.S. provisional patent application Ser. No. 61/539,969 filed Sep. 27, 2011, entitled “Apparatuses, Methods, And Systems For Finding, Storing, And Applying Discounts For Use In An Electronic Transaction,” attorney docket no. 110US01|20270-197PV.

PCT application no. PCT/US12/26205 is also a continuation-in-part of, and claims priority under 35 U.S.C. §§120, 365 to: U.S. nonprovisional patent application Ser. No. 13/398,817 filed Feb. 16, 2012, entitled “Snap Mobile Payment Apparatuses, Methods And Systems,” attorney docket no. P-42032US01|20270-127US, and U.S. nonprovisional patent application Ser. No. 13/348,634 filed Jan. 11, 2012, entitled “Universal Value Exchange Apparatuses, Methods And Systems,” attorney docket no. P-41948US01|20270-089US.

This application is related to Patent Cooperation Treaty international application Ser No. ______ filed Jul. 7, 2012 entitled “Bidirectional Bandwidth Reducing Notifications And Targeted Incentive Platform Apparatuses, Methods And Systems” (attorney docket no. P-42157WO01|20270-141PC).

The entire contents of the aforementioned applications are expressly incorporated by reference herein.

### FIELD

The present innovations generally address apparatuses, methods, and systems for online advertising, and more particularly, include BIDIRECTIONAL BANDWIDTH REDUCING NOTIFICATIONS AND TARGETED INCENTIVE PLATFORM APPARATUSES, METHODS AND SYSTEMS (“Ad-Track”).

### BACKGROUND

Merchants advertise their products to attract consumers. For example, a merchant may pay a newspaper for advertising their products by publishing a picture of their product, and/or a description of their products in the newspaper. A consumer who reads the newspaper may obtain information of the advertised product, and may be interested in purchasing the product.

### BRIEF DESCRIPTION OF THE DRAWINGS

The accompanying appendices, drawings, figures, images, etc. illustrate various example, non-limiting, inventive aspects, embodiments, and features (“e.g.,” or “example(s)”) in accordance with the present disclosure:

FIGS. 1A-C show block diagrams illustrating example aspects of the Ad-Track;

FIGS. 2A-2B show a block diagram illustrating data flows between Ad-Track affiliated entities within embodiments of Ad-Track;

FIGS. 3A-3B provide logic flow diagrams illustrating consumer tracking within embodiments of the Ad-Track;

FIGS. 4A-4C provide logic flow diagrams illustrating consumer tracking heuristics analysis within embodiments of the Ad-Track;

FIGS. 5A-5E provide exemplary user interface diagrams illustrating example aspects of the Ad-Track;

FIGS. 6A-E show user interface and logic flow diagrams illustrating example aspects of virtual store injection into a virtual wallet application in some embodiments of the Ad-Track;

FIGS. 7A-C show user interface diagrams illustrating example aspects of a discovery shopping mode of a virtual wallet application in some embodiments of the Ad-Track;

FIGS. 8A-C show user interface and logic flow diagrams illustrating example aspects of creating a user shopping trail within a virtual wallet application and associated revenue sharing scheme in some embodiments of the Ad-Track;

FIG. 9 shows a block diagram illustrating example aspects of a centralized personal information platform in some embodiments of the Ad-Track;

FIGS. 10A-F show block diagrams illustrating example aspects of data models within a centralized personal information platform in some embodiments of the Ad-Track;

FIG. 11 shows a block diagram illustrating example Ad-Track component configurations in some embodiments of the Ad-Track;

FIG. 12 shows a data flow diagram illustrating an example search result aggregation procedure in some embodiments of the Ad-Track;

FIG. 13 shows a logic flow diagram illustrating example aspects of aggregating search results in some embodiments of the Ad-Track, e.g., a Search Results Aggregation (“SRA”) component 1300;

FIGS. 14A-D show data flow diagrams illustrating an example card-based transaction execution procedure in some embodiments of the Ad-Track;

FIGS. 15A-E show logic flow diagrams illustrating example aspects of card-based transaction execution, resulting in generation of card-based transaction data and service usage data, in some embodiments of the Ad-Track, e.g., a Card-Based Transaction Execution (“CTE”) component 1500;

FIG. 16 shows a data flow diagram illustrating an example procedure to aggregate card-based transaction data in some embodiments of the Ad-Track;

FIG. 17 shows a logic flow diagram illustrating example aspects of aggregating card-based transaction data in some embodiments of the Ad-Track, e.g., a Transaction Data Aggregation (“TDA”) component 1700;

FIG. 18 shows a data flow diagram illustrating an example social data aggregation procedure in some embodiments of the Ad-Track;

FIG. 19 shows a logic flow diagram illustrating example aspects of aggregating social data in some embodiments of the Ad-Track, e.g., a Social Data Aggregation (“SDA”) component 1900;

FIG. 20 shows a data flow diagram illustrating an example procedure for enrollment in value-add services in some embodiments of the Ad-Track;

FIG. 21 shows a logic flow diagram illustrating example aspects of social network payment authentication enrollment in some embodiments of the Ad-Track, e.g., a Value-Add Service Enrollment (“VASE”) component 2100;

FIGS. 22A-B show flow diagrams illustrating example aspects of normalizing aggregated search, enrolled, service usage, transaction and/or other aggregated data into a standardized data format in some embodiments of the Ad-Track, e.g., a Aggregated Data Record Normalization (“ADRN”) component 2200;

FIG. 23 shows a logic flow diagram illustrating example aspects of recognizing data fields in normalized aggregated data records in some embodiments of the Ad-Track, e.g., a Data Field Recognition (“DFR”) component 2300;

FIG. 24 shows a logic flow diagram illustrating example aspects of classifying entity types in some embodiments of the Ad-Track, e.g., an Entity Type Classification (“ETC”) component 2400;

FIG. 25 shows a logic flow diagram illustrating example aspects of identifying cross-entity correlation in some embodiments of the Ad-Track, e.g., a Cross-Entity Correlation (“CEC”) component 2500;

FIG. 26 shows a logic flow diagram illustrating example aspects of associating attributes to entities in some embodiments of the Ad-Track, e.g., an Entity Attribute Association (“EAA”) component 2600;

FIG. 27 shows a logic flow diagram illustrating example aspects of updating entity profile-graphs in some embodiments of the Ad-Track, e.g., an Entity Profile-Graph Updating (“EPGU”) component 2700;

FIG. 28 shows a logic flow diagram illustrating example aspects of generating search terms for profile-graph updating in some embodiments of the Ad-Track, e.g., a Search Term Generation (“STG”) component 2800;

FIG. 29 shows a logic flow diagram illustrating example aspects of analyzing a user's behavior based on aggregated purchase transaction data in some embodiments of the Ad-Track, e.g., a User Behavior Analysis (“UBA”) component 2900;

FIG. 30 shows a logic flow diagram illustrating example aspects of generating recommendations for a user based on the user's prior aggregate purchase transaction behavior in some embodiments of the Ad-Track, e.g., a User Behavior-Based Offer Recommendations (“UBOR”) component 3000;

FIG. 31 shows a user interface diagram illustrating an overview of example features of virtual wallet applications in some embodiments of the Ad-Track;

FIGS. 32A-G show user interface diagrams illustrating example features of virtual wallet applications in a shopping mode, in some embodiments of the Ad-Track;

FIGS. 33A-F show user interface diagrams illustrating example features of virtual wallet applications in a payment mode, in some embodiments of the Ad-Track;

FIG. 34 shows a user interface diagram illustrating example features of virtual wallet applications, in a history mode, in some embodiments of the Ad-Track;

FIGS. 35A-E show user interface diagrams illustrating example features of virtual wallet applications in a snap mode, in some embodiments of the Ad-Track;

FIG. 36 shows a user interface diagram illustrating example features of virtual wallet applications, in an offers mode, in some embodiments of the Ad-Track;

FIGS. 37A-B show user interface diagrams illustrating example features of virtual wallet applications, in a security and privacy mode, in some embodiments of the Ad-Track;

FIG. 38 shows a datagraph diagram illustrating example aspects of transforming a user checkout request input via a User Purchase Checkout (“UPC”) component into a checkout data display output;

FIG. 39 shows a logic flow diagram illustrating example aspects of transforming a user checkout request input via a User Purchase Checkout (“UPC”) component into a checkout data display;

FIGS. 40A-B show datagraph diagrams illustrating example aspects of transforming a user virtual wallet access input via a Purchase Transaction Authorization (“PTA”) component into a purchase transaction receipt notification;

FIGS. 41A-B show logic flow diagrams illustrating example aspects of transforming a user virtual wallet access input via a Purchase Transaction Authorization (“PTA”) component into a purchase transaction receipt notification;

FIGS. 42A-B show datagraph diagrams illustrating example aspects of transforming a merchant transaction batch data query via a Purchase Transaction Clearance (“PTC”) component into an updated payment ledger record;

FIGS. 43A-B show logic flow diagrams illustrating example aspects of transforming a merchant transaction batch data query via a Purchase Transaction Clearance (“PTC”) component into an updated payment ledger record; and

FIG. 44 shows a block diagram illustrating example aspects of a Ad-Track controller.

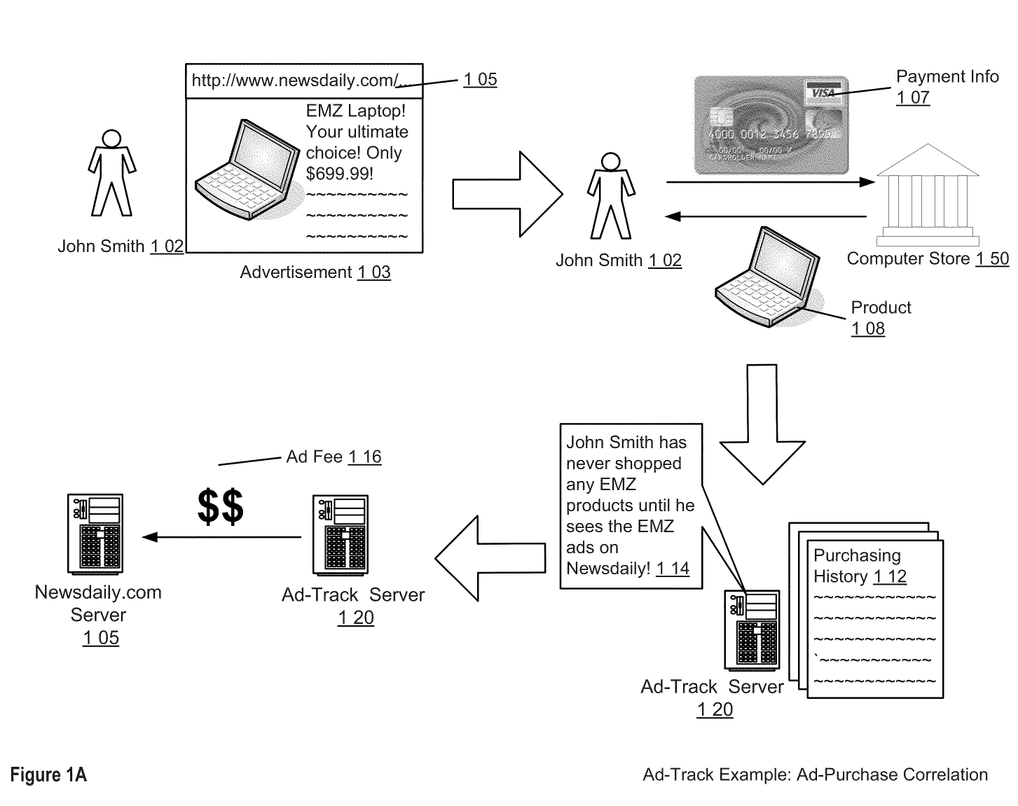

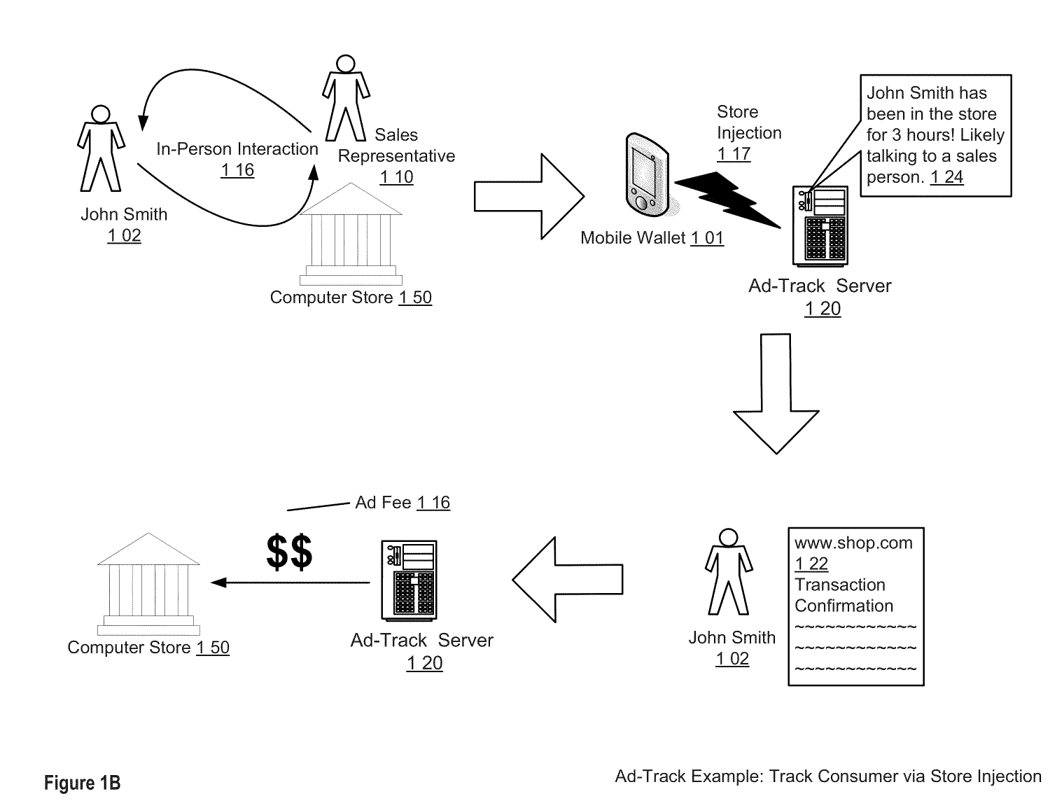

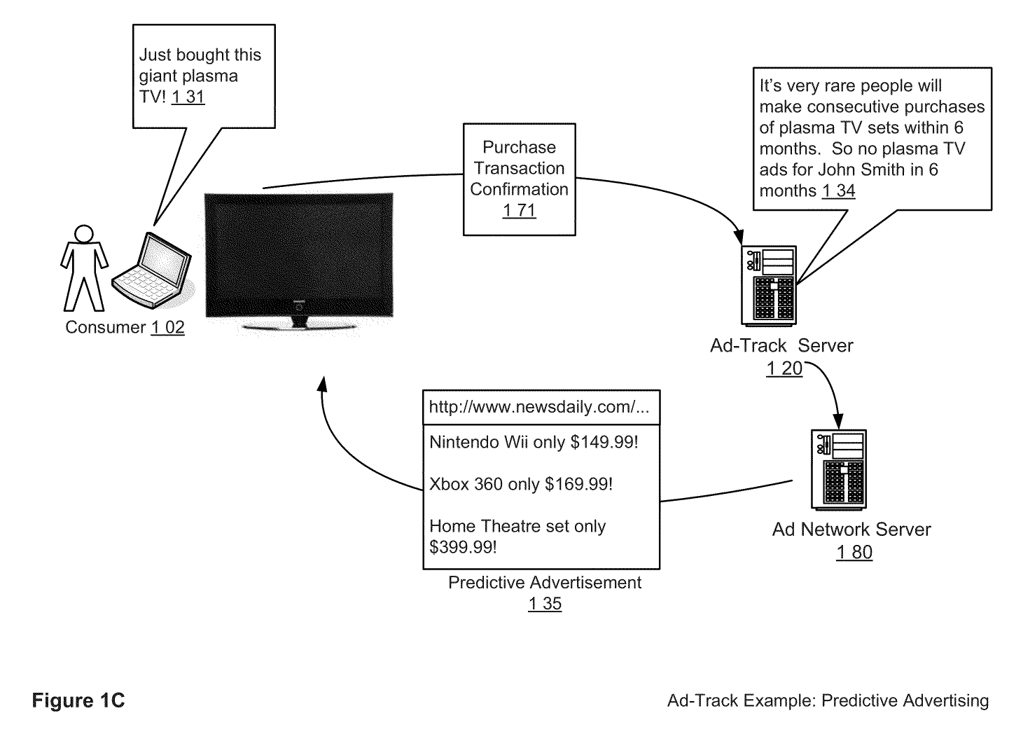

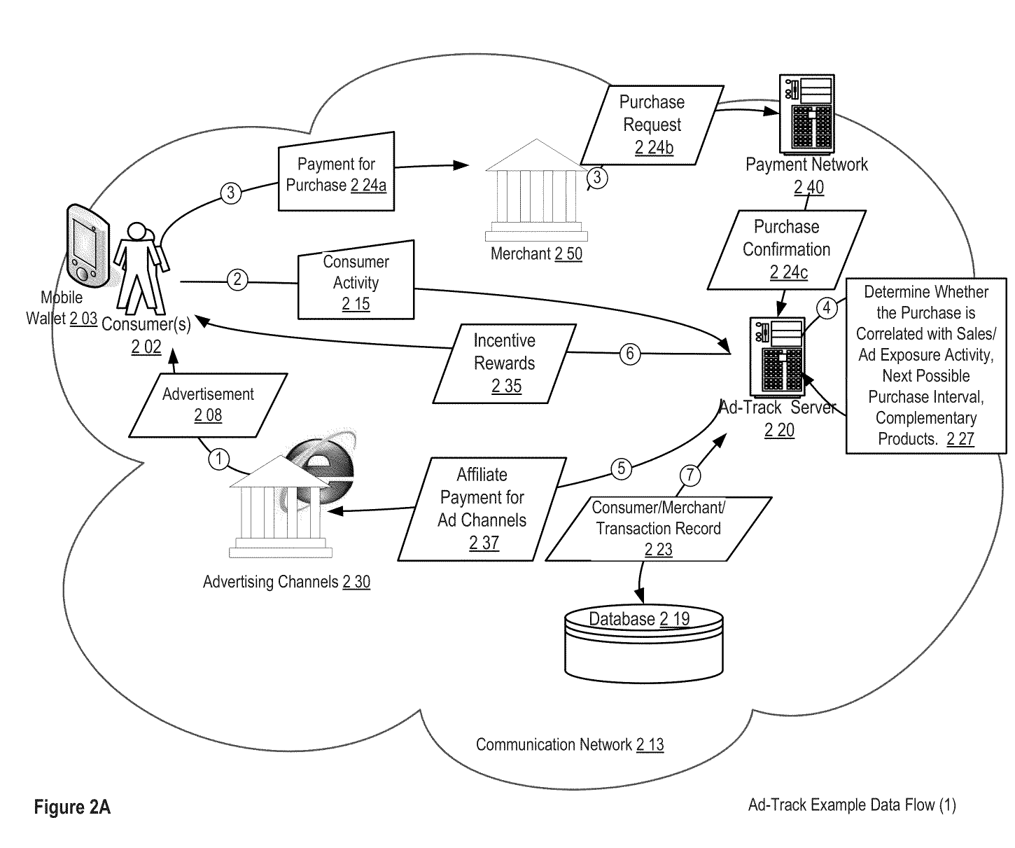

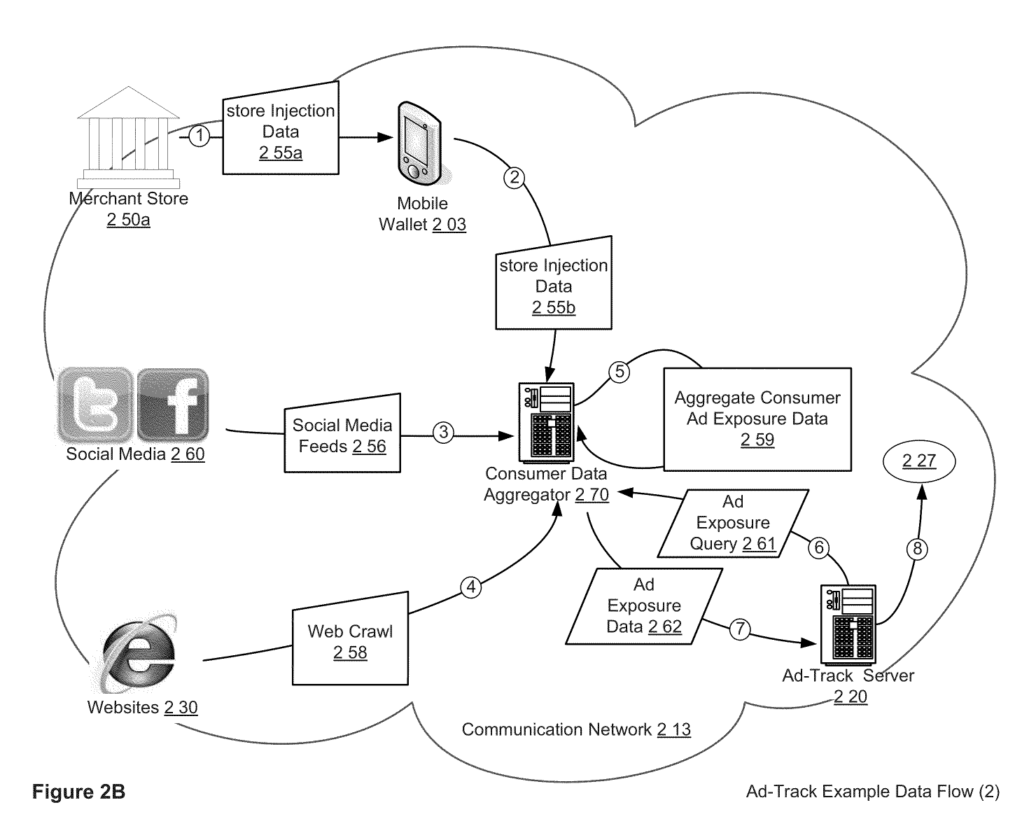

The leading number of each reference number within the drawings indicates the figure in which that reference number is introduced and/or detailed. As such, a detailed discussion of reference number 101 would be found and/or introduced in FIG. 1. Reference number 201 is introduced in FIG. 2, etc.

### DETAILED DESCRIPTION

The BIDIRECTIONAL BANDWIDTH REDUCING NOTIFICATIONS AND TARGETED INCENTIVE PLATFORM APPARATUSES, METHODS AND SYSTEMS (hereinafter “Ad-Track”) provides an advertising tracking and payment platform which combines online tracking of consumer behaviors and merchant advertising into purchase data. In one embodiment, Ad-Track may assist advertisers (e.g., merchants, etc.) close the loop between online/offline advertising and consumer's purchases while creating an incentive model for all participants.

Integration of an electronic wallet, a desktop application, a plug-in to existing applications, a standalone mobile application, a web based application, a smart prepaid card, and/or the like in capturing payment transaction related objects such as purchase labels, payment cards, barcodes, receipts, and/or the like reduces the number of network transactions and messages that fulfill a transaction payment initiation and procurement of payment information (e.g., a user and/or a merchant does not need to show an advertisement in the print media or obtain and send digital images of paper bills, hand in a physical payment card to a cashier, etc., to initiate a payment transaction, fund transfer, and/or the like). In this way, with the reduction of network communications, the number of transactions that may be processed per day is increased, i.e., processing efficiency is improved. In one implementation, the Ad-Track may provide customized advertisements to consumers, which reduces the volume of network communication messages of ads, and thus saves the network bandwidth usage, and improves ad network transmission efficiency and data communication latency performance.

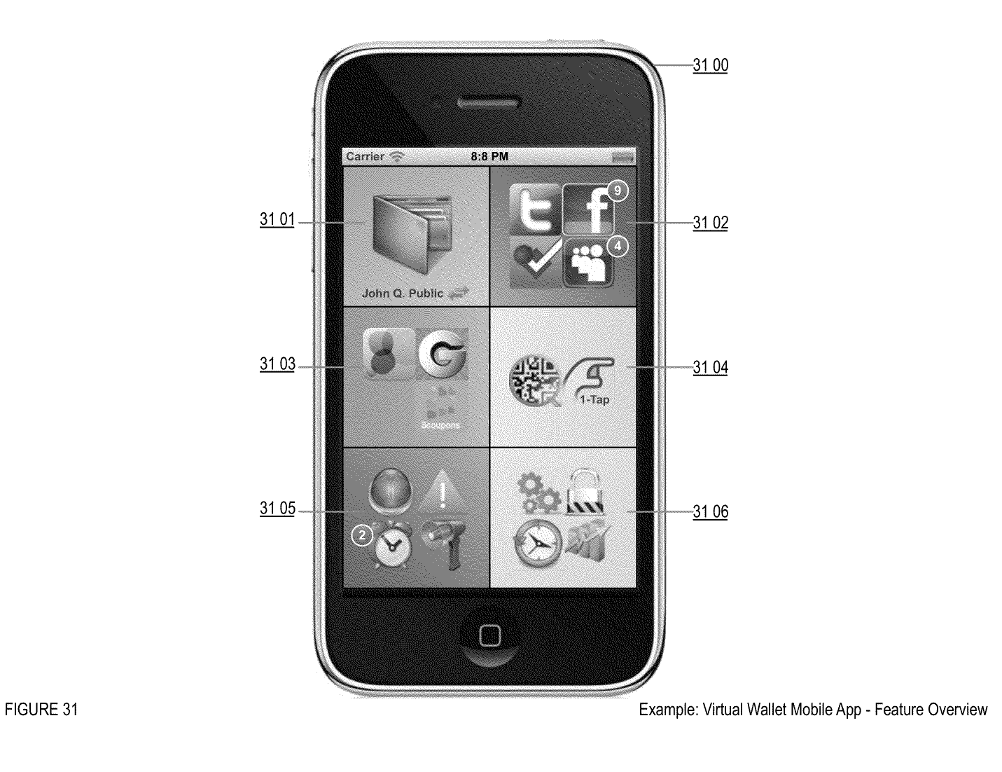

It should be noted that although a mobile wallet platform is depicted (e.g., see FIGS. 31-40B), a digital/electronic wallet, a smart/prepaid card linked to a user's various payment accounts, and/or other payment platforms are contemplated embodiments as well; as such, subset and superset features and data sets of each or a combination of the aforementioned payment platforms (e.g., see FIGS. 31-40B) may be accessed, modified, provided, stored, etc. via cloud/server services and a number of varying client devices throughout the instant specification. Similarly, although mobile wallet user interface elements are depicted, alternative and/or complementary user interfaces are also contemplated including: desktop applications, plug-ins to existing applications, stand alone mobile applications, web based applications (e.g., applications with web objects/frames, HTML 5 applications/wrappers, web pages, etc.), and other interfaces are contemplated. It should be further noted that the Ad-Track payment processing component may be integrated with an digital/electronic wallet (e.g., a Visa V-Wallet, etc.), comprise a separate stand alone component instantiated on a user device, comprise a server/cloud accessed component, be loaded on a smart/prepaid card that can be substantiated at a PoS terminal, an ATM, a kiosk, etc., which may be accessed through a physical card proxy, and/or the like. In further implementations, the Ad-Track may provide a merchant configuration UI for a merchant to create a campaign, set ad revenue sharing rules, and/or the like.

### Bidirectional Bandwidth Reducing Notifications and Targeted Incentive Platform (Ad-Track)

FIG. 1A provides an example block diagram illustrating Ad-purchase correlation within embodiments of the Ad-Track. Within embodiments, the a consumer “John Smith” 102 may view an advertisement 103 featuring a product, e.g., a laptop, etc., via an advertisement channel 105, e.g., a new website, etc. In one implementation, the consumer “John Smith” 102 may purchase the featured product 108, e.g., at a merchant computer store 150, by submitting his payment information 107 to the point of sale (POS) terminal at the merchant store. In one implementation, the consumer's credit card purchasing history may reflect the purchase of the laptop product.

In one implementation, the Ad-Track server 120 may determine whether the consumer's purchase of the advertised product 108 should be attributed to the advertisement 103 exposure. For example, if the Ad-Track server 120 reviews the consumer's purchasing history 112 and determines that the consumer has never shopped any product with the featured brand 114, the Ad-Track server 120 may correlate the purchase with the advertisement exposure. For example, the Ad-Track server 120 may distribute a contingent advertisement fee 116 to the advertisement channel 105, wherein the advertisement fee is provided by the merchant as part of advertisement revenue sharing.

FIG. 1B provides an example block diagram illustrating tracking consumer ad exposure via store injection within embodiments of the Ad-Track. Within embodiments, in one implementation, the consumer “John Smith” 102, instead of clicking and viewing an Internet ad as shown in FIG. 1A, may walk into a computer store 150 and obtain information from a sales representative no for a featured product. In one implementation, such in-person interaction 116 including exposure to advertisements may not be able to be tracked by monitoring the consumer's online activities.

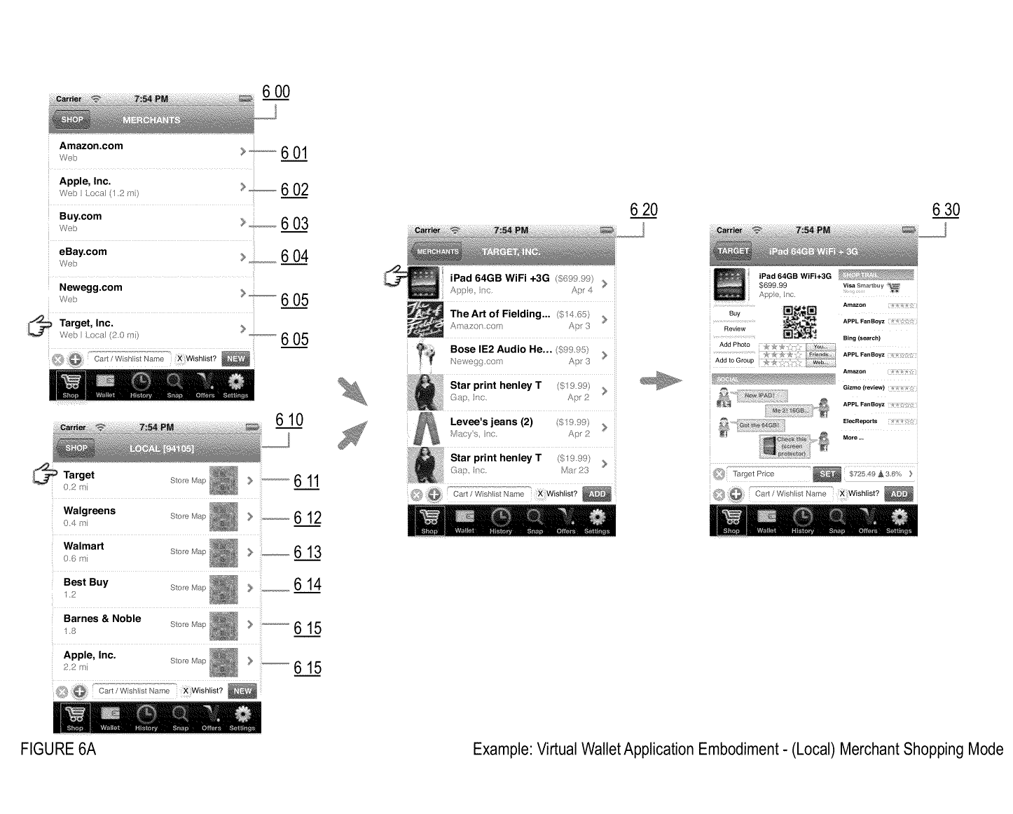

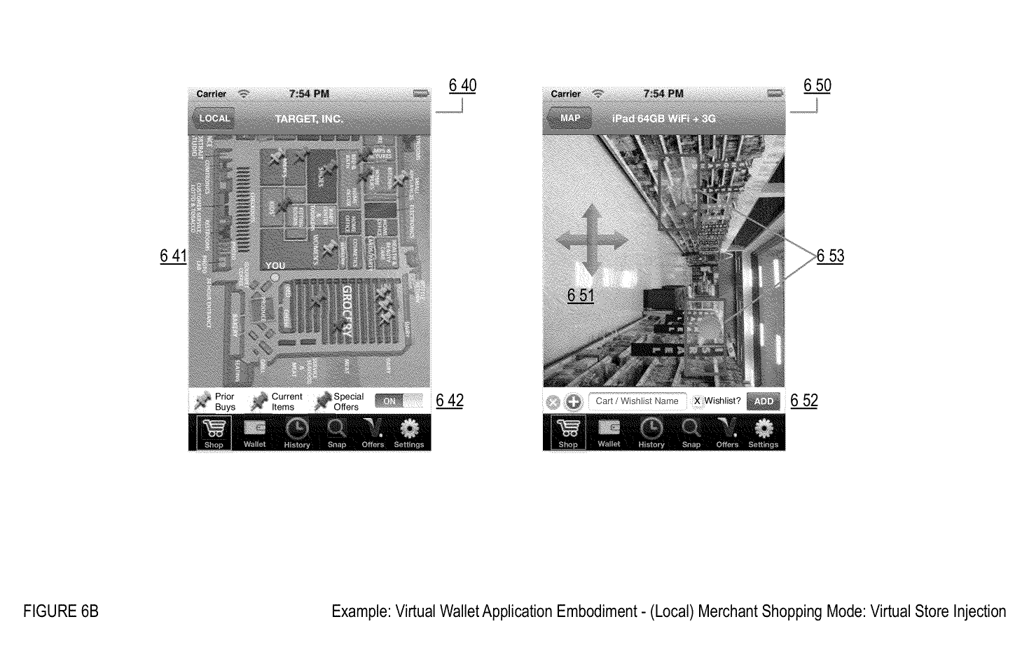

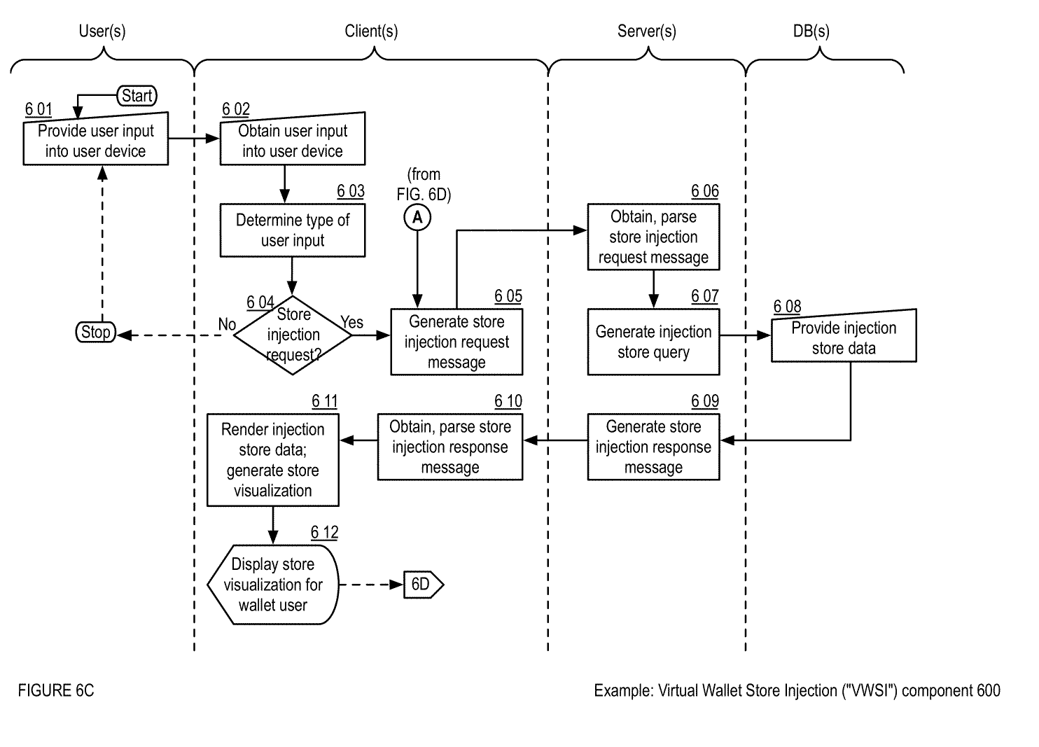

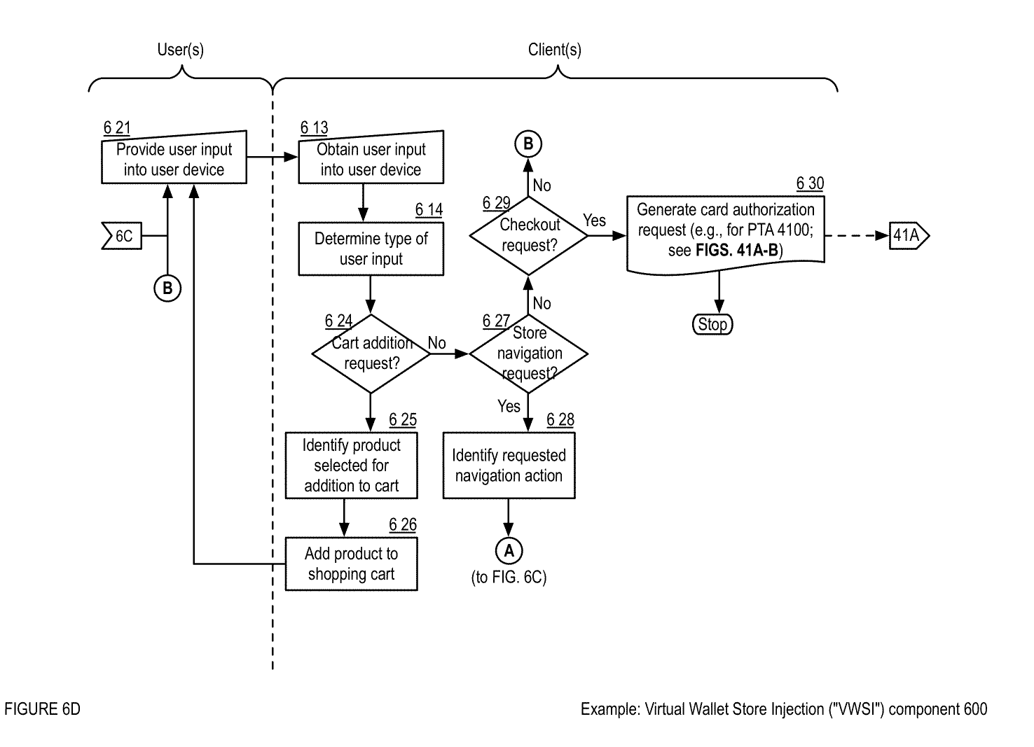

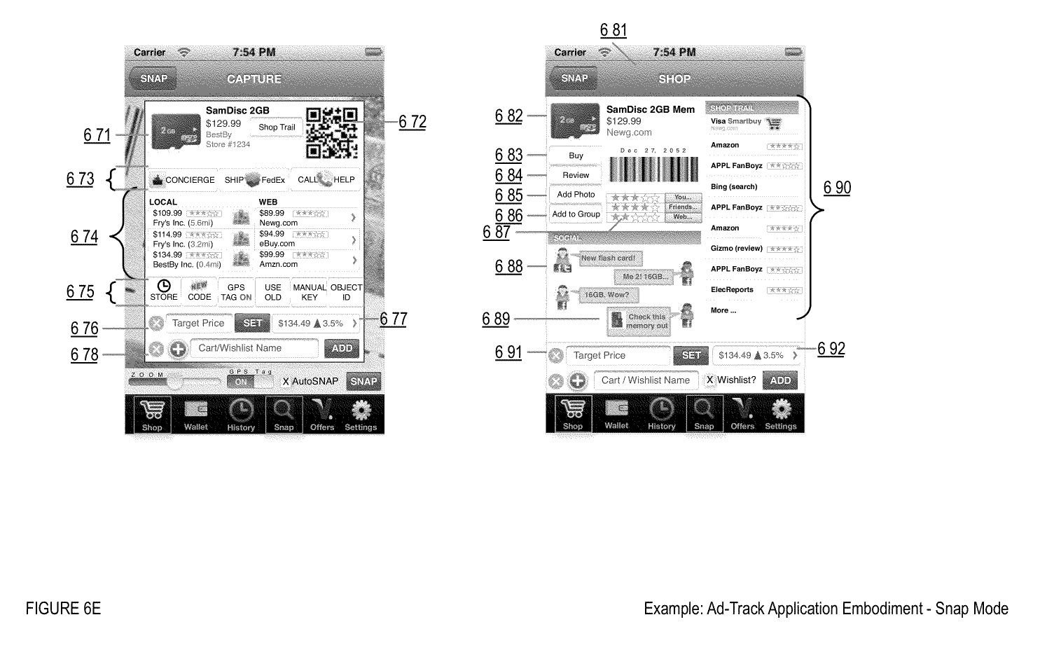

In one implementation, the Ad-Track may track such in-store advertisement exposure via a store injection component 117 instantiated with the consumer's mobile wallet 101. For example, the consumer's mobile wallet 101 may track the consumer's store check-in showing the consumer has spent significant time with the merchant store 124. In another implementation, the store injection component 117 may track the consumer's interested products in store. Further implementations of the store injection component 117 are discussed in FIG. 6A-6D.

In one implementation, when the consumer “John Smith” 102 makes a subsequent purchase, e.g., via an Internet shopping site 122, the Ad-Track server 120 may generate heuristics that the purchase is a result of the in-store advertisement and sales work. The Ad-Track server 120 may then distribute a contingent ad fee 116 to the retailer, e.g., the computer store 150.

FIG. 1C provides an example block diagram illustrating predictive/seasonal advertising within embodiments of the Ad-Track. Within implementations, upon purchasing a product, the Ad-Track may obtain a purchase transaction confirmation 171 from a consumer, a merchant, a financial processing payment network/issuer (e.g., Visa, etc.) and/or the like. The Ad-Track server 120 may may generate heuristics data based on the consumer's purchasing history and shopping patterns to provide individualized advertisement delivery. For example, if the consumer 102 has just bought a plasma TV 131, the Ad-Track server 120 may based on heuristics 134 that it is unlikely the consumer may be interested in shopping for another plasma TV within at least 6 months, and may not provide plasma TV ads to the user.

In one implementation, the Ad-Track server may be integrated with an Ad Network server 180 to provide ads to a consumer. In another implementation, the Ad-Track server may comprise an independent server that will feed information to the ad network server 180 as to what ads to be provided to the consumer. For example, the ad network server 180 may receive instructions to generate predictive ads 135 that does not include a TV ad. In another example, the Ad-Track server may instead feature TV related products ads to the user 135, e.g., video game equipments, home theatre system, etc. For example, if the same consumer browses an online store for electronics and searches for popular electronic products, the electronics store may not provide ads of plasma TVs but the complementary gaming gadgets to the consumer.

FIG. 2A shows a block diagram illustrating data flows between Ad-Track server and affiliated entities within various embodiments of the Ad-Track. Within various embodiments, one or more consumers 202, Ad-Track server 220, Ad-Track database(s) 219, merchant 250, and/or advertising channels 230 are shown to interact via various communication network 213.

In one embodiment, a consumer 202, may operate a wide variety of different user devices, including communications devices and technologies within embodiments of Ad-Track operation. For example, in one embodiment, the consumer devices may include, but are not limited to, computer terminals, work stations, cellular telephony handsets, smart phones, tablets, personal digital assistants (PDAs), and/or the like. In one embodiment, the Ad-Track server 220 may be equipped at a terminal computer of the consumer 202. For example, the Ad-Track component may be instantiated on a consumer device to conduct Ad-Track analysis. In another embodiment, the Ad-Track server 220 may be a remote server which is accessed by the consumer 202 via a communication network 213, such as, but not limited to local area network (LAN), in-house intranet, the Internet, and/or the like.

In one implementation, the consumer 202 may be associated with an electronic wallet 203, which may have various registered accounts, including one or more bank accounts, an Ad-Track service account, a merchant membership account, and/or the like, possessed with the consumer 202. For example, a consumer may possess an electronic wallet linked a Bank of America checking account, a Chase credit card account, a Sam's Club membership account, and/or the like. For another example, the consumer's electronic wallet may be registered for the Ad-Track service. For another example, a consumer may operate a mobile device to access his electronic wallet to make a purchase, as further illustrated in the example screen shots in FIGS. 31-43.

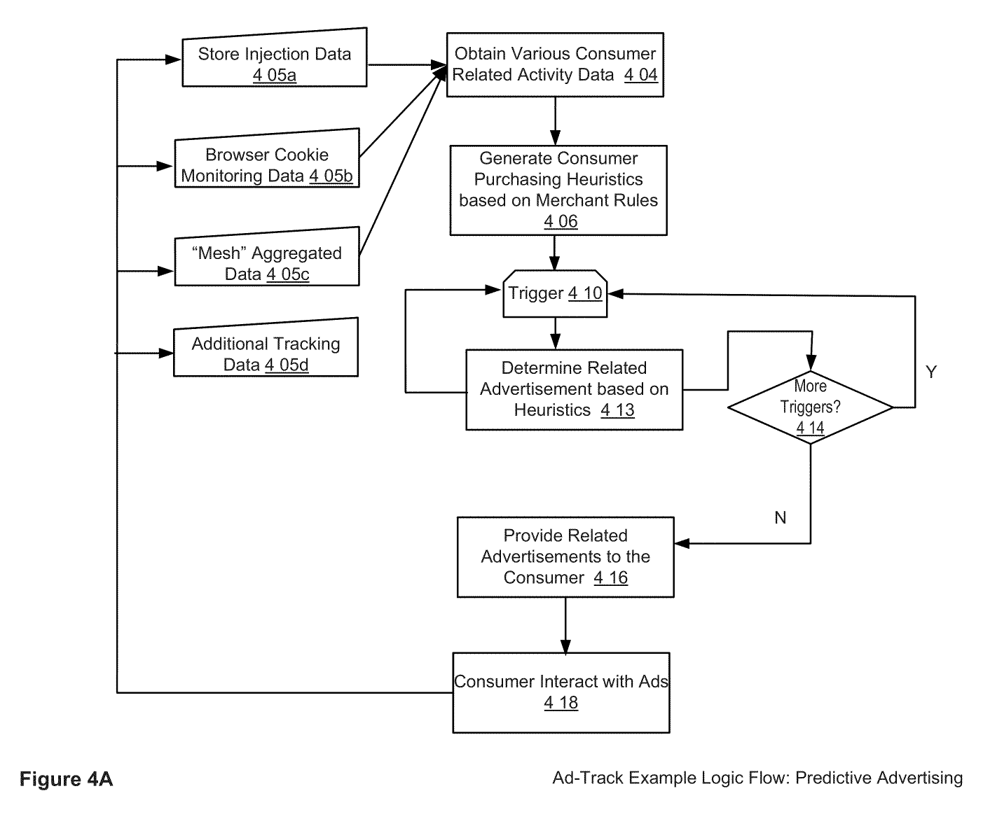

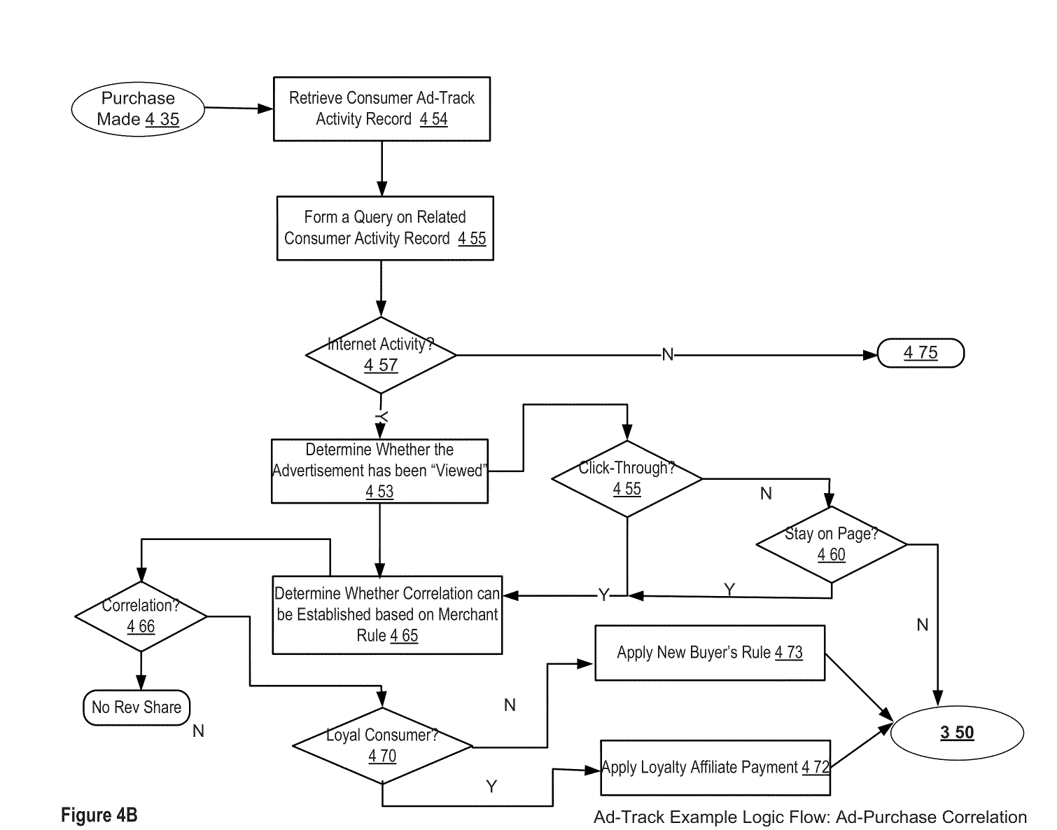

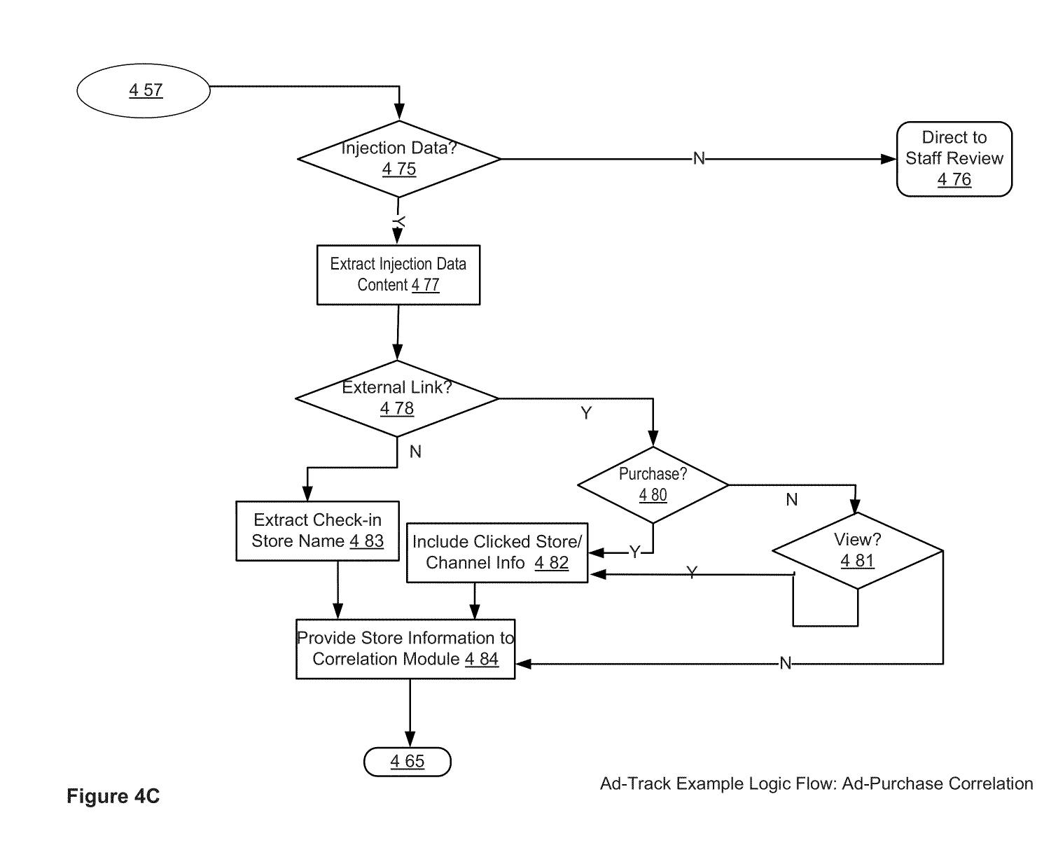

In one embodiment, the consumer's electronic wallet may be registered with the Ad-Track server 220. For example, the consumer's electronic wallet may comprise a tag indicating the consumer electronic wallet is “Ad-Track enabled.” In one implementation, when a consumer initiates a browser session via a personal device (e.g., a laptop, a smart phone, etc.), such as opening a browsing window on Internet Explorer, Firefox, Safari, Google Chrome, and/or the like, the browser may state information of the session indicating the session is eligible for Ad-Track service. For example, when a consumer searches for desired products on Google, the user's browser may contain cookies of an Ad-Track label, and may notify the Google server of such Ad-Track label; the search engine may return a list of Ad-Track featured search results, e.g., listing the Ad-Track participating merchants' products/advertisements on top of the list, as shown in one example in FIG. 4A. In this way, the consumer may obtain advertising information 208 from the merchants' advertising channels 230, e.g., the Internet, etc.

In alternative implementations, the consumer 202 may click on a URL link and view an online advertisement 208 from an advertising channel 230, such as a news site, a social media ad, and/or the like.

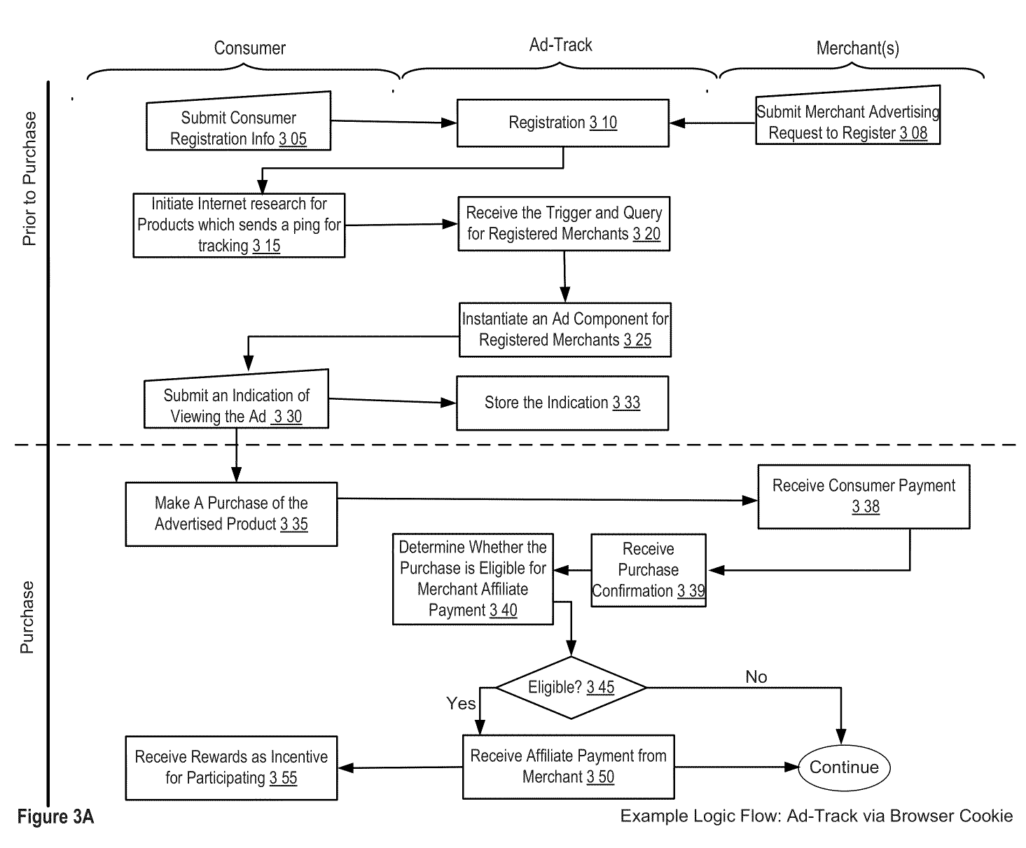

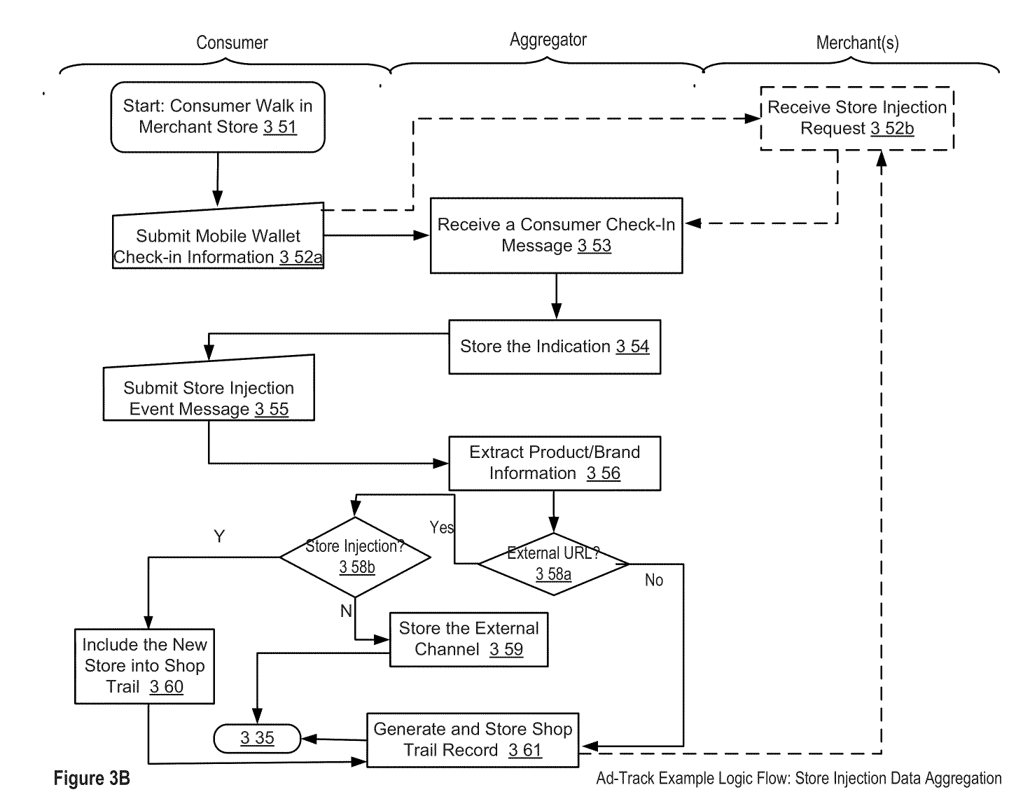

In another embodiment, upon receiving an advertisement (e.g., on the consumer's Internet browser, etc.), the consumer's activities 215 may be recorded and forwarded to the Ad-Track server 220. For example, in one implementation, the Ad-Track server may run a Java applet within the consumer's browser and monitor the consumer's interactive activities with the displayed advertisement, e.g., clicking on the advertisement link, visiting a merchant website following links provided in the advertisement, making a subsequent purchase on the merchant website, and/or the like. The Ad-Track server 220 may store the consumer activity information, and correlate it with subsequently received purchasing information to determine whether the consumer's purchase is triggered by the advertisement, as further illustrated in FIGS. 3A-3C.

For example, in one implementation, the consumer device may provide a consumer activity message 215 to the Ad-Track server 220 as a HTTP(S) POST message including XML-formatted data. An example listing of a consumer activity message 215, substantially in the form of a HTTP(S) POST message including XML-formatted data, is provided below:

POST /consumer_activity.php HTTP/1.1
Host: www.Ad-Track.com
Content-Type: Application/XML
Content-Length: 667
<?XML version = “1.0” encoding = “UTF-8”?>
<consumer_activity>

<activity_ID> WEB2015-9991 </activity_ID>
<timestamp>2015-12-15 17:15:56 </timestamp>
<Source>

<hardware_id> JS-00923 <hardware_id>
<hardware_type> Apple iPhone </hardware_type>
<IP_address> 206.205.82.130 </IP_address>
<session_type> browser </session_type>
<session_id> G656TD <session_id>
...

</Source>
<user>

<user_id> JS-001 </user_id>
<user_name> John Smith </user_name>
<user_number> 000-000-0001 </user_number>
...

</user>
<Message>

<message_type> query </message_type>
<url> www.google.com </url>
<key_term> ″men sweater″ </key_term>
<ad_exposure>

<ad_1>

<ad-id> BR_0001 </ad-id>
<ad_sponsor> Banana Republic </ad_sponsor>
<url> www.banana-republic.com/men/sweater
</url>
<activity> click and view </activity>
<duration> 00:01:56 </duration>
...

</ad_1>
<ad_2>

<ad-id> AX_0001 </ad-id>
<ad_sponsor> Armani Exchange </ad_sponsor>
<url> www.armani_exchange.com/men/sweater
</url>
<activity> click </activity>
<duration> 00:00:04 </duration>
...

</ad_2>

...
<ad_exposure>

</Message>

...

</consumer_activity>

In the above example, the consumer activity message 215 includes a consumer Google search event for “men sweater,” and the consumer subsequently clicked on two advertisement links returned in the search results, e.g., the “Banana Republic” and “Armani Exchange,” and the consumer's interactions with the advertisements, e.g., click and view, or just click through, etc., and the duration that the consumer has stayed on the advertisement are recorded and included in the consumer activity message 215.

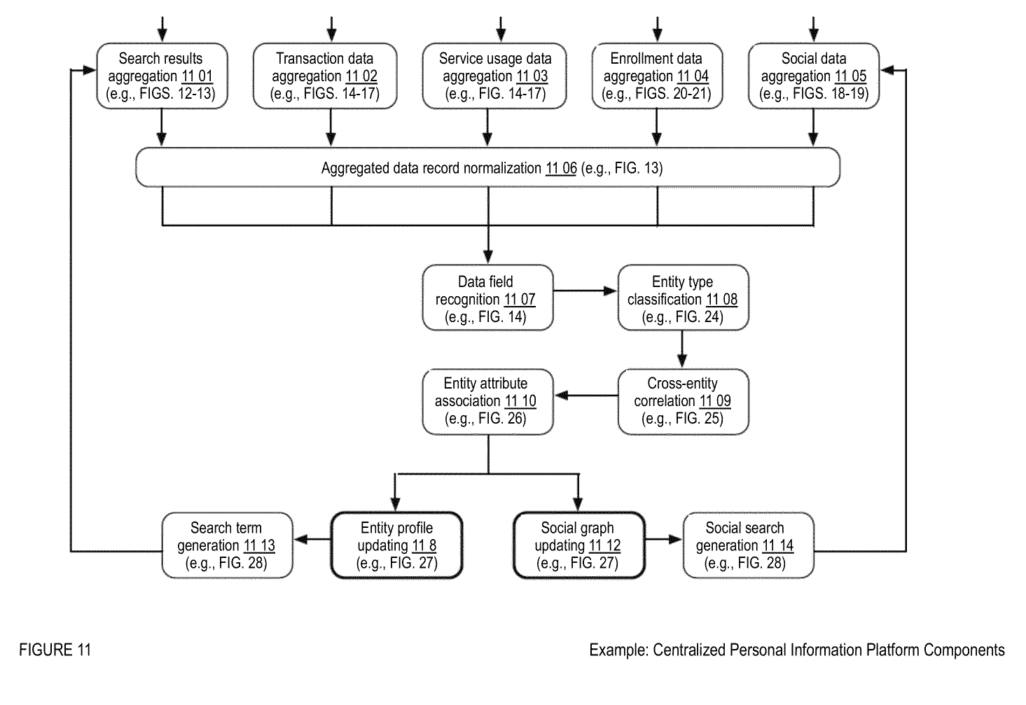

In another implementation, the Ad-Track may track consumer advertisement exposure via In-Store injection data (e.g., see 600 in FIGS. 6C-6D) and web crawl via a profile aggregator (e.g., see the centralized personalized data file platform in FIG. 11).

In one implementation, the consumer may submit payment information to make a purchase request 224a with the merchant 250 (e.g., either at a physical merchant store, or an online shopping site, etc.) when the consumer is interested in the advertised products. For example, in one implementation, the consumer may visit a participating merchant store's website, a third party shopping website featuring the merchant's product (e.g., Amazon.com, Zappos.com, etc.) and/or visit product advertisement via social media (e.g., Facebook, Twitter, etc.), and/or the like, and may submit an online purchase request if a desired product by providing payment information, e.g., entering a credit card number, electronic wallet information, and/or the like.

For another example, the consumer may visit a merchant store and make an in-store purchase of the product. In one embodiment, the consumer 202 may provide his Ad-Track wallet information included in the payment request 224a to a merchant store 250 prior to his check-out. For example, in one implementation, the consumer may swipe an Ad-Track membership magstripe card at a POS terminal of the merchant store. For another example, the consumer may operate a smart phone for registration with the POS via short messages. For another example, the consumer may register with the merchant via bar code scan of the consumer's AD-Track membership card and/or the product.

For example, in one implementation, the consumer may provide a purchase request 224a to the merchant server 250 as a HTTP(S) POST message including XML-formatted data. An example listing of a payment request 224a, substantially in the form of a HTTP(S) POST message including XML-formatted data, is provided below:

POST /payment-request.php HTTP/1.1
Host: www.merchant.com
Content-Type: Application/XML
Content-Length: 667
<?XML version = “1.0” encoding = “UTF-8”?>
<payment_request>

<request_ID>RS-99942e</request_ID>
<timestamp>2015-12-20 17:15:56 </timestamp>
<Source>

<hardware_id> JS-00923 <hardware_id>
<hardware_type> Apple iPhone </hardware_type>
<IP_address> 206.205.82.130 </IP_address>
<session_type> browser </session_type>
<session_id> G656TD <session_id>
...

</Source>
<user>

<user_id> JS-001 </user_id>
<user_name> John Smith </user_name>
<user_number> 000-000-0001 </user_number>
...

</user>
<payment>

<type> Visa mobile wallet </type>
<account> visa </account>
<account_no> 0000 0000 0000 0000 </account_no>
<routing_no> 123456789 </routing_no>
<CCV> 000 </CCV>
<amount> 99.99 </amount>
...

</payment>
<product>

<MCC> 09090909 </MCC>
<category> apparel </category>
<description> men sweater navy </description>
<price> 99.99 </price>
<brand> Banana Republic </brand>
...

</product>
<merchant>

<merchant_name> Banana Republic </merchant_name>
<source> www.banana-republic.com/online/shop/... </source>
...

</merchant>
...

</payment_request>

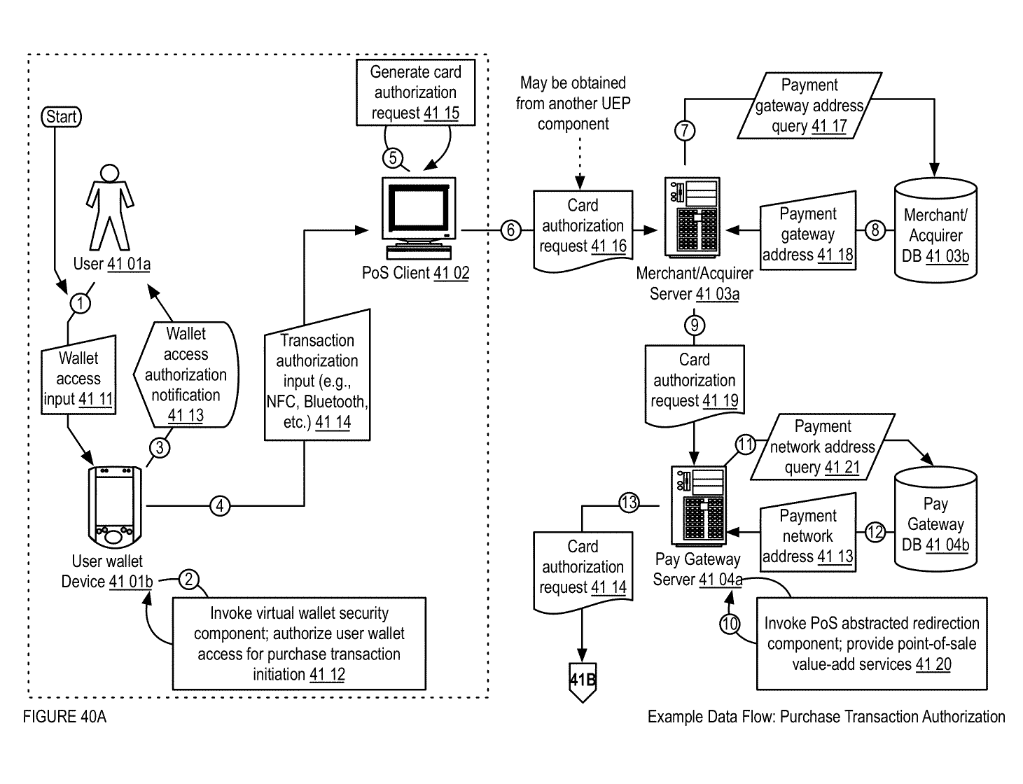

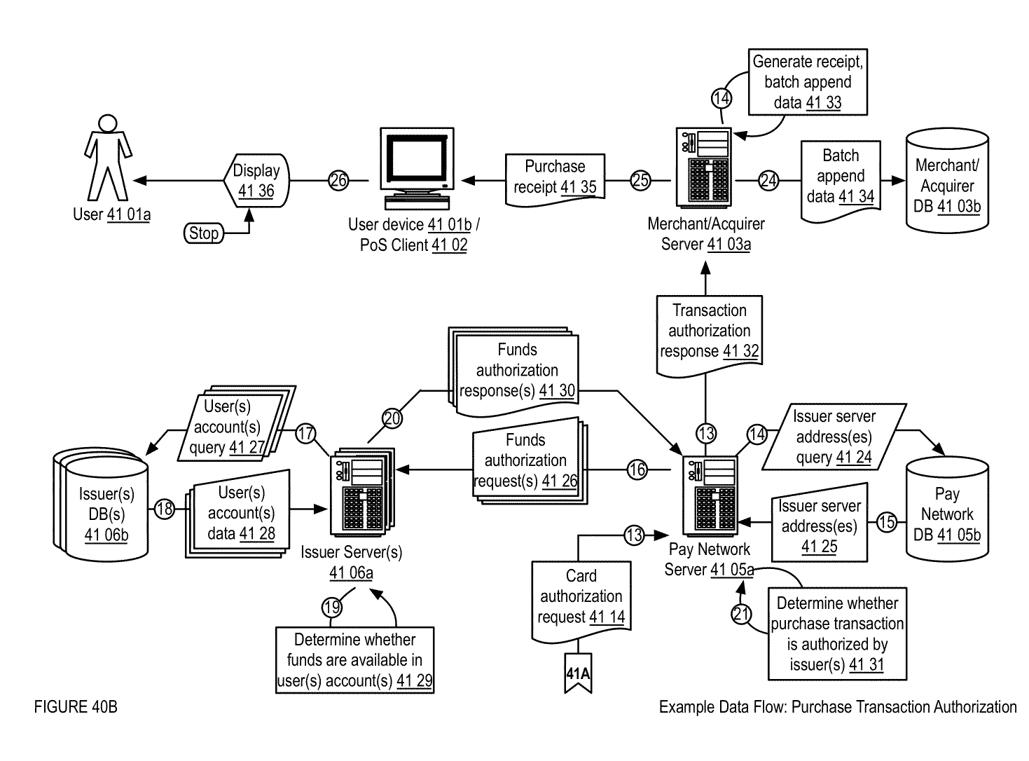

Further implementations of a purchase transaction are discussed in FIGS. 40A-43B.

In one implementation, the Ad-Track server 220 may obtain an indication of the user purchase from a purchase request 224b received from a merchant 220. In another implementation, a payment network/issuer (e.g., Visa) 240 may receive and process the purchase request 224b from the merchant 250 and may provide a purchase confirmation 224c to the Ad-Track server 220 as an indication of purchase transaction when the transaction is finished and cleared. For example, the purchase confirmation message 224c may include fields similar to that of the purchase request, including fields such as the product information, merchant information, a timestamp, and/or the like.

In one implementation, the Ad-Track server 220 may determine whether the purchase is correlated with any prior ad exposure activity 227, e.g., see FIGS. 3B-3C. For example, in one implementation, the Ad-Track may determine whether the purchase transaction is a result of consumer exposure to an ad, or the consumer naturally having the propensity to shop with the merchant. In another example, the Ad-Track may determine a next possible purchase interval (e.g., if a consumer has bought a plasma TV, it is unlikely the consumer may purchase a second one within 6 months, etc.). In another example, the Ad-Track may determine complementary products to the purchase transaction (e.g., video gaming gadgets as complementary to the purchase of a plasma TV, etc.). Upon the correlation, the merchant 250 may determine whether an affiliate payment 233 is due to the Ad-Track server 220 and/or the advertising channel 230, as further discussed in FIG. 3A. In an alternative implementation, the Ad-Track server 220 may receive an indication of the purchase (e.g., via the consumer's wallet, via the Ad-Track java applet if the consumer makes an online purchase, etc.), and then determine a correlation of the purchase between the purchase and the consumer's Internet activity. For example, if the merchant record shows the consumer has never purchased any products from the merchant in the past six months, but the purchase is made after a subsequent viewing of the merchant's advertisement, as indicated in the internet activity 215 recorded at the Ad-Track server 220, the merchant may provide affiliate payment to Ad-Track server 220 and the advertising channel 230 based on their agreement, e.g., 2% of the purchase price to Ad-Track server, 2% to the advertising channel (e.g., Google, etc.).

In one embodiment, the merchant may provide an incentive rewards to the consumer, e.g., a rebate amount, etc., for using Ad-Track. For example, after the consumer has made a purchase, and the Ad-Track server has correlated the purchase to the consumer's internet activity of viewing an Ad-Track advertisement of the product, the merchant 250 may allocate 2% of the purchase price of the purchase as an incentive rewards to the consumer. In one implementation, the Ad-Track server credit the incentive rewards to the consumer's electronic wallet. In alternative implementations, a variety of incentive awards may be provided to the consumer, such as store points, coupons, sample gifts, and/or the like.

In one implementation, the merchant may provide affiliate payment to the Ad-Track server 220, which may re-distribute the affiliate payment to the consumer as incentive rewards, and affiliate payment to the advertising channels 230 for advertising fee. For example, the merchant may allocate 6% of the purchase price of a transaction to the Ad-Track server 220, and request 2% be re-distributed to an advertising channel (e.g., Google, etc.), and 2% be credited to the consumer.

In one embodiment, the Ad-Track server 220 may establish data records of registered consumers, merchants, past transactions 223 for storage in a database 219. For example, in one implementation, the consumer/merchant transaction record 223 may comprise information with regard to the purchase price, a purchase time-stamp, conditions of the purchase (e.g., whether eligible for Ad-Track affiliate payment), and/or the like.

For example, an exemplary XML record of a transaction may take a form similar to the following:

```
<Transaction>
    <TransactionID> 223456789 </TranactionID>
    <TransactionTime> 09:10:23 06-06-2000 </TransactionTime>
    <TransactionPrice> 39.99 </TransactionPrice>
    <ProductID> BR-Men-89999 <?ProductID>
    <Merchant>
        <MerchantID> M0008 </MerchantID>
        <MerchantName> Banana Republic </MerchantName>
        <ProductID> BR_Men_Sweater_89999 </ProductID>
        <MerchantRule>
            <TimeFrame> 280 days </TimeFrame>
            <PurchseRange> Category <PurhcaseRange>
            <BrandRange> Banana Republic <BrandRange>
            <AffiliatePaymentRule>
                <Rule1>
                    <Amount> 2% </Amount
                    <Entity> Ad-Track <Entity>
                </Rule1>
                <Rule2>
                    <Amount> 2% </Amount>
            ... <Entity> Google <Entity>
                </Rule2>
                <Rule3>
                    <Amount> 2% </Amount>
            ... <Entity> Consumer <Entity>
                </Rule3>
                ...
            </AffiliatePaymentRule>
            ...
        </MerchantRule>
            <EligibleSourceSites>
                <Site1> www.bananarepublic.com </Site1>
                <Site2> www.Amazon.com </Site2>
                <Site3> www.6pm.com </Site2>
            ...
            </EligibleSourceSites>
        ...
    </Merchant>
    <ConsumerID> 00001 </ConsumerID>
        <ConsumerWalletID> Wallet8888 </ConsumerWalletID>
    <Consumer>
    <ConsumerHistory>
        <Brand> banana republic </Brand>
        <ProductRange> Men's apparel </PRoductRange>
        <PurchaseRecord> Null </PurchaseRecord>
        ...
        </ConsumerHistory>
        ...
    <AffiliatePayment>
        <Payment1>
            <Amount> 0.8 </Amount>
            <Entity> Ad-Track <Entity>
        </Payment1>
        <Payment2>
            <Amount> 0.8 </Amount>
            ...<Entity> Google <Entity>
        </Payment2>
        <Payment3>
            <Amount> 0.8 </Amount>
            ...<Entity> Consumer <Entity>
        </Payment3>
        ...
    </AffiliatePayment>
    ...
</Transaction>
```

In the above XML example, the purchase includes a product from the merchant “Banana Republic,” and the merchant may specify rules for the affiliate payment eligibility, e.g., a time frame of 280 days prior to the purchase, during which the consumer did not purchase any product of the same “category,” e.g., Banana Republic men's apparel. For another example, the merchant may expand the purchase range to the entire brand name, e.g., requiring a consumer with no prior purchase of any Banana Republic products within the past 280 days, etc. The merchant may further specify that purchases made via a list of participating sites are eligible to be considered for affiliate payment, e.g., Amazon.com, etc. The merchant may further specify the affiliate payment rule, e.g., splitting 2% of the purchase price to the Ad-Track, Google and the consumer, etc.

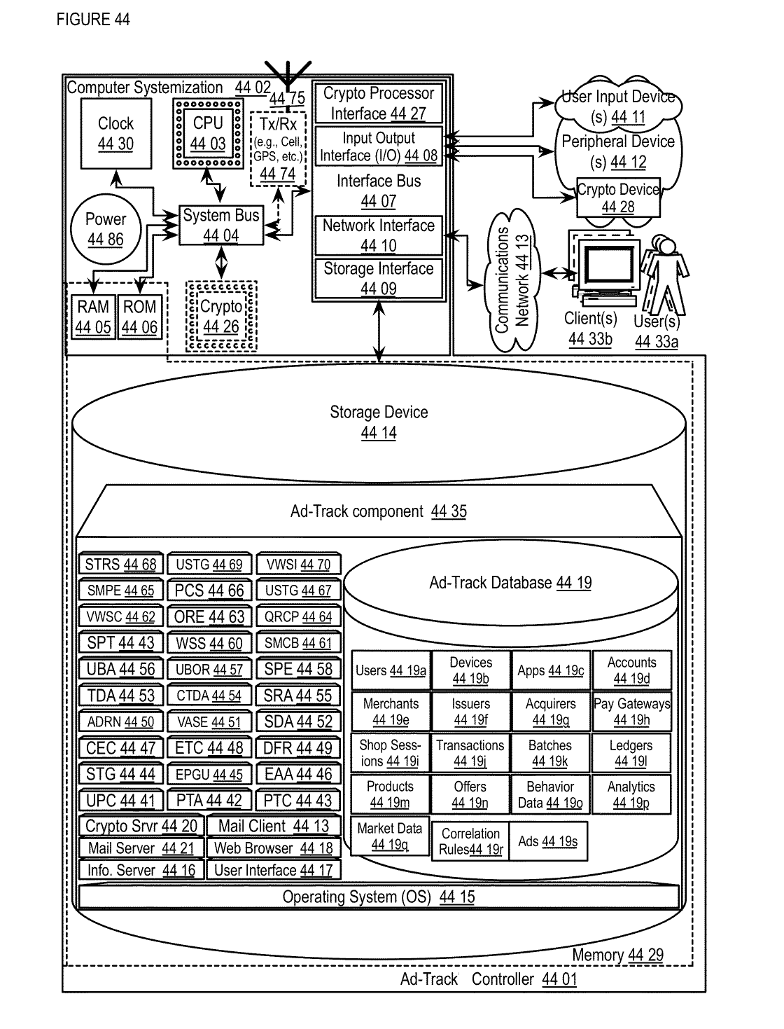

In some embodiments, the Ad-Track server 220 may store the transaction record by issuing PHP/SQL commands to store the data to the database table (such as FIG. 44, Transactions 4419j). An example transaction record store command 223, substantially in the form of PHP/SQL commands, is provided below:

```
<?PHP
header(‘Content-Type: text/plain’);
mysql_connect(“254.92.185.103”,$DBserver,$password); // access
database server
mysql_select(“Ad-Track_DB.SQL”); // select database to append
mysql_query(“INSERT INTO TransactionTable (transaction_id,
  transaction_date,  requested_time, receipt_time, user_id,
  user_name, user_password, account_no, total_amount,
  transfer_log, payee_id, payor_id, transfer_amount ...)
VALUES ($transaction_id$, $transaction_date$, $requested_time$,
  $receipt_time$, $user_id$, $user_name$, $user_password$,
  $account_no$, $total_amount$,  $transfer_log$,
  $payee_id$, $payor_id$, $transfer_amount$ ...); //
add data to table in database ; // add data to table in database
mysql_close(“Ad-Track_DB.SQL”); // close connection to database
?>
```

With reference to FIG. 2B, a consumer data aggregator 270 may collect various consumer data from various sources (e.g., see 1101-1105 in FIG. 11).

For example, in one implementation, the consumer operating a mobile wallet 203 may obtain store injection data 255a from the merchant store, and forward such injection data 255b indicating consumer activities in a physical merchant sore to the consumer data aggregator 270. In one implementation, the store injection data 255a-b may comprise the consumer's GPS location information, duration of the stay, price-checking using barcode/QR code scanning via the mobile wallet, and/or the like. For example, the mobile wallet 203 may provide an store injection data message 255b to the Ad-Track server as a HTTP(S) POST message including XML-formatted data. An example listing of an store injection data message, substantially in the form of a HTTP(S) POST message including XML-formatted data, is provided below:

```
POST /store_event.php HTTP/1.1
Host: www.merchant.com
Content-Type: Application/XML
Content-Length: 667
<?XML version = “1.0” encoding = “UTF-8”?>
<store_event>
    <event_ID> BR_1122 </event_ID>
    <timestamp>2015-12-18 17:15:56 </timestamp>
    <event_type> check-in </event_type>
    <GPS> 38°53′22.0000″N 77°2′6.000″W </GPS>
    <store_location>
        <address_line1> 133 palm street </address_line1>
        <address_line2> San Isla, CA </address_line>
        <zipcode> 00000 </zipcode>
        ...
    </store_location>
    <merchant>
        <merchant_id> BR001 </merchant_id>
        <merchant_name> Banana republic </merchant_name>
        <merchant_category> apparel </merchant_category>
        ...
    </merchant>
    <user>
        <wallet_id> JS-001 </user_id>
        <user_name> John Smith </user_name>
        <user_number> 000-000-0001 </user_number>
        ...
    </user>
    <duration> 00:56:34 </duration>
    ...
    </store_event>
```

In the above example, the store injection data message 255b includes the GPS information of a physical “Banana Republic” store and indicates that the consumer “John Smith” has visited and stayed in the store for 56 minutes. In another example, other store event types may reflect in-store ad exposure to the consumer, such as price checking, etc. Another example listing of an store injection data message 225b, substantially in the form of a HTTP(S) POST message including XML-formatted data, is provided below:

```
POST /store_event.php HTTP/1.1
Host: www.mobile-wallet.com
Content-Type: Application/XML
Content-Length: 667
<?XML version = “1.0” encoding = “UTF-8”?>
<store_event>
    <event_ID> BR_1122 </event_ID>
    <timestamp>2015-12-18 17:15:56 </timestamp>
    <event_type> price check </event_type>
    <GPS> 38°53′22.0000″N 77°2′6.000″W </GPS>
    ...
    <merchant>
        <merchant_id> BR001 </merchant_id>
        <merchant_name> Banana republic </merchant_name>
        <merchant_category> apparel </merchant_category>
        ...
    </merchant>
    <user>
        <wallet_id> JS-001 </user_id>
        <user_name> John Smith </user_name>
        <user_number> 000-000-0001 </user_number>
        ...
    </user>
    <product>
        <product_id> MC0001 </ProductID>
        <product_name> men sweater spring </product_name>
        <product_description>
            <QR_code> 877fsf.jpg </QR_code>
            <color> navy </color>
            ...
        </product_description>
        <price> 99.99 </price>
        ...
    </product>
    <purchase_channel>
        <channel1>
            <url> www.amazon.com </url>
            <price> 99.99 </price>
            <activity> none </activity>
            ...
        </channel1>
        <channel2>
            <url> www.shop.com </url>
            <price> 85.99 </price>
            <activity> click </activity>
            ...
        </channel2>
    </purchase_channel>
...
</store_event>
```

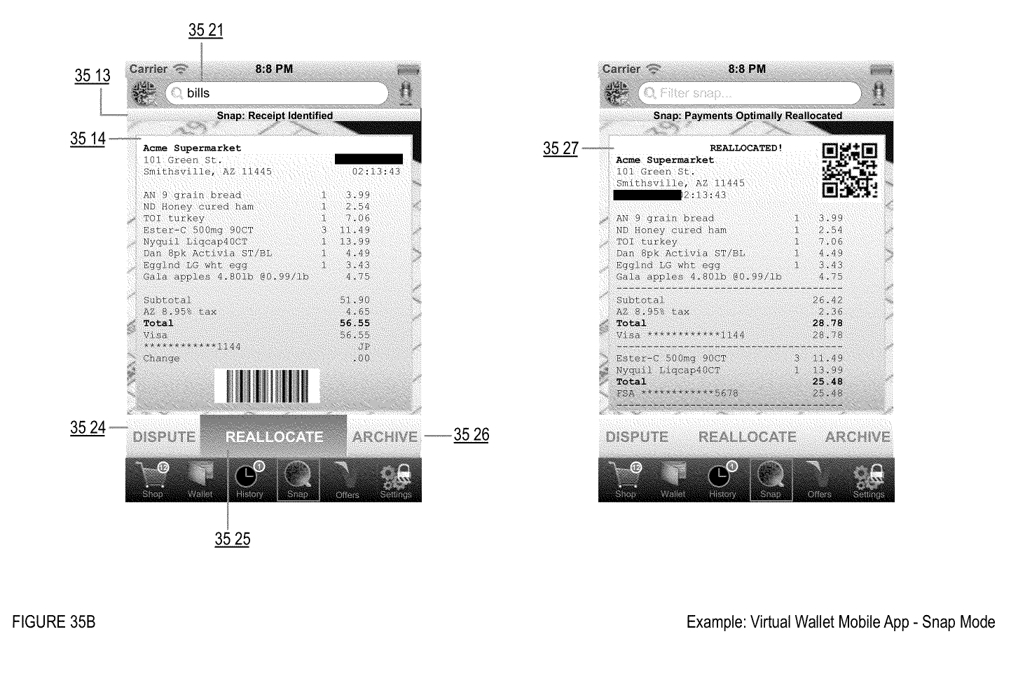

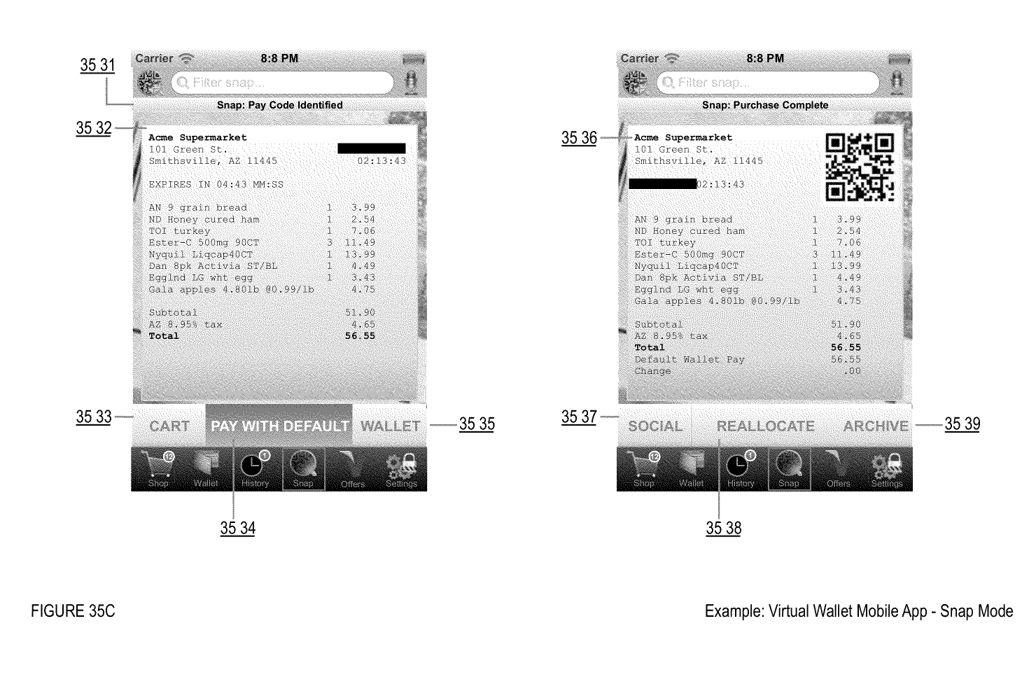

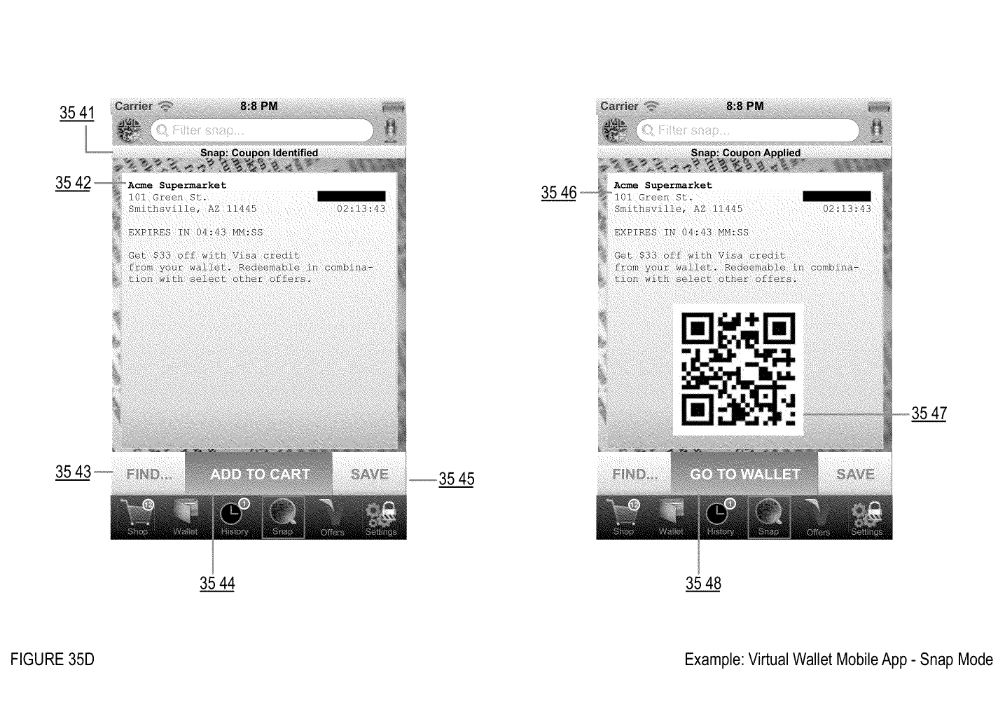

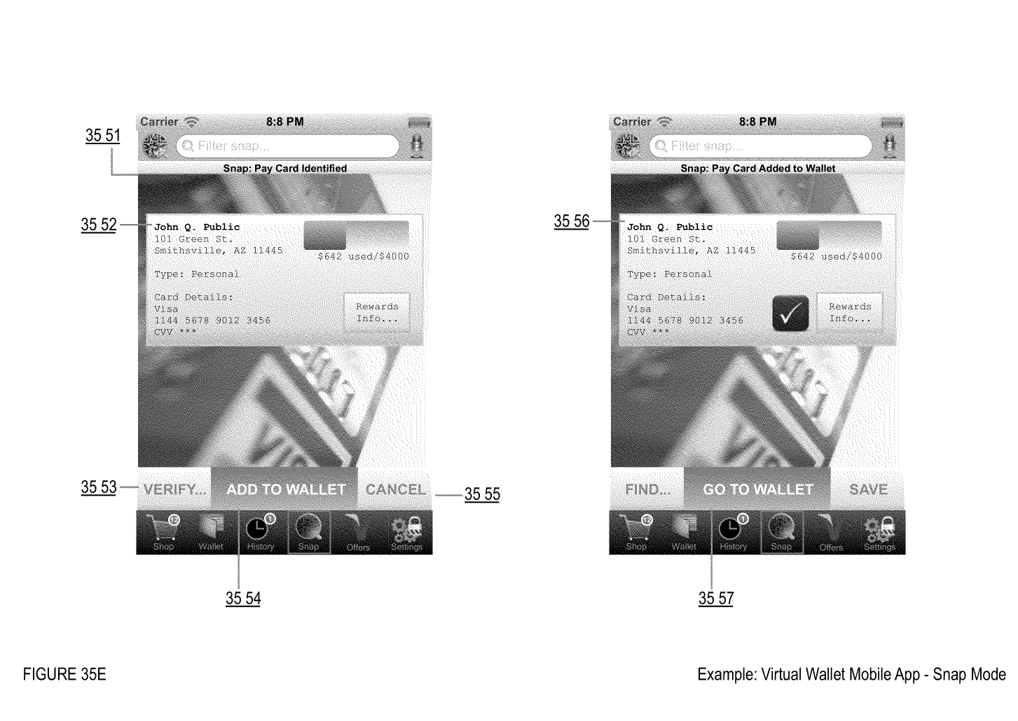

In the above example, the store injection data message 255b comprise information of consumer's price check of a product using a mobile wallet. For example, the consumer may operate his/her mobile wallet device (e.g., a smartphone, etc.) to scan a QR code of the product (e.g., see 3516 in FIG. 35A) and generate a price comparison check, e.g., the price listings on merchant sites “amazon.com” and “shop.com.” If the user has clicked on a searched merchant site, e.g., www.shop.com, such information is also fed to the consumer data aggregator 270, which may be considered as an ad exposure event. Further implementations of store injection data collection is illustrated in FIGS. 6A-6D.

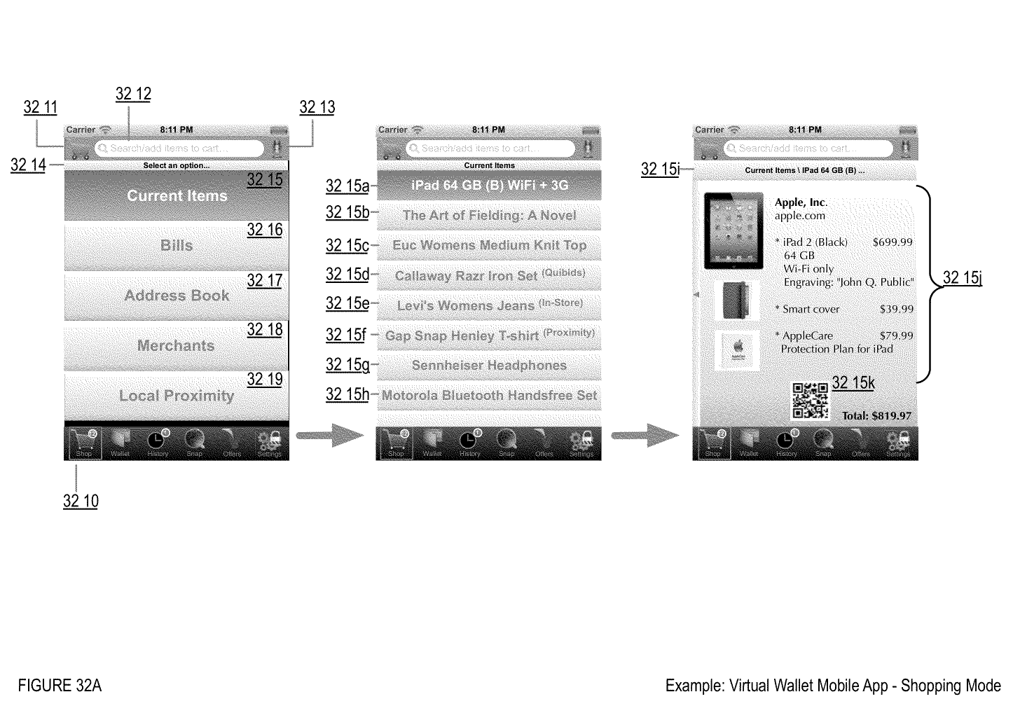

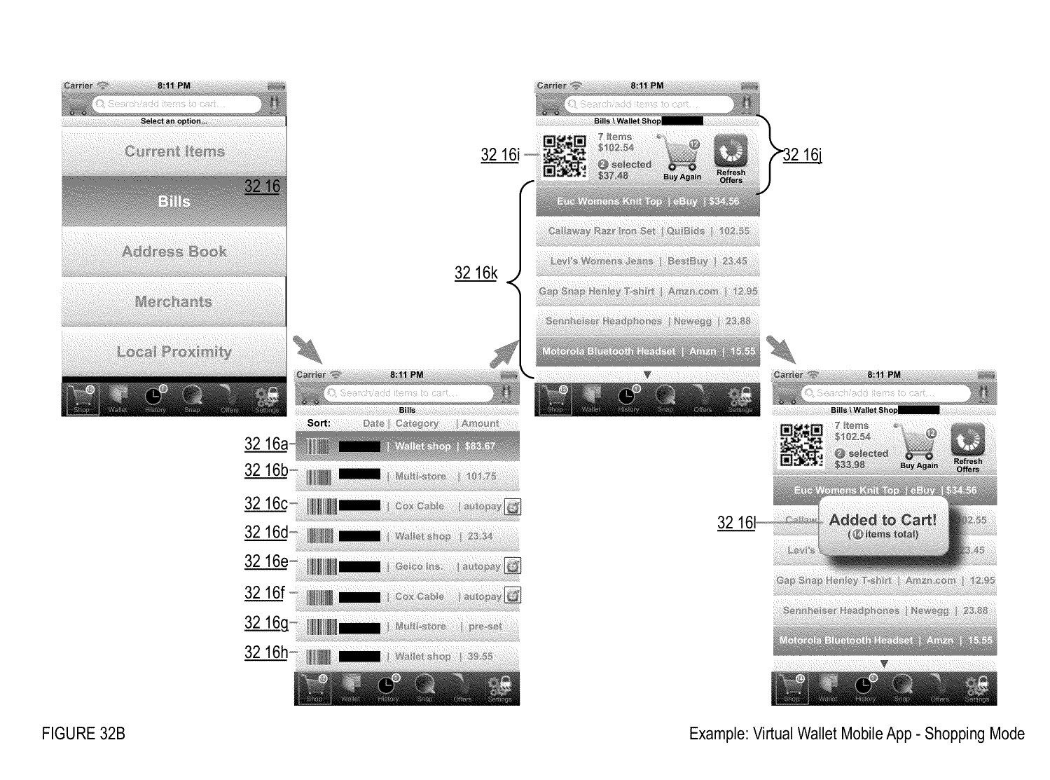

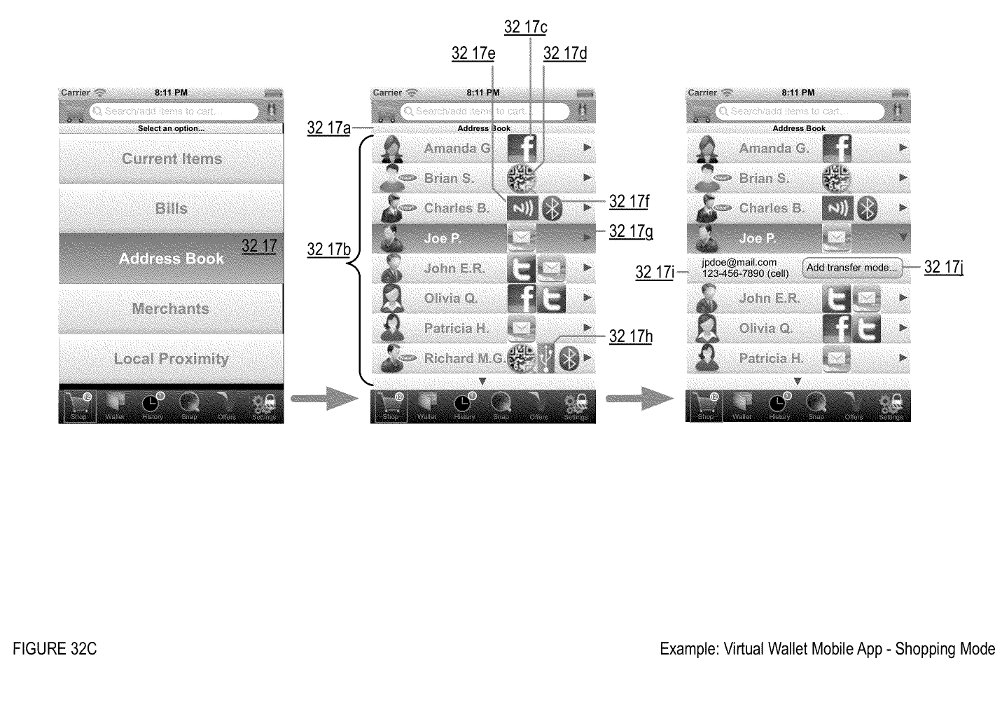

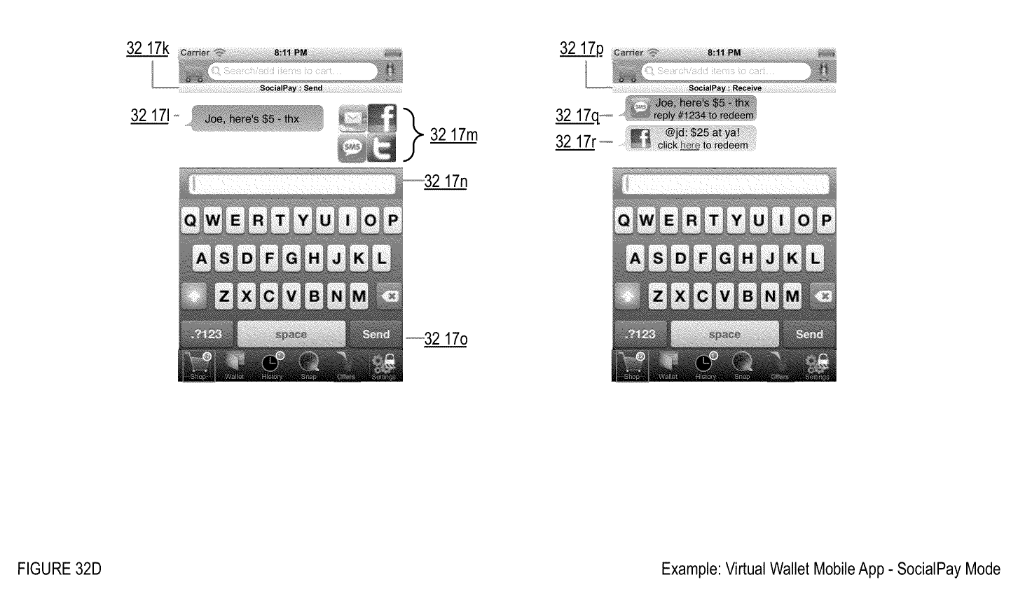

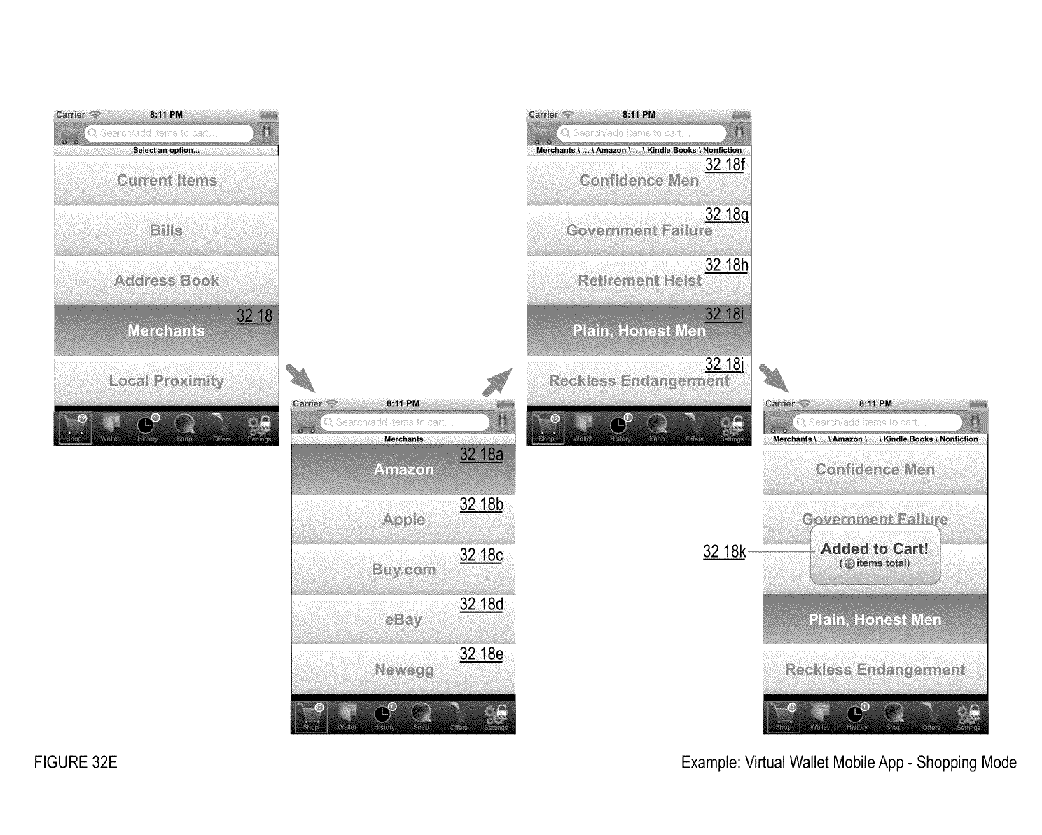

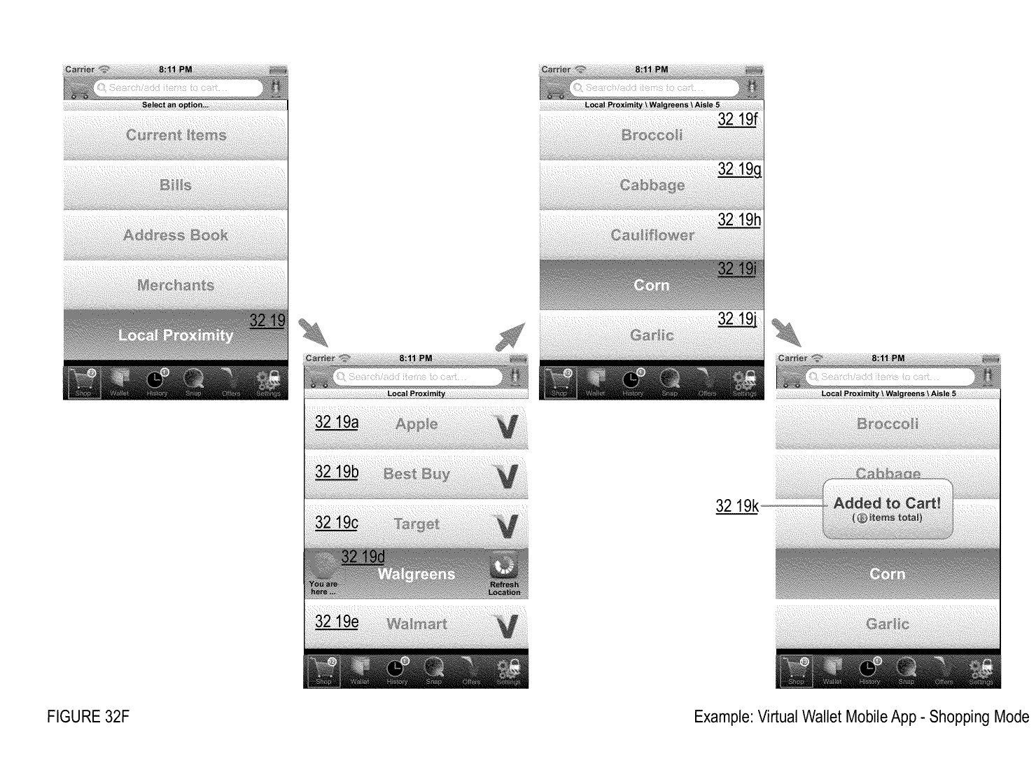

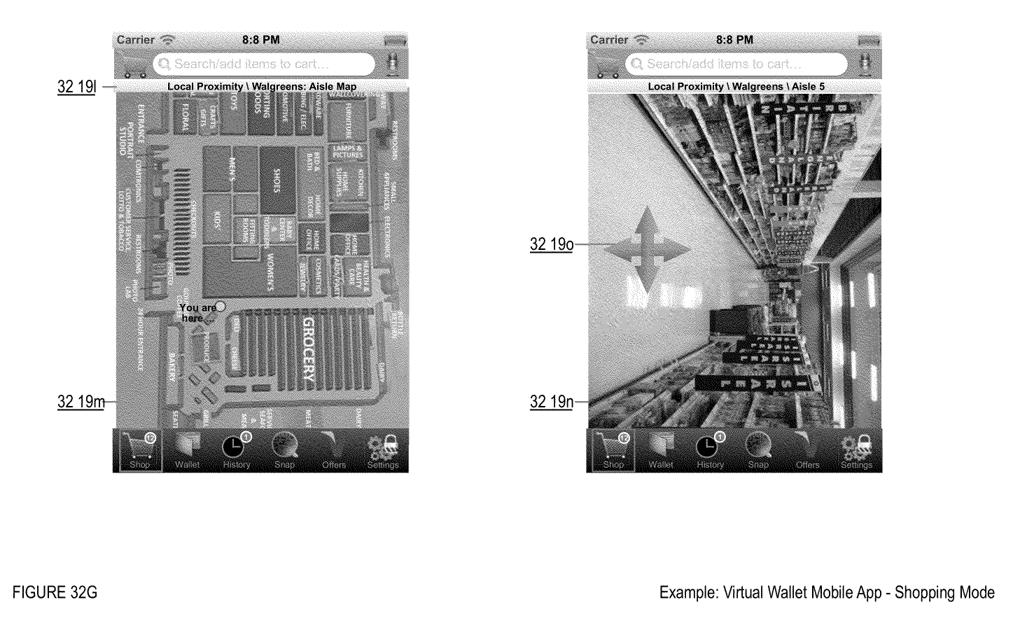

In another implementation, the consumer data aggregator 270 may obtain social media feeds 256 from a social media platform 260. For example, a consumer's social payment (e.g., see FIG. 32D), social comments, “like” event on Facebook, and/or the like, may reflect a consumer's sentiment towards a product, or a brand name.

For example, the social media platforms 260 may provide a social media feeds message 256 to the Ad-Track server as a HTTP(S) POST message including XML-formatted data. An example listing of a social media feeds message, substantially in the form of a HTTP(S) POST message including XML-formatted data, is provided below:

```
POST /social_feed.php HTTP/1.1
Host: www.social_media.com
Content-Type: Application/XML
Content-Length: 667
<?XML version = “1.0” encoding = “UTF-8”?>
<social_feed>
    <feed_ID> FB_0001 </feed_ID>
    <timestamp>2015-12-11 17:15:56 </timestamp>
    <social_platform>
        <name> Facebook </name >
        <server> www.facebook.com </server>
        <server_ip> 000.000.00.00 </server_ip>
        <feed_type> like </feed_type>
        <object> “Buy 1 get 1 50% Banana Republic Coupon” </object>
        ...
    </social_platform>
    <user>
        <wallet_id> JS-001 </user_id>
        <user_name> John Smith </user_name>
        <user_number> 000-000-0001 </user_number>
        ...
    </user>
        ...
    </social_feed>
```

In another implementation, the consumer data aggregator 270 may obtain updates from web crawl 258 from various website 230, e.g., consumer's blog posts, browsing activities, etc. For example, the web server 230 may provide an update message 258 to the Ad-Track server as a HTTP(S) POST message including XML-formatted data. An example listing of an web update message 258, substantially in the form of a HTTP(S) POST message including XML-formatted data, is provided below:

```
POST /web-claw.php HTTP/1.1
Host: www.variousweb.com
Content-Type: Application/XML
Content-Length: 667
<?XML version = “1.0” encoding = “UTF-8”?>
<web_claw>
    <web_ID> web_0001 </feed_ID>
    <timestamp>2015-12-11 17:15:56 </timestamp>
    <user>
        <wallet_id> JS-001 </user_id>
        <user_name> John Smith </user_name>
        <user_number> 000-000-0001 </user_number>
        ...
    </user>
    <source> www.amazon.com </source>
    <event_type> rating </event_type>
    <product>
        <product_id> MC0001 </ProductID>
        <product_name> men sweater spring </product_name>
        <product_description>
            <color> navy </color>
            ...
        </product_description>
        <price> 99.99 </price>
        ...
    </product>
...
</web_claw>
```

Further implementations of aggregating consumer related data from social media, web, and/or various internet resources are further illustrated in FIG. 11.

In one implementation, the consumer data aggregator 270 may aggregate consumer ad exposure data 259, and store the aggregation results in a data store. In one implementation, the Ad-Track server 220 may generate an ad exposure query 261 to the consumer data aggregator 270. For example, when the Ad-Track server 220 has received a purchase indication (e.g., see 224b in FIG. 2A), the Ad-Track server 220 may query on the purchased item to determine whether the consumer has prior ad exposure for the purchased item.

For example, the Ad-Track server 220 may issue PHP/SQL commands to query a database table (such as FIG. 44, social 4419, web data 4419) for ad exposure data. An example ad exposure data query 261, substantially in the form of PHP/SQL commands, is provided below:

<?PHP
header(‘Content-Type: text/plain’);
mysql_connect(“254.93.179.112”,$DBserver,$password); // access
database server
mysql_select_db(“Ad-Track_DB.SQL”); // select database table to
search
//create query
$query = “SELECT comment like access FROM SocialTable WHERE
product LIKE ‘%’
$Banana Republic”;
$result = mysql_query($query); // perform the search query
mysql_close(“Ad-Track_DB.SQL”); // close database access
?>

In some embodiments, the Ad-Track server may receive an ad exposure data 262 query results from the consumer data aggregator 270, indicating whether there is prior ad exposure to the queries product name, or brand name. For example, the ad exposure data 262 may comprise any previously stored ad exposure record in a form similar to the received store injection data 255b, social media feeds 256, web crawl 258, and/or the like. The Ad-Track server 220 may then proceed to correlation at 227 in FIG. 2A.

FIGS. 3A-3B provide logic flow diagrams illustrating embodiments of the Ad-Track. Within embodiments, a consumer may submit consumer registration information 305 to register with the Ad-Track. For example, a consumer may establish a user account with the Ad-Track, and submit payment information (e.g., a credit card, a debit card, a checking account, PayPal account, etc.) to Ad-Track in order to register 310. In one embodiment, upon user registration, the Ad-Track may run a remote component (e.g., Java Applet, etc.) at the consumer's browser to track consumer's Internet browsing behaviors. Further wallet implementations are discussed in FIGS. 31-37B.

In one embodiment, a merchant, e.g., a brand name product company, etc., may register with the Ad-Track by submitting merchant information 308. In another implementation, the merchant may submit a request to advertise to the Ad-Track, so that the Ad-Track may generate an advertising component for display at the consumer terminal for the merchant. In an alternative implementation, the merchant may submit information with regard to a third party advertising channel wherein the merchant's products are advertised, to the Ad-Track 120.

In one embodiment, upon registration with Ad-Track, a consumer may initiate Internet research for a desired product 315. For example, if the consumer wants to buy a sweater, he may initiate a search based on key term “sweater.” In one implementation, during the course of the Internet research for a sweater, the consumer may trigger an event which sends an indication to Ad-Track indicating the consumer is looking for a “sweater.” The consumer's device may send a query to search network, e.g., Google, Yahoo, Bing, etc., or may click on certain ads. Such indication of interests may be saved as an ad cookie on the consumer device, intercepted by the use of a plug-in of the consumer's web browser, captured in log by the target of the search, e.g., web search engine, advertising networks, merchants, etc.) those targets may subsequently make the search terms available to the Ad-Track, and/or the ad networks; such information may be passed as a data structure through a HTTP POST message (e.g., se 215 in FIG. 2A). For example, the triggered event may include, but not limited to consumer clicking on a search advertisement of “men's sweaters”, consumer clicking on a display advertisement of “men's sweaters,” consumer interacting with an advertisement related to “men's sweaters” for an extended period, consumer visiting a merchant website featuring “men's sweaters,” consumer visiting a product review website related to “men's sweaters,” and/or the like.

In one implementation, the Ad-Track may receive the event trigger and query for registered related merchants 320. For example, in one implementation, if the consumer clicks on an advertisement for “new collection for men's sweaters,” the Ad-Track may receive this indication that the consumer is interested in “men's sweaters,” and may form a query in its merchant database for merchants that offer “men's sweaters.”

In one implementation, the Ad-Track may instantiate an advertisement component (e.g., on the browser, etc.) for a queried merchant 325. For example, the Ad-Track may determine “Banana Republic” offers “men's sweaters,” and may then display an advertisement for Banana Republic to the consumer. In one implementation, there may be more than one registered merchants that offer “men's sweaters.” In one implementation, the Ad-Track may sort a list of advertisements of different merchants based on a variety of metrics, such as, but not limited to relevancy, the percentage of affiliated payment the merchant is willing to pay Ad-Track, and/or the like.

In one embodiment, the consumer may view the provided advertisement and submit an indication of view the advertisement to Ad-Track 330, e.g., by clicking on the advertisement. The Ad-Track may store the indication 333, e.g., a time-stamp, an advertisement ID, a consumer ID, and/or the like. As such, to this point, the Ad-Track may operate as an ad network. In one embodiment, Ad-Track may communicate with an ad network, and otherwise shed such ad network features itself, and provide indication of transactions while performing operations as follows.

In one implementation, a consumer may subsequently make a purchase of the advertised product 335, e.g., a Banana Republic sweater for men as discussed in the above example. Within a variety of implementations, the consumer may purchase the product via a variety of commercial channels, such as in-store, via the merchant website, via a shopping website (e.g., Amazon.com, macys.com, etc.), and/or the like.

In one implementation, information that used to confer an eligible product has been purchased by the consumer may be obtained from the user device (e.g., an electronic wallet on a mobile device, etc.), the merchant, an issuer and/or payment network cooperating with the Ad-Track system. In one implementation, registered consumers may have all account transactions that occur with registered accounts serve as a trigger to determine if such purchased item are eligible for Ad-Track rewards.

In an alternative embodiment, when the merchant has no direct relationship with Ad-Track, a merchant may charge a consumer's payment account for the purchase, and the transaction may be processed by a payment network and/or an issuer (e.g., Visa, etc.). The Ad-Track may be disposed with communication with the payment network/issuer, and thereby may be provided the payment indication through such networks (e.g., see 224b in FIG. 2A).

Upon receiving payment from the consumer 338, the merchant may confirm purchase transaction with a payment network. For example, the Ad-Track may receive purchase confirmation 339 from the merchant, the payment network, and/or the like. In one implementation, the merchant and the Ad-Track may determine whether the purchase is eligible for a merchant affiliate payment 340, e.g., whether the merchant should pay Ad-Track for advertising. In one implementation, rules for determining the eligibility may be established in a merchant-Ad-Track agreement. In one embodiment, the Ad-Track has aggregated different types of consumer activities (e.g., 215 in FIG. 2A; cookies, ad interception, click interception, search results 1101, transaction data aggregation 1102, service usage data aggregation 1103, enrollment data aggregation 1104, social data aggregation 1105, etc. in FIG. 11), all of which may be saved at an Ad-Track database and associated with a consumer identifier, and a timestamp at which the activity occurs. As such, the consumer activity Ad-Track database may be used to correlate activities with obtained purchase confirmation by the same consumer, and such database may be queried on rules that establish eligibility for revenue sharing, incentive rewards, and/or the like. For example, if the Ad-Track determines the consumer hasn't made a purchase with the merchant in the last 180 days, the merchant should pay a portion of the transaction amount to the Ad-Track. For another example, Ad-Track and the merchant may agree that if the purchase takes place within a short period of time (e.g., within 34 hours, etc.) subsequent to the time stamped indication of consumer viewing an advertisement at 333, Ad-Track is eligible for affiliate payment from merchant. For example, the Ad-Track may generate a query into the correlation rule table (e.g., 4419r in FIG. 44) to determine whether the purchase is correlated with the ad exposure:

```
<?PHP
header(‘Content-Type: text/plain’);
mysql_connect(“254.93.179.112”,$DBserver,$password); // access
database server
mysql_select_db(“Ad-Track_DB.SQL”); // select database table to
search
//create query
$query = “SELECT correlation_id, correlation_name,
    rule_sponsor, ad_fee_sponsor, ad_product_id,
    correlation_status FROM CorrelationTable WHERE
    purchase_interval LIKE ‘%’ $purchase_interval”;
$result = mysql_query($query); // perform the search query
mysql_close(“Ad-Track_DB.SQL”); // close database access
?>
```

In another example, if the consumer has repeatedly clicked on the advertisement by the same merchant (e.g., Banana Republic) within a period of time (e.g., a week), the correlation rule may acknowledge a subsequent purchase as a result of ad exposure. For example, the Ad-Track may generate a query into the correlation rule table:

```
<?PHP
header(‘Content-Type: text/plain’);
mysql_connect(“254.93.179.112”,$DBserver,$password); // access
database server
mysql_select_db(“Ad-Track_DB.SQL”); // select database table to
search
//create query
$query  =  “SELECT  correlation_id,  correlation_name,
    rule_sponsor,  ad_fee_sponsor,  ad_product_id,
    correlation_status  FROM  CorrelationTable WHERE
    visits_per_week LIKE ‘%’ $visits_per_week”;
$result = mysql_query($query); // perform the search query
mysql_close(“Ad-Track_DB.SQL”); // close database access
?>
```

For another example, eligibility of the purchased item may be determined 345 upon whether the consumer has “viewed” the advertisement by retrieving an indication 333, e.g., whether the user has clicked on, followed a link by a related advertisement of the merchant's product. As such, the Ad-Track would work regardless where the purchase takes place, e.g., online purchase, in-store purchase, and/or the like.

In one embodiment, if eligible, the merchant may through pay a portion (e.g., 5%) of purchase transaction to Ad-Track as an affiliate payment 350. In one implementation, this payment may be variable based on the consumer's previous activity—for example, if they had made a purchase (or multiple purchases) at the same merchant in the last 180 days, then the payment could be lower. In one implementation, Ad-Track may split the payment. For example, a portion of the payment (e.g., 3%) may be made to the site/channel where the most relevant driving event occurred, or splitting the payment amongst channels. For another example, a portion of the payment (e.g., 1%) may be made to the consumer as an incentive for participation 355. In one implementation, Ad-Track may provide rewards as incentive to consumers in a variety of forms, such as, but not limited to cash backs, coupons for next purchase, and/or the like.

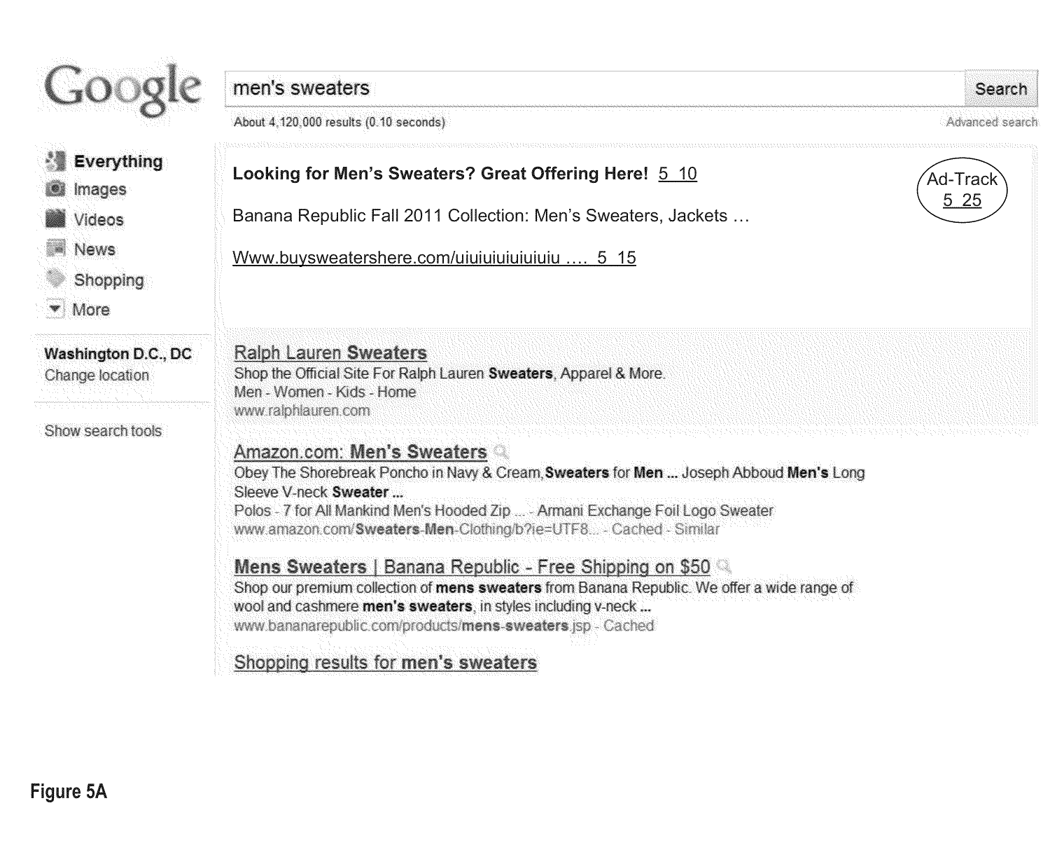

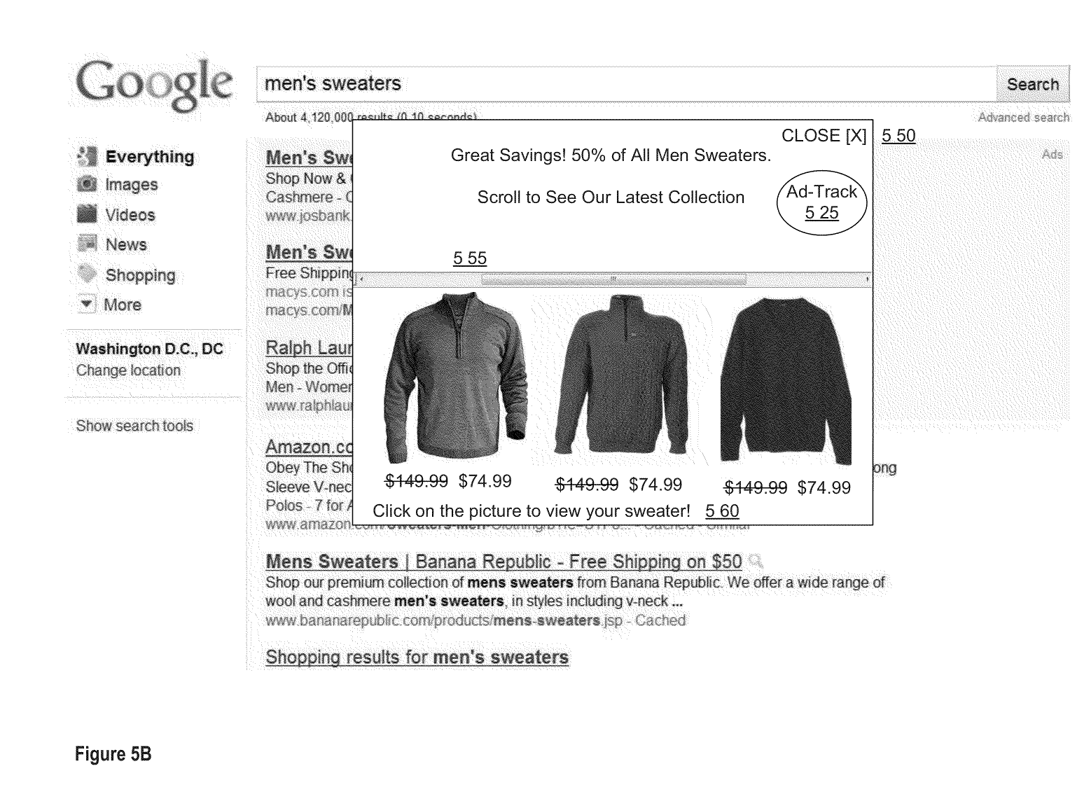

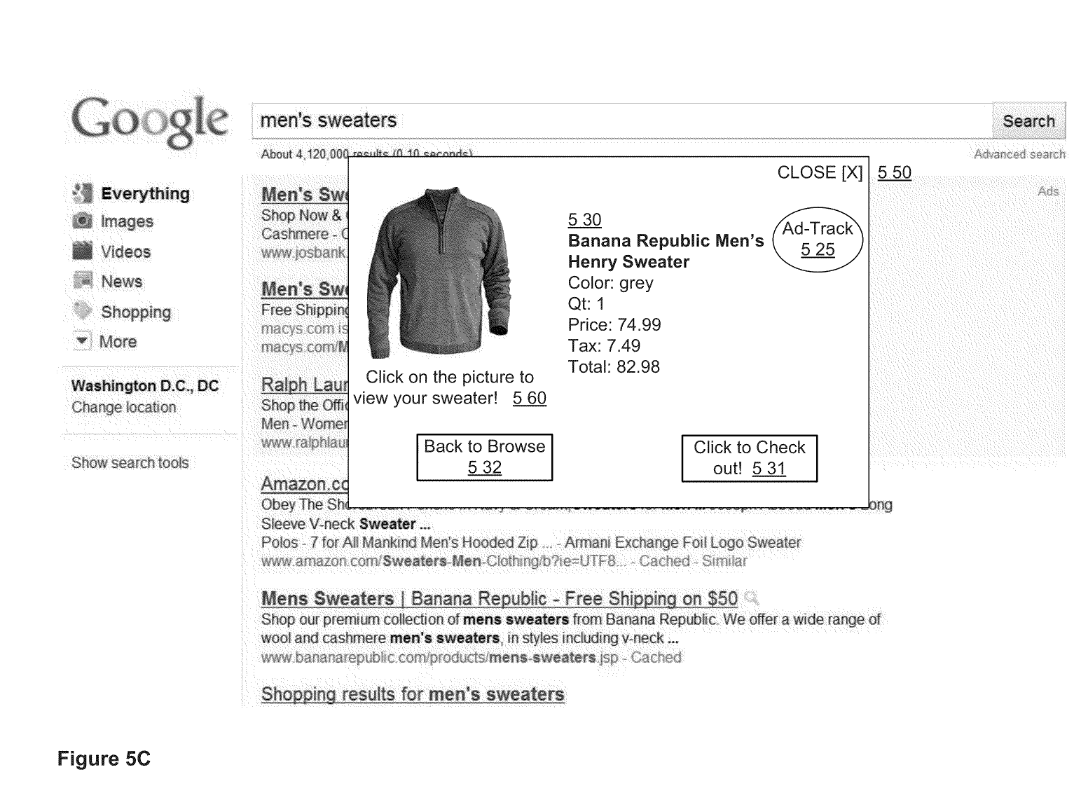

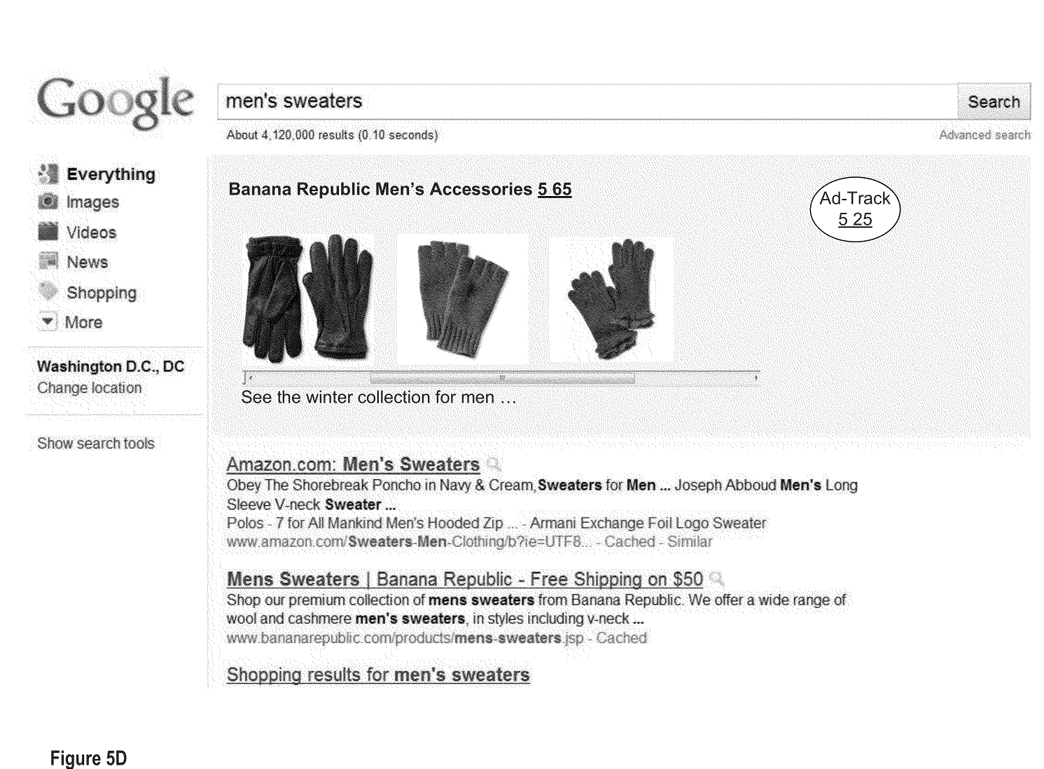

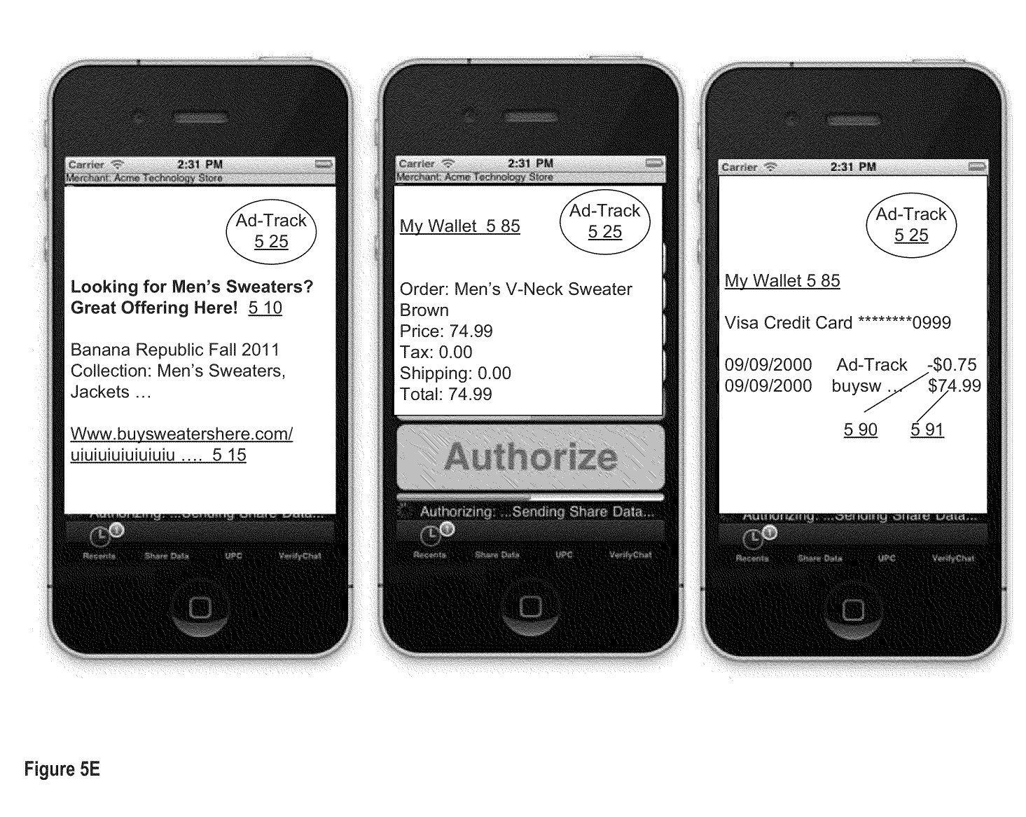

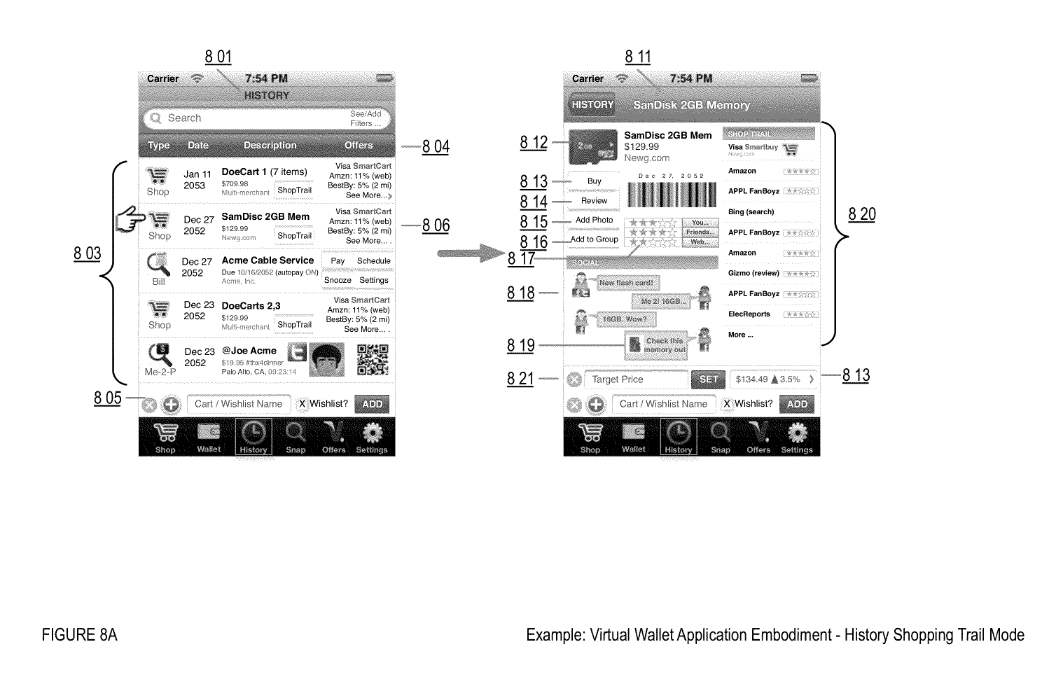

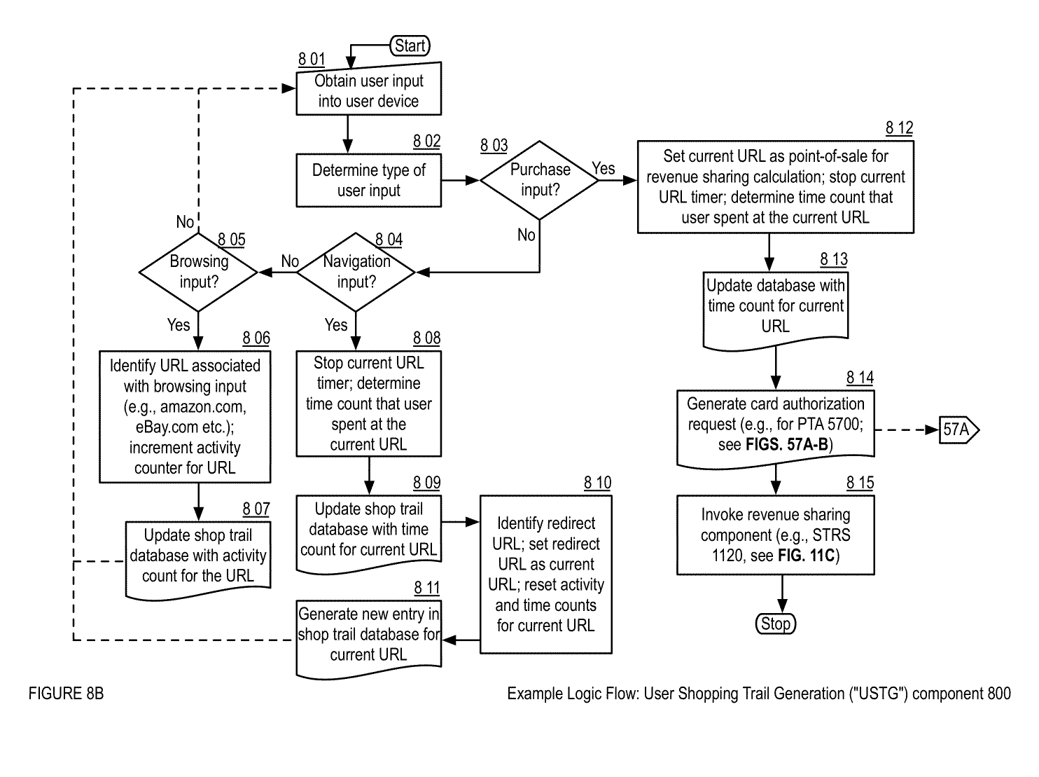

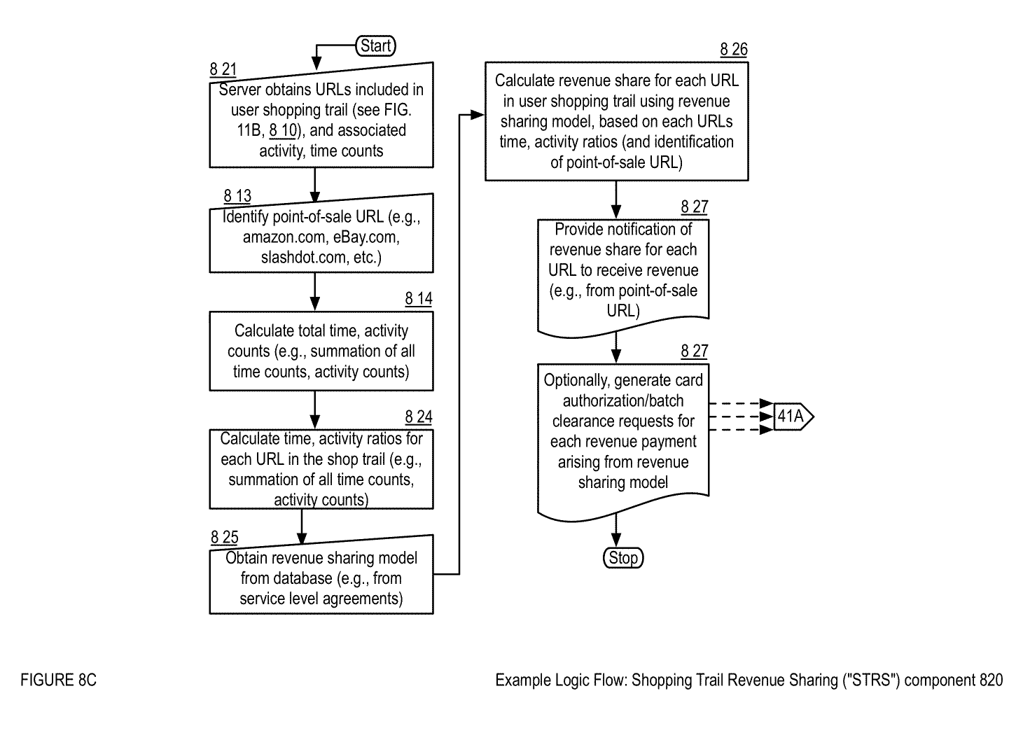

In one implementation, the Ad-Track rewards may be provided to the consumer in various ways. For example, a consumer may obtain cash back via his electronic wallet, as shown in FIG. 5C. For another example, a consumer may receive a check in the mail after the purchase, and/or the like. For another example, a consumer may obtain store points credited to a brand membership card, and/or the like. Further implementations of determining consumer purchasing heuristics are discussed in a shopping trail revenue sharing component at FIGS. 8A-8C.

FIG. 3B provides a logic flow diagram illustrating store injection data aggregation within embodiments of the Ad-Track. Within implementations, a consumer may start the process by walking into a merchant store 351. In one implementation, the consumer may operate a mobile wallet and submit a check-in message to the consumer data aggregator via the wallet check-in component 352a. In another implementation, the merchant may receive store injection request 352b, and provide merchant store information to aggregator via the mobile wallet.

Upon receiving a check message 353, the data aggregator may store the consumer location indication 354 from the check-in message and monitor further store injection data. If there is a store injection event message 355 received from the mobile wallet, the aggregator may extract product/brand information 356 from the message, e.g., the consumer may operate the mobile wallet to scan a barcode of a product, price check and comparison, checkout at a merchant POS, etc. In one implementation, the aggregator may determine whether there is an external URL 358a in the store injection message, e.g., the consumer may snap the barcode/QR code to conduct Internet search on the product, and/or conduct a price match which may direct the consumer to another URL. In one implementation, if there is no external link included in the store injection event message 355 (e.g., the message is not a price match/search event, etc.), the aggregator may generate and store the shop trail record 361 including the current merchant store, e.g., the store that consumer has walked in at 351.

In another implementation, if the store injection event message includes an external link and the consumer click on the external link 358a, e.g., from the price match results, the aggregator may proceed to determine a type of the link, e.g., whether it is a store injection to a new store 358b. For example, if the external URL 358a includes an advertisement of the product on “Newsdaily.com,” then the URL is not a store injection 358b, and the aggregator may store the external channel (e.g., “Newsdaily.com”) 359 and proceed to 335.

In another implementation, if the external link is a store injection 358b, e.g., the consumer may be directed to another online store (e.g., Amazon.com, buy.com, etc.) 358b, the aggregator may include the new store into the shop trail 360, and generate and store the shop trail record 361. In one implementation, the currently injected store merchant (e.g., Amazon.com, buy.com, etc.) may receive a store check-in message e.g., at 352b. Further implementations of the store injection shop trail are discussed in FIG. 6E.

The aggregator may store the external channel 359 if it is visited by the consumer and generate/store the injection record 361. Further discussions of store injection data aggregation are provided in FIGS. 6A-6D.

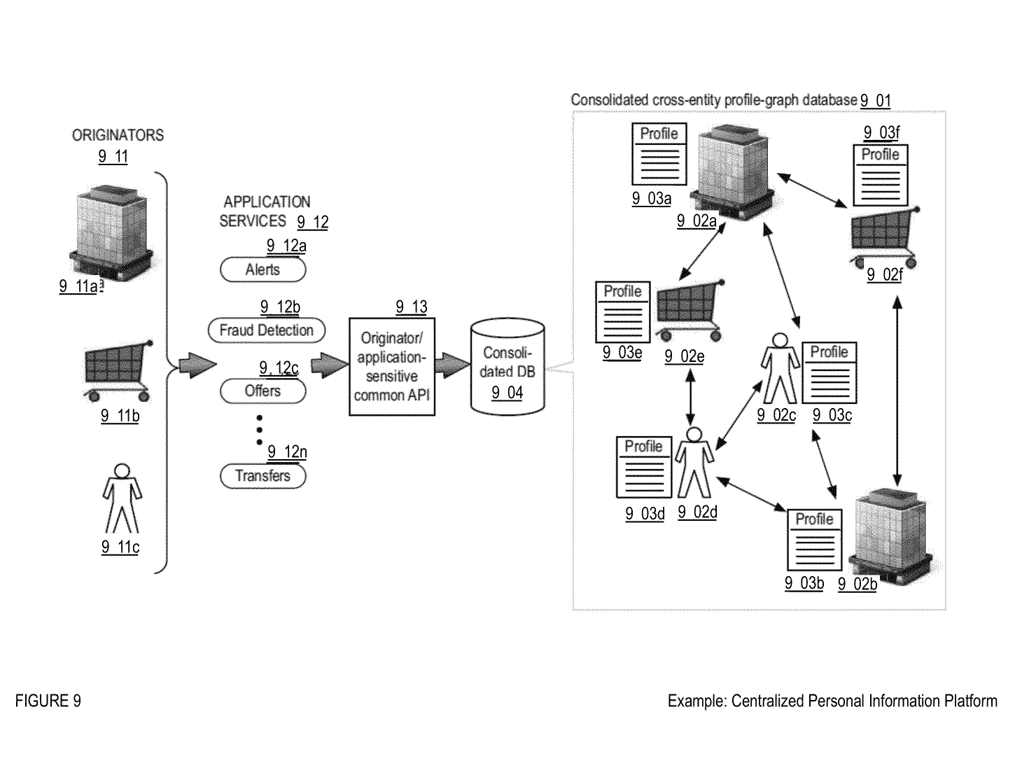

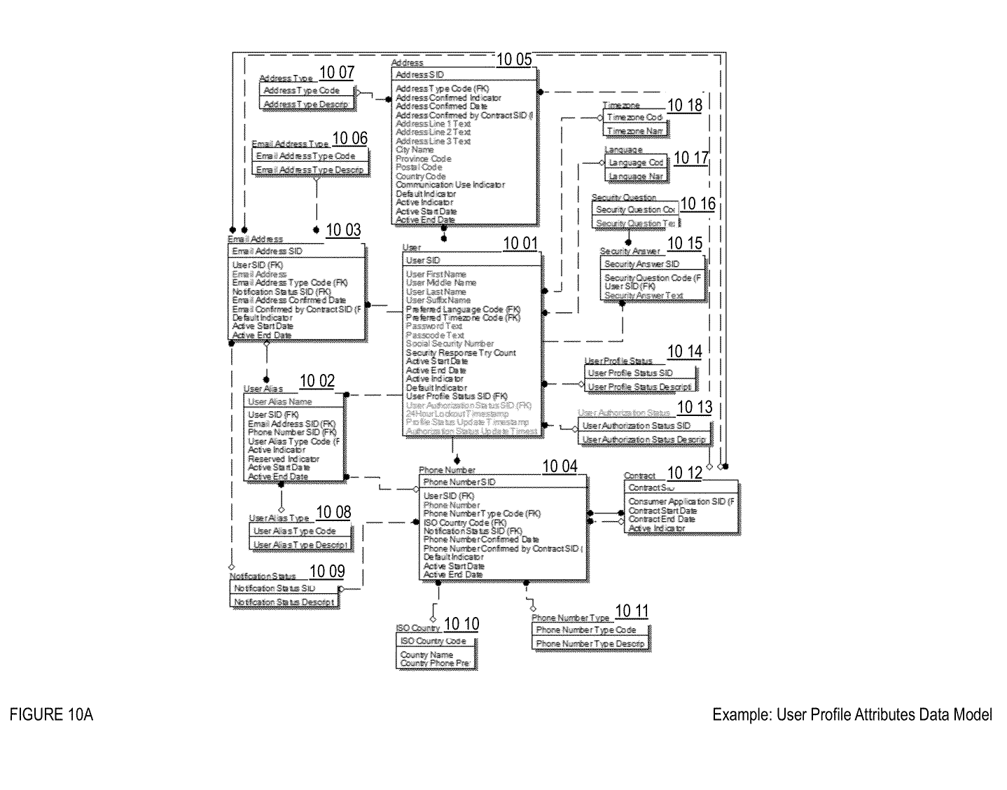

FIG. 4A provides a logic flow diagram illustrating predictive advertising within embodiments of the Ad-Track. Within implementation, the Ad-Track may collect various consume related activity data 404, e.g., store injection data 405a, browser cookie monitoring data 405b, “mesh” aggregated data 405c (e.g., see the centralized personal information platform discussed in FIGS. 9-30), and any additional tracking data 405d (e.g., consumer filled out questionnaire, etc.). The Ad-Track may generate consumer purchasing heuristics based on merchant rules 406. For example, a merchant may specify a rule that if a consumer has purchased a digital camera, advertisement of a related product, e.g., a camera bag, etc., shall be provided to the consumer. In another example, Ad-Track may establish rules and heuristics that if a consumer regularly purchases a product, advertisement of similar products shall be provided. In another example, Ad-Track may perform data mining on consumer purchasing pattern on a group of consumers and determine that consumers who bought a digital camera may have the propensity to purchase a camera bag, and may then correlate the purchase of a digital camera with a camera bag. For example, this may be achieved by having an Ad-Track table in the Ad-Track database having a field for “complementary_product_id” which may be supplied by merchants, manufacturers, advertisers, heuristics generated by the Ad-Track, and/or the like. As such, when a product has been purchased which is not likely to be purchased again for a short period of time (e.g., a plasma TV, etc.), the Ad-Track may purge the complementary product identifier in the table and use such query results to provide additional ads to the consumer.

For example, in one implementation, when the Ad-Track receives a purchase confirmation that a consumer has purchased a plasma TV, the Ad-Track may perform the following query for ads featuring complementary products:

```
<?PHP
header(‘Content-Type: text/plain’);
mysql_connect(“254.93.179.112”,$DBserver,$password); // access
database server
mysql_select_db(“Ad-Track_DB.SQL”); // select database table
to search
//create query
$query  =  “SELECT  ad_id,  ad_name,  ad_product_id,
    ad_data,  ad_merchant_id,  ad_template  FROM  AdsTable
    WHERE  ad_complementary_product_id  LIKE  ‘%‘
    “PlasmaTV001”;
$result = mysql_query($query); // perform the search query
mysql_close(“Ad-Track_DB.SQL”); // close database access
?>
```

In the above example, the Ad-Track may query for any complementary products which are labeled as complementary to the purchased plasma TV. For example, the complementary products may include video gaming gadgets, a TV stand, and/or the like.

In one implementation, when the Ad-Track receives a trigger event 410, e.g., the consumer has made a purchase, etc., the Ad-Track may determine related advertisement based on the generated heuristics 413 at step 406. The Ad-Track may receive a batch of triggers (e.g., transaction records, etc.), and may review and analyze each record 414 until there is no more triggers. In one implementation, for example, if the trigger event indicates a purchase of relatively long-lasting goods, e.g., a plasma TV, a mattress, etc., the Ad-Track may determine not to provide advertisements of similar products to the consumer within a period of time (e.g., 6 months, etc.), as consumer purchasing pattern may reflect that it is rare a consumer may consecutively purchase a plasma TV within 6 months.

In one implementation, upon receiving an advertisement (e.g., via an online channel, mobile wallet, social media, etc.), the consumer may interact with the ads 418, e.g., click-through, etc. Such activities may be captured by the aggregator for analysis.

FIGS. 4B-4C provides a logic flow illustrating correlating consumer trigger activities and purchases in one embodiment of the Ad-Track. In one implementation, upon Ad-Track receiving an indication that a registered consumer has purchased products from a registered merchant, the Ad-Track may retrieve consumer Ad-Track activity records 454, e.g., stored at 433, to determine whether the consumer has viewed a related advertisement. In one implementation, the Ad-Track may form a query based on the purchased product category, brand name, merchant name, and/or the like, to search for related advertisement 455.

In one implementation, the Ad-Track and/or the merchant may establish eligibility rule of advertisement. For example, the Ad-Track may require the purchased product and the advertisement must be within the same category, e.g., a consumer who has interacted with an advertisement on “Banana Republic collection on women's dresses” but has bought a men's sweater is not eligible. For another example, the Ad-Track and/or the merchant may have a more relaxed rule, e.g., as long as the consumer has viewed an advertisement with the brand, e.g., a consumer who viewed an ad on “Banana Republic collection on women's dresses” may likely view the men's collection as well.

If there is an Internet activity record 457 based on the eligibility rule, the Ad-Track may determine whether the ad has been “viewed” by the consumer 453, as the consumer may close the ad without viewing it. For example, the Ad-Track may determine whether the consumer has clicked on the presented ad 455. If not, the Ad-Track may determine whether the consumer has stayed on the ad 460 for a sufficient period of time, e.g., scrolling down the ad to view product listings, as shown in FIG. 234B. If the Ad-Track determines the consumer has “viewed” the ad, the Ad-Track may go on to determine whether the consumer viewing correlates to his subsequent purchase 465.

In one implementation, if the correlation is established 466, the Ad-Track may move on to determine an affiliate payment, e.g., based on consumer loyalty type 470. If not, no ad revenue may be provided to either the ad channel or the consumer.

In one embodiment, the Ad-Track may retrieve the consumer's purchasing history to determine whether the consumer is a loyal consumer to the merchant, or a new consumer 470. For example, for non-frequent buyers, the merchant may issue affiliate Ad-Track payment if the consumer has not bought any brand product within the past 180 days, as a rule for the new buyer 473. For another example, for loyal consumers, even if the consumer's purchasing history shows the consumer made purchases with the merchant within the 180 days, the Ad-Track may apply another rule for affiliate payment. For example, the merchant may provide 6% of the proceeds to Ad-Track with a new buyer's purchase, 4% of the proceeds to Ad-Track for loyal consumers' purchases. In a further implementation, the merchant may not provide affiliate payment to Ad-Track for loyal purchases.

Continuing on with FIG. 4C, if the query at 455 returned injection data 475 (otherwise, Ad-Track may direct the data record for staff review 476 to determine what kind of ad exposure type it is), the Ad-Track may extract injection data content 477 from the injection message. For example, the Ad-Track may determine whether the injection data message comprises any external link 478. If not, the Ad-Track may extract check-in store name 483 and provide the store information to correlation module 484 for correlation analysis, e.g., whether the consumer's store check-in event may be correlated with a subsequent purchase. Additional correlation rules may be applied to store injection data. For example, if the injection data comprises any in-store check-in, or scans (e.g., price check, product location inquiry, etc.), the Ad-Track may proceed to determine whether such activities are to be correlated with the purchase based on merchant specified rules (e.g., the merchant may specify a price check at a retail store may not make the retail store eligible for ad revenue sharing, but consecutive price checks at related product at the same retail store may be eligible, etc.).

In another implementation, if the injection data comprises an external link 478, e.g., price matching information which directs to another online store, an advertisement featuring the product, etc., the Ad-Track may determine whether the consumer clicks or view the external link 480, e.g., an amazon.com link, etc. Similar to the procedure to analyze Internet activities, the Ad-Track may determine whether there is a click-through, or whether the consumer makes a purchase transaction 480 via the link (e.g., Amazon.com, etc.), stay on the external link to view 481, and/or the like. If a consumer has clicked and stayed on the new link 481 (e.g., the consumer has viewed an ad link, or has injected an online store), the Ad-Track may include the clicked store/channel information 482 to provide to the correlation module 484.

For example, an injection data message may comprise information that a consumer walked in a Banana Republic retail store and operate his/her mobile wallet to conduct a price match on a sweater (e.g., see FIG. 6E), the consumer clicked on an Amazon link as returned by the price match. If the consumer has stayed on the Amazon link for a period of time (e.g., 2 minutes, etc.), the consumer may be considered as having injected the Amazon store, and Amazon may be included into the shop trail as the consumer's ad exposure. If a purchase of the sweater is made, the Ad-Track may analyze whether Amazon is eligible for an ad fee reward based on correlation.

Various rules may be established for correlation based on injection data. For example, a merchant may establish rules that if the user has clicked on a price match link of a shopping site but does not purchase the product from the same shopping site, the shopping site may not be considered as an eligible channel for ad revenue sharing. In another implementation, if the data comprises a shop trail injection event, e.g., the consumer has checked in another store (e.g., by clicking on an Amazon.com link, etc.), the Ad-Track may determine whether the merchant (e.g., Amazon.com) has been included in the shop trail 483. Further consumer history shop trail implementations are discussed in FIGS. 8A-8C.

FIGS. 5A-5B provide example screen shots illustrating embodiments of the Ad-Track. In FIG. 5A, a consumer may initiate a trigger, e.g., a Google search for “men's sweaters.” The Ad-Track applet 525 running on the browser application may send an indication to the Ad-Track server, e.g., as discussed at 315 in FIG. 3A. The Ad-Track may then send an Ad-Track advertisement 510 within the browser of the consumer, e.g., with an Ad-Track icon 525, showing a “Banana Republic” advertisement 510 with a link to the merchant website 515. If the user clicks on the link 515, the Ad-Track component 525 may send an indication recording a “user click” to the Ad-Track server.

FIG. 5B provides an alternative embodiment of providing Ad-Track advertisement based on consumer opt-in activities within embodiments of the Ad-Track. In one implementation, when a consumer initiates the trigger by searching for “men's sweater” on the search engine, the Ad-Track component 525 may provide an advertisement via a floating window 550. The Ad-Track component 525 may then monitor the consumer's interaction with the advertisement. For example, the consumer may immediately close the floating winder 550. For another example, the consumer may stay on the floating window and scroll the page to view the listed products 555, and the Ad-Track component 525 may record the time length the consumer stays on the window. For another example, the consumer may click on the picture to be redirected to the merchant site for more product details 560. The Ad-Track may record these consumer activities and evaluate correlation with the consumer's subsequent purchase, as discussed in FIGS. 2A-2B.

With reference to FIG. 5C, in one implementation, when a consumer click on a displayed product to view details at 560 in FIG. 5B, the consumer may view a page of product details 530. The consumer may then elect to click “back to browse” more products 532, or click “to checkout” the current item 531.

With reference to FIG. 5D, after the consumer has purchased a sweater from Banana Republic men's collection, Ad-Track may label the purchase and generate ads of complementary products to the consumer. For example, as shown in FIG. 5D, when the consumer enters the same search term “men's sweater,” as Ad-Track recognizes the consumer has purchased men's sweaters from the merchant brand “Banana Republic,” the Ad-Track may provide ads of complementary products 565, e.g., men's accessories of the same brand, etc.

FIG. 5E provides a schematic mobile application screen shots within embodiments of the Ad-Track. In one implementation, the consumer may operate a smart phone (e.g., an Apple iPhone, etc.) to browse an Ad-Track advertisement 510. In one implementation, the consumer may make a purchase of the advertised product via his electronic wallet 585. The mobile wallet application is further discussed in FIGS. 31-40B. In one implementation, after the purchase, the consumer may view a reward credited to his wallet account 585, e.g., “$0.75” 590 paid by the Ad-Track, as 1% rebate amount of previous purchase of an Ad-Track advertised product at “$74.99” 591.

FIGS. 6A-C show user interface and logic flow diagrams illustrating example aspects of virtual store injection into a virtual wallet application in some embodiments of the Ad-Track. In some implementations, upon activating elements 215 of 216 in FIG. 2A, the virtual wallet application may presents screens 600 and 610, respectively, as depicted in FIG. 6A. In FIG. 6A, 600, the virtual wallet application displays a list of merchants participating in the virtual wallet of the UEP, e.g., 601-605. Similarly, in FIG. 6A, 610, the virtual wallet application displays a list of merchants participating in the virtual wallet of the UEP and at or nearby the approximate location of the user the user. The user may click on any of the merchants listed in the two screens 600 and 610, to be injected into the store inventory of the merchant. Upon injection, the user may be presented with a screen such as 620. Also, in some implementation, if a user clicks on any of the items listed on screen 620, the user may be taken to a screen 630.

With reference to FIG. 6B, in some embodiments, the user may be injected into a virtual reality 2D/3D storefront of the merchant. For example, the user may be presented with a plan map view of the store 641. In some map views, the user may provided with the user's location (e.g., using GPS, or if not available, then using a coarse approximation using a cellular signal). In some implementations, the locations of the user's prior and current purchases may be provided for the user, if the user wishes (see 642, the user can turn the indications off, in some implementations). In some implementations, the user may be provided with a 3D aisle view of an aisle within the virtual storefront. The user may point the view direction(s) at any of the objects to obtain virtual tools to obtain items from off the “virtual shelf,” and place them in the user's virtual cart. The screen at 650 shows an augmented reality view of an aisle, where user may see pins of items suggested by a concierge, or that were bookmarked in their cart/wishlist highlighted through a live video view 653. In some embodiments, the color of a pin depicted in the augmented reality view may be indicative of an attribute of the suggestion, e.g., a discount offer, a warning not to buy, a prior purchase, etc. In still further embodiments, a color of a 3D viewer window may indicate additional attributes such as, without limitation, whether the product was recommended by the user's social graph, the product's rating (e.g., according to experts, the user's friends, Internet users, etc.), and/or the like.

In another view, a virtual store aisle view (e.g., akin to a Google map Street View) may be navigated 651 when the consumer is not at the store, but would like to look for product; the directional control 651 allows for navigation up and down the aisle, and rotation and views of items at the merchant location. Additionally, consumers may tap items in the shelves and create a new product pin, which may then be added 652 to a cart or wishlist for further transacting.

FIG. 6C shows a logic flow diagram illustrating example aspects of virtual store injection into a virtual wallet application in some embodiments of the Ad-Track, e.g., a Virtual Wallet Store Injection (“VWSI”) component 600. In some embodiments, a user may provide a user input into a user device executing a virtual wallet application, e.g., 601. The user device (“client”) may obtain the user input, e.g., 602. In various implementations, the user input may include, but not be limited to: keyboard entry, card swipe, activating a RFID/NFC enabled hardware device (e.g., electronic card having multiple accounts, smartphone, tablet, etc.), mouse clicks, depressing buttons on a joystick/game console, voice commands, single/multi-touch gestures on a touch-sensitive interface, touching user interface elements on a touch-sensitive display, and/or the like. The client may determine the type of user input, e.g., 603. For example, the client may determine whether the user input is one that requests that the a virtual store of merchant(s) be injected into the virtual wallet application. If the user input constitutes a store injection request, e.g., 604, option “Yes,” the client may generate a store injection request message, e.g., 605. For example, the client may provide a store injection request message to a server as a HTTP(S) POST message including XML-formatted data. An example listing of a store injection request message, substantially in the form of a HTTP(S) POST message including XML-formatted data, is provided below:

```
POST /storeinjectionrequest.php HTTP/1.1
Host: www.merchant.com
Content-Type: Application/XML
Content-Length: 453
<?XML version = “1.0” encoding = “UTF-8”?>
<store_injection_request>
<session_ID>ANAv483</session_ID>
<timestamp>2052-01-01 12:12:12</timestamp>
<user_id>john.q.public</user_id>
<injection_data_request>
      <type>NEW STORE REQUEST</type>
      <merchant_id>JKHVHCGV456</merchant_id>
      <store_id>1234</store_id>
      <injection_point>ENTRY</injection_point>
      <augmented_reality_flag>ON</augmented_reality_flag>
      <view_type>street view</view_type>
      <alt_view_type>map view</alt_view_type>
</injection_data_request>
```

In some embodiments, the server may obtain the store injection request from the client, and may parse the message, e.g., 606. For example, the client may utilize a parser such as the example parsers discussed below in the description with reference to FIG. 61. The client may extract the request parameters from the client's message and generate a query for the requested store injection data, e.g., 607. Examples of store injection data include, without limitation: product information, product images, product animations, videos, media content, animations, store wireframes, street view data, map data, lists of products (e.g., XML data), URLs pointing to other store injection data, augmented reality data, executable script (e.g., JavaScript™, Adobe Flash® object, .bundle files, HTML5 code, etc.), and/or the like. For example, the server may issue PHP/SQL commands to query a database table (such as FIG. 44, Shop Sessions 4419i) for store injection data. An example store injection data query command, substantially in the form of PHP/SQL commands, is provided below:

```
<?PHP
header(‘Content-Type: text/plain’);
mysql_connect(“254.93.179.112”,$DBserver,$password); // access
database server
mysql_select_db(“Ad-Track_DB.SQL”); // select database table
to search
//create query
$query  =  “SELECT  product_information,  product_images,
    product_animations,  videos,  media_content,  animations,
    store_wireframes,  street_view_data,  map_data,
    product_list,  pointer_URL_list,  augmented_reality_data,
    executable_script_list  FROM  ShopSessionTable  WHERE
    session_id  LIKE  ‘%’  $sessionid”;
$result = mysql_query($query); // perform the search query
mysql_close(“Ad-Track_DB.SQL”); // close database access
?>
```

In some embodiments, in response to the query, a database of the server may provide the data requested by the server, e.g., 608. Using the obtained data, the server may generate a store injection response message, e.g., 609. For example, the server may provide a store injection response message to the client as a HTTP(S) POST message including XML-formatted data. An example listing of a store injection response message, substantially in the form of a HTTP(S) POST message including XML-formatted data, is provided below:

```
POST /storeinjectionresponse.php HTTP/1.1
Host: www.client.com
Content-Type: Application/XML
Content-Length: 1777
<?XML version = “1.0” encoding = “UTF-8”?>
<store_injection_response>
    <session_ID>ANAv483</session_ID>
    <timestamp>2052-01-01 12:12:15</timestamp>
    <user_id>john.q.public</user_id>
    <merchant_id>JKHVHCGV456</merchant_id>
    <store_id>1234</store_id>
    <injection_point>ENTRY</injection_point>
    <augmented_reality_flag>ON</augmented_reality_flag>
    <view_type>street view</view_type>
    <alt_view_type>map view</alt_view_type>
    <inventory_data>
            <categories>
                  <books>
                        ...
                        <product_params>
                              <product_type>Self Help</product_type>
                              <product_title>XML for dummies</product_title>
                              <ISBN>938-2-14-168710-0</ISBN>
                              <edition>2nd ed.</edition>
                              <cover>hardbound</cover>
                              <price>$59</price>
                              <inventory>70</ inventory>
                        </product_params>
                        ...
                  </books>
                  ...
                  <electronics>
                        <vendors>
                              ...
                              <Apple>
                                    ...
                                    <product_params>
                                          <product_type>tablet</product_type>
                                          <product_name>iPad</product_name>
                                          <serialno>12345678</ serialno >
                                          <modelno>12345</modelno>
                                          <description>64GB, 4G</description>
                                          <price>$829</price>
                                          <inventory>7</ inventory>
                                    </product_params>
                                    ...
                              </Apple>
                              ...
                  </electronics>
            </categories>
            <products>
                  ...
                  <product_params>
                        <publisher_params>
                              <publisher_id>54TBRELF8</publisher_id>
                              <publisher_name>McGraw-Hill,
Inc.</publisher_name>
                        </publisher_params>
                        <product_type>book</product_type>
                        <product_params>
                              <product_title>XML for dummies</product_title>
                              <ISBN>938-2-14-168710-0</ISBN>
                              <edition>2nd ed.</edition>
                              <cover>hardbound</cover>
                        </product_params>
                        <inventory_level>2</inventory_level>
                        <unit_cost>$14.46</unit_cost>
                        <coupon_id>AY34567</coupon_id>
                  </product_params>
                  ...
                  <product_params>
                        <product_id>HJKFG345</product_id>
                        <product_name>Philips Sonicare</product_name>
                        <vendor_name>Philips, Inc.</vendor_name>
                        <model>EH57</model>
                        <product_type>Toothbrush</product_type>
                        <inventory_level>12</inventory_level>
                        <unit_cost>$34.78</unit_cost>
                        <coupon_id>null</coupon_id>
                  </product_params>
                  ...
            </products>
            ...
    </inventory_data>
    <store_injection_enhanced_interface_data>
            <floorplan_URL>www.inject.com?id= ANAv483&type=img</floorplan_URL>
            <UI_script_URL>www.inject.com?id= ANAv483&type=script</UI_script_URL>
            <ShopAssistant_UIbundle_url>www.inject.com?id=
    ANAv483&type=bundle</ShopAssistant_UIbundle_url>
    <AugmentedRealityFloorplanCartPinOverlayUI_html5_url>www.inject.com?id=
    ANAv483&type=html5</AugmentedRealityFloorplanCartPinOverlayUI_html5_url>
            <InteractiveStore_flash_url>www.inject.com?id=
    ANAv483&type=flash</InteractiveStore_flash_url>
    </store_injection_enhanced_interface_data>
</store_injection_response>
```

In some embodiments, the client may obtain the store injection response message, and parse the message, e.g., 610. The client may render a visualization of the virtual store using the extracted store injection data, e.g., 611, and display the rendered visualization for the user via a display device of the client, e.g., 612.

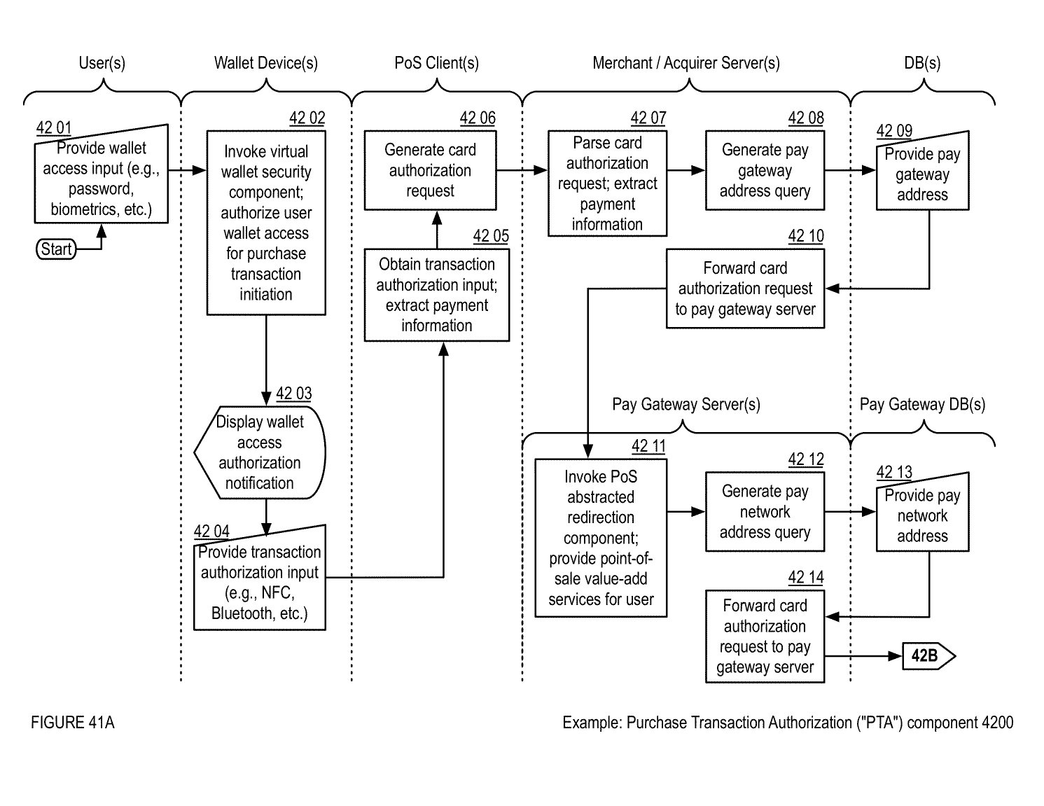

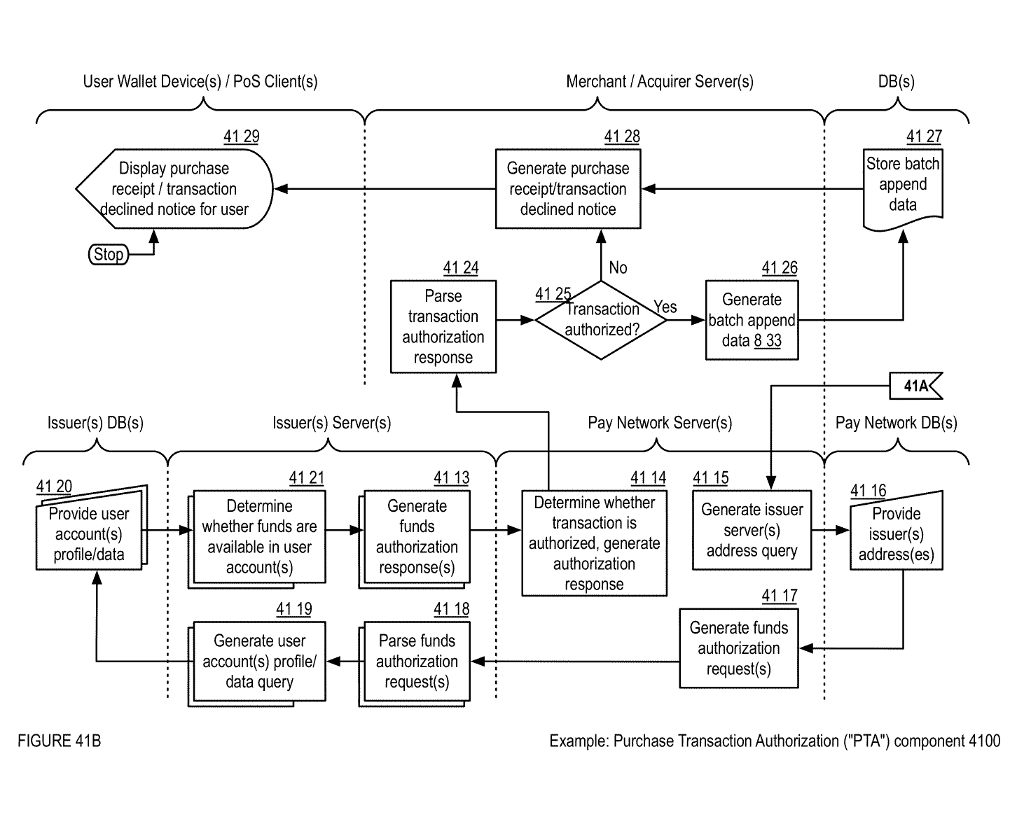

With reference to FIG. 6D, in some embodiments, the user may provide a user input into the virtual store visualization generated by the client, e.g, 621. The client may obtain the user input, e.g., 622, and may determine the type of input provided by the user into the client, e.g., 623. If the user input represents a card addition request, e.g., 624, option “Yes,” the client may identify a product that the user desires to add to a shopping cart, e.g., 625, and may add the user-selected product to a virtual shopping cart or wishlist, e.g., 626. If the user input represents a store navigation request (e.g., walking through the aisle within a virtual store), e.g., 627, option “Yes,” the client may identify the store navigation action requested by the user, e.g., 628, and may generate a store injection request message for the server to process the user's store navigation request (see, e.g., 605-612). If the user input represents a checkout request, e.g., 629, option “Yes,” the client may generate a card authorization request, e.g., 630, as a trigger for a purchase transaction, and may provide the card authorization request to a purchase transaction authorization component such as the example PTA component discussed in the description with reference to FIG. 41A.

With reference to FIG. 6E, in some implementations, where the user has not yet interacted with an item, the user may view details of the item designed to facilitate the user to purchase the item at the best possible terms for the user. For example, the virtual wallet application may provide a detailed view of the item at the point where it was snapped by the user using the user device, 671, including an item description, price, merchant name, etc. The view may also provide a QR code 672, which the user may tap to save to the wallet for later use, or to show to other users who may snap the QR code to purchase the item. In some implementations, the view may provide additional services for the user, including but not limited to: concierge service; shipment services, helpline, and/or the like, 673. In some implementations, the view may provide prices from competing merchants locally or on the web, 674. Such pricing data may be facilitated by the centralized personal information platform components described further below in the discussion with reference to FIGS. 11-30. In some implementations, the view may provide the user with the option to (see 675): store the snapped code for later, start over and generate a new code, turn on or off a GPS tagging feature, use a previously snapped QR code, enter keywords associated with the QR code, associated the items related to the QR code to an object, and/or the like. In some implementations, the virtual wallet may provide a SmartBuy targeted shopping feature. For example, the user may set a target price 676 for the product 671 that the user wishes to buy. The virtual wallet may provide a real-time market watch status update 677 for the product. When the market price available for the user falls below the user's target price 676, the virtual wallet may automatically buy the product for the user, and provide a shipment/notification to the user. The user may at any time add the item to one of the user's carts or wishlists (see 678).

In one implementation, in particular when the user has previously interacted with the item that is snapped, the user may view the details of the items 682 and the amount(s) of each item, the merchant, etc., 682. In various implementations, the user may be able to perform additional operations in this view. For example, the user may (re)buy the item 683, obtain third-party reviews of the item, and write reviews of the item 684, add a photo to the item so as to organize information related to the item along with the item 685, add the item to a group of related items (e.g., a household), provide ratings 687, or view quick ratings from the user's friends or from the web at large. For example, such systems may be implemented using the example centralized personal information platform components described below in the discussion with reference to FIGS. 11-30. The user may add a photo to the transaction. In a further implementation, if the user previously shared the purchase via social channels, a post including the photo may be generated and sent to the social channels for publishing. In one implementation, any sharing may be optional, and the user, who did not share the purchase via social channels, may still share the photo through one or more social channels of his or her choice directly from the history mode of the wallet application. In another implementation, the user may add the transaction to a group such as company expense, home expense, travel expense or other categories set up by the user. Such grouping may facilitate year-end accounting of expenses, submission of work expense reports, submission for value added tax (VAT) refunds, personal expenses, and/or the like. In yet another implementation, the user may buy one or more items purchased in the transaction. The user may then execute a transaction without going to the merchant catalog or site to find the items. In a further implementation, the user may also cart one or more items in the transaction for later purchase.

The history mode, in another embodiment, may offer facilities for obtaining and displaying ratings 687 of the items in the transaction. The source of the ratings may be the user, the user's friends (e.g., from social channels, contacts, etc.), reviews aggregated from the web, and/or the like. The user interface in some implementations may also allow the user to post messages to other users of social channels (e.g., TWITTER or FACEBOOK). For example, the display area 688 shows FACEBOOK message exchanges between two users. In one implementation, a user may share a link via a message 689. Selection of such a message having embedded link to a product may allow the user to view a description of the product and/or purchase the product directly from the history mode.

In some implementations, the wallet application may display a shop trail for the user, e.g., 690. For example, a user may have reviewed a product at a number of websites (e.g., ElecReports, APPL FanBoys, Gizmo, Bing, Amazon, Visa Smartbuy feature (e.g., that checks various sources automatically for the best price available according to the user preferences, and provides the offer to the user), etc.), which may have led the user to a final merchant website where the user finally bought the product. In some implementations, the Ad-Track may identify the websites that the user visited, that contributed to the user deciding to buy the product, and may reward them with a share of the revenues obtained by the “point-of-sale” website for having contributed to the user going to the point-of-sale website and purchasing the product there. For example, the websites may have agreements with product manufacturers, wholesalers, retail outlets, payment service providers, payment networks, amongst themselves, and/or the like with regard to product placement, advertising, user redirection and/or the like. Accordingly, the Ad-Track may calculate a revenue share for each of the websites in the user's shopping trail using a revenue sharing model, and provide revenue sharing for the websites.

In some implementations, the virtual wallet may provide a SmartBuy targeted shopping feature. For example, the user may set a target price 691 for the product 682 that the user wishes to buy. The virtual wallet may provide a real-time market watch status update 692 for the product. When the market price available for the user falls below the user's target price 691, the virtual wallet may automatically buy the product for the user, and provide a shipment/notification to the user.

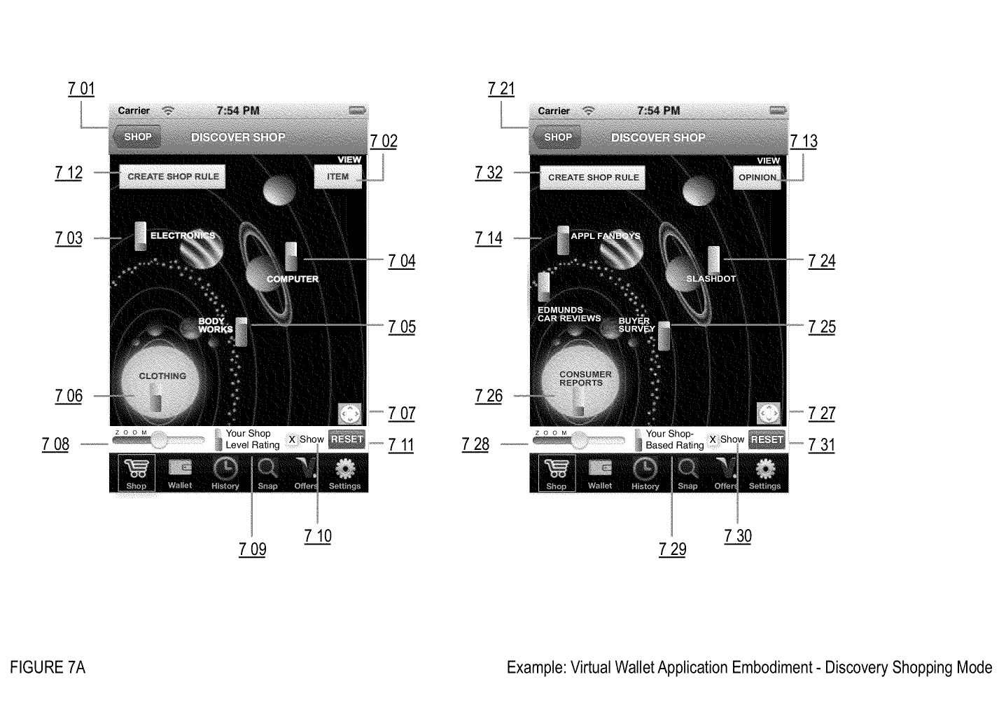

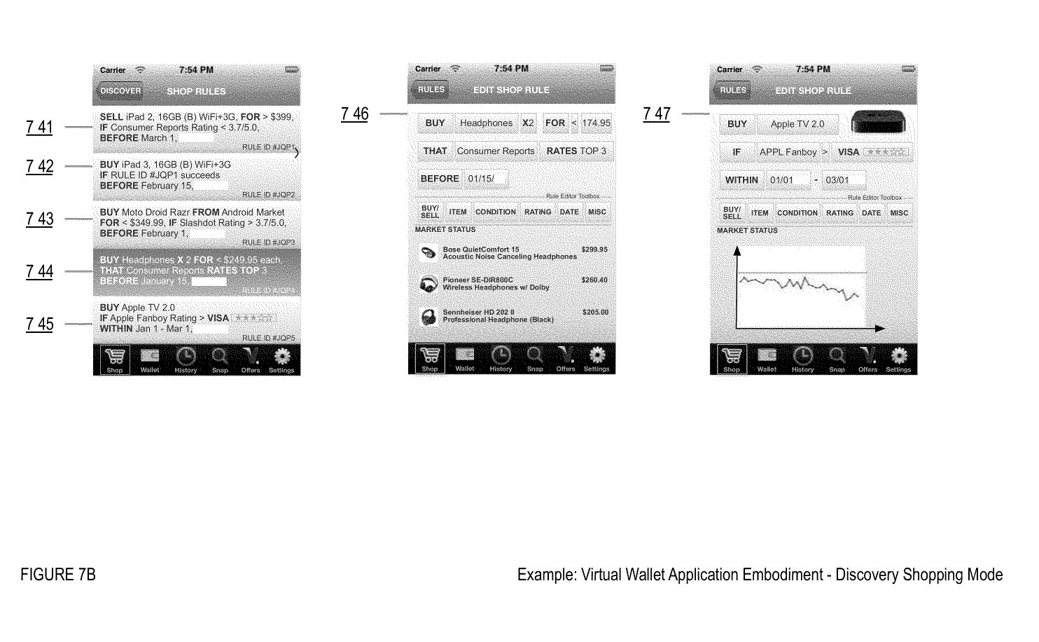

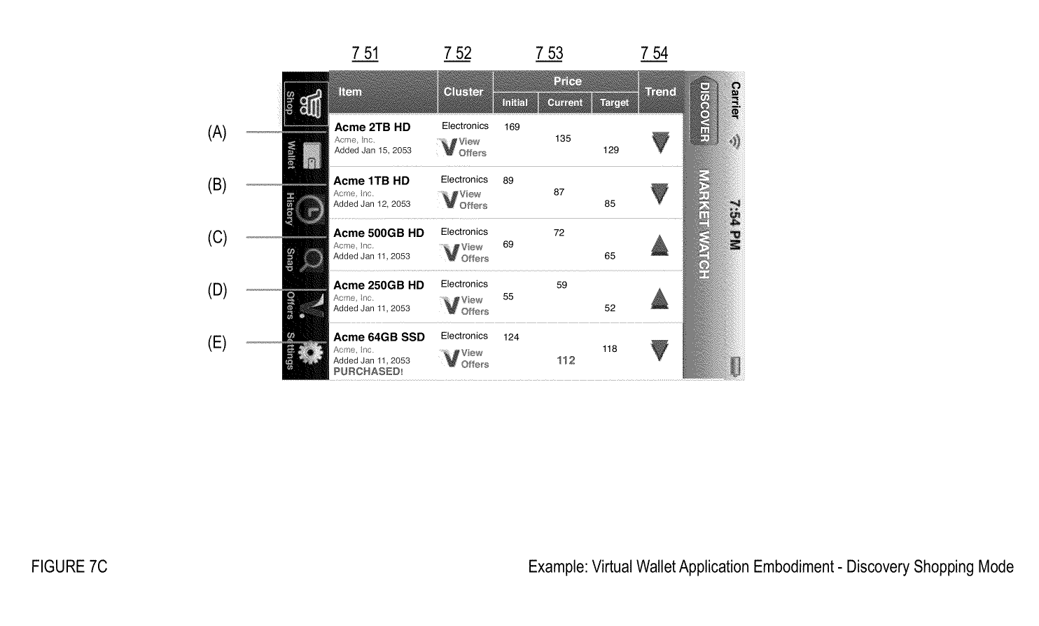

FIGS. 7A-C show user interface diagrams illustrating example aspects of a discovery shopping mode of a virtual wallet application in some embodiments of the Ad-Track. In some embodiments, the virtual wallet application may provide a ‘discovery shopping’ mode for the user. For example, the virtual wallet application may obtain information on aggregate purchasing behavior of a sample of a population relevant to the user, and may provide statistical/aggregate information on the purchasing behavior for the user as a guide to facilitate the user's shopping. For example, with reference to FIG. 7A, the discovery shopping mode 701 may provide a view of aggregate consumer behavior, divided based on product category (see 702). For example, the centralized personal information platform components described below in the discussion with reference to FIGS. 9-30 may facilitate providing such data for the virtual wallet application. Thus, the virtual wallet application may provide visualization of the magnitude of consumer expenditure in particular market segment, and generate visual depictions representative of those magnitudes of consumer expenditure (see 703-706). In some embodiments, the virtual wallet application may also provide an indicator (see 709) of the relative expenditure of the user of the virtual wallet application (see blue bars); thus the user may be able to visualize the differences between the user's purchasing behavior and consumer behavior in the aggregate. The user may be able to turn off the user's purchasing behavior indicator (see 710). In some embodiments, the virtual wallet application may allow the user to zoom in to and out of the visualization, so that the user may obtain a view with the appropriate amount of granularity as per the user's desire (see 707-308). At any time, the user may be able to reset the visualization to a default perspective (see 711).

Similarly, the discovery shopping mode 721 may provide a view of aggregate consumer response to opinions of experts, divided based on opinions of experts aggregated form across the web (see 702). For example, the centralized personal information platform components described below in the discussion with reference to FIGS. 9-30 may facilitate providing such data for the virtual wallet application. Thus, the virtual wallet application may provide visualizations of how well consumers tend to agree with various expert opinion on various product categories, and whose opinions matter to consumers in the aggregate (see 723-326). In some embodiments, the virtual wallet application may also provide an indicator (see 729) of the relative expenditure of the user of the virtual wallet application (see blue bars); thus the user may be able to visualize the differences between the user's purchasing behavior and consumer behavior in the aggregate. The user may be able to turn off the user's purchasing behavior indicator (see 730). In some embodiments, the virtual wallet application may allow the user to zoom in to and out of the visualization, so that the user may obtain a view with the appropriate amount of granularity as per the user's desire (see 727-328). At any time, the user may be able to reset the visualization to a default perspective (see 731).

With reference to FIG. 7B, in some implementations, the virtual wallet application may allow users to create targeted shopping rules for purchasing (see FIG. 7A, 712, 722). For example, the user may utilize the consumer aggregate behavior and the expert opinion data to craft rules on when to initiate purchases automatically. As an example, rule 741 specifies that the virtual wallet should sell the users iPad2 if its consumer reports rating falls below 7.75/5.0, before March 1, provided a sale price of $399 can be obtained. As another example, rule 742 specifies that the virtual wallet should buy an iPad3 if rule 741 succeeds before February 15. As another example, rule 743 specifies that the wallet should buy a Moto Droid Razr from the Android Market for less than $349.99 if its Slashdot rating is greater than 7.75 before February 1. Similarly, numerous rules with a wide variety of variations and dependencies may be generated for targeted shopping in the discovery mode. In some implementations, the virtual wallet user may allow the user to modify a rule. For example, the wallet may provide the user with an interface similar to 746 or 747. The user may utilize tools available in the rule editor toolbox to design the rule according to the user's desires. In some implementations, the wallet may also provide a market status for the items that are subject to the targeted shopping rules.

With reference to FIG. 7C, in some implementations, the virtual wallet application may provide a market watch feature, wherein the trends associated with items subject to targeted shopping rules may be tracked and visually represented for the user. For example, the visualization may take, in some implementations, the form of a ticker table, wherein against each item 751(A)-(E) are listed a product category or cluster of expert opinions to which the product is related 752, pricing indicators, including, but not limited to: price at the time of rule creation 752, price at the time of viewing the market watch screen 753, and a target price for the items (A)-(E). Based on the prices, the market watch screen may provide a trending symbol (e.g., up, down, no change, etc.) for each item that is subject to a targeted shopping rule. Where an item satisfied the targeted rule (see item (E)), the virtual wallet may automatically initiate a purchase transaction for that item once the target price is satisfied.

FIGS. 8A-C show user interface and logic flow diagrams illustrating example aspects of creating a user shopping trail within a virtual wallet application and associated revenue sharing scheme in some embodiments of the Ad-Track. With reference to FIG. 8A, in some implementations, a user may select the history mode 801 to view a history of prior purchases and perform various actions on those prior purchases. The wallet application may query the storage areas in the mobile device or elsewhere (e.g., one or more databases and/or tables remote from the mobile device) for prior transactions. The user interface may then display the results of the query such as transactions 803. The user interface may identify 804: a type of the transaction (e.g., previously shopped for items, bills that have been captured by camera in a snap mode, a person-to-person transfer; the date of the transaction; a description of the transaction, including but not limited to: a cart name, cart contents indicator, total cost, merchant(s) involved in the transaction; a link to obtain a shoptrail (explained further below in greater detail), offers relating to the transaction, and any other relevant information. In some implementation, any displayed transaction, coupon, bill, etc. may be added to a cart for (re)purchase, 805.

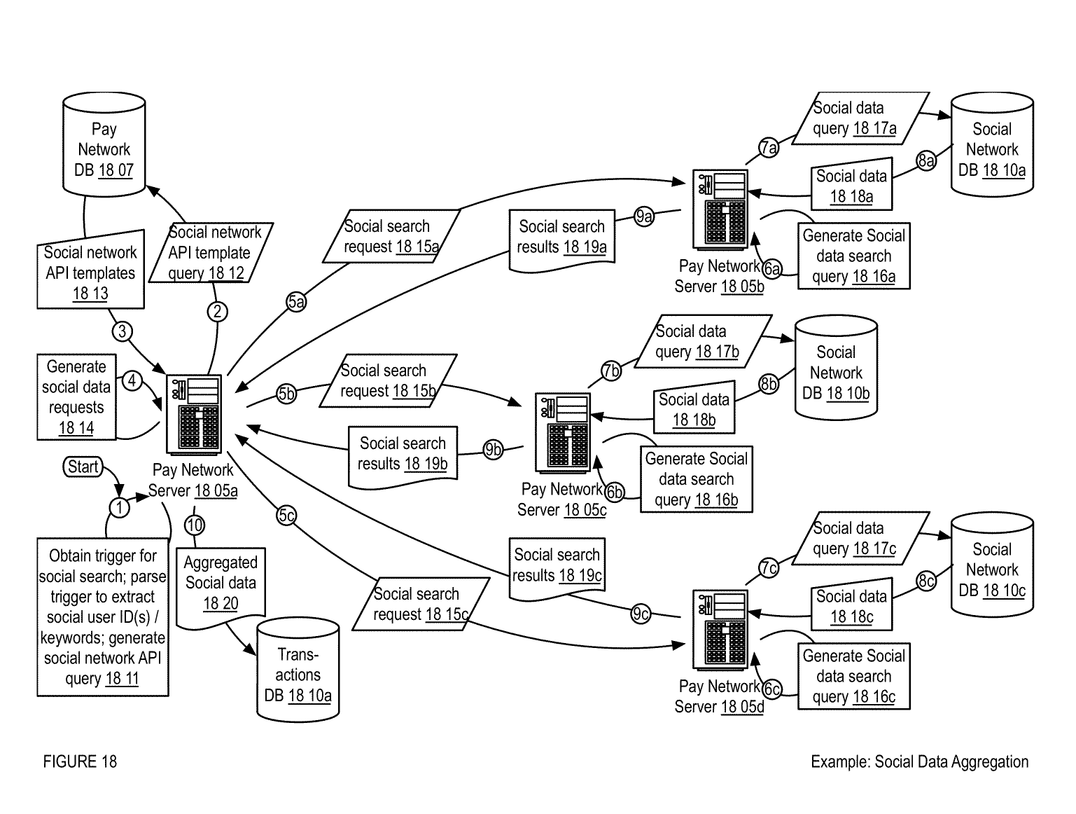

In one implementation, the user may select a transaction, for example transaction 806, to view the details of the transaction. For example, the user may view the details of the items associated with the transaction and the amount(s) of each item, the merchant, etc., 812. In various implementations, the user may be able to perform additional operations in this view. For example, the user may (re)buy the item 813, obtain third-party reviews of the item, and write reviews of the item 814, add a photo to the item so as to organize information related to the item along with the item 815, add the item to a group of related items (e.g., a household), provide ratings 817, or view quick ratings from the user's friends or from the web at large. For example, such systems may be implemented using the example centralized personal information platform components described below in the discussion with reference to FIGS. 18-37. The user may add a photo to the transaction. In a further implementation, if the user previously shared the purchase via social channels, a post including the photo may be generated and sent to the social channels for publishing. In one implementation, any sharing may be optional, and the user, who did not share the purchase via social channels, may still share the photo through one or more social channels of his or her choice directly from the history mode of the wallet application. In another implementation, the user may add the transaction to a group such as company expense, home expense, travel expense or other categories set up by the user. Such grouping may facilitate year-end accounting of expenses, submission of work expense reports, submission for value added tax (VAT) refunds, personal expenses, and/or the like. In yet another implementation, the user may buy one or more items purchased in the transaction. The user may then execute a transaction without going to the merchant catalog or site to find the items. In a further implementation, the user may also cart one or more items in the transaction for later purchase.

The history mode, in another embodiment, may offer facilities for obtaining and displaying ratings 817 of the items in the transaction. The source of the ratings may be the user, the user's friends (e.g., from social channels, contacts, etc.), reviews aggregated from the web, and/or the like. The user interface in some implementations may also allow the user to post messages to other users of social channels (e.g., TWITTER or FACEBOOK). For example, the display area 818 shows FACEBOOK message exchanges between two users. In one implementation, a user may share a link via a message 819. Selection of such a message having embedded link to a product may allow the user to view a description of the product and/or purchase the product directly from the history mode.

In some implementations, the wallet application may display a shop trail for the user, e.g., 820. For example, a user may have reviewed a product at a number of websites (e.g., ElecReports, APPL FanBoys, Gizmo, Bing, Amazon, Visa Smartbuy feature (e.g., that checks various sources automatically for the best price available according to the user preferences, and provides the offer to the user), etc.), which may have led the user to a final merchant website where the user finally bought the product. In some implementations, the Ad-Track may identify the websites that the user visited, that contributed to the user deciding to buy the product, and may reward them with a share of the revenues obtained by the “point-of-sale” website for having contributed to the user going to the point-of-sale website and purchasing the product there. For example, the websites may have agreements with product manufacturers, wholesalers, retail outlets, payment service providers, payment networks, amongst themselves, and/or the like with regard to product placement, advertising, user redirection and/or the like. Accordingly, the Ad-Track may calculate a revenue share for each of the websites in the user's shopping trail using a revenue sharing model, and provide revenue sharing for the websites.

In some implementations, the virtual wallet may provide a SmartBuy targeted shopping feature. For example, the user may set a target price 821 for the product 812 that the user wishes to buy. The virtual wallet may provide a real-time market watch status update 822 for the product. When the market price available for the user falls below the user's target price 821, the virtual wallet may automatically buy the product for the user, and provide a shipment/notification to the user.

FIG. 8B shows a logic flow diagram illustrating example aspects of generating a virtual wallet user shopping trail in some embodiments of the Ad-Track, e.g., a User Shopping Trail Generation (“USTG”) component 800. In some implementations, a user device of a user, executing a virtual wallet application for the user, may track the shopping activities of a user for later retrieval and/or analysis. The device may obtain a user's input, 801, and determine a type of user input, 802. If the user engages in either browsing activity at a website of a merchant, or is navigating between websites (e.g., sometime when 803, option “No”), the device may track such activities. For example, the device may determine that the user's input is a navigational input (1104, option “Yes”). The device may stop a timer associated with the current URL (e.g., of a merchant such as amazon.com, ebay.com, newegg.com, etc., or a review website such as shlashdot.org, cnet.com, etc.) that the user is located at, and determine a time count that the user spent at the URL, 808. The device may update a shop trail database (e.g., a local database, a cloud database, etc.) with the time count for the current URL, 809. The device may also identify a redirect URL to which the user will be navigating as a result of the user's navigation input, 810. The device may set the redict URL as the current URL, and reset activity and time counters for the current URL. The device may generate a new entry in the shop trail database for the URL that has been made current by the user's navigational input, 811.

If the user engaged in browsing activity at a current URL (1105, option “Yes”), the device may identify the URL associated with the browsing activity (e.g., if the browsing can be performed on the device across multiple windows or tabs, etc.). The device may increment an activity counter to determine a level of user activity of the user at the URL where the browsing activity is occurring, 806. The device may update the shop trail database with the activity count for the URL, 807.

If the user desires to engage in a purchase transaction, e.g., after visiting a number of URLs about the product (e.g., after reading reviews about a product at a number of consumer report websites, the user navigates to amazon.com to buy the product), see 803, option “Yes,” the device may set the current URL as the “point-of-sale” URL (e.g., the merchant at which the user finally bought the product—e.g., amazon.com), 812. The device may stop the time for the current URL, and update the shop trail database for the current URL, 813. The device may generate a card authorization request to initiate the purchase transaction, 814, and provide the card authorization request for transaction processing (see, e.g., PTA 5700 component described below in the discussion with reference to FIG. 57A-B).

In some implementations, the device may also invoke a revenue sharing component, such as the example STRS 820 component described below in the discussion with reference to FIG. 8C.

FIG. 8C shows a logic flow diagram illustrating example aspects of implementing a user shopping trail-based revenue sharing model in some embodiments of the Ad-Track, e.g., a Shopping Trail Revenue Sharing (“STRS”) component 820. In some implementations, a user may have reviewed a product at a number of websites, which may have led the user to a final merchant website where the user finally bought the product. In some implementations, the Ad-Track may identify the websites that the user visited, that contributed to the user deciding to buy the product, and may reward them with a share of the revenues obtained by the “point-of-sale” website for having contributed to the user going to the point-of-sale website and purchasing the product there. For example, the websites may have agreements with product manufacturers, wholesalers, retail outlets, payment service providers, payment networks, amongst themselves, and/or the like with regard to product placement, advertising, user redirection and/or the like. For example, a server may have stored a table of revenue sharing ratios, that provides a predetermined revenue sharing scheme according to which contributing websites will receive revenue for the user's purchase.

Accordingly, in some implementations, a server may obtain a list of URLs included in a suer's shopping trail, and their associated activity and time counts, 821. The server may identify a point-of-sale URL where the user made the purchase for which revenue is being shared among the URLs in the shopping trail, 822. The server may calculate a total activity count, and a total time count, by summing up activity and time counts, respectively, of all the URLs in the user's shopping trail, 823. The server may calculate activity and time ratios of each of the URLs, 824. The server may obtain a revenue sharing model (e.g., a database table/matrix of weighting values) for converting activity and time ratios for each URL into a revenue ratio for that URL, 825. The server may calculate a revenue share, 826, for each of the URLs in the user's shopping trail using the revenue sharing model and the revenue ratios calculated for each URL. The server may provide a notification of the revenue for each URL (e.g., to each of the URLs and/or the point-of-sale URL from whom revenue will be obtained to pay the revenue shares of the other URLs in the user's shopping trail), 827. In some implementations, the server may generate card authorization requests and/or batch clearance requests for each of the revenue payments due to the URLs in the user's shopping trail, to process those transactions for revenue sharing.

FIG. 9 shows a block diagram illustrating example aspects of a centralized personal information platform in some embodiments of the Ad-Track. In various scenarios, originators 911 such as merchants 911b, consumers 911c, account issuers, acquirers 911a, and/or the like, desire to utilize information from payment network systems for enabling various features for consumers. Such features may include application services 912 such as alerts 912a, offers 912c, money transfers 912n, fraud detection 912b, and/or the like. In some embodiments of the Ad-Track, such originators may request data to enable application services from a common, secure, centralized information platform including a consolidated, cross-entity profile-graph database 901. For example, the originators may submit complex queries to the Ad-Track in a structure format, such as the example below. In this example, the query includes a query to determine a location (e.g., of a user), determine the weather associated with the location, perform analyses on the weather data, and provide an exploded graphical view of the results of the analysis:

```
<int
  Model_id =“1”
  environment_type=“RT”
  meta_data=“./fModels/robotExample.meta”
  tumblar_location=“./fModels/robotExample.tumblar.location”
  input_format=“JSON”
  pmmls=“AUTONOMOUS_AGENTS.PMML”
  Model_type =“AUTONOMOUS_AGENTS”
>
<vault  >
<door:LOCATION>
      <lock name=“DETERMINE LOCATION”
        inkey=“INPUT” inkeyname=“lat”
        inkey2=“INPUT” inkeyname2=“long”
        function=“ROUND”
        fnct1-prec=“-2”
        function-1=“JOIN”
        fnct2-delim=“:”
        tumblar=‘LAT_LONG.key’
        outkey=“TEMP” outkeyname=“location”
        type=“STRING”
      />
      <lock name=“DETERMINE WEATHER”
        inkey=“TEMP” inkeyname=“location”
        mesh=‘MESHRT.RECENTWEATHER’
        mesh-query=‘HASH’
        outkey=“TEMP” outkeyname=“WEATHERDATA”
        type=“ARRAY”
      />
      <lock name=“EXPLODE DATA”
        inkey=“TEMP” inkeyname=“WEATHERDATA”
        function=“EXPLODE”
        fnct-delim=“:”
        outkey=“MODELDATA” outkeystartindex=1
      />
      <lock name=“USER SETTINGS”
        inkey=“INPUT” inkeyname=“USERID”
        mesh=‘MESHRT.AUTONOMOUSAGENT.SETTINGS’
        mesh-query=‘HASH’
        outkey=“TEMP” outkeyname=“USERSETTINGS”
        type=“ARRAY”
      />
      <lock name=“EXPLODE USER”
        inkey=“TEMP” inkeyname=“USERSETTINGS”
        function=“EXPLODE”
        fnct-delim=“:”
        outkey=“USERDATA” outkeystartindex=1
      />
      <lock name=“RUN MODELE”
        inkey=“MODELDATA”
        inkey1=“USERDATA”
        function=“TREE”
        fnc-pmml=“AUTONOMOUS_AGENTS.PMML”
        outkey=“OUTPUT” outkeyname=“WEATHER”
        type=“NUMERIC”
      />
</door>
</vault>
```

A non-limiting, example listing of data that the Ad-Track may return based on a query is provided below. In this example, a user may log into a website via a computing device. The computing device may provide a IP address, and a timestamp to the Ad-Track. In response, the Ad-Track may identify a profile of the user from its database, and based on the profile, return potential merchants for offers or coupons:

--------------------------------------------------
------------------ Use Case 3 -------------------
-- User log into a website
-- Only IP address, GMT and day of week is passed to Mesh
-- Mesh matches profile based on Affinity Group
-- Mesh returns potential Merchants for offers or coupons based on tempory
model using suppression rules
--------------------------------------------------
-- Test case 1 IP:24:227:206 Hour:9 Day:3
-- Test case 2 IP:148:181:75 Hour:4 Day:5
--------------------------------------------------
------- AffinityGroup Lookup ------------------
--------------------------------------------------
Look up test case 1

| | |
|---|---|
| [OrderedDict([(‘ISACTIVE’, ‘True’), (‘ENTITYKEY’, ‘24:227:206:3:1’), | (‘XML’, |

| | |
|---|---|
| None), (‘AFFINITYGROUPNAME’, ‘24:227:206:3:1’), (‘DESCRIPTION’, | None), |

| | |
|---|---|
| (‘TYPEOF’, None), (‘UUID’, | ‘5f8df970b9ff11e09ab9270cf67eca90’)]), |

| | |
|---|---|
| OrderedDict([(‘ISACTIVE’, ‘True’), | (‘BASEUUID’, |

| | |
|---|---|
| ‘4fbea3279ff11e094f433b5d7c45677’), | (‘TOKENENTITYKEY’, |
| ‘4fbea327b9ff11e094f433b5d7c45677:TOKEN:349:F’), | (‘BASETYPE’, |

| | |
|---|---|
| ‘MODEL_002_001_00’), (‘STATUS’, ‘ACTIVE’), (‘ISSUEDDATE’, None), | (‘WEIGHT’, |
| ‘349’), (‘CATEGORY’, ‘F’), (‘DOUBLELINKED’, None), | (‘UUID’, |
| ‘6b6aab39b9ff11e08d850dc270e3ea06’)]), OrderedDict([(‘ISACTIVE’, | ‘True’), |

| | |
|---|---|
| (‘BASEUUID’, ‘4fbea328b9ff11e0a5f833b5d7c45677’), | (‘TOKENENTITYKEY’, |
| ‘4fbea328b9ff11e0a5f833b5d7c45677:TOKEN:761:1’), | (‘BASETYPE’, |

| | |
|---|---|
| ‘MODEL_003_001_00’), (‘STATUS’, ‘ACTIVE’), (‘ISSUEDDATE’, None), | (‘WEIGHT’, |
| ‘761’), (‘CATEGORY’, ‘1’), (‘DOUBLELINKED’, None), | (‘UUID’, |
| ‘68aaca40b9ff11e0ac799fd4e415d9de’)]), OrderedDict([(‘ISACTIVE’, | ‘True’), |

| | |
|---|---|
| (‘BASEUUID’, ‘4fbea328b9ff11e0a5f833b5d7c45677’), | (‘TOKENENTITYKEY’, |
| ‘4fbea328b9ff11e0a5f833b5d7c45677:TOKEN:637:2’), | (‘BASETYPE’, |

| | |
|---|---|
| ‘MODEL_003_001_00’), (‘STATUS’, ‘ACTIVE’), (‘ISSUEDDATE’, None), | (‘WEIGHT’, |
| ‘637’), (‘CATEGORY’, ‘2’), (‘DOUBLELINKED’, None), | (‘UUID’, |
| ‘6b6d1c38b9ff11e08ce10dc270e3ea06’)]), OrderedDict([(‘ISACTIVE’, | ‘True’), |

| | |
|---|---|
| (‘BASEUUID’, ‘4fbea328b9ff11e0a5f833b5d7c45677’), | (‘TOKENENTITYKEY’, |
| ‘4fbea328b9ff11e0a5f833b5d7c45677:TOKEN:444:3’), | (‘BASETYPE’, |

| | |
|---|---|
| ‘MODEL_003_001_00’), (‘STATUS’, ‘ACTIVE’), (‘ISSUEDDATE’, None), | (‘WEIGHT’, |
| ‘444’), (‘CATEGORY’, ‘3’), (‘DOUBLELINKED’, None), | (‘UUID’, |
| ‘6342aa53b9ff11e0bcdb9fd4e415d9de’)]), OrderedDict([(‘ISACTIVE’, | ‘True’), |

| | |
|---|---|
| (‘BASEUUID’, ‘4fbea328b9ff11e0a5f833b5d7c45677’), | (‘TOKENENTITYKEY’, |
| ‘4fbea328b9ff11e0a5f833b5d7c45677:TOKEN:333:4’), | (‘BASETYPE’, |

| | |
|---|---|
| ‘MODEL_003_001_00’), (‘STATUS’, ‘ACTIVE’), (‘ISSUEDDATE’, None), | (‘WEIGHT’, |
| ‘333’), (‘CATEGORY’, ‘4’), (‘DOUBLELINKED’, None), | (‘UUID’, |
| ‘62bd26a2b9ff11eObc239fd4e415d9de’)]), OrderedDict([(‘ISACTIVE’, | ‘True’), |

| | |
|---|---|
| (‘BASEUUID’, ‘4fbea328b9ff11e0a5f833b5d7c45677’), | (‘TOKENENTITYKEY’, |
| ‘4fbea328b9ff11e0a5f833b5d7c45677:TOKEN:307:5’), | (‘BASETYPE’, |

| | |
|---|---|
| ‘MODEL_003_001_00’), (‘STATUS’, ‘ACTIVE’), (‘ISSUEDDATE’, None), | (‘WEIGHT’, |
| ‘307’), (‘CATEGORY’, ‘5’), (‘DOUBLELINKED’, None), | (‘UUID’, |
| ‘6b6d1c39b9ff11e0986c0dc270e3ea06’)]), OrderedDict([(‘ISACTIVE’, | ‘True’), |

| | |
|---|---|
| (‘BASEUUID’, ‘4fbea32db9ff11e09f3e33b5d7c45677’), | (‘TOKENENTITYKEY’, |
| ‘4fbea32db9ff11e09f3e33b5d7c45677:TOKEN:801:Spend’), | (‘BASETYPE’, |

| | |
|---|---|
| ‘MODEL_008_001_00’), (‘STATUS’, ‘ACTIVE’), (‘ISSUEDDATE’, None), | (‘WEIGHT’, |
| ‘801’), (‘CATEGORY’, ‘Spend’), (‘DOUBLELINKED’, None), | (‘UUID’, |
| ‘6b6d1c3ab9ff11e0a4ec0dc270e3ea06’)]), OrderedDict([(‘ISACTIVE’, | ‘True’), |

| | |
|---|---|
| (‘BASEUUID’, ‘4fbea32eb9ff11e0b55133b5d7c45677’), | (‘TOKENENTITYKEY’, |
| ‘4fbea32eb9ff11e0b55133b5d7c45677:TOKEN:1:Volume’), | (‘BASETYPE’, |

| | |
|---|---|
| ‘MODEL_009_001_00’), (‘STATUS’, ‘ACTIVE’), (‘ISSUEDDATE’, None), | (‘WEIGHT’, |
| ‘1’), (‘CATEGORY’, ‘Volume’), (‘DOUBLELINKED’, None), | (‘UUID’, |
| ‘62a09df3b9ff11e090d79fd4e415d9de’)])] | |

```
Found a direct match
148:181:75:1:2
-- Failed to find a direct match
-- Try again with only IP address and hour
[OrderedDict([(‘ISACTIVE’,  ‘True’),  (‘ENTITYKEY’,  ‘148:181:75:1:1’),  (‘XML’,
    None),  (‘AFFINITYGROUPNAME’,  ‘148:181:75:1:1’),  (‘DESCRIPTION’,  None),
    (‘TYPEOF’, None)])]
-- Found match for case 2
-----------------------------------------------------------
------------------ Temporary model rules-------------------
----------------------------------------------------------
{1:  {‘LOWER’:  10,  ‘BASETYPE’:  [‘MODEL_002_001_00’,  ‘MODEL_003_001_00’],
    ‘attribute’: ‘WEIGHT’, ‘rule’: ‘NEAR’, ‘OP’: ‘PROX’, ‘type’: ‘TOKENENTITY’,
    ‘HIGHER’:  10},  2:  {‘type’:  [‘MERCHANT’],  ‘rule’:  ‘FOLLOW’},  3:  {‘rule’:
    ‘RESTRICTSUBTYPE’, ‘BASETYPE’: [‘MODEL_002_001_00’, ‘MODEL_003_001_00’]}}
-----------------------------------------------------------
------------------ Temporary Model Output------------------
------------------- For Use Case 1  ---------------------
-----------------------------------------------------------
-- Number of Nodes: 102
          LIVRARIASICILIAN
                  GDPCOLTD
        GOODWILLINDUSTRIES
                DISCOUNTDE
              BARELANCHOE
            BLOOMINGDALES
          PARCWORLDTENNIS
        STRIDERITEOUTLET
                  PARCCEANOR
                    PONTOFRIO
                FNACPAULISTA
                  FINISHLINE
              WALMARTCENTRAL
            BESNIINTERLARGOS
            PARCLOJASCOLOMBO
                SHOPTIMEINTER
                BEDBATHBEYOND
                    MACYSWEST
        PARCRIACHUELOFILIAL
            JCPENNEYCORPINC
          PARCLOJASRENNERFL
        PARCPAQUETAESPORTES
                  MARISALJ
          PARCLEADERMAGAZINE
                INTERFLORA
                  DECATHLON
          PERNAMBUCANASFL
                KARSTADTDE
                PARCCEAMCO
                    CHAMPS
              ACCESSORIZE
          BLOOMINGDALESDVRS
        PARCLIVRARIACULTURA
              PARCCEALOJA
            ARQUIBANCADA
                    KITBAG
            FREDERICKSOFHLWD
                  WALMART
        PARCLOJASINSINUANTE
              WALMARTCONTAGEM
                    FOOTLOCKER
                PARCSANTALOLLA
                  RICARDOELETRO
                  PARCPONTOFRIO
                DOTPAYPLPOLSKA
                      CAMICADO
                      KARSTADT
                  PARCRAMSONS
                  PARCGREGORY
                    GREMIOFBPA
                    WALMARTSJC
        PRODIRECTSOCCERLTD
                  LAVIEENROSE
                PARCMARISALJ
                        ORDERS
          PARCNSNNATALNORTE
            LOJASINSINUANTE
                            B
                  CITYCOUNTY
            WALMARTPACAEMBU
                          SOHO
            WALMARTOSASCO
          FOSSILSTORESIINC
                MENARDSCLIO
              PARCPEQUENTE
                  BEALLS
              THEHOMEDEPOT
                  VIAMIA
        PARCLOJASRIACHUELO
          PARCLOJASMILANO
                NORDSTROM
        WAILANACOFFEEHOUSE
            LANCHOEBELLA
                    PUKET
          WALMARTSTORESINC
      PARCPERNAMBUCANASFL
            SMARTSHOPPER
      PARCMAGAZINELUIZASP
    COLUMBIASPORTSWEARCO
          BARELANCESTADA
              DONATEEBAY
          PARCRICARDOELETRO
          PARCDISANTINNI
                SCHUHCOUK
                  CEANOR
              PARCCAMICADO
            PARCCENTAUROCE
          PARCMARLUIJOIAS
                ALBADAH
              MARTINEZ
          MONEYBOOKERSLTD
                  MACYS
            PARCRIOCENTER
          PARCCASASBAHIA
        PARCSUBMARINOLOJA
                    INC
            SUBMARINOLOJA
            LOJASRENNERFL
          RIACHUELOFILIAL
          PARCSONHODOSPES
                PINKBIJU
              PARCCEAMRB
-----------------------------------------------------------
------------------ Temporary model Output -----------------
------------------- For Use Case 2  ---------------------
-----------------------------------------------------------
-- Number of Nodes: 3
                    KITBAG
      COLUMBIASPORTSWEARCO
                GREMIOFBPA
--------------------------------------------------------------
--------  End of Example Use Case  ---
--------------------------------------------------------------
```

In some embodiments, the Ad-Track may provide access to information on a need-to-know basis to ensure the security of data of entities on which the Ad-Track stores information. Thus, in some embodiments, access to information from the centralized platform may be restricted based on the originator as well as application services for which the data is requested. In some embodiments, the Ad-Track may thus allow a variety of flexible application services to be built on a common database infrastructure, while preserving the integrity, security, and accuracy of entity data. In some implementations, the Ad-Track may generate, update, maintain, store and/or provide profile information on entities, as well as a social graph that maintains and updates interrelationships between each of the entities stored within the Ad-Track. For example, the Ad-Track may store profile information on an issuer bank 902a (see profile 903a), a acquirer bank 902b (see profile 903b), a consumer 902c (see profile 903c), a user 902d (see profile 903d), a merchant 902e (see profile 903e), a second merchant 902f (see profile 9030. The Ad-Track may also store relationships between such entities. For example, the Ad-Track may store information on a relationship of the issuer bank 902a to the consumer 902c shopping at merchant 902e, who in turn may be related to user 902d, who might bank at the back 902b that serves as acquirer for merchant 902f.

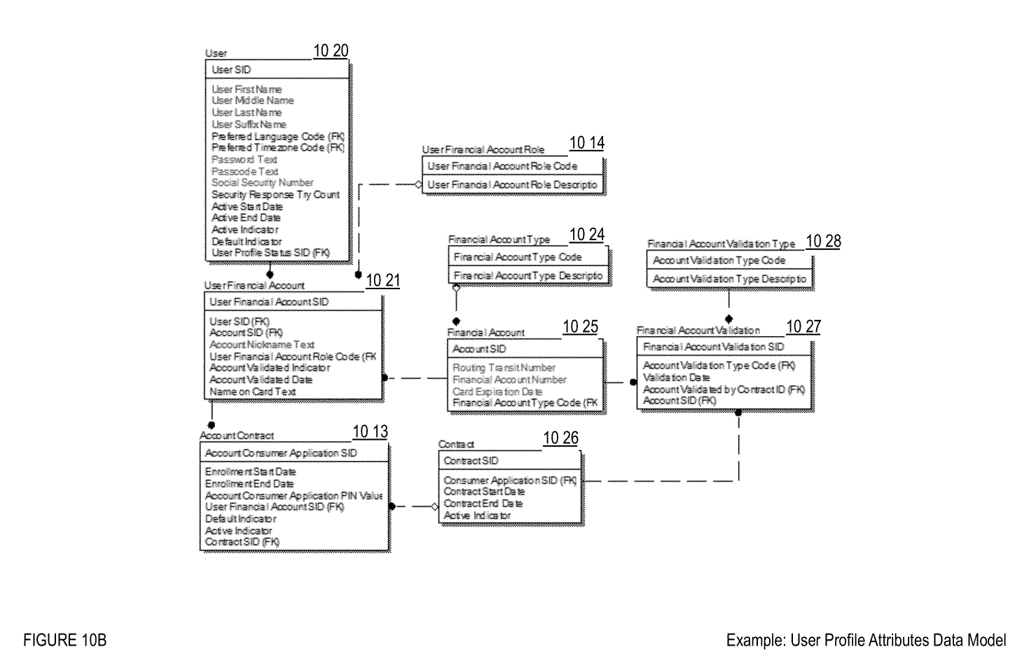

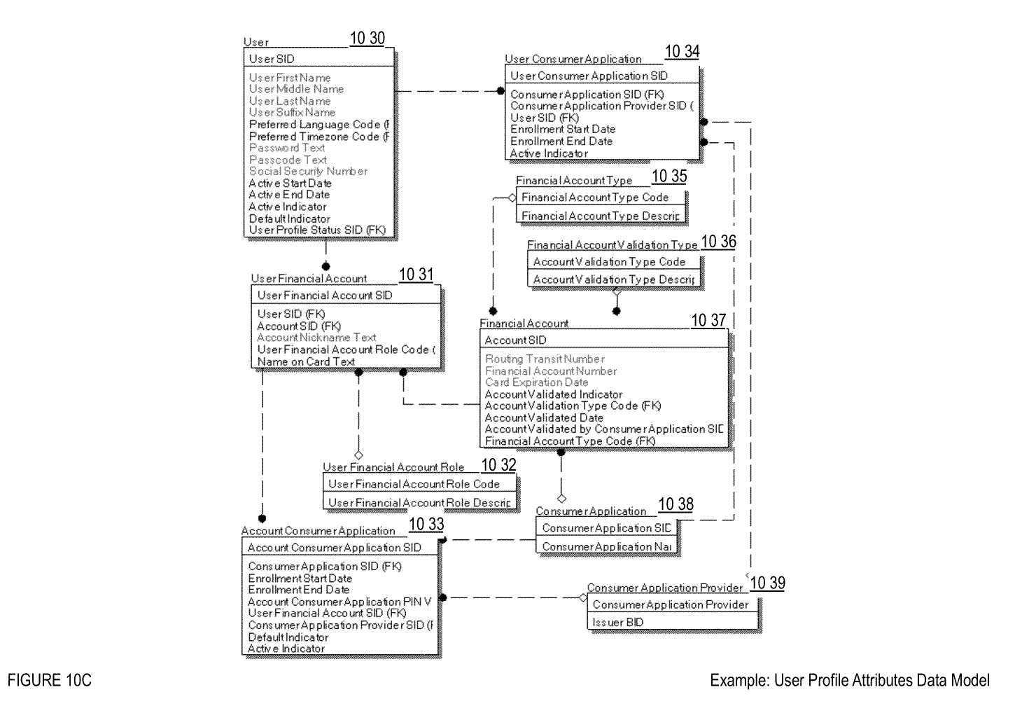

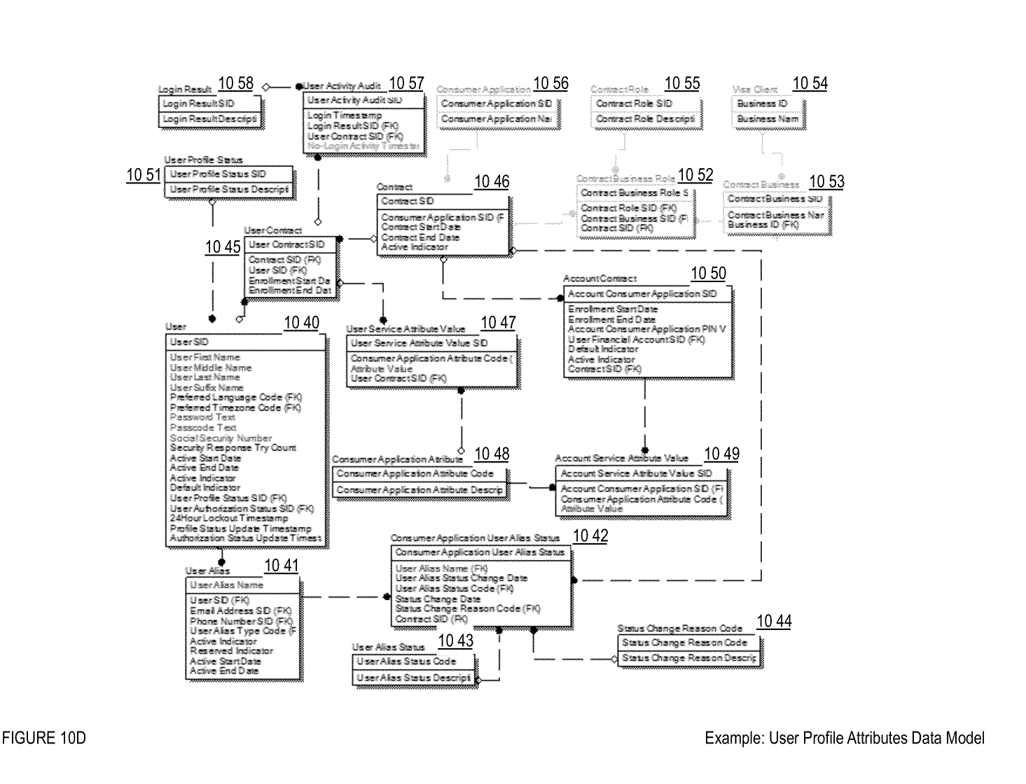

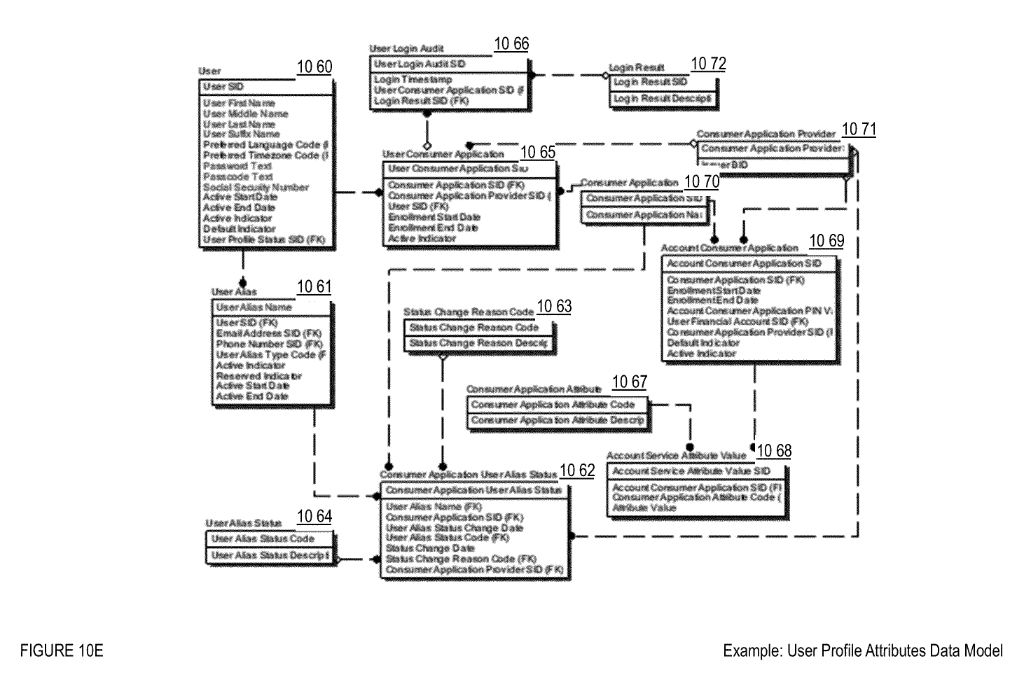

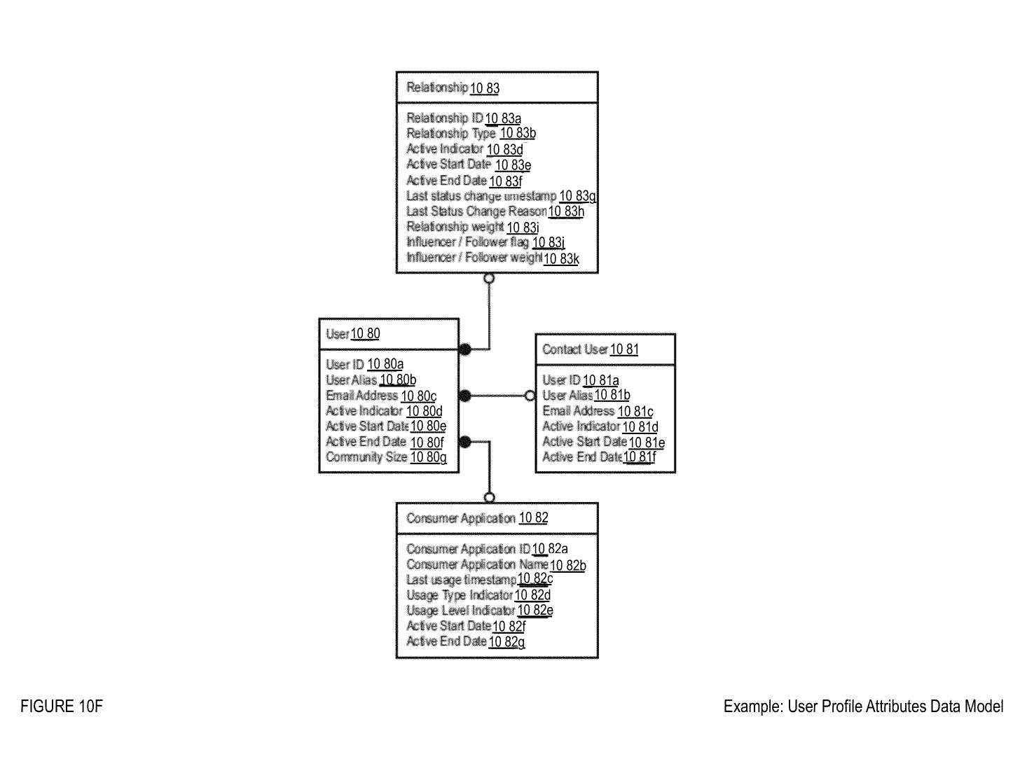

FIGS. 10A-F show block diagrams illustrating example aspects of data models within a centralized personal information platform in some embodiments of the Ad-Track. In various embodiments, the Ad-Track may store a variety of attributes of entities according to various data models. A few non-limiting example data models are provided below. In some embodiments, the Ad-Track may store user profile attributes. For example, a user profile model may store user identifying information 1001, user aliases 1002, email addresses 1003, phone numbers 1004, addresses 1005, email address types 1006, address types 1007, user alias types 1008, notification statuses 1009, ISO country 1010, phone number types 1011, contract information with the Ad-Track 1012, user authorization status 1013, user profile status 1014, security answer 1015, security questions 1016, language 1017, time zone 1018, and/or the like, each of the above field types including one or more fields and field values. As another example, a user financial attributes model may store user identifying information 1020, user financial account information 1021, account contract information 1022, user financial account role 1023, financial account type 1024, financial account identifying information 1025, contract information 1026, financial account validation 1027, financial account validation type 1028, and/or the like. As another example, a user payment card attributes data model may include field types such s, but not limited to: user identifying information 1030, user financial account information 1031, user financial account role 1032, account consumer applications 1033, user consumer application 1034, financial account type 1035, financial account validation type 1036, 18 financial account information 1037, consumer application information 1038, consumer application provider information 1039, and/or the like. As another example, a user services attributes data model may include field types such as, but not limited to: user identifying information 1040, user alias 1041, consumer application user alias status 1042, user alias status 1043, status change reason code 1044, user contract 1045, contract information 1046, user service attribute value 1047, consumer application attributes 1048, account service attribute value, account contract 1050, user profile status 1051, contract business role 1052, contract business 1053, client information 1054, contract role 1055, consumer application 1056, user activity audit 1057, login results 1058, and/or the like. As another example, a user services usage attributes data model may include field types such as, but not limited to: user identifying information 1060, user alias 1061, consumer application user alias status 1062, status change reason code 1063, user alias status 1064, user consumer application 1065, user login audit 1066, login result 1067, account service attribute value 1068, account consumer application 1069, consumer application 1070, consumer application provider 1071, login result 1072, and/or the like. As another example, a user graph attributes data model may include field types such as, but not limited to: user identifying information 1080, user contact 1081, consumer application user alias status 1082, relationship 1083, and/or the like. In some embodiments, the Ad-Track may store each object (e.g., user, merchant, issuer, acquirer, IP address, household, etc.) as a node in graph database, and store data with respect to each node in a format such as the example format provided below:

<Nodes Data>
ID,Nodes,Label
2fdc7e3fbd1c11e0be645528b00e8d0e,2fdc7e3fbd1c11e0be645528b00e8d0e,AFFINITYGROUP

NAME:49:95:0:3:1

32b1d53ebd1c11e094172557fb829fdf,32b1d53ebd1c11e094172557fb829fdf,TOKENENTITYKE

Y:2b8494f0bd1c11e09c856d888c43f7c2:TOKEN:0:F

2e6381e4bd1c11e0b9ffc929a54bb0fd,2e6381e4bd1c11e0b9ffc929a54bb0fd,MERCHANTNAME:

MERCHANT_ABC

2fdc7e3dbd1c11e0a22d5528b00e8d0e,2fdc7e3dbd1c11e0a22d5528b00e8d0e,AFFINITYGROUP

NAME:49:95:0:1:1

2e6381e7bd1c11e091b7c929a54bb0fd,2e6381e7bd1c11e091b7c929a54bb0fd,MERCHANTNAME:

MERCHANT_XYZ

2cf8cbabbd1c11e0894a5de4f9281135,2cf8cbabbd1c11e0894a5de4f9281135,USERNAME:0000

60FF6557F103

2e6381debd1c11e0b336c929a54bb0fd,2e6381debd1c11e0b336c929a54bb0fd,MERCHANTNAME:

MERCHANT_123

2e6381e0bd1c11e0b4e8c929a54bb0fd,2e6381e0bd1c11e0b4e8c929a54bb0fd,MERCHANTNAME:

MERCHANT_FGH

2cf681c1bd1c11e0b8815de4f9281135,2cf681c1bd1c11e0b8815de4f9281135,USERNAME:0000

30C57080FFE8

2b8494f1bd1c11e0acbd6d888c43f7c2,2b8494f1bd1c11e0acbd6d888c43f7c2,MODELNAME:MOD

EL_003_001_00

32b44638bd1c11e0b01c2557fb829fdf,32b44638bd1c11e0b01c2557fb829fdf,TOKENENTITYKE

Y:2b8494f1bd1c11e0acbd6d888c43f7c2:TOKEN:1000:1

2fdc7e40bd1c11e094675528b00e8d0e,2fdc7e40bd1c11e094675528b00e8d0e,AFFINITYGROUP

NAME:49:95:0:4:1

2b8494f0bd1c11e09c856d888c43f7c2,2b8494f0bd1c11e09c856d888c43f7c2,MODELNAME:MOD

EL_002_001_00

32b44639bd1c11e0b15b2557fb829fdf,32b44639bd1c11e0b15b2557fb829fdf,TOKENENTITYKE

Y:2b8494f1bd1c11e0acbd6d888c43f7c2:TOKEN:0:2

32ce84febd1c11e0b0112557fb829fdf,32ce84febd1c11e0b0112557fb829fdf,TOKENENTITYKE

Y:2b8494f1bd1c11e0acbd6d888c43f7c2:TOKEN:1000:4

2e6381e3bd1c11e095b1c929a54bb0fd,2e6381e3bd1c11e095b1c929a54bb0fd,MERCHANTNAME:

MERCHANT_789

34582a87bd1c11e080820167449bc60f,34582a87bd1c11e080820167449bc60f,TOKENENTITYKE

Y:2b8494f1bd1c11e0acbd6d888c43f7c2:TOKEN:778:5

2e6381e5bd1c11e0b62cc929a54bb0fd,2e6381e5bd1c11e0b62cc929a54bb0fd,MERCHANTNAME:

MERCHANT_456

2fdc7e3ebd1c11e088b55528b00e8d0e,2fdc7e3ebd1c11e088b55528b00e8d0e,AFFINITYGROUP

NAME:49:95:0:2:1

32c4e80dbd1c11e09e442557fb829fdf,32c4e80dbd1c11e09e442557fb829fdf,TOKENENTITYKE

Y:2b8494f1bd1c11e0acbd6d888c43f7c2:TOKEN:774:5

2e6381e1bd1c11e0bf28c929a54bb0fd,2e6381e1bd1c11e0bf28c929a54bb0fd,MERCHANTNAME:

MERCHANT_WER

2cf681b8bd1c11e08be85de4f9281135,2cf681b8bd1c11e08be85de4f9281135,USERNAME:0000

2552FC930FF8

2cf8cba8bd1c11e09fbc5de4f9281135,2cf8cba8bd1c11e09fbc5de4f9281135,USERNAME:0000

570FF1B46A24

32b4463abd1c11e0bdaa2557fb829fdf,32b4463abd1c11e0bdaa2557fb829fdf,TOKENENTITYKE

Y:2b8494f1bd1c11e0acbd6d888c43f7c2:TOKEN:0:3

2cf8cbaebd1c11e0b6515de4f9281135,2cf8cbaebd1c11e0b6515de4f9281135,USERNAME:0000

64A20FF962D4

2e6381e6bd1c11e08087c929a54bb0fd,2e6381e6bd1c11e08087c929a54bb0fd,MERCHANTNAME:

MERCHANT_496

2e6381e2bd1c11e0941dc929a54bb0fd,2e6381e2bd1c11e0941dc929a54bb0fd,MERCHANTNAME:

MERCHANT_SDF

<Edge Data>Source,Target,Type,label, Weight
32ce84febd1c11e0b0112557fb829fdf,2e6381e6bd1c11e08087c929a54bb0fd,MODEL_003_001

_00,2b8494f1bd1c11e0acbd6d888c43f7c2:TOKEN:1000:4,1000

2fdc7e3ebd1c11e088b55528b00e8d0e,32ce84febd1c11e0b0112557fb829fdf,MODEL_003_001

_00,2b8494f1bd1c11e0acbd6d888c43f7c2:TOKEN:1000:4,1000

2e6381e2bd1c11e0941dc929a54bb0fd,34582a87bd1c11e080820167449bc60f,MODEL_003_001

_00,2b8494f1bd1c11e0acbd6d888c43f7c2:TOKEN:778:5,778

2b8494f1bd1c11e0acbd6d888c43f7c2,34582a87bd1c11e080820167449bc60f,MODEL_003_001

_00,2b8494f1bd1c11e0acbd6d888c43f7c2:TOKEN:778:5,778

2e6381e1bd1c11e0bf28c929a54bb0fd,32b44639bd1c11e0b15b2557fb829fdf,MODEL_003_001

_00,2b8494f1bd1c11e0acbd6d888c43f7c2:TOKEN:0:2,0

2e6381e0bd1c11e0b4e8c929a54bb0fd,32ce84febd1c11e0b0112557fb829fdf,MODEL_003_001

_00,2b8494f1bd1c11e0acbd6d888c43f7c2:TOKEN:1000:4,1000

32b44639bd1c11e0b15b2557fb829fdf,2e6381e6bd1c11e08087c929a54bb0fd,MODEL_003_001

_00,2b8494f1bd1c11e0acbd6d888c43f7c2:TOKEN:0:2,0

2e6381e1bd1c11e0bf28c929a54bb0fd,32ce84febd1c11e0b0112557fb829fdf,MODEL_003_001

_00,2b8494f1bd1c11e0acbd6d888c43f7c2:TOKEN:1000:4,1000

2e6381debd1c11e0b336c929a54bb0fd,32ce84febd1c11e0b0112557fb829fdf,MODEL_003_001

_00,2b8494f1bd1c11e0acbd6d888c43f7c2:TOKEN:1000:4,1000

2e6381e3bd1c11e095b1c929a54bb0fd,34582a87bd1c11e080820167449bc60f,MODEL_003_001

_00,2b8494f1bd1c11e0acbd6d888c43f7c2:TOKEN:778:5,778

2fdc7e40bd1c11e094675528b00e8d0e,32b44639bd1c11e0b15b2557fb829fdf,MODEL_003_001

_00,2b8494f1bd1c11e0acbd6d888c43f7c2:TOKEN:0:2,0

2b8494f1bd1c11e0acbd6d888c43f7c2,32b4463abd1c11e0bdaa2557fb829fdf,MODEL_003_001

_00,2b8494f1bd1c11e0acbd6d888c43f7c2:TOKEN:0:3,0

2e6381e3bd1c11e095b1c929a54bb0fd,32b4463abd1c11e0bdaa2557fb829fdf,MODEL_003_001

_00,2b8494f1bd1c11e0acbd6d888c43f7c2:TOKEN:0:3,0

2e6381e3bd1c11e095b1c929a54bb0fd,32b1d53ebd1c11e094172557fb829fdf,MODEL_002_001

_00,2b8494f0bd1c11e09c856d888c43f7c2:TOKEN:0:F,0

2e6381e5bd1c11e0b62cc929a54bb0fd,34582a87bd1c11e080820167449bc60f,MODEL_003_001

_00,2b8494f1bd1c11e0acbd6d888c43f7c2:TOKEN:778:5,778

2cf8cbabbd1c11e0894a5de4f9281135,32b44638bd1c11e0b01c2557fb829fdf,MODEL_003_001

_00,2b8494f1bd1c11e0acbd6d888c43f7c2:TOKEN:1000:1,1000

2cf681b8bd1c11e08be85de4f9281135,32b1d53ebd1c11e094172557fb829fdf,MODEL_002_001

_00,2b8494f0bd1c11e09c856d888c43f7c2:TOKEN:0:F,0

32b4463abd1c11e0bdaa2557fb829fdf,2e6381e6bd1c11e08087c929a54bb0fd,MODEL_003_001

_00,2b8494f1bd1c11e0acbd6d888c43f7c2:TOKEN:0:3,0

2e6381debd1c11e0b336c929a54bb0fd,32b44639bd1c11e0b15b2557fb829fdf,MODEL_003_001

_00,2b8494f1bd1c11e0acbd6d888c43f7c2:TOKEN:0:2,0

2e6381e1bd1c11e0bf28c929a54bb0fd,32b44638bd1c11e0b01c2557fb829fdf,MODEL_003_001

_00,2b8494f1bd1c11e0acbd6d888c43f7c2:TOKEN:1000:1,1000

2e6381e5bd1c11e0b62cc929a54bb0fd,32ce84febd1c11e0b0112557fb829fdf,MODEL_003_001

_00,2b8494f1bd1c11e0acbd6d888c43f7c2:TOKEN:1000:4,1000

2e6381e1bd1c11e0bf28c929a54bb0fd,32b4463abd1c11e0bdaa2557fb829fdf,MODEL_003_001

_00,2b8494f1bd1c11e0acbd6d888c43f7c2:TOKEN:0:3,0

2e6381e2bd1c11e0941dc929a54bb0fd,32b44639bd1c11e0b15b2557fb829fdf,MODEL_003_001

_00,2b8494f1bd1c11e0acbd6d888c43f7c2:TOKEN:0:2,0

2b8494f1bd1c11e0acbd6d888c43f7c2,32c4e80dbd1c11e09e442557fb829fdf,MODEL_003_001

_00,2b8494f1bd1c11e0acbd6d888c43f7c2:TOKEN:774:5,774

2e6381e2bd1c11e0941dc929a54bb0fd,32b1d53ebd1c11e094172557fb829fdf,MODEL_002_001

_00,2b8494f0bd1c11e09c856d888c43f7c2:TOKEN:0:F,0

2e6381e4bd1c11e0b9ffc929a54bb0fd,32b4463abd1c11e0bdaa2557fb829fdf,MODEL_003_001

_00,2b8494f1bd1c11e0acbd6d888c43f7c2:TOKEN:0:3,0

2fdc7e3fbd1c11e0be645528b00e8d0e,32b4463abd1c11e0bdaa2557fb829fdf,MODEL_003_001

_00,2b8494f1bd1c11e0acbd6d888c43f7c2:TOKEN:0:3,0

2e6381e1bd1c11e0bf28c929a54bb0fd,32b1d53ebd1c11e094172557fb829fdf,MODEL_002_001

_00,2b8494f0bd1c11e09c856d888c43f7c2:TOKEN:0:F,0

2fdc7e40bd1c11e094675528b00e8d0e,32ce84febd1c11e0b0112557fb829fdf,MODEL_003_001

_00,2b8494f1bd1c11e0acbd6d888c43f7c2:TOKEN:1000:4,1000

2cf8cba8bd1c11e09fbc5de4f9281135,32c4e80dbd1c11e09e442557fb829fdf,MODEL_003_001

_00,2b8494f1bd1c11e0acbd6d888c43f7c2:TOKEN:774:5,774

2e6381e2bd1c11e0941dc929a54bb0fd,32b44638bd1c11e0b01c2557fb829fdf,MODEL_003_001

_00,2b8494f1bd1c11e0acbd6d888c43f7c2:TOKEN:1000:1,1000

2e6381e4bd1c11e0b9ffc929a54bb0fd,32b1d53ebd1c11e094172557fb829fdf,MODEL_002_001

_00,2b8494f0bd1c11e09c856d888c43f7c2:TOKEN:0:F,0

2e6381e5bd1c11e0b62cc929a54bb0fd,32b44639bd1c11e0b15b2557fb829fdf,MODEL_003_001

_00,2b8494f1bd1c11e0acbd6d888c43f7c2:TOKEN:0:2,0

32b1d53ebd1c11e094172557fb829fdf,2e6381e6bd1c11e08087c929a54bb0fd,MODEL_002_001

_00,2b8494f0bd1c11e09c856d888c43f7c2:TOKEN:0:F,0

2b8494f1bd1c11e0acbd6d888c43f7c2,32b44639bd1c11e0b15b2557fb829fdf,MODEL_003_001

_00,2b8494f1bd1c11e0acbd6d888c43f7c2:TOKEN:0:2,0

2e6381e3bd1c11e095b1c929a54bb0fd,32b44638bd1c11e0b01c2557fb829fdf,MODEL_003_001

_00,2b8494f1bd1c11e0acbd6d888c43f7c2:TOKEN:1000:1,1000

2fdc7e3dbd1c11e0a22d5528b00e8d0e,32ce84febd1c11e0b0112557fb829fdf,MODEL_003_001

_00,2b8494f1bd1c11e0acbd6d888c43f7c2:TOKEN:1000:4,1000

2cf681c1bd1c11e0b8815de4f9281135,32b44638bd1c11e0b01c2557fb829fdf,MODEL_003_001

_00,2b8494f1bd1c11e0acbd6d888c43f7c2:TOKEN:1000:1,1000

2cf681c1bd1c11e0b8815de4f9281135,32b1d53ebd1c11e094172557fb829fdf,MODEL_002_001

_00,2b8494f0bd1c11e09c856d888c43f7c2:TOKEN:0:F,0

2e6381e3bd1c11e095b1c929a54bb0fd,32b44639bd1c11e0b15b2557fb829fdf,MODEL_003_001

_00,2b8494f1bd1c11e0acbd6d888c43f7c2:TOKEN:0:2,0

2fdc7e3fbd1c11e0be645528b00e8d0e,32b1d53ebd1c11e094172557fb829fdf,MODEL_002_001

_00,2b8494f0bd1c11e09c856d888c43f7c2:TOKEN:0:F,0

32b44638bd1c11e0b01c2557fb829fdf,2e6381e6bd1c11e08087c929a54bb0fd,MODEL_003_001

_00,2b8494f1bd1c11e0acbd6d888c43f7c2:TOKEN:1000:1,1000

2cf8cbaebd1c11e0b6515de4f9281135,32ce84febd1c11e0b0112557fb829fdf,MODEL_003_001

_00,2b8494f1bd1c11e0acbd6d888c43f7c2:TOKEN:1000:4,1000

2e6381e6bd1c11e08087c929a54bb0fd,32b1d53ebd1c11e094172557fb829fdf,MODEL_002_001

_00,2b8494f0bd1c11e09c856d888c43f7c2:TOKEN:0:F,0

2e6381e7bd1c11e091b7c929a54bb0fd,34582a87bd1c11e080820167449bc60f,MODEL_003_001

_00,2b8494f1bd1c11e0acbd6d888c43f7c2:TOKEN:778:5,778

2e6381e1bd1c11e0bf28c929a54bb0fd,34582a87bd1c11e080820167449bc60f,MODEL_003_001

_00,2b8494f1bd1c11e0acbd6d888c43f7c2:TOKEN:778:5,778

2e6381e5bd1c11e0b62cc929a54bb0fd,32b1d53ebd1c11e094172557fb829fdf,MODEL_002_001

_00,2b8494f0bd1c11e09c856d888c43f7c2:TOKEN:0:F,0

2b8494f0bd1c11e09c856d888c43f7c2,32b1d53ebd1c11e094172557fb829fdf,MODEL_002_001

_00,2b8494f0bd1c11e09c856d888c43f7c2:TOKEN:0:F,0

2b8494f1bd1c11e0acbd6d888c43f7c2,32b44638bd1c11e0b01c2557fb829fdf,MODEL_003_001

_00,2b8494f1bd1c11e0acbd6d888c43f7c2:TOKEN:1000:1,1000

2e6381e6bd1c11e08087c929a54bb0fd,32b4463abd1c11e0bdaa2557fb829fdf,MODEL_003_001

_00,2b8494f1bd1c11e0acbd6d888c43f7c2:TOKEN:0:3,0

2b8494f1bd1c11e0acbd6d888c43f7c2,32ce84febd1c11e0b0112557fb829fdf,MODEL_003_001

_00,2b8494f1bd1c11e0acbd6d888c43f7c2:TOKEN:1000:4,1000

2cf681c1bd1c11e0b8815de4f9281135,32b44639bd1c11e0b15b2557fb829fdf,MODEL_003_001

_00,2b8494f1bd1c11e0acbd6d888c43f7c2:TOKEN:0:2,0

2cf681c1bd1c11e0b8815de4f9281135,32b4463abd1c11e0bdaa2557fb829fdf,MODEL_003_001

_00,2b8494f1bd1c11e0acbd6d888c43f7c2:TOKEN:0:3,0

2e6381e2bd1c11e0941dc929a54bb0fd,32b4463abd1c11e0bdaa2557fb829fdf,MODEL_003_001

_00,2b8494f1bd1c11e0acbd6d888c43f7c2:TOKEN:0:3,0

2e6381e3bd1c11e095b1c929a54bb0fd,32ce84febd1c11e0b0112557fb829fdf,MODEL_003_001

_00,2b8494f1bd1c11e0acbd6d888c43f7c2:TOKEN:1000:4,1000

2e6381e6bd1c11e08087c929a54bb0fd,32ce84febd1c11e0b0112557fb829fdf,MODEL_003_001

_00,2b8494f1bd1c11e0acbd6d888c43f7c2:TOKEN:1000:4,1000

2e6381e6bd1c11e08087c929a54bb0fd,34582a87bd1c11e080820167449bc60f,MODEL_003_001

_00,2b8494f1bd1c11e0acbd6d888c43f7c2:TOKEN:778:5,778

2e6381e6bd1c11e08087c929a54bb0fd,32b44638bd1c11e0b01c2557fb829fdf,MODEL_003_001

_00,2b8494f1bd1c11e0acbd6d888c43f7c2:TOKEN:1000:1,1000

2fdc7e3ebd1c11e088b55528b00e8d0e,32b44639bd1c11e0b15b2557fb829fdf,MODEL_003_001

_00,2b8494f1bd1c11e0acbd6d888c43f7c2:TOKEN:0:2,0

2e6381e5bd1c11e0b62cc929a54bb0fd,32b4463abd1c11e0bdaa2557fb829fdf,MODEL_003_001

_00,2b8494f1bd1c11e0acbd6d888c43f7c2:TOKEN:0:3,0

2e6381e4bd1c11e0b9ffc929a54bb0fd,34582a87bd1c11e080820167449bc60f,MODEL_003_001

_00,2b8494f1bd1c11e0acbd6d888c43f7c2:TOKEN:778:5,778

2e6381e4bd1c11e0b9ffc929a54bb0fd,32b44638bd1c11e0b01c2557fb829fdf,MODEL_003_001

_00,2b8494f1bd1c11e0acbd6d888c43f7c2:TOKEN:1000:1,1000

34582a87bd1c11e080820167449bc60f,2e6381e6bd1c11e08087c929a54bb0fd,MODEL_003_001

_00,2b8494f1bd1c11e0acbd6d888c43f7c2:TOKEN:778:5,778

2e6381e6bd1c11e08087c929a54bb0fd,32b44639bd1c11e0b15b2557fb829fdf,MODEL_003_001

_00,2b8494f1bd1c11e0acbd6d888c43f7c2:TOKEN:0:2,0

2e6381e5bd1c11e0b62cc929a54bb0fd,32b44638bd1c11e0b01c2557fb829fdf,MODEL_003_001

_00,2b8494f1bd1c11e0acbd6d888c43f7c2:TOKEN:1000:1,1000

2fdc7e3fbd1c11e0be645528b00e8d0e,32b44638bd1c11e0b01c2557fb829fdf,MODEL_003_001

_00,2b8494f1bd1c11e0acbd6d888c43f7c2:TOKEN:1000:1,1000

2cf681b8bd1c11e08be85de4f9281135,32b44639bd1c11e0b15b2557fb829fdf,MODEL_003_001

_00,2b8494f1bd1c11e0acbd6d888c43f7c2:TOKEN:0:2,0

2e6381e4bd1c11e0b9ffc929a54bb0fd,32b44639bd1c11e0b15b2557fb829fdf,MODEL_003_001

_00,2b8494f1bd1c11e0acbd6d888c43f7c2:TOKEN:0:2,0

2cf681b8bd1c11e08be85de4f9281135,32b4463abd1c11e0bdaa2557fb829fdf,MODEL_003_001

_00,2b8494f1bd1c11e0acbd6d888c43f7c2:TOKEN:0:3,0

2e6381e4bd1c11e0b9ffc929a54bb0fd,32ce84febd1c11e0b0112557fb829fdf,MODEL_003_001

_00,2b8494f1bd1c11e0acbd6d888c43f7c2:TOKEN:1000:4,1000

2e6381e2bd1c11e0941dc929a54bb0fd,32ce84febd1c11e0b0112557fb829fdf,MODEL_003_001

_00,2b8494f1bd1c11e0acbd6d888c43f7c2:TOKEN:1000:4,1000

2fdc7e3dbd1c11e0a22d5528b00e8d0e,32b44639bd1c11e0b15b2557fb829fdf,MODEL_003_001

_00,2b8494f1bd1c11e0acbd6d888c43f7c2:TOKEN:0:2,0

2cf681b8bd1c11e08be85de4f9281135,32b44638bd1c11e0b01c2557fb829fdf,MODEL_003_001

_00,2b8494f1bd1c11e0acbd6d888c43f7c2:TOKEN:1000:1,1000

In alternate examples, the Ad-Track may store data in a JavaScript Object Notation (“JSON”) format. The stored information may include data regarding the object, such as, but not limited to: commands, attributes, group information, payment information, account information, etc., such as in the example below:

{‘MERCHANT’: {‘TYPEOFTYPES’: [‘MERCHANTS’, ‘SYNTHETICNETWORKS’], ‘FUNCTIONS’:

{‘ENTITYCREATION’: ‘putNetwork’}

, ‘UNIQUEATTIBUTES’: [‘MERCHANTNAME’], ‘TOKENENTITIESRELATIONSHIPS’: [ ],

‘ATTRIBUTES’: {‘MERCHANT’: (2, ‘STRING’, 0, ‘VALUE’), ‘MERCH_ZIP_CD’: (7,
‘STRING’, 0, ‘VALUE’), ‘MERCH_NAME’: (8, ‘STRING’, 0, ‘VALUE’),
‘MERCHANTNAME’: (3, ‘STRING’, 0, ‘VALUE’), ‘ACQ_CTRY_NUM’: (4, ‘STRING’, 0,
‘VALUE’), ‘ACQ_PCR’: (6, ‘STRING’, 0, ‘VALUE’), ‘ACQ_REGION_NUM’: (5,
‘STRING’, 0, ‘VALUE’), ‘ISACTIVE’: (0, ‘BOOL’, 1, ‘VALUE’), ‘ENTITYKEY’: (1,
‘STRING’, 0, ‘VALUE’)}

}
, ‘AFFINITYGROUP’: {‘TYPEOFTYPES’: [‘AFFINITYGROUPS’], ‘FUNCTIONS’:

{‘ENTITYCREATION’: ‘putNetwork’}

, ‘UNIQUEATTIBUTES’: [‘AFFINITYGROUPNAME’], ‘TOKENENTITIESRELATIONSHIPS’: [ ],

‘ATTRIBUTES’: {‘XML’: (2, ‘STRING’, 0, ‘VALUE’), ‘DESCRIPTION’: (4,
‘STRING’, 0, ‘VALUE’), ‘ENTITYKEY’: (1, ‘STRING’, 0, ‘VALUE’), ‘TYPEOF’: (5,
‘STRING’, 0, ‘VALUE’), ‘AFFINITYGROUPNAME’: (3, ‘STRING’, 0, ‘VALUE’),
‘ISACTIVE’: (0, ‘BOOL’, 1, ‘VALUE’)}

}
, ‘CASCADINGPAYMENT’: {‘TYPEOFTYPES’: [‘CASCADINGPAYMENT’], ‘FUNCTIONS’:

{‘ENTITYCREATION’: ‘putNetwork’}

, ‘UNIQUEATTIBUTES’: [‘CASCADINGPAYMENTNAME’], ‘TOKENENTITIESRELATIONSHIPS’:

[‘GROUP’], ‘ATTRIBUTES’: {‘STATUS’: (2, ‘STRING’, 0, ‘VALUE’), ‘EXPDT’: (6,
‘DATETIME’, 0, ‘VALUE’), ‘GROUP’: (3, ‘STRING’, 0, ‘VALUE’), ‘RESTRICTIONS’:
(7, ‘DICT’, 0, ‘VALUE’), ‘CASCADINGPAYMENTNAME’: (4, ‘STRING’, 0, ‘VALUE’),
‘STARTDT’: (5, ‘DATETIME’, 0, ‘VALUE’), ‘ISACTIVE’: (0, ‘BOOL’, 1, ‘VALUE’),
‘ENTITYKEY’: (1, ‘STRING’, 0, ‘VALUE’)}

}
, ‘GROUP’: {‘TYPEOFTYPES’: [ ], ‘FUNCTIONS’: {‘ENTITYCREATION’: ‘putNetwork’}
, ‘UNIQUEATTIBUTES’: [‘GROUPNAME’], ‘TOKENENTITIESRELATIONSHIPS’: { }
, ‘ATTRIBUTES’: {‘GROUPNAME’: (2, ‘STRING’, 0, ‘VALUE’), ‘DESCRIPTION’: (2,

‘STRING’, 0, ‘VALUE’), ‘ISACTIVE’: (0, ‘BOOL’, 1, ‘VALUE’), ‘ENTITYKEY’: (1,
‘STRING’, 0, ‘VALUE’)}

}
, ‘USERS’: {‘TYPEOFTYPES’: [ ], ‘FUNCTIONS’: {‘ENTITYCREATION’: ‘putNetwork’}
, ‘UNIQUEATTIBUTES’: [‘USERSID’], ‘TOKENENTITIESRELATIONSHIPS’: { }
, ‘ATTRIBUTES’: {‘USERSID’: (2, ‘STRING’, 0, ‘VALUE’), ‘ISACTIVE’: (0, ‘BOOL’,

1, ‘VALUE’), ‘ENTITYKEY’: (1, ‘STRING’, 0, ‘VALUE’)}

}
, ‘TWITTERUSER’: {‘TYPEOFTYPES’: [‘TOKENENTITY’], ‘FUNCTIONS’:

{‘ENTITYCREATION’: ‘putWGTNetwork’}

, ‘UNIQUEATTIBUTES’: [‘USERNAME’], ‘TOKENENTITIESRELATIONSHIPS’: [‘USER’],

‘ATTRIBUTES’: {‘USERNAME’: (2, ‘STRING’, 0, ‘VALUE’), ‘CITY’: (5, ‘STRING’,
0, ‘VALUE’), ‘ENTITYKEY’: (1, ‘STRING’, 0, ‘VALUE’), ‘USERLINK’: (6,
‘STRING’, 0, ‘VALUE’), ‘FULLNAME’: (4, ‘STRING’, 0, ‘VALUE’), ‘USERTAG’: (3,
‘STRING’, 0, ‘VALUE’), ‘ISACTIVE’: (0, ‘BOOL’, 1, ‘VALUE’)}

}
, ‘COUPON’: {‘TYPEOFTYPES’: [‘COUPON’], ‘FUNCTIONS’: {‘ENTITYCREATION’:

‘putNetwork’}

, ‘UNIQUEATTIBUTES’: [‘COUPONNAME’], ‘TOKENENTITIESRELATIONSHIPS’:

[‘MERCHANT’], ‘ATTRIBUTES’: {‘STATUS’: (2, ‘STRING’, 0, ‘VALUE’),
‘MERCHANT’: (3, ‘STRING’, 0, ‘VALUE’), ‘TITLE’: (5, ‘STRING’, 0, ‘VALUE’),
‘NOTES’: (7, ‘STRING’, 0, ‘VALUE’), ‘UPDATEDBY’: (11, ‘STRING’, 0, ‘VALUE’),
‘ENTITYKEY’: (1, ‘STRING’, 0, ‘VALUE’), ‘DECRIPTION ’: (6, ‘STRING’, 0,
‘VALUE’), ‘CREATEDBY’: (10, ‘STRING’, 0, ‘VALUE’), ‘LASTUPDATEDT’: (9,
‘DATETIME’, 0, ‘VALUE’), ‘EXPDT’: (13, ‘DATETIME’, 0, ‘VALUE’),
‘RESTRICTIONS’: (14, ‘DICT’, 0, ‘VALUE’), ‘COUPONNAME ’: (4, ‘STRING’, 0,
‘VALUE’), ‘CREATIONDT’: (8, ‘DATETIME’, 0, ‘VALUE’), ‘STARTDT’: (12,
‘DATETIME’, 0, ‘VALUE’), ‘ISACTIVE’: (0, ‘BOOL’, 1, ‘VALUE’)}

}
, ‘MEMBERSHIP’: {‘TYPEOFTYPES’: [‘MEMBERSHIPS’], ‘FUNCTIONS’:

{‘ENTITYCREATION’: ‘putNetwork’}

, ‘UNIQUEATTIBUTES’: [‘MEMBERSHIPNAME’], ‘TOKENENTITIESRELATIONSHIPS’:

[‘MERCHANT’], ‘ATTRIBUTES’: {‘STATUS’: (2, ‘STRING’, 0, ‘VALUE’),
‘MERCHANT’: (3, ‘STRING’, 0, ‘VALUE’), ‘RESTRICTIONS’: (7, ‘DICT’, 0,
‘VALUE’), ‘MEMBERSHIPNAME’: (4, ‘STRING’, 0, ‘VALUE’), ‘STARTDT’: (5,
‘DATETIME’, 0, ‘VALUE’), ‘EXPDT’: (6, ‘DATETIME’, 0, ‘VALUE’), ‘ISACTIVE’:
(0, ‘BOOL’, 1, ‘VALUE’), ‘ENTITYKEY’: (1, ‘STRING’, 0, ‘VALUE’)}

}
, ‘USERSECURITY’: {‘TYPEOFTYPES’: [‘SECURITY’], ‘FUNCTIONS’: {‘ENTITYCREATION’:

‘putNetwork’}

, ‘UNIQUEATTIBUTES’: [‘USERSECURITYNAME’], ‘TOKENENTITIESRELATIONSHIPS’:

[‘USER’], ‘ATTRIBUTES’: {‘STATUS’: (2, ‘STRING’, 0, ‘VALUE’), ‘EXPDT’: (6,
‘DATETIME’, 0, ‘VALUE’), ‘USERSECURITYNAME’: (4, ‘STRING’, 0, ‘VALUE’),
‘USER’: (3, ‘STRING’, 0, ‘VALUE’), ‘RESTRICTIONS’: (7, ‘DICT’, 0, ‘VALUE’),
‘STARTDT’: (5, ‘DATETIME’, 0, ‘VALUE’), ‘ISACTIVE’: (0, ‘BOOL’, 1, ‘VALUE’),
‘ENTITYKEY’: (1, ‘STRING’, 0, ‘VALUE’)}

}
, ‘MCC’: {‘TYPEOFTYPES’: [‘MCC’], ‘FUNCTIONS’: {‘ENTITYCREATION’:

‘putWGTNetwork’}

, ‘UNIQUEATTIBUTES’: [‘MCCNAME’, ‘MCC’], ‘TOKENENTITIESRELATIONSHIPS’:

[‘MCCSEG’], ‘ATTRIBUTES’: {‘MCCSEG’: (4, ‘STRING’, 0, ‘VALUE’), ‘MCC’: (2,
‘STRING’, 0, ‘VALUE’), ‘MCCNAME’: (3, ‘STRING’, 0, ‘VALUE’), ‘ISACTIVE’: (0,
‘BOOL’, 1, ‘VALUE’), ‘ENTITYKEY’: (1, ‘STRING’, 0, ‘VALUE’)}

}
, ‘ZIPCODE’: {‘TYPEOFTYPES’: [‘LOCATION’], ‘FUNCTIONS’: {‘ENTITYCREATION’:

‘putNetwork’}

, ‘UNIQUEATTIBUTES’: [‘ZIPCODE’], ‘TOKENENTITIESRELATIONSHIPS’: [ ],

‘ATTRIBUTES’: {‘STATE’: (4, ‘STRING’, 0, ‘VALUE’), ‘POPULATION’: (3,
‘STRING’, 0, ‘VALUE’), ‘ZIPCODE’: (2, ‘STRING’, 0, ‘VALUE’), ‘ISACTIVE’: (0,
‘BOOL’, 1, ‘VALUE’), ‘ENTITYKEY’: (1, ‘STRING’, 0, ‘VALUE’)}

}
, ‘PAYMENTCARD’: {‘TYPEOFTYPES’: [‘PAYMENTCARDS’], ‘FUNCTIONS’:

{‘ENTITYCREATION’: ‘putNetwork’}

, ‘UNIQUEATTIBUTES’: [‘CARDNUMBER’], ‘TOKENENTITIESRELATIONSHIPS’: [‘USER’],

‘ATTRIBUTES’: {‘EXPDATE’: (5, ‘DATETIME’, 0, ‘VALUE’), ‘ENTITYKEY’: (1,
‘STRING’, 0, ‘VALUE’), ‘CARDTYPE’: (4, ‘STRING’, 0, ‘VALUE’), ‘CARDNUMBER’:
(2, ‘STRING’, 0, ‘VALUE’), ‘USER’: (3, ‘STRING’, 0, ‘VALUE’), ‘ISACTIVE’:
(0, ‘BOOL’, 1, ‘VALUE’)}

}
, ‘GENERICTOKEN’: {‘TYPEOFTYPES’: [‘COUPON’], ‘FUNCTIONS’: {‘ENTITYCREATION’:

‘putNetwork’}

, ‘UNIQUEATTIBUTES’: [‘GENERICTOKENNAME’], ‘TOKENENTITIESRELATIONSHIPS’:

[‘MERCHANT’], ‘ATTRIBUTES’: {‘STATUS’: (2, ‘STRING’, 0, ‘VALUE’),
‘MERCHANT’: (3, ‘STRING’, 0, ‘VALUE’), ‘TITLE’: (5, ‘STRING’, 0, ‘VALUE’),
‘NOTES’: (7, ‘STRING’, 0, ‘VALUE’), ‘UPDATEDBY’: (11, ‘STRING’, 0, ‘VALUE’),
‘ENTITYKEY’: (1, ‘STRING’, 0, ‘VALUE’), ‘DECRIPTION ’: (6, ‘STRING’, 0,
‘VALUE’), ‘CREATEDBY’: (10, ‘STRING’, 0, ‘VALUE’), ‘LASTUPDATEDT’: (9,
‘DATETIME’, 0, ‘VALUE’), ‘EXPDT’: (13, ‘DATETIME’, 0, ‘VALUE’),
‘RESTRICTIONS’: (14, ‘DICT’, 0, ‘VALUE’), ‘STARTDT’: (12, ‘DATETIME’, 0,
‘VALUE’), ‘CREATIONDT’: (8, ‘DATETIME’, 0, ‘VALUE’), ‘GENERICTOKENNAME’: (4,
‘STRING’, 0, ‘VALUE’), ‘ISACTIVE’: (0, ‘BOOL’, 1, ‘VALUE’)}

}
, ‘USER’: {‘TYPEOFTYPES’: [‘USERS’, ‘SYNTHETICNETWORKS’], ‘FUNCTIONS’:

{‘ENTITYCREATION’: ‘putNetwork’}

, ‘UNIQUEATTIBUTES’: [‘USERNAME’], ‘TOKENENTITIESRELATIONSHIPS’: [‘USERS’],

‘ATTRIBUTES’: {‘USERNAME’: (5, ‘STRING’, 0, ‘VALUE’), ‘USERS’: (2, ‘STRING’,
0, ‘VALUE’), ‘FIRSTNAME’: (3, ‘STRING’, 0, ‘VALUE’), ‘LASTNAME’: (4,
‘STRING’, 0, ‘VALUE’), ‘ENTITYKEY’: (1, ‘STRING’, 0, ‘VALUE’), ‘ISACTIVE’:
(0, ‘BOOL’, 1, ‘VALUE’)}

}
, ‘TWEETS’: {‘TYPEOFTYPES’: [‘TOKENENTITY’], ‘FUNCTIONS’: {‘ENTITYCREATION’:

‘putWGTNetwork’}

, ‘UNIQUEATTIBUTES’: [‘TWEETID’], ‘TOKENENTITIESRELATIONSHIPS’:

[‘TWITTERUSER’], ‘ATTRIBUTES’: {‘Title’: (4, ‘STRING’, 0, ‘VALUE’),
‘RawTweet’: (5, ‘STRING’, 0, ‘VALUE’), ‘DATETIME’: (3, ‘STRING’, 0,
‘VALUE’), ‘CLEANEDTWEET’: (6, ‘STRING’, 0, ‘VALUE’), ‘ENTITYKEY’: (1,
‘STRING’, 0, ‘VALUE’), ‘TWEETID’: (2, ‘STRING’, 0, ‘VALUE’), ‘ISACTIVE’: (0,
‘BOOL’, 1, ‘VALUE’)}

}
, ‘MODEL’: {‘TYPEOFTYPES’: [‘MODELS’], ‘FUNCTIONS’: {‘ENTITYCREATION’:

‘putNetwork’}

, ‘UNIQUEATTIBUTES’: [‘MODELNAME’], ‘TOKENENTITIESRELATIONSHIPS’: [‘USER’,

‘MERCHANT’, ‘PAYMENTCARD’], ‘ATTRIBUTES’: {‘XML’: (2, ‘STRING’, 0, ‘VALUE’),
‘MODELNAME’: (3, ‘STRING’, 0, ‘VALUE’), ‘DESCRIPTION’: (4, ‘STRING’, 0,
‘VALUE’), ‘ENTITYKEY’: (1, ‘STRING’, 0, ‘VALUE’), ‘TYPEOF’: (5, ‘STRING’, 0,
‘VALUE’), ‘ISACTIVE’: (0, ‘BOOL’, 1, ‘VALUE’)}

}
, ‘MCCSEG’: {‘TYPEOFTYPES’: [‘MCCSEG’], ‘FUNCTIONS’: {‘ENTITYCREATION’:

‘putWGTNetwork’}

, ‘UNIQUEATTIBUTES’: [‘MCCSEGID’], ‘TOKENENTITIESRELATIONSHIPS’: { }
, ‘ATTRIBUTES’: {‘MCCSEGID’: (2, ‘STRING’, 0, ‘VALUE’), ‘MCCSEGNAME’: (3,

‘STRING’, 0, ‘VALUE’), ‘ISACTIVE’: (0, ‘BOOL’, 1, ‘VALUE’), ‘ENTITYKEY’: (1,
‘STRING’, 0, ‘VALUE’)}

}
, ‘TOKENENTITY’: {‘TYPEOFTYPES’: [‘TOKENENTITY’], ‘FUNCTIONS’:

{‘ENTITYCREATION’: ‘putWGTNetwork’}

, ‘UNIQUEATTIBUTES’: [‘TOKENENTITYKEY’], ‘TOKENENTITIESRELATIONSHIPS’: { }
, ‘ATTRIBUTES’: {‘STATUS’: (4, ‘STRING’, 0, ‘VALUE’), ‘ISSUEDDATE’: (5,

‘STRING’, 0, ‘VALUE’), ‘DOUBLELINKED’: (8, ‘BOOL’, 1, ‘VALUE’), ‘BASEUUID’:
(1, ‘STRING’, 0, ‘VALUE’), ‘WEIGHT’: (6, ‘STRING’, 0, ‘VALUE’), ‘BASETYPE’:
(3, ‘STRING’, 0, ‘VALUE’), ‘CATEGORY’: (7, ‘STRING’, 0, ‘VALUE’),
‘ISACTIVE’: (0, ‘BOOL’, 1, ‘VALUE’), ‘TOKENENTITYKEY’: (2, ‘STRING’, 0,
‘VALUE’)}

}
}

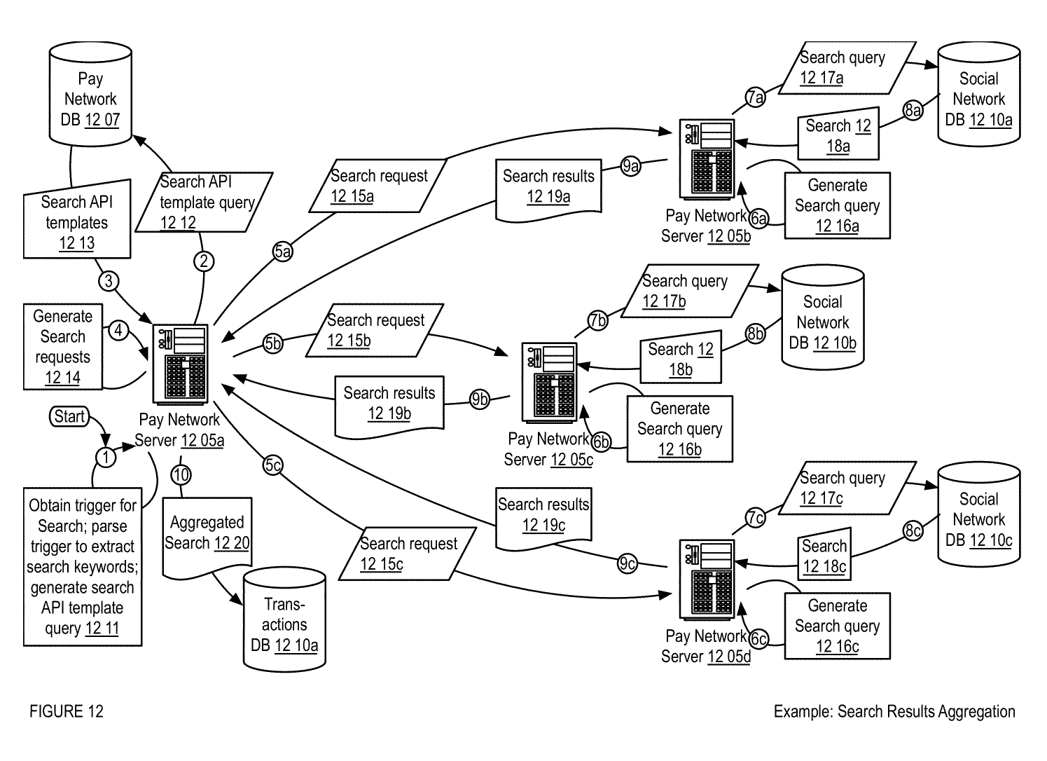

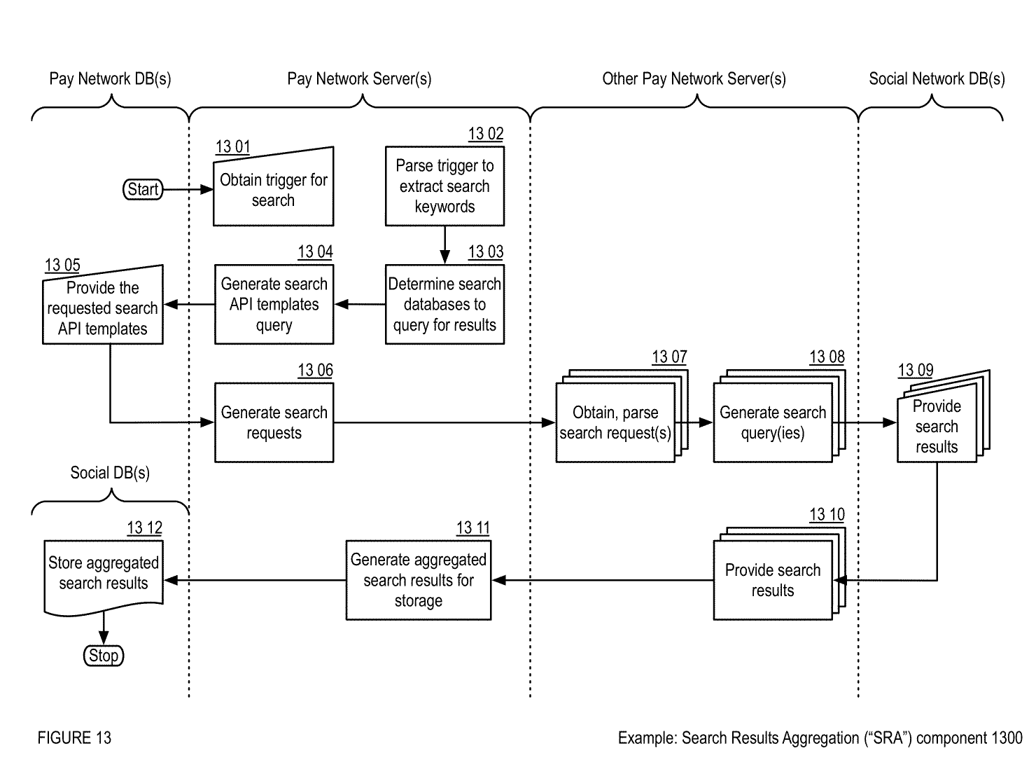

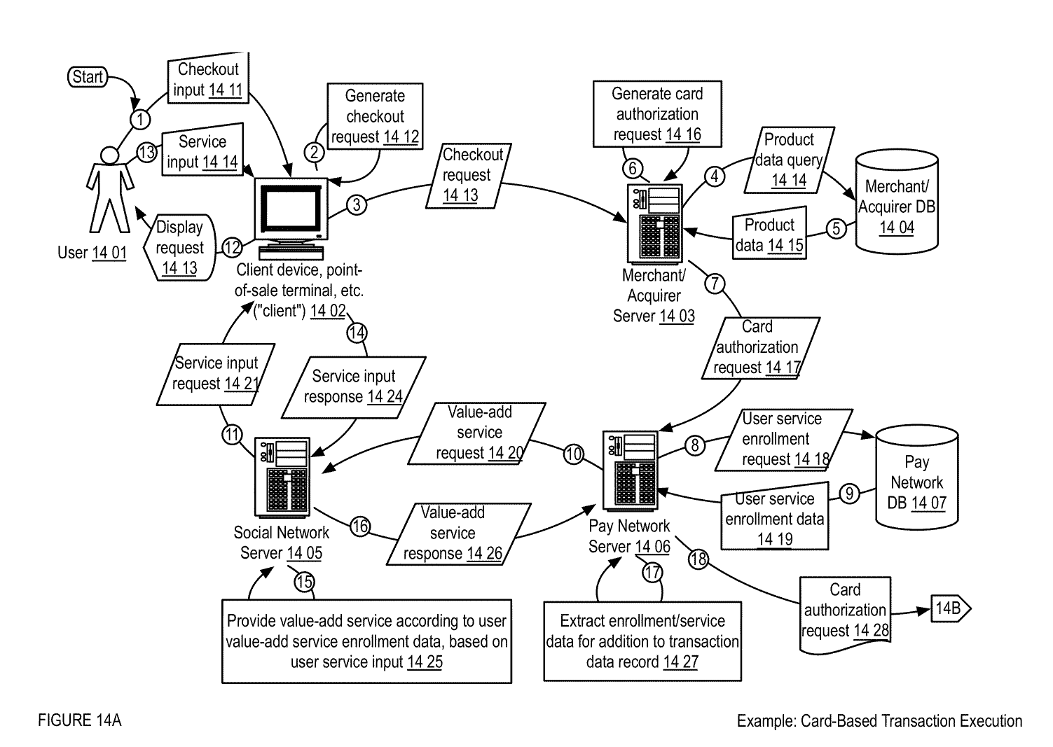

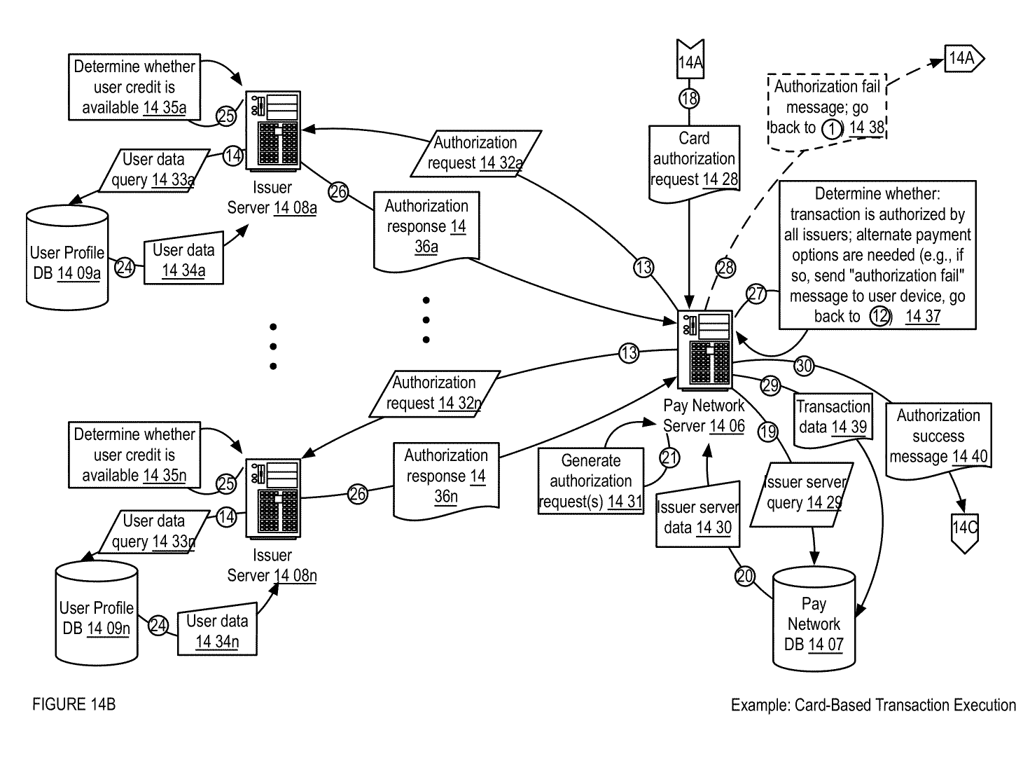

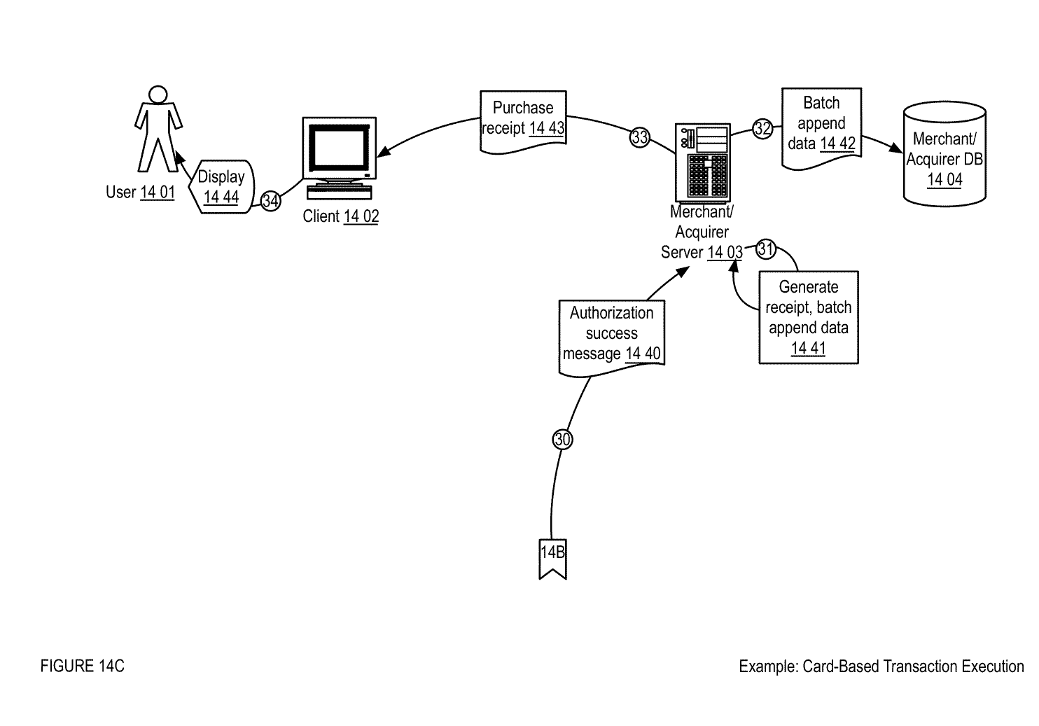

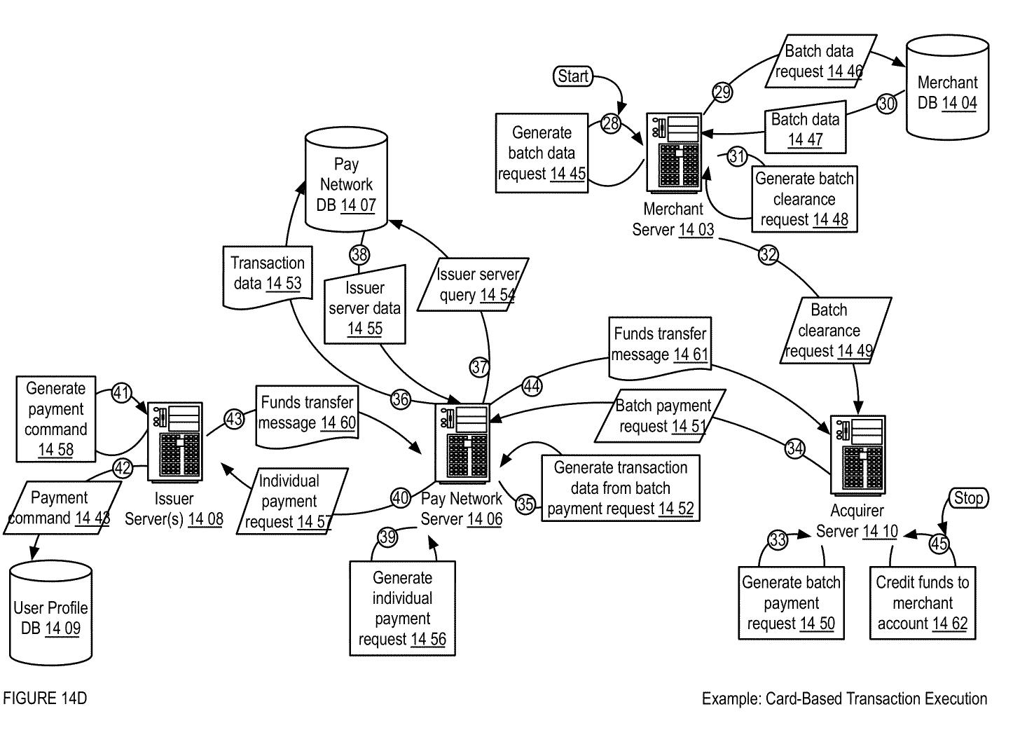

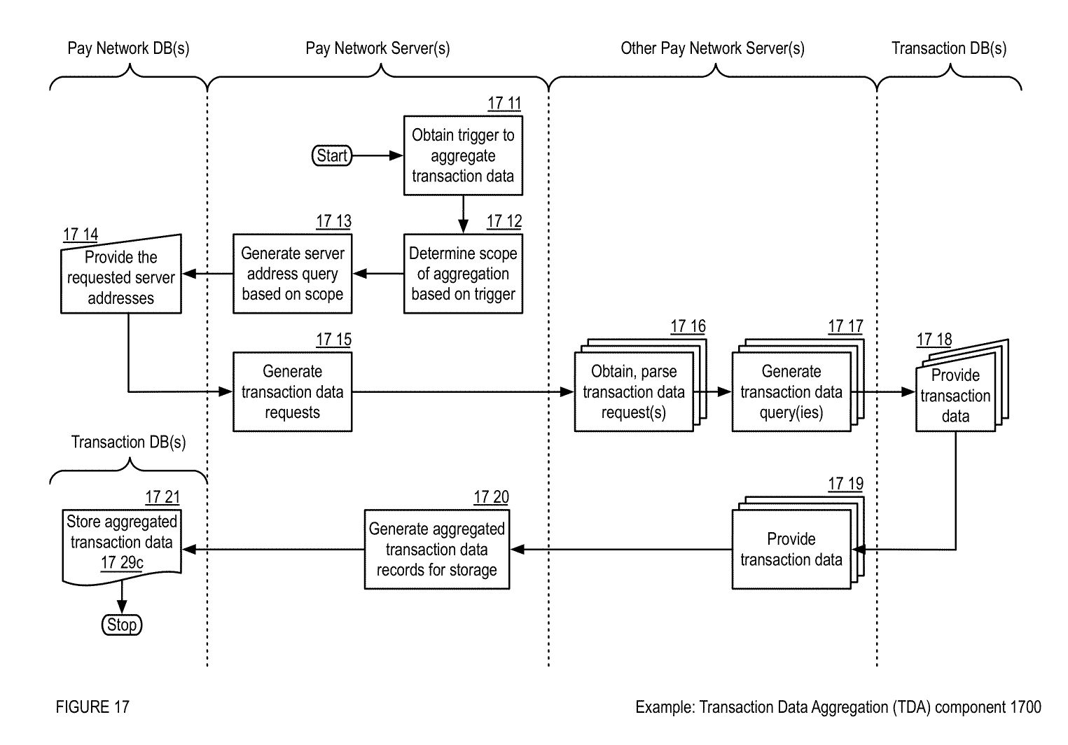

FIG. 11 shows a block diagram illustrating example Ad-Track component configurations in some embodiments of the Ad-Track. In some embodiments, the Ad-Track may aggregate data from a variety of sources to generate centralized personal information. The may also aggregate various types of data in order to generate the centralized personal information. For example, the Ad-Track may utilize search results aggregation component(s) 1101 (e.g., such as described in FIGS. 12-13) to aggregate search results from across a wide range of computer networked systems, e.g., the Internet. As another example, the Ad-Track may utilize transaction data aggregation component(s) 1102 (e.g., such as described in FIGS. 14-17) to aggregate transaction data, e.g., from transaction processing procedure by a payment network. As another example, the Ad-Track may utilize service usage data aggregation component(s) 1103 (e.g., such as described in FIGS. 14-17) to aggregate data on user's usage of various services associated with the Ad-Track. As another example, the Ad-Track may utilize enrollment data component(s) 1104 (e.g., such as described in FIGS. 14-17) to aggregate data on user's enrollment into various services associated with the Ad-Track. As another example, the Ad-Track may utilize social data aggregation component(s) 1103 (e.g., such as described in FIGS. 17-19) to aggregate data on user's usage of various social networking services accessible by the Ad-Track.

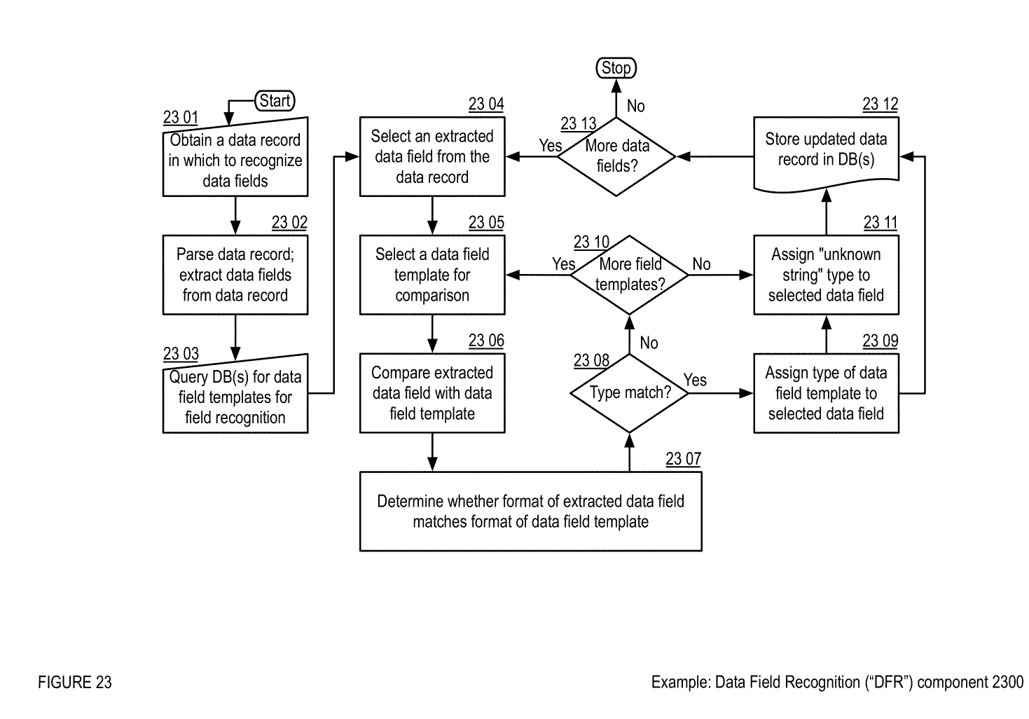

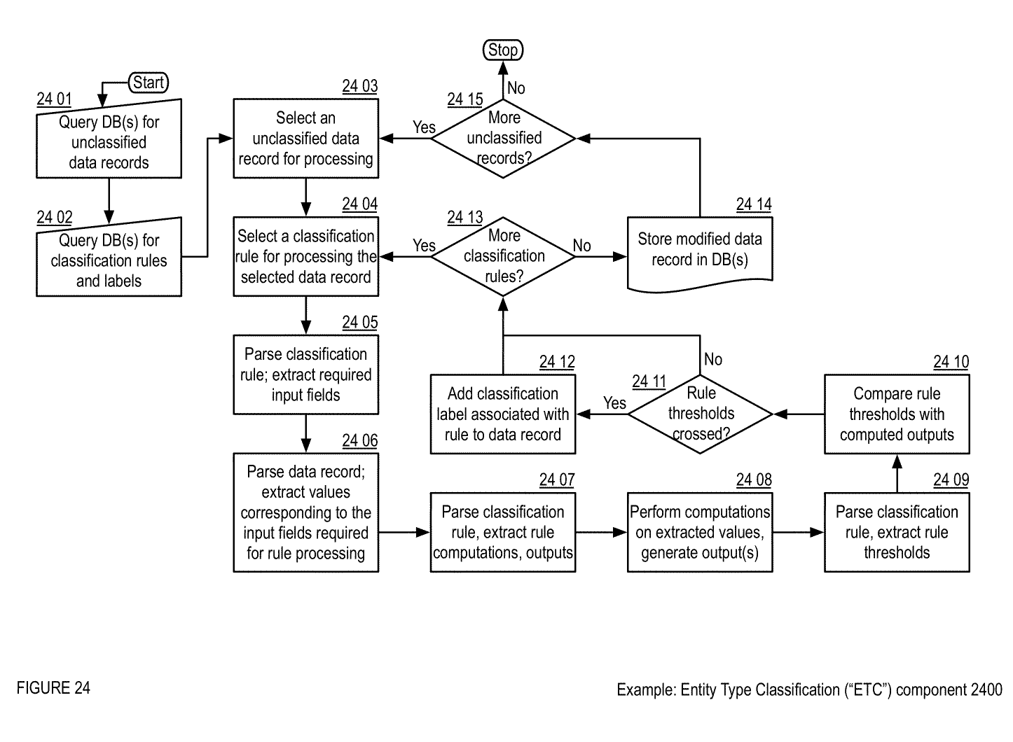

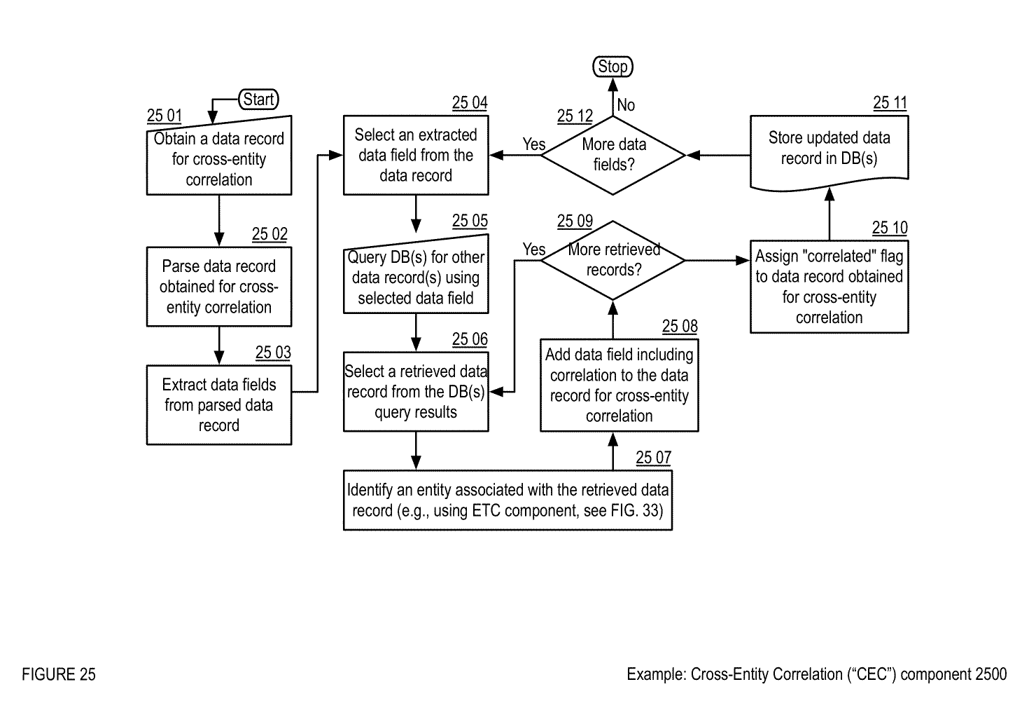

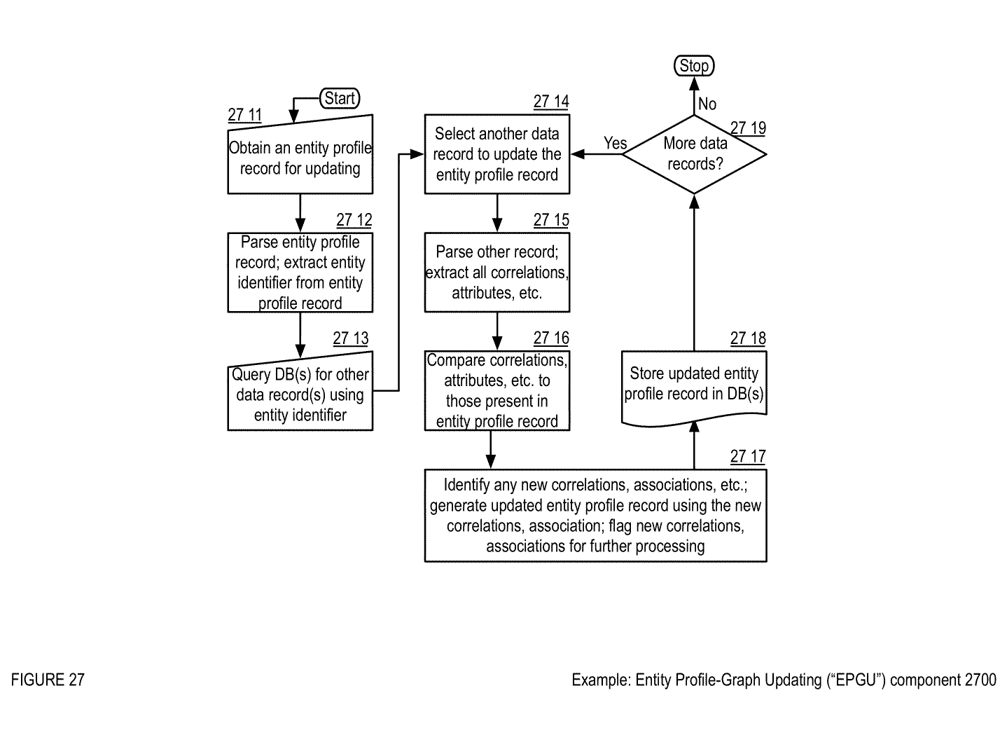

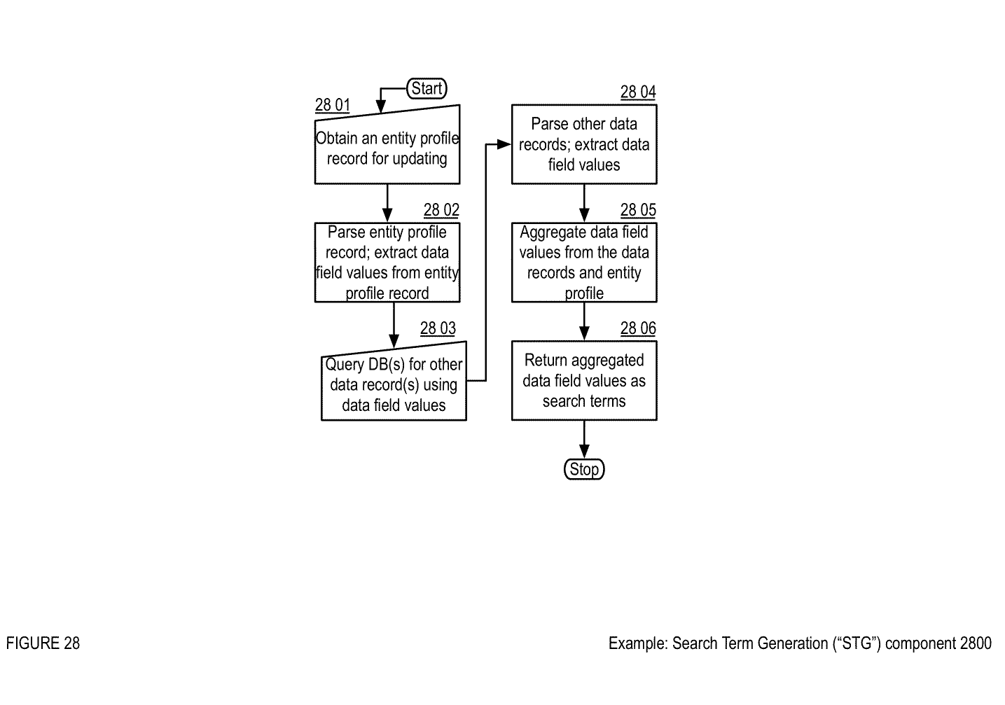

In some embodiments, the Ad-Track may acquire the aggregated data, and normalize the data into formats that are suitable for uniform storage, indexing, maintenance, and/or further processing via data record normalization component(s) 1106 (e.g., such as described in FIG. 22). The Ad-Track may extract data from the normalized data records, and recognize data fields, e.g., the Ad-Track may identify the attributes of each field of data included in the normalized data records via data field recognition component(s) 1107 (e.g., such as described in FIG. 23). For example, the Ad-Track may identify names, user ID(s), addresses, network addresses, comments and/or specific words within the comments, images, blog posts, video, content within the video, and/or the like from the aggregated data. In some embodiments, for each field of data, the Ad-Track may classify entity types associated with the field of data, as well as entity identifiers associated with the field of data, e.g., via component(s) 1108 (e.g., such as described in FIG. 24). For example, the Ad-Trackmay identify an Internet Protocol (IP) address data field to be associated with a user ID john.q.public (consumer entity type), a user John Q. Public (consumer entity type), a household (the Public household—a multi-consumer entity type/household entity type), a merchant entity type with identifier Acme Merchant Store, Inc. from which purchases are made from the IP address, an Issuer Bank type with identifier First National Bank associated with the purchases made from the IP address, and/or the like. In some embodiments, the Ad-Track may utilize the entity types and entity identifiers to correlate entities across each other, e.g., via cross-entity correlation component(s) 1109 (e.g., such as described in FIG. 25). For example, the Ad-Track may identify, from the aggregated data, that a household entity with identifier H123 may include a user entity with identifier John Q. Public and social identifier john.q.public@facebook.com, a second user entity with identifier Jane P. Doe with social identifier jpdoe@twitter.com, a computer entity with identifier IP address 192.168.4.5, a card account entity with identifier ****1234, a bank issuer entity with identifier AB23145, a merchant entity with identifier Acme Stores, Inc. where the household sub-entities make purchases, and/or the like. In some embodiments, the Ad-Track may utilize the entity identifiers, data associated with each entity and/or correlated entities to identify associations to other entities, e.g., via entity attribute association component(s) 1110 (e.g., such as described in FIG. 35). For example, the Ad-Track may identify specific purchases made via purchase transactions by members of the household, and thereby identify attributes of members of the household on the basis of the purchases in the purchase transactions made by members of the household. Based on such correlations and associations, the Ad-Track may update a profile for each entity identified from the aggregated data, as well as a social graph interrelating the entities identified in the aggregated data, e.g., via entity profile-graph updating component(s) 1111 (e.g., such as described in FIG. 27). In some embodiments, the updating of profile and/or social graphs for an entity may trigger a search for additional data that may be relevant to the newly identified correlations and associations for each entity, e.g., via search term generation component(s) 1113-2014 (e.g., such as described in FIG. 28). For example, the updating of a profile and/or social graph may trigger searches across the Internet, social networking websites, transaction data from payment networks, services enrolled into and/or utilized by the entities, and/or the like. In some embodiments, such updating of entity profiles and/or social graphs may be performed continuously, periodically, on-demand, and/or the like.

FIG. 12 shows a data flow diagram illustrating an example search result aggregation procedure in some embodiments of the Ad-Track. In some implementations, the pay network server may obtain a trigger to perform a search. For example, the pay network server may periodically perform a search update of its aggregated search database, e.g., 1210, with new information available from a variety of sources, such as the Internet. As another example, a request for on-demand search update may be obtained as a result of a user wishing to enroll in a service, for which the pay network server may facilitate data entry by providing an automated web form filling system using information about the user obtained from the search update. In some implementations, the pay network server may parse the trigger to extract keywords using which to perform an aggregated search. The pay network server may generate a query for application programming interface (API) templates for various search engines (e.g., Google™, Bing®, AskJeeves, market data search engines, etc.) from which to collect data for aggregation. The pay network server may query, e.g., 1212, a pay network database, e.g., 1207, for search API templates for the search engines. For example, the pay network server may utilize PHP/SQL commands similar to the examples provided above. The database may provide, e.g., 1213, a list of API templates in response. Based on the list of API templates, the pay network server may generate search requests, e.g., 1214. The pay network server may issue the generated search requests, e.g., 1215a-c, to the search engine servers, e.g., 1201a-c. For example, the pay network server may issue PHP commands to request the search engine for search results. An example listing of commands to issue search requests 1215a-c, substantially in the form of PHP commands, is provided below:

<?PHP
// API URL with access key
$url = [″https://ajax.googleapis.com/ajax/services/search/web?v=1.0&″

. ″q=” $keywords
“&key=1234567890987654&userip=datagraph.cpip.com″];

// Send Search Request
$ch = curl_init( );
curl_setopt($ch, CURLOPT_URL, $url);
curl_setopt($ch, CURLOPT_RETURNTRANSFER, 1);
curl_setopt($ch, CURLOPT_REFERER, “datagraph.cpip.com”);
$body = curl_exec($ch);
curl_close($ch);
// Obtain, parse search results
$json = json_decode($body);
?>

In some embodiments, the search engine servers may query, e.g., 1217a-c, their search databases, e.g., 1202a-c, for search results falling within the scope of the search keywords. In response to the search queries, the search databases may provide search results, e.g., 1218a-c, to the search engine servers. The search engine servers may return the search results obtained from the search databases, e.g., 1219a-c, to the pay network server making the search requests. An example listing of search results 1219a-c, substantially in the form of JavaScript Object Notation (JSON)-formatted data, is provided below:

{“responseData”: {

“results”: [

{

“GsearchResultClass”: “GwebSearch”,
“unescapedUrl”: “http://en.wikipedia.org/wiki/John_Q_Public”,
“url”: “http://en.wikipedia.org/wiki/John_Q_Public”,
“visibleUrl”: “en.wikipedia.org”,
“cacheUrl”:
“http://www.google.com/search?q\u003dcache:TwrPfhd22hYJ:en.wikipedia.org”,
“title”: “\u003cb\u003eJohn Q. Public\u003c/b\u003e - Wikipedia, the free
encyclopedia”,
“titleNoFormatting”: “John Q. Public - Wikipedia, the free encyclopedia”,
“content”: “\[1\] In 2006, he served as Chief Technology Officer...”

},
{

“GsearchResultClass”: “GwebSearch”,
“unescapedUrl”: “http://www.imdb.com/name/nm0385296/”,
“url”: “http://www.imdb.com/name/nm0385296/”,
“visibleUrl”: “www.imdb.com”,
“cacheUrl”:
“http://www.google.com/search?q\u003dcache:1i34KkqnsooJ:www.imdb.com”,
“title”: “\u003cb\u003eJohn Q. Public\u003c/b\u003e”,
“titleNoFormatting”: “John Q. Public”,
“content”: “Self: Zoolander. Socialite \u003cb\u003eJohn Q.
Public\u003c/b\u003e...”

},
...

],
“cursor”: {

“pages”: [

{ “start”: “0”, “label”: 1 },
{ “start”: “4”, “label”: 2 },
{ “start”: “8”, “label”: 3 },
{ “start”: “12”,“label”: 4 }

],
“estimatedResultCount”: “59600000”,
“currentPageIndex”: 0,
“moreResultsUrl”:

“http://www.google.com/search?oe\u003dutf8\u0026ie\u003dutf8...”

}

}
, “responseDetails”: null, “responseStatus”: 200}

In some embodiments, the pay network server may store the aggregated search results, e.g., 1220, in an aggregated search database, e.g., 1210.

FIG. 13 shows a logic flow diagram illustrating example aspects of aggregating search results in some embodiments of the Ad-Track, e.g., a Search Results Aggregation (“SRA”) component 1300. In some implementations, the pay network server may obtain a trigger to perform a search, e.g., 1301. For example, the pay network server may periodically perform a search update of its aggregated search database with new information available from a variety of sources, such as the Internet. As another example, a request for on-demand search update may be obtained as a result of a user wishing to enroll in a service, for which the pay network server may facilitate data entry by providing an automated web form filling system using information about the user obtained from the search update. In some implementations, the pay network server may parse the trigger, e.g., 1302, to extract keywords using which to perform an aggregated search. The pay network server may determine the search engines to search, e.g., 1303, using the extracted keywords. Then, the pay network server may generate a query for application programming interface (API) templates for the various search engines (e.g., Google™, Bing®, AskJeeves, market data search engines, etc.) from which to collect data for aggregation, e.g., 1304. The pay network server may query, e.g., 1305, a pay network database for search API templates for the search engines. For example, the pay network server may utilize PHP/SQL commands similar to the examples provided above. The database may provide, e.g., 1305, a list of API templates in response. Based on the list of API templates, the pay network server may generate search requests, e.g., 1306. The pay network server may issue the generated search requests to the search engine servers. The search engine servers may parse the obtained search results(s), e.g., 1307, and query, e.g., 1308, their search databases for search results falling within the scope of the search keywords. In response to the search queries, the search databases may provide search results, e.g., 1309, to the search engine servers. The search engine servers may return the search results obtained from the search databases, e.g., 1310, to the pay network server making the search requests. The pay network server may generate, e.g., 1311, and store the aggregated search results, e.g., 1312, in an aggregated search database.

FIGS. 14A-D show data flow diagrams illustrating an example card-based transaction execution procedure in some embodiments of the Ad-Track. In some implementations, a user, e.g., 1401, may desire to purchase a product, service, offering, and/or the like (“product”), from a merchant. The user may communicate with a merchant server, e.g., 1403, via a client such as, but not limited to: a personal computer, mobile device, television, point-of-sale terminal, kiosk, ATM, and/or the like (e.g., 1402). For example, the user may provide user input, e.g., purchase input 1411, into the client indicating the user's desire to purchase the product. In various implementations, the user input may include, but not be limited to: keyboard entry, card swipe, activating a RFID/NFC enabled hardware device (e.g., electronic card having multiple accounts, smartphone, tablet, etc.), mouse clicks, depressing buttons on a joystick/game console, voice commands, single/multi-touch gestures on a touch-sensitive interface, touching user interface elements on a touch-sensitive display, and/or the like. For example, the user may direct a browser application executing on the client device to a website of the merchant, and may select a product from the website via clicking on a hyperlink presented to the user via the website. As another example, the client may obtain track 1 data from the user's card (e.g., credit card, debit card, prepaid card, charge card, etc.), such as the example track 1 data provided below:

%B123456789012345\hat{ }PUBLIC/J.Q.\hat{ }99011200000000000000**901******?*
(wherein ‘123456789012345’ is the card number of ‘J.Q. Public’ and has a CVV

number of 901. ‘990112’ is a service code, and *** represents decimal digits
which change randomly each time the card is used.)

In some implementations, the client may generate a purchase order message, e.g., 1412, and provide, e.g., 1413, the generated purchase order message to the merchant server. For example, a browser application executing on the client may provide, on behalf of the user, a (Secure) Hypertext Transfer Protocol (“HTTP(S)”) GET message including the product order details for the merchant server in the form of data formatted according to the eXtensible Markup Language (“XML”). Below is an example HTTP(S) GET message including an XML-formatted purchase order message for the merchant server:

GET /purchase.php HTTP/1.1
Host: www.merchant.com
Content-Type: Application/XML
Content-Length: 1306
<?XML version = “1.0” encoding = “UTF-8”?>
<purchase_order>

<order_ID>4NFU4RG94</order_ID>
<timestamp>2011-02-22 15:22:43</timestamp>
<user_ID>john.q.public@gmail.com</user_ID>
<client_details>

<client_IP>192.168.23.126</client_IP>
<client_type>smartphone</client_type>
<client_model>HTC Hero</client_model>
<OS>Android 2.2</OS>
<app_installed_flag>true</app_installed_flag>

</client_details>
<purchase_details>

<num_products>1</num_products>
<product>

<product_type>book</product_type>
<product_params>

<product_title>XML for dummies</product_title>
<ISBN>938-2-14-168710-0</ISBN>
<edition>2nd ed.</edition>
<cover>hardbound</cover>
<seller>bestbuybooks</seller>

</product_params>
<quantity>1</quantity>

</product>

</purchase_details>
<account_params>

<account_name>John Q. Public</account_name>
<account_type>credit</account_type>
<account_num>123456789012345</account_num>
<billing_address>123 Green St., Norman, OK
98765</billing_address>
<phone>123-456-7809</phone>
<sign>/jqp/</sign>
<confirm_type>email</confirm_type>
<contact_info>john.q.public@gmail.com</contact_info>

</account_params>
<shipping_info>

<shipping_adress>same as billing</shipping_address>
<ship_type>expedited</ship_type>
<ship_carrier>FedEx</ship_carrier>
<ship_account>123-45-678</ship_account>
<tracking_flag>true</tracking_flag>
<sign_flag>false</sign_flag>

</shipping_info>

</purchase_order>

In some implementations, the merchant server may obtain the purchase order message from the client, and may parse the purchase order message to extract details of the purchase order from the user. The merchant server may generate a card query request, e.g., 1414 to determine whether the transaction can be processed. For example, the merchant server may attempt to determine whether the user has sufficient funds to pay for the purchase in a card account provided with the purchase order. The merchant server may provide the generated card query request, e.g., 1415, to an acquirer server, e.g., 1404. For example, the acquirer server may be a server of an acquirer financial institution (“acquirer”) maintaining an account of the merchant. For example, the proceeds of transactions processed by the merchant may be deposited into an account maintained by the acquirer. In some implementations, the card query request may include details such as, but not limited to: the costs to the user involved in the transaction, card account details of the user, user billing and/or shipping information, and/or the like. For example, the merchant server may provide a HTTP(S) POST message including an XML-formatted card query request similar to the example listing provided below:

POST /cardquery.php HTTP/1.1
Host: www.acquirer.com
Content-Type: Application/XML
Content-Length: 624
<?XML version = “1.0” encoding = “UTF-8”?>
<card_query_request>

<query_ID>VNEI39FK</query_ID>
<timestamp>2011-02-22 15:22:44</timestamp>
<purchase_summary>

<num_products>1</num_products>
<product>

<product_summary>Book - XML for dummies</product_summary>
<product_quantity>1</product_quantity?

</product>

</purchase_summary>
<transaction_cost>$34.78</transaction_cost>
<account_params>

<account_name>John Q. Public</account_name>
<account_type>credit</account_type>
<account_num>123456789012345</account_num>
<billing_address>123 Green St., Norman, OK 98765</billing_address>
<phone>123-456-7809</phone>
<sign>/jqp/</sign>

</account_params>
<merchant_params>

<merchant_id>3FBCR4INC</merchant_id>
<merchant_name>Books & Things, Inc.</merchant_name>
<merchant_auth_key>1NNF484MCP59CHB27365</merchant_auth_key>

</merchant_params>

</card_query_request>

In some implementations, the acquirer server may generate a card authorization request, e.g., 1416, using the obtained card query request, and provide the card authorization request, e.g., 1417, to a pay network server, e.g., 1405. For example, the acquirer server may redirect the HTTP(S) POST message in the example above from the merchant server to the pay network server.

In some implementations, the pay network server may determine whether the user has enrolled in value-added user services. For example, the pay network server may query 1418 a database, e.g., pay network database 1407, for user service enrollment data. For example, the server may utilize PHP/SQL commands similar to the example provided above to query the pay network database. In some implementations, the database may provide the user service enrollment data, e.g., 1419. The user enrollment data may include a flag indicating whether the user is enrolled or not, as well as instructions, data, login URL, login API call template and/or the like for facilitating access of the user-enrolled services. For example, in some implementations, the pay network server may redirect the client to a value-add server (e.g., such as a social network server where the value-add service is related to social networking) by providing a HTTP(S) REDIRECT 300 message, similar to the example below:

HTTP/1.1 300 Multiple Choices
Location:

https://www.facebook.com/dialog/oauth?client_id=snpa_app_ID&redirect_uri=
www.paynetwork.com/purchase.php

<html>

<head><title>300 Multiple Choices</title></head>
<body><h1>Multiple Choices</h1></body>

</html>

In some implementations, the pay network server may provide payment information extracted from the card authorization request to the value-add server as part of a value add service request, e.g., 1420. For example, the pay network server may provide a HTTP(S) POST message to the value-add server, similar to the example below:

POST /valueservices.php HTTP/1.1
Host: www.valueadd.com
Content-Type: Application/XML
Content-Length: 1306
<?XML version = “1.0” encoding = “UTF-8”?>
<service_request>

<request_ID>4NFU4RG94</order_ID>
<timestamp>2011-02-22 15:22:43</timestamp>
<user_ID>john.q.public@gmail.com</user_ID>
<client_details>

<client_IP>192.168.23.126</client_IP>
<client_type>smartphone</client_type>
<client_model>HTC Hero</client_model>
<OS>Android 2.2</OS>
<app_installed_flag>true</app_installed_flag>

</client_details>
<account_params>

<account_name>John Q. Public</account_name>
<account_type>credit</account_type>
<account_num>123456789012345</account_num>
<billing_address>123 Green St., Norman, OK
98765</billing_address>
<phone>123-456-7809</phone>
<sign>/jqp/</sign>
<confirm_type>email</confirm_type>
<contact_info>john.q.public@gmail.com</contact_info>

</account_params>
<!--optional-->
<merchant>

<merchant_id>CQN3Y42N</merchant_id>
<merchant_name>Acme Tech, Inc.</merchant_name>
<user_name>john.q.public</user_name>
<cardlist>
www.acme.com/user/john.q.public/cclist.xml<cardlist>
<user_account_preference>1 3 2 4 7 6
5<user_account_preference>

</merchant>

</service_request>

In some implementations, the value-add server may provide a service input request, e.g., 1421, to the client. For example, the value-add server may provide a HTML input/login form to the client. The client may display, e.g., 1422, the login form for the user. In some implementations, the user may provide login input into the client, e.g., 1423, and the client may generate a service input response, e.g., 1424, for the value-add server. In some implementations, the value-add server may provide value-add services according to user value-add service enrollment data, user profile, etc., stored on the value-add server, and based on the user service input. Based on the provision of value-add services, the value-add server may generate a value-add service response, e.g., 1426, and provide the response to the pay network server. For example, the value-add server may provide a HTTP(S) POST message similar to the example below:

POST /serviceresponse.php HTTP/1.1
Host: www.paynet.com
Content-Type: Application/XML
Content-Length: 1306
<?XML version = “1.0” encoding = “UTF-8”?>
<service_response>

<request_ID>4NFU4RG94</order_ID>
<timestamp>2011-02-22 15:22:43</timestamp>
<result>serviced</result>
<servcode>943528976302-45569-003829-04</servcode>

</service_response>

In some implementations, upon receiving the value-add service response from the value-add server, the pay network server may extract the enrollment service data from the response for addition to a transaction data record. In some implementations, the pay network server may forward the card authorization request to an appropriate pay network server, e.g., 1428, which may parse the card authorization request to extract details of the request. Using the extracted fields and field values, the pay network server may generate a query, e.g., 1429, for an issuer server corresponding to the user's card account. For example, the user's card account, the details of which the user may have provided via the client-generated purchase order message, may be linked to an issuer financial institution (“issuer”), such as a banking institution, which issued the card account for the user. An issuer server, e.g., 1408a-n, of the issuer may maintain details of the user's card account. In some implementations, a database, e.g., pay network database 1407, may store details of the issuer servers and card account numbers associated with the issuer servers. For example, the database may be a relational database responsive to Structured Query Language (“SQL”) commands. The pay network server may execute a hypertext preprocessor (“PHP”) script including SQL commands to query the database for details of the issuer server. An example PHP/SQL command listing, illustrating substantive aspects of querying the database, is provided below:

<?PHP
header(′Content-Type: text/plain′);
mysql_connect(“254.93.179.112”,$DBserver,$password); // access
database server
mysql_select_db(“ISSUERS.SQL”); // select database table to search
//create query for issuer server data
$query = “SELECT issuer_name issuer_address issuer_id ip_address
mac_address

auth_key port_num security_settings_list FROM IssuerTable
WHERE account_num LIKE ′%′ $accountnum”;

$result = mysql_query($query); // perform the search query
mysql_close(“ISSUERS.SQL”); // close database access
?>

In response to obtaining the issuer server query, e.g., 1429, the pay network database may provide, e.g., 1430, the requested issuer server data to the pay network server. In some implementations, the pay network server may utilize the issuer server data to generate a forwarding card authorization request, e.g., 1431, to redirect the card authorization request from the acquirer server to the issuer server. The pay network server may provide the card authorization request, e.g., 1432a-n, to the issuer server. In some implementations, the issuer server, e.g., 1408a-n, may parse the card authorization request, and based on the request details may query 1433a-n database, e.g., user profile database 1409a-n, for data of the user's card account. For example, the issuer server may issue PHP/SQL commands similar to the example provided below:

<?PHP
header(′Content-Type: text/plain′);
mysql_connect(“254.93.179.112”,$DBserver,$password); // access
database server
mysql_select_db(“USERS.SQL”); // select database table to search
//create query for user data
$query = “SELECT user_id user_name user_balance account_type

FROM UserTable WHERE account_num LIKE ′%′ $accountnum”;

$result = mysql_query($query); // perform the search query
mysql_close(“USERS.SQL“); // close database access
?>

In some implementations, on obtaining the user data, e.g., 1434a-n, the issuer server may determine whether the user can pay for the transaction using funds available in the account, e.g., 1435a-n. For example, the issuer server may determine whether the user has a sufficient balance remaining in the account, sufficient credit associated with the account, and/or the like. If the issuer server determines that the user can pay for the transaction using the funds available in the account, the server may provide an authorization message, e.g., 1436a-n, to the pay network server. For example, the server may provide a HTTP(S) POST message similar to the examples above.

In some implementations, the pay network server may obtain the authorization message, and parse the message to extract authorization details. Upon determining that the user possesses sufficient funds for the transaction, the pay network server may generate a transaction data record from the card authorization request it received, and store, e.g., 1439, the details of the transaction and authorization relating to the transaction in a database, e.g., pay network database 1407. For example, the pay network server may issue PHP/SQL commands similar to the example listing below to store the transaction data in a database:

<?PHP
header(′Content-Type: text/plain′);
mysql_connect(″254.92.185.103”,$DBserver,$password); // access
database server
mysql_select(″TRANSACTIONS.SQL″); // select database to append
mysql_query(“INSERT INTO PurchasesTable (timestamp,

purchase_summary_list, num_products, product_summary,
product_quantity, transaction_cost, account_params_list,
account_name, account_type, account_num, billing_addres,
zipcode, phone, sign, merchant_params_list, merchant_id,
merchant_name, merchant_auth_key)

VALUES (time( ), $purchase_summary_list, $num_products,

$product_summary, $product_quantity, $transaction_cost,
$account_params_list, $account_name, $account_type,
$account_num, $billing_addres, $zipcode, $phone, $sign,
$merchant_params_list, $merchant_id, $merchant_name,
$merchant_auth_key)”);
// add data to table in database

mysql_close(″TRANSACTIONS.SQL″); // close connection to database
?>

In some implementations, the pay network server may forward the authorization message, e.g., 1440, to the acquirer server, which may in turn forward the authorization message, e.g., 1440, to the merchant server. The merchant may obtain the authorization message, and determine from it that the user possesses sufficient funds in the card account to conduct the transaction. The merchant server may add a record of the transaction for the user to a batch of transaction data relating to authorized transactions. For example, the merchant may append the XML data pertaining to the user transaction to an XML data file comprising XML data for transactions that have been authorized for various users, e.g., 1441, and store the XML data file, e.g., 1442, in a database, e.g., merchant database 1404. For example, a batch XML data file may be structured similar to the example XML data structure template provided below:

<?XML version = “1.0” encoding = “UTF-8”?>
<merchant_data>

<merchant_id>3FBCR4INC</merchant_id>
<merchant_name>Books & Things, Inc.</merchant_name>
<merchant_auth_key>1NNF484MCP59CHB27365</merchant_auth_key>
<account_number>123456789</account_number>

</merchant_data>
<transaction_data>

<transaction 1>

...

</transaction 1>
<transaction 2>

...

</transaction 2>

.
.
.

<transaction n>

...

</transaction n>

</transaction_data>

In some implementations, the server may also generate a purchase receipt, e.g., 1443, and provide the purchase receipt to the client. The client may render and display, e.g., 1444, the purchase receipt for the user. For example, the client may render a webpage, electronic message, text/SMS message, buffer a voicemail, emit a ring tone, and/or play an audio message, etc., and provide output including, but not limited to: sounds, music, audio, video, images, tactile feedback, vibration alerts (e.g., on vibration-capable client devices such as a smartphone etc.), and/or the like.

With reference to FIGS. 14C-D, in some implementations, the merchant server may initiate clearance of a batch of authorized transactions. For example, the merchant server may generate a batch data request, e.g., 1445, and provide the request, e.g., 1446, to a database, e.g., merchant database 1404. For example, the merchant server may utilize PHP/SQL commands similar to the examples provided above to query a relational database. In response to the batch data request, the database may provide the requested batch data, e.g., 1447. The server may generate a batch clearance request, e.g., 1448, using the batch data obtained from the database, and provide, e.g., 1441, the batch clearance request to an acquirer server, e.g., 1410. For example, the merchant server may provide a HTTP(S) POST message including XML-formatted batch data in the message body for the acquirer server. The acquirer server may generate, e.g., 1450, a batch payment request using the obtained batch clearance request, and provide the batch payment request to the pay network server, e.g., 1451. The pay network server may parse the batch payment request, and extract the transaction data for each transaction stored in the batch payment request, e.g., 1452. The pay network server may store the transaction data, e.g., 1453, for each transaction in a database, e.g., pay network database 1407. For each extracted transaction, the pay network server may query, e.g., 1454-2355, a database, e.g., pay network database 1407, for an address of an issuer server. For example, the pay network server may utilize PHP/SQL commands similar to the examples provided above. The pay network server may generate an individual payment request, e.g., 1456, for each transaction for which it has extracted transaction data, and provide the individual payment request, e.g., 1457, to the issuer server, e.g., 1408. For example, the pay network server may provide a HTTP(S) POST request similar to the example below:

POST /requestpay.php HTTP/1.1
Host: www.issuer.com
Content-Type: Application/XML
Content-Length: 788
<?XML version = “1.0” encoding = “UTF-8”?>
<pay_request>

<request_ID>CNI4ICNW2</request_ID>
<timestamp>2011-02-22 17:00:01</timestamp>
<pay_amount>$34.78</pay_amount>
<account_params>

<account_name>John Q. Public</account_name>
<account_type>credit</account_type>
<account_num>123456789012345</account_num>
<billing_address>123 Green St., Norman, OK 98765</billing_address>
<phone>123-456-7809</phone>
<sign>/jqp/</sign>

</account_params>
<merchant_params>

<merchant_id>3FBCR4INC</merchant_id>
<merchant_name>Books & Things, Inc.</merchant_name>
<merchant_auth_key>1NNF484MCP59CHB27365</merchant_auth_key>

</merchant_params>
<purchase_summary>

<num_products>1</num_products>
<product>

<product_summary>Book - XML for dummies</product_summary>
<product_quantity>1</product_quantity?

</product>

</purchase_summary>

</pay_request>

In some implementations, the issuer server may generate a payment command, e.g., 1458. For example, the issuer server may issue a command to deduct funds from the user's account (or add a charge to the user's credit card account). The issuer server may issue a payment command, e.g., 1459, to a database storing the user's account information, e.g., user profile database 1408. The issuer server may provide a funds transfer message, e.g., 1460, to the pay network server, which may forward, e.g., 1461, the funds transfer message to the acquirer server. An example HTTP(S) POST funds transfer message is provided below:

POST /clearance.php HTTP/1.1
Host: www.acquirer.com
Content-Type: Application/XML
Content-Length: 206
<?XML version = “1.0” encoding = “UTF-8”?>
<deposit_ack>

<request_ID>CNI4ICNW2</request_ID>
<clear_flag>true</clear_flag>
<timestamp>2011-02-22 17:00:02</timestamp>
<deposit_amount>$34.78</deposit_amount>

</deposit_ack>

In some implementations, the acquirer server may parse the funds transfer message, and correlate the transaction (e.g., using the request_ID field in the example above) to the merchant. The acquirer server may then transfer the funds specified in the funds transfer message to an account of the merchant, e.g., 1462.

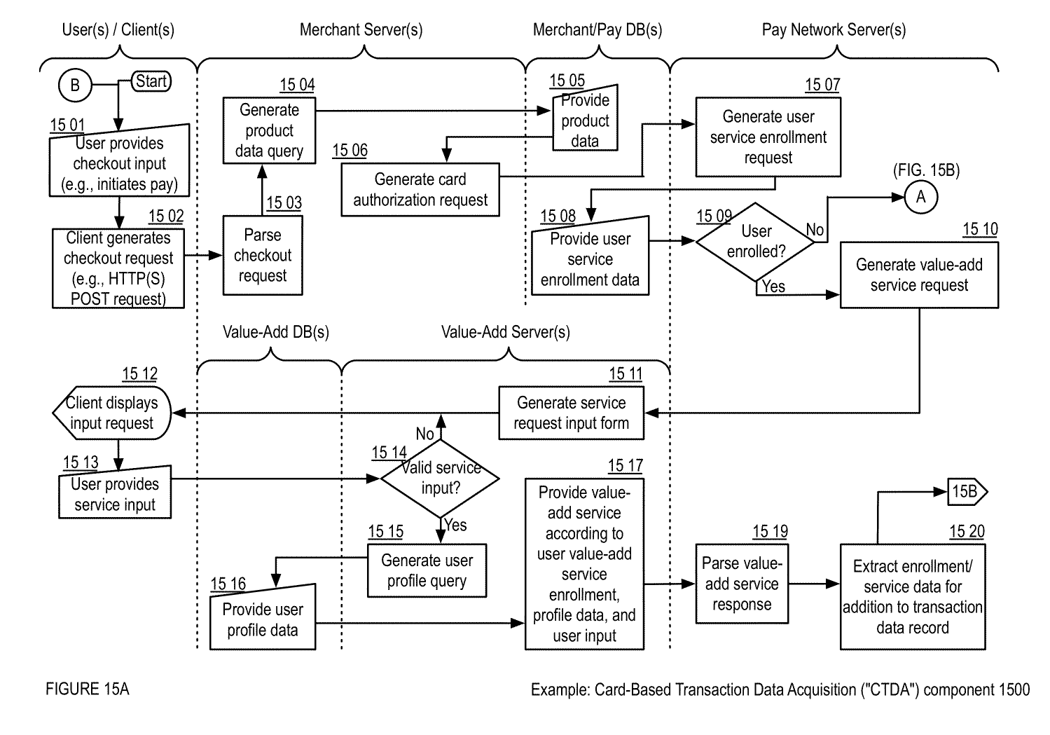

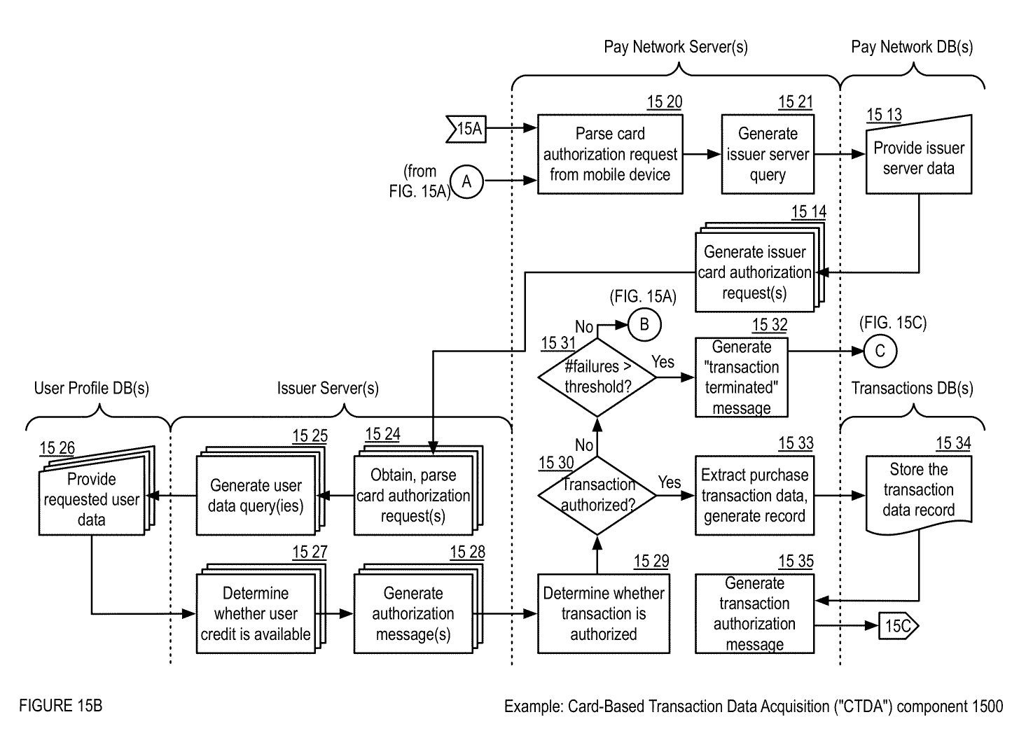

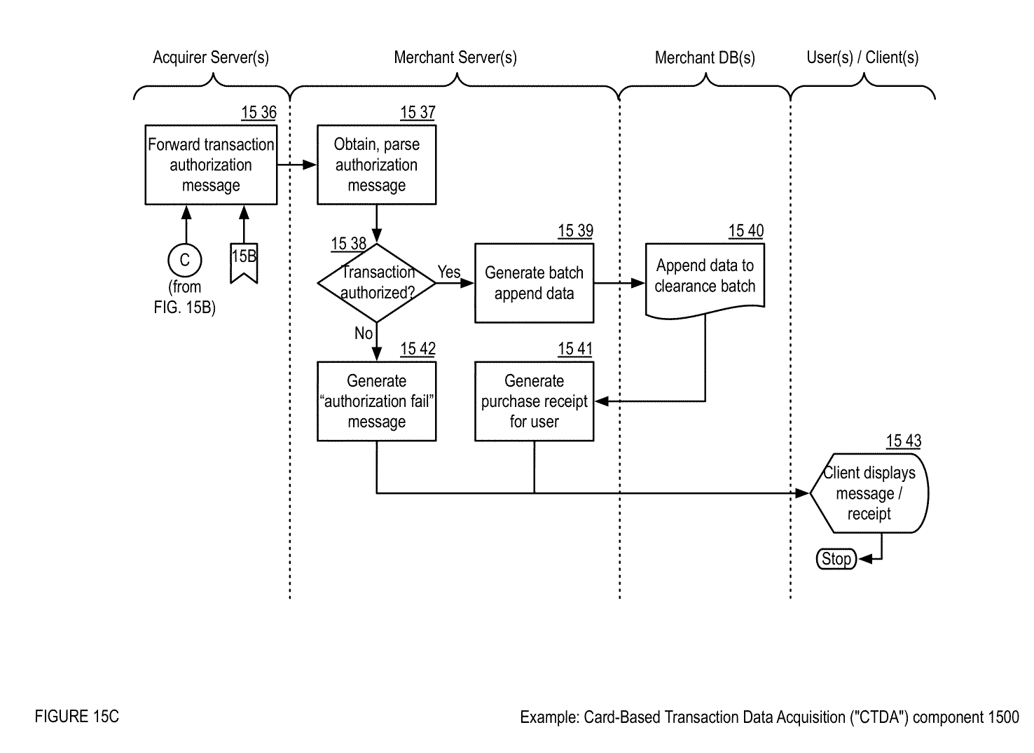

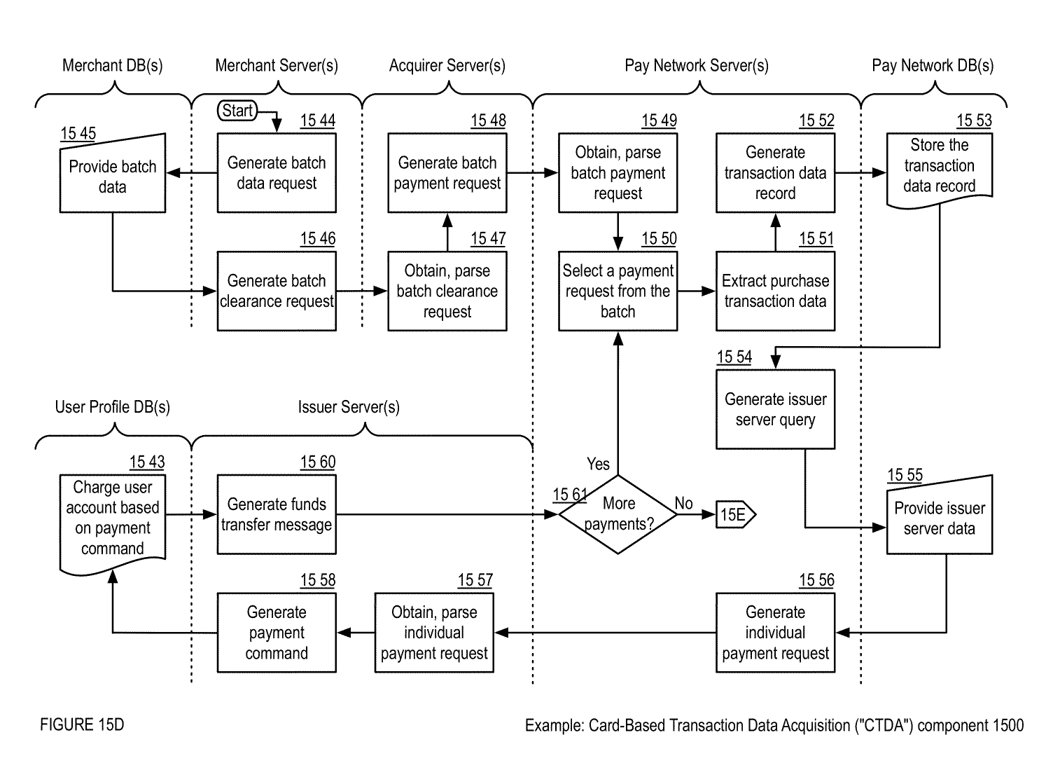

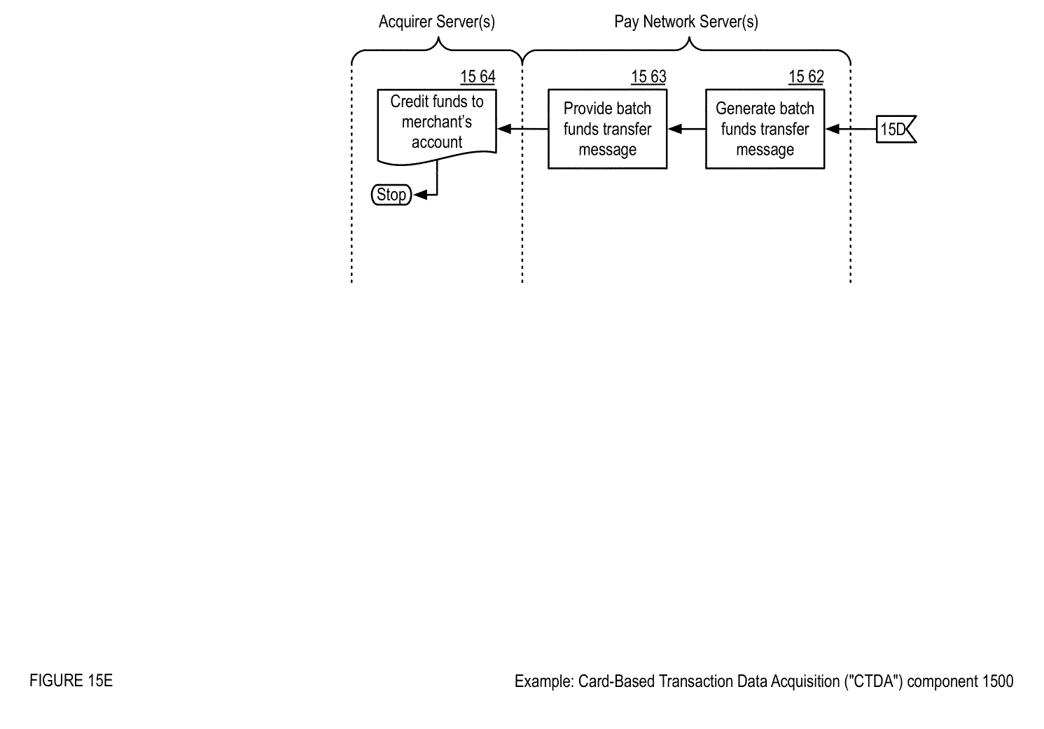

FIGS. 15A-E show logic flow diagrams illustrating example aspects of card-based transaction execution, resulting in generation of card-based transaction data and service usage data, in some embodiments of the Ad-Track, e.g., a Card-Based Transaction Execution (“CTE”) component 1500. In some implementations, a user may provide user input, e.g., 1501, into a client indicating the user's desire to purchase a product from a merchant. The client may generate a purchase order message, e.g., 1502, and provide the generated purchase order message to the merchant server. In some implementations, the merchant server may obtain, e.g., 1503, the purchase order message from the client, and may parse the purchase order message to extract details of the purchase order from the user. Example parsers that the merchant client may utilize are discussed further below with reference to FIG. 61. The merchant may generate a product data query, e.g., 1504, for a merchant database, which may in response provide the requested product data, e.g., 1505. The merchant server may generate a card query request using the product data, e.g., 1504, to determine whether the transaction can be processed. For example, the merchant server may process the transaction only if the user has sufficient funds to pay for the purchase in a card account provided with the purchase order. The merchant server may optionally provide the generated card query request to an acquirer server. The acquirer server may generate a card authorization request using the obtained card query request, and provide the card authorization request to a pay network server.

In some implementations, the pay network server may determine whether the user has enrolled in value-added user services. For example, the pay network server may query a database, e.g., 1507, for user service enrollment data. For example, the server may utilize PHP/SQL commands similar to the example provided above to query the pay network database. In some implementations, the database may provide the user service enrollment data, e.g., 1508. The user enrollment data may include a flag indicating whether the user is enrolled or not, as well as instructions, data, login URL, login API call template and/or the like for facilitating access of the user-enrolled services. For example, in some implementations, the pay network server may redirect the client to a value-add server (e.g., such as a social network server where the value-add service is related to social networking) by providing a HTTP(S) REDIRECT 300 message. In some implementations, the pay network server may provide payment information extracted from the card authorization request to the value-add server as part of a value add service request, e.g., 1510.

In some implementations, the value-add server may provide a service input request, e.g., 1511, to the client. The client may display, e.g., 1512, the input request for the user. In some implementations, the user may provide input into the client, e.g., 1513, and the client may generate a service input response for the value-add server. In some implementations, the value-add server may provide value-add services according to user value-add service enrollment data, user profile, etc., stored on the value-add server, and based on the user service input. Based on the provision of value-add services, the value-add server may generate a value-add service response, e.g., 1517, and provide the response to the pay network server. In some implementations, upon receiving the value-add service response from the value-add server, the pay network server may extract the enrollment service data from the response for addition to a transaction data record, e.g., 1519-1520.

With reference to FIG. 15B, in some implementations, the pay network server may obtain the card authorization request from the acquirer server, and may parse the card authorization request to extract details of the request, e.g., 1520. Using the extracted fields and field values, the pay network server may generate a query, e.g., 1521-2422, for an issuer server corresponding to the user's card account. In response to obtaining the issuer server query the pay network database may provide, e.g., 1522, the requested issuer server data to the pay network server. In some implementations, the pay network server may utilize the issuer server data to generate a forwarding card authorization request, e.g., 1523, to redirect the card authorization request from the acquirer server to the issuer server. The pay network server may provide the card authorization request to the issuer server. In some implementations, the issuer server may parse, e.g., 1524, the card authorization request, and based on the request details may query a database, e.g., 1525, for data of the user's card account. In response, the database may provide the requested user data. On obtaining the user data, the issuer server may determine whether the user can pay for the transaction using funds available in the account, e.g., 1526. For example, the issuer server may determine whether the user has a sufficient balance remaining in the account, sufficient credit associated with the account, and/or the like, but comparing the data from the database with the transaction cost obtained from the card authorization request. If the issuer server determines that the user can pay for the transaction using the funds available in the account, the server may provide an authorization message, e.g., 1527, to the pay network server.

In some implementations, the pay network server may obtain the authorization message, and parse the message to extract authorization details. Upon determining that the user possesses sufficient funds for the transaction (e.g., 1530, option “Yes”), the pay network server may extract the transaction card from the authorization message and/or card authorization request, e.g., 1533, and generate a transaction data record using the card transaction details. The pay network server may provide the transaction data record for storage, e.g., 1534, to a database. In some implementations, the pay network server may forward the authorization message, e.g., 1535, to the acquirer server, which may in turn forward the authorization message, e.g., 1536, to the merchant server. The merchant may obtain the authorization message, and parse the authorization message o extract its contents, e.g., 1537. The merchant server may determine whether the user possesses sufficient funds in the card account to conduct the transaction. If the merchant server determines that the user possess sufficient funds, e.g., 1538, option “Yes,” the merchant server may add the record of the transaction for the user to a batch of transaction data relating to authorized transactions, e.g., 1539-1540. The merchant server may also generate a purchase receipt, e.g., 1541, for the user. If the merchant server determines that the user does not possess sufficient funds, e.g., 1538, option “No,” the merchant server may generate an “authorization fail” message, e.g., 1542. The merchant server may provide the purchase receipt or the “authorization fail” message to the client. The client may render and display, e.g., 1543, the purchase receipt for the user.

In some implementations, the merchant server may initiate clearance of a batch of authorized transactions by generating a batch data request, e.g., 1544, and providing the request to a database. In response to the batch data request, the database may provide the requested batch data, e.g., 1545, to the merchant server. The server may generate a batch clearance request, e.g., 1546, using the batch data obtained from the database, and provide the batch clearance request to an acquirer server. The acquirer server may generate, e.g., 1548, a batch payment request using the obtained batch clearance request, and provide the batch payment request to a pay network server. The pay network server may parse, e.g., 1549, the batch payment request, select a transaction stored within the batch data, e.g., 1550, and extract the transaction data for the transaction stored in the batch payment request, e.g., 1551. The pay network server may generate a transaction data record, e.g., 1552, and store the transaction data, e.g., 1553, the transaction in a database. For the extracted transaction, the pay network server may generate an issuer server query, e.g., 1554, for an address of an issuer server maintaining the account of the user requesting the transaction. The pay network server may provide the query to a database. In response, the database may provide the issuer server data requested by the pay network server, e.g., 1555. The pay network server may generate an individual payment request, e.g., 1556, for the transaction for which it has extracted transaction data, and provide the individual payment request to the issuer server using the issuer server data from the database.

In some implementations, the issuer server may obtain the individual payment request, and parse, e.g., 1557, the individual payment request to extract details of the request. Based on the extracted data, the issuer server may generate a payment command, e.g., 1558. For example, the issuer server may issue a command to deduct funds from the user's account (or add a charge to the user's credit card account). The issuer server may issue a payment command, e.g., 1559, to a database storing the user's account information. In response, the database may update a data record corresponding to the user's account to reflect the debit/charge made to the user's account. The issuer server may provide a funds transfer message, e.g., 1560, to the pay network server after the payment command has been executed by the database.

In some implementations, the pay network server may check whether there are additional transactions in the batch that need to be cleared and funded. If there are additional transactions, e.g., 1561, option “Yes,” the pay network server may process each transaction according to the procedure described above. The pay network server may generate, e.g., 1562, an aggregated funds transfer message reflecting transfer of all transactions in the batch, and provide, e.g., 1563, the funds transfer message to the acquirer server. The acquirer server may, in response, transfer the funds specified in the funds transfer message to an account of the merchant, e.g., 1564.

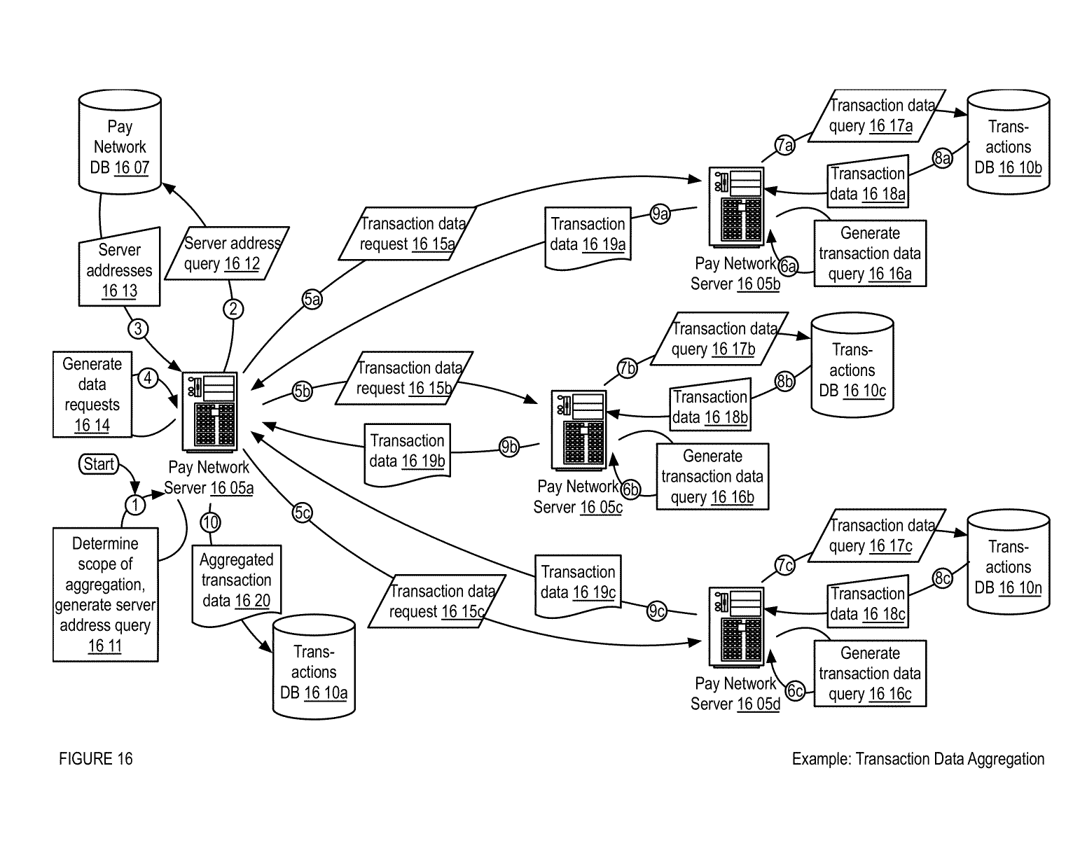

FIG. 16 shows a data flow diagram illustrating an example procedure to aggregate card-based transaction data in some embodiments of the Ad-Track. In some implementations, the pay network server may determine a scope of data aggregation required to perform the analysis, e.g., 1611. The pay network server may initiate data aggregation based on the determined scope. The pay network server may generate a query for addresses of server storing transaction data within the determined scope. The pay network server may query, e.g., 1612, a pay network database, e.g., 1607a, for addresses of pay network servers that may have stored transaction data within the determined scope of the data aggregation. For example, the pay network server may utilize PHP/SQL commands similar to the examples provided above. The database may provide, e.g., 1613, a list of server addresses in response to the pay network server's query. Based on the list of server addresses, the pay network server may generate transaction data requests, e.g., 1614. The pay network server may issue the generated transaction data requests, e.g., 1615a-c, to the other pay network servers, e.g., 1605b-d. The other pay network servers may query, e.g., 1617a-c, their pay network database, e.g., 1607a-d, for transaction data falling within the scope of the transaction data requests. In response to the transaction data queries, the pay network databases may provide transaction data, e.g., 1618a-c, to the other pay network servers. The other pay network servers may return the transaction data obtained from the pay network databases, e.g., 1619a-c, to the pay network server making the transaction data requests, e.g., 1605a. The pay network server, e.g., 1605a, may store the aggregated transaction data, e.g., 1620, in an aggregated transactions database, e.g., 1610a.

FIG. 17 shows a logic flow diagram illustrating example aspects of aggregating card-based transaction data in some embodiments of the Ad-Track, e.g., a Transaction Data Aggregation (“TDA”) component 1700. In some implementations, a pay network server may obtain a trigger to aggregate transaction data, e.g., 1701. For example, the server may be configured to initiate transaction data aggregation on a regular, periodic, basis (e.g., hourly, daily, weekly, monthly, quarterly, semi-annually, annually, etc.). As another example, the server may be configured to initiate transaction data aggregation on obtaining information that the U.S. Government (e.g., Department of Commerce, Office of Management and Budget, etc) has released new statistical data related to the U.S. business economy. As another example, the server may be configured to initiate transaction data aggregation on-demand, upon obtaining a user investment strategy analysis request for processing. The pay network server may determine a scope of data aggregation required to perform the analysis, e.g., 1702. For example, the scope of data aggregation may be pre-determined. As another example, the scope of data aggregation may be determined based on a received user investment strategy analysis request. The pay network server may initiate data aggregation based on the determined scope. The pay network server may generate a query for addresses of server storing transaction data within the determined scope, e.g., 1703. The pay network server may query a database for addresses of pay network servers that may have stored transaction data within the determined scope of the data aggregation. The database may provide, e.g., 1704, a list of server addresses in response to the pay network server's query. Based on the list of server addresses, the pay network server may generate transaction data requests, e.g., 1705. The pay network server may issue the generated transaction data requests to the other pay network servers. The other pay network servers may obtain and parse the transaction data requests, e.g., 1706. Based on parsing the data requests, the other pay network servers may generate transaction data queries, e.g., 1707, and provide the transaction data queries to their pay network databases. In response to the transaction data queries, the pay network databases may provide transaction data, e.g., 1708, to the other pay network servers. The other pay network servers may return, e.g., 1709, the transaction data obtained from the pay network databases to the pay network server making the transaction data requests. The pay network server may generate aggregated transaction data records from the transaction data received from the other pay network servers, e.g., 1710, and store the aggregated transaction data in a database, e.g., 1711.

FIG. 18 shows a data flow diagram illustrating an example social data aggregation procedure in some embodiments of the Ad-Track. In some implementations, the pay network server may obtain a trigger to perform a social data search. For example, the pay network server may periodically perform an update of its aggregated social database, e.g., 1810, with new information available from a variety of sources, such as the social networking services operating on the Internet. As another example, a request for on-demand social data update may be obtained as a result of a user wishing to enroll in a service, for which the pay network server may facilitate data entry by providing an automated web form filling system using information about the user obtained from the social data update. In some implementations, the pay network server may parse the trigger to extract keywords using which to perform an aggregated social data update. The pay network server may generate a query for application programming interface (API) templates for various social networking services (e.g., Facebook®, Twitter', etc.) from which to collect social data for aggregation. The pay network server may query, e.g., 1812, a pay network database, e.g., 1807, for social network API templates for the social networking services. For example, the pay network server may utilize PHP/SQL commands similar to the examples provided above. The database may provide, e.g., 1813, a list of API templates in response. Based on the list of API templates, the pay network server may generate social data requests, e.g., 1814. The pay network server may issue the generated social data requests, e.g., 1815a-c, to the social network servers, e.g., 1801a-c. For example, the pay network server may issue PHP commands to request the social network servers for social data. An example listing of commands to issue social data requests 1815a-c, substantially in the form of PHP commands, is provided below:

<?PHP
header(‘Content-Type: text/plain’);
// Obtain user ID(s) of friends of the logged-in user
$friends =

json_decode(file_get_contents(′https://graph.facebook.com/me/friends?access
token=′$cookie[′oauth_access_token′]), true);

$friend_ids = array_keys($friends);
// Obtain message feed associated with the profile of the logged-in user
$feed =

json_decode(file_get_contents(‘https:llgraph.facebook.com/me/feed?access_tok
en=′$cookie[′oauth_access_token′]), true);

// Obtain messages by the user's friends
$result = mysql_query(′SELECT * FROM content WHERE uid IN (′

.implode($friend_ids, ′,′) . ′)′);

$friend_content = array( );
while ($row = mysql_fetch_assoc($result))
$friend_content [ ] $row;
?>

In some embodiments, the social network servers may query, e.g., 1817a-c, their databases, e.g., 1802a-c, for social data results falling within the scope of the social keywords. In response to the queries, the databases may provide social data, e.g., 1818a-c, to the search engine servers. The social network servers may return the social data obtained from the databases, e.g., 1819a-c, to the pay network server making the social data requests. An example listing of social data 1819a-c, substantially in the form of JavaScript Object Notation (JSON)-formatted data, is provided below:

| | |
|---|---|
| [ “data”: | [ |

| | |
|---|---|
| { | “name”: “Tabatha Orloff”, |
| | “id”: “483722”}, |
| { | “name”: “Darren Kinnaman”, |
| | “id”: “86S743”}, |
| { | “name”: “Sharron Jutras”, |
| | “id”: “O91274”} |

] }

In some embodiments, the pay network server may store the aggregated search results, e.g., 1820, in an aggregated search database, e.g., 1810.

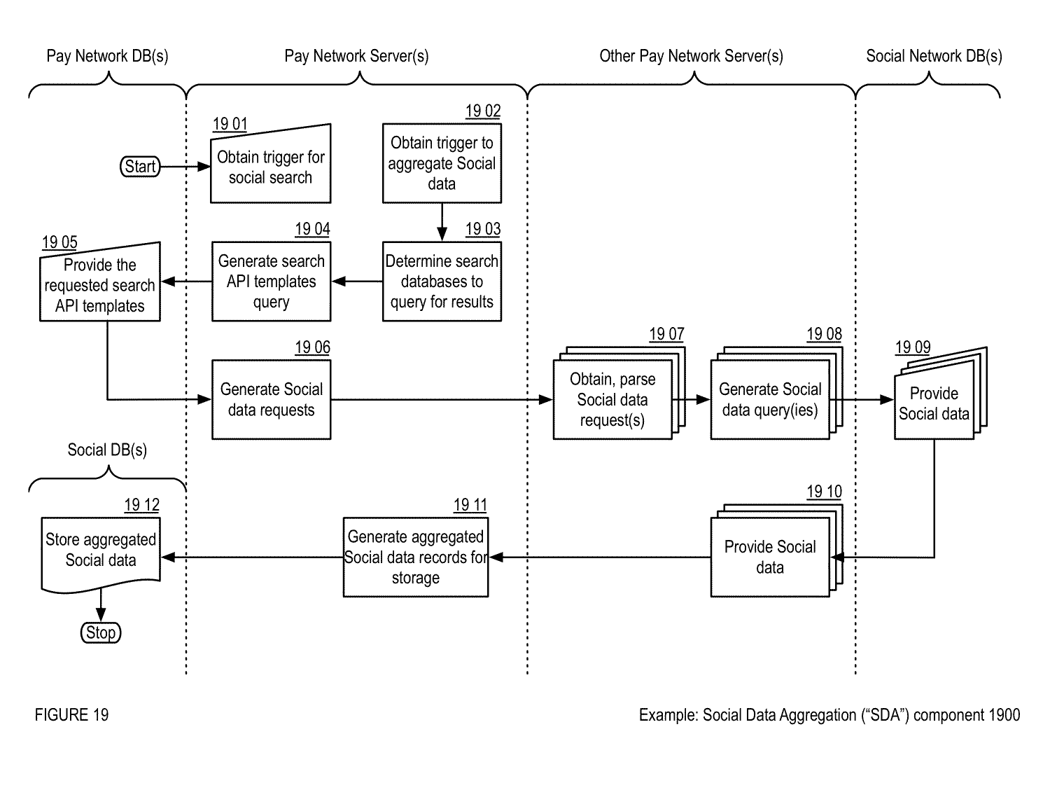

FIG. 19 shows a logic flow diagram illustrating example aspects of aggregating social data in some embodiments of the Ad-Track, e.g., a Social Data Aggregation (“SDA”) component 1900. In some implementations, the pay network server may obtain a trigger to perform a social search, e.g., 1901. For example, the pay network server may periodically perform an update of its aggregated social database with new information available from a variety of sources, such as the Internet. As another example, a request for on-demand social data update may be obtained as a result of a user wishing to enroll in a service, for which the pay network server may facilitate data entry by providing an automated web form filling system using information about the user obtained from the social data update. In some implementations, the pay network server may parse the trigger, e.g., 1902, to extract keywords and/or user ID(s) using which to perform an aggregated search for social data. The pay network server may determine the social networking services to search, e.g., 1903, using the extracted keywords and/or user ID(s). Then, the pay network server may generate a query for application programming interface (API) templates for the various social networking services (e.g., Facebook®, Twitter', etc.) from which to collect social data for aggregation, e.g., 1904. The pay network server may query, e.g., 1905, a pay network database for search API templates for the social networking services. For example, the pay network server may utilize PHP/SQL commands similar to the examples provided above. The database may provide, e.g., 1905, a list of API templates in response. Based on the list of API templates, the pay network server may generate social data requests, e.g., 1906. The pay network server may issue the generated social data requests to the social networking services. The social network servers may parse the obtained search results(s), e.g., 1907, and query, e.g., 1908, their databases for social data falling within the scope of the search keywords. In response to the social data queries, the databases may provide social data, e.g., 1909, to the social networking servers. The social networking servers may return the social data obtained from the databases, e.g., 1910, to the pay network server making the social data requests. The pay network server may generate, e.g., 1911, and store the aggregated social data, e.g., 1912, in an aggregated social database.

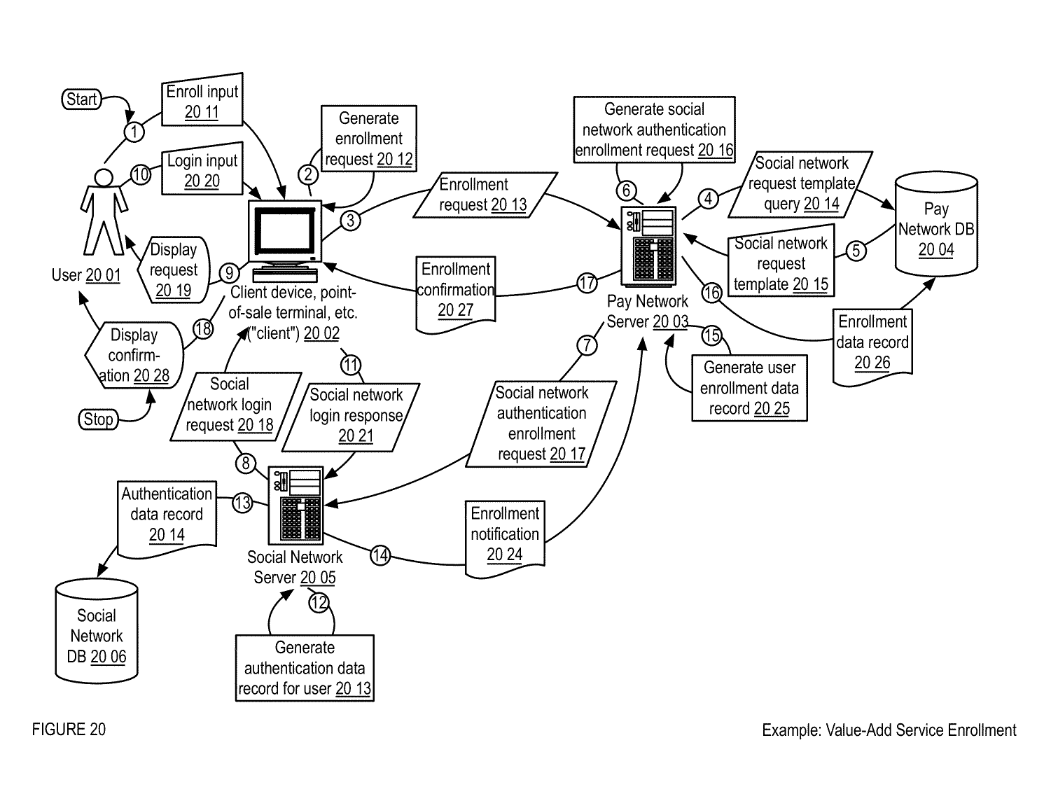

FIG. 20 shows a data flow diagram illustrating an example procedure for enrollment in value-add services in some embodiments of the Ad-Track. In some implementations, a user, e.g., 2001, may desire to enroll in a value-added service. Let us consider an example wherein the user desires to enroll in social network authenticated purchase payment as a value-added service. It is to be understood that any other value-added service may take the place of the below-described value-added service. The user may communicate with a pay network server, e.g., 2003, via a client such as, but not limited to: a personal computer, mobile device, television, point-of-sale terminal, kiosk, ATM, and/or the like (e.g., 2002). For example, the user may provide user input, e.g., enroll input 2011, into the client indicating the user's desire to enroll in social network authenticated purchase payment. In various implementations, the user input may include, but not be limited to: a single tap (e.g., a one-tap mobile app purchasing embodiment) of a touchscreen interface, keyboard entry, card swipe, activating a RFID/NFC enabled hardware device (e.g., electronic card having multiple accounts, smartphone, tablet, etc.) within the user device, mouse clicks, depressing buttons on a joystick/game console, voice commands, single/multi-touch gestures on a touch-sensitive interface, touching user interface elements on a touch-sensitive display, and/or the like. For example, the user may swipe a payment card at the client 2002. In some implementations, the client may obtain track 1 data from the user's card as enroll input 2011 (e.g., credit card, debit card, prepaid card, charge card, etc.), such as the example track 1 data provided below:

%B123456789012345\hat{ }PUBLIC/J.Q.\hat{ }99011200000000000000**901******?*
(wherein ‘123456789012345’ is the card number of ‘J.Q. Public’ and has a CVV

number of 901. ‘990112’ is a service code, and *** represents decimal digits
which change randomly each time the card is used.)

In some implementations, using the user's input, the client may generate an enrollment request, e.g., 2012, and provide the enrollment request, e.g., 2013, to the pay network server. For example, the client may provide a (Secure) Hypertext Transfer Protocol (“HTTP(S)”) POST message including data formatted according to the eXtensible Markup Language (“XML”). Below is an example HTTP(S) POST message including an XML-formatted enrollment request for the pay network server:

POST /enroll.php HTTP/1.1
Host: www.merchant.com
Content-Type: Application/XML
Content-Length: 718
<?XML version = “1.0” encoding = “UTF-8”?>
<enrollment_request>

<cart_ID>4NFU4RG94</order_ID>
<timestamp>2011-02-22 15:22:43</timestamp>
<user_ID>john.q.public@gmail.com</user_ID>
<client_details>

<client_IP>192.168.23.126</client_IP>
<client_type>smartphone</client_type>
<client_model>HTC Hero</client_model>
<OS>Android 2.2</OS>
<app_installed_flag>true</app_installed_flag>

</client_details>
<!--account_params> <optional>

<account_name>John Q. Public</account_name>
<account_type>credit</account_type>
<account_num>123456789012345</account_num>
<billing_address>123 Green St., Norman, OK
98765</billing_address>
<phone>123-456-7809</phone>
<sign>/jqp/</sign>
<confirm_type>email</confirm_type>
<contact_info>john.q.public@gmail.com</contact_info>

</account_params-->
<checkout_purchase_details>

<num_products>1</num_products>
<product>

<product_type>book</product_type>
<product_params>

<product_title>XML for dummies</product_title>
<ISBN>938-2-14-168710-0</ISBN>
<edition>2nd ed.</edition>
<cover>hardbound</cover>
<seller>bestbuybooks</seller>

</product_params>
<quantity>1</quantity>

</product>

</checkout_purchase_details>

</enrollment_request>

In some implementations, the pay network server may obtain the enrollment request from the client, and extract the user's payment detail (e.g., XML data) from the enrollment request. For example, the pay network server may utilize a parser such as the example parsers described below in the discussion with reference to FIG. 61. In some implementations, the pay network server may query, e.g., 2014, a pay network database, e.g., 2004, to obtain a social network request template, e.g., 2015, to process the enrollment request. The social network request template may include instructions, data, login URL, login API call template and/or the like for facilitating social network authentication. For example, the database may be a relational database responsive to Structured Query Language (“SQL”) commands. The merchant server may execute a hypertext preprocessor (“PHP”) script including SQL commands to query the database for product data. An example PHP/SQL command listing, illustrating substantive aspects of querying the database, e.g., 2014-2915, is provided below:

<?PHP
header(′Content-Type: text/plain′);
mysql_connect(“254.93.179.112”,$DBserver,$password); // access
database server
mysql_select_db(“SOCIALAUTH.SQL”); // select database table to
search
//create query
$query = “SELECT template FROM EnrollTable WHERE network LIKE
′%′ $socialnet”;
$result = mysql_query($query); // perform the search query
mysql_close(“SOCIALAUTH.SQL”); // close database access
?>

In some implementations, the pay network server may redirect the client to a social network server by providing a HTTP(S) REDIRECT 300 message, similar to the example below:

HTTP/1.1 300 Multiple Choices
Location:

https://www.facebook.com/dialog/oauth?client_id=snpa_app_ID&redirect_uri=
www.paynetwork.com/enroll.php

<html>

<head><title>300 Multiple Choices</title></head>
<body><h1>Multiple Choices</h1></body>

</html>

In some implementations, the pay network server may provide payment information extracted from the card authorization request to the social network server as part of a social network authentication enrollment request, e.g., 2017. For example, the pay network server may provide a HTTP(S) POST message to the social network server, similar to the example below:

POST /authenticate_enroll.php HTTP/1.1
Host: www.socialnet.com
Content-Type: Application/XML
Content-Length: 1306
<?XML version = “1.0” encoding = “UTF-8”?>
<authenticate_enrollment_request>

<request_ID>4NFU4RG94</order_ID>
<timestamp>2011-02-22 15:22:43</timestamp>
<user_ID>john.q.public@gmail.com</user_ID>
<client_details>

<client_IP>192.168.23.126</client_IP>
<client_type>smartphone</client_type>
<client_model>HTC Hero</client_model>
<OS>Android 2.2</OS>
<app_installed_flag>true</app_installed_flag>

</client_details>
<account_params>

<account_name>John Q. Public</account_name>
<account_type>credit</account_type>
<account_num>123456789012345</account_num>
<billing_address>123 Green St., Norman, OK
98765</billing_address>
<phone>123-456-7809</phone>
<sign>/jqp/</sign>
<confirm_type>email</confirm_type>
<contact_info>john.q.public@gmail.com</contact_info>

</account_params>

</authenticate_enrollment_request>

In some implementations, the social network server may provide a social network login request, e.g., 2018, to the client. For example, the social network server may provide a HTML input form to the client. The client may display, e.g., 2019, the login form for the user. In some implementations, the user may provide login input into the client, e.g., 2020, and the client may generate a social network login response, e.g., 2021, for the social network server. In some implementations, the social network server may authenticate the login credentials of the user, and access payment account information of the user stored within the social network, e.g., in a social network database. Upon authentication, the social network server may generate an authentication data record for the user, e.g., 2022, and provide an enrollment notification, e.g., 2024, to the pay network server. For example, the social network server may provide a HTTP(S) POST message similar to the example below:

POST /enrollnotification.php HTTP/1.1
Host: www.paynet.com
Content-Type: Application/XML
Content-Length: 1306
<?XML version = “1.0” encoding = “UTF-8”?>
<enroll_notification>

<request_ID>4NFU4RG94</order_ID>
<timestamp>2011-02-22 15:22:43</timestamp>
<result>enrolled</result>

</enroll_notification>

Upon receiving notification of enrollment from the social network server, the pay network server may generate, e.g., 2025, a user enrollment data record, and store the enrollment data record in a pay network database, e.g., 2026, to complete enrollment. In some implementations, the enrollment data record may include the information from the enrollment notification 2024.

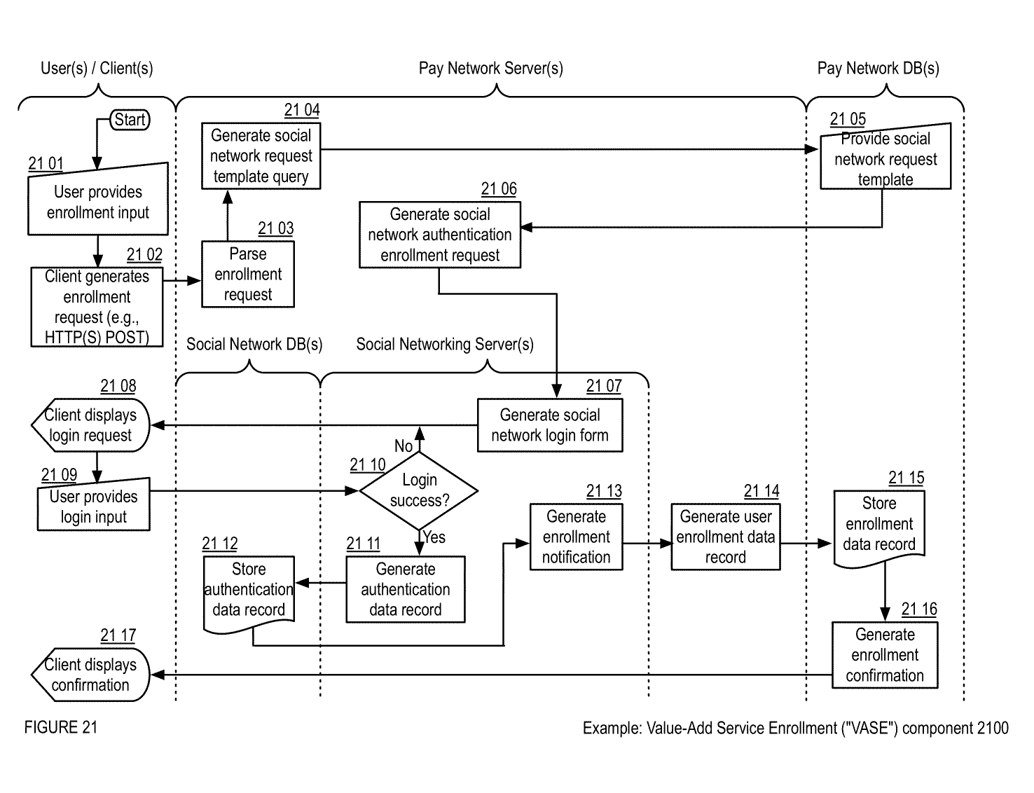

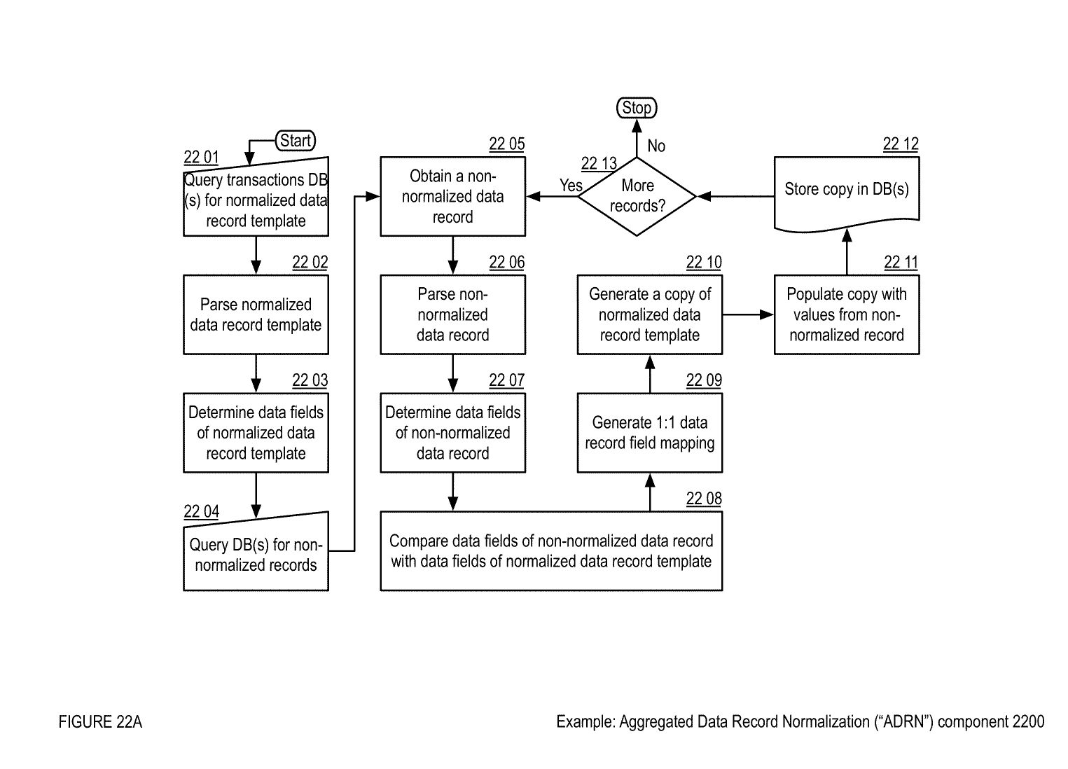

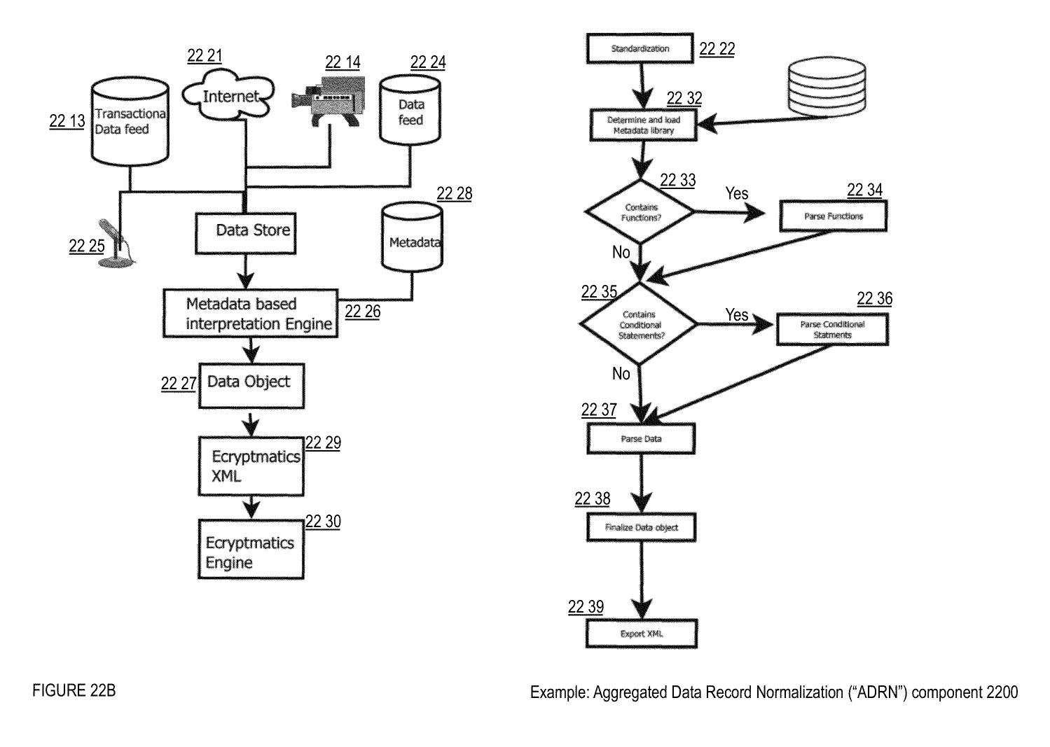

FIG. 21 shows a logic flow diagram illustrating example aspects of enrollment in a value-added service in some embodiments of the Ad-Track, e.g., a Value-Add Service Enrollment (“VASE”) component 2100. In some implementations, a user, e.g., 2901, may desire to enroll in a value-added service. Let us consider an example wherein the user desires to enroll in social network authenticated purchase payment as a value-added service. It is to be understood that any other value-added service may take the place of the below-described value-added service. The user may communicate with a pay network server via a client. For example, the user may provide user input, e.g., 2101, into the client indicating the user's desire to enroll in social network authenticated purchase payment. In various implementations, the user input may include, but not be limited to: a single tap (e.g., a one-tap mobile app purchasing embodiment) of a touchscreen interface, keyboard entry, card swipe, activating a RFID/NFC enabled hardware device (e.g., electronic card having multiple accounts, smartphone, tablet, etc.) within the user device, mouse clicks, depressing buttons on a joystick/game console, voice commands, single/multi-touch gestures on a touch-sensitive interface, touching user interface elements on a touch-sensitive display, and/or the like. In some implementations, using the user's input, the client may generate an enrollment request, e.g., 2102, and provide the enrollment request to the pay network server. In some implementations, the SNPA may provide an enrollment button that may take the user to an enrollment webpage where account info may be entered into web form fields. In some implementations, the pay network server may obtain the enrollment request from the client, and extract the user's payment detail from the enrollment request. For example, the pay network server may utilize a parser such as the example parsers described below in the discussion with reference to FIG. 61. In some implementations, the pay network server may query, e.g., 2104, a pay network database to obtain a social network request template, e.g., 2105, to process the enrollment request. The social network request template may include instructions, data, login URL, login API call template and/or the like for facilitating social network authentication. In some implementations, the pay network server may provide payment information extracted from the card authorization request to the social network server as part of a social network authentication enrollment request, e.g., 2106. In some implementations, the social network server may provide a social network login request, e.g., 2107, to the client. For example, the social network server may provide a HTML input form to the client. The client may display, e.g., 2108, the login form for the user. In some implementations, the user may provide login input into the client, e.g., 2109, and the client may generate a social network login response for the social network server. In some implementations, the social network server may authenticate the login credentials of the user, and access payment account information of the user stored within the social network, e.g., in a social network database. Upon authentication, the social network server may generate an authentication data record for the user, e.g., 2111, 6 and provide an enrollment notification to the pay network server, e.g., 2113. Upon receiving notification of enrollment from the social network server, the pay network server may generate, e.g., 2114, a user enrollment data record, and store the enrollment data record in a pay network database, e.g., 2115, to complete enrollment. The pay network server may provide an enrollment confirmation, and provide the enrollment confirmation to the client, which may display, e.g., 2117, the confirmation for the user.

FIGS. 22A-B show flow diagrams illustrating example aspects of normalizing aggregated search, enrolled, service usage, transaction and/or other aggregated data into a standardized data format in some embodiments of the Ad-Track, e.g., a Aggregated Data Record Normalization (“ADRN”) component 2200. With reference to FIG. 22A, in some implementations, a pay network server (“server”) may attempt to convert any aggregated data records stored in an aggregated records database it has access to in a normalized data format. For example, the database may have a transaction data record template with predetermined, standard fields that may store data in pre-defined formats (e.g., long integer/double float/4 digits of precision, etc.) in a pre-determined data structure. A sample XML transaction data record template is provided below:

<?XML version = “1.0” encoding = “UTF-8”?>
<transaction_record>

<record_ID>00000000</record_ID>
<norm_flag>false</norm_flag>
<timestamp>yyyy-mm-dd hh:mm:ss</timestamp>
<transaction_cost>$0,000,000,00</transaction_cost>
<merchant_params>

<merchant_id>00000000</merchant_id>
<merchant_name>TBD</merchant_name>
<merchant_auth_key>0000000000000000</merchant_auth_key>

</merchant_params>
<merchant_products>

<num_products>000</num_products>
<product>

<product_type>TBD</product_type>
<product_name>TBD</product_name>
<class_labels_list>TBD<class_labels_list>
<product_quantity>000</product_quantity>
<unit_value>$0,000,000.00</unit_value>
<sub_total>$0,000,000.00</sub_total>
<comment>normalized transaction data record template</comment>

</product>

</merchant_products>
<user_account_params>

<account_name>JTBD</account_name>
<account_type>TBD</account_type>
<account_num>0000000000000000</account_num>
<billing_line1>TBD</billing_line1>
<billing_line2>TBD</billing_line2>
<zipcode>TBD</zipcode>
<state>TBD</state>
<country>TBD</country>
<phone>00-00-000-000-0000</phone>
<sign>TBD</sign>

</user_account_params>

</transaction_record>

In some implementations, the server may query a database for a normalized data record template, e.g., 2201. The server may parse the normalized data record template, e.g., 2202. Based on parsing the normalized data record template, the server may determine the data fields included in the normalized data record template, and the format of the data stored in the fields of the data record template, e.g., 2203. The server may obtain transaction data records for normalization. The server may query a database, e.g., 2204, for non-normalized records. For example, the server may issue PHP/SQL commands to retrieve records that do not have the ‘norm_flag’ field from the example template above, or those where the value of the ‘norm_flag’ field is ‘false’. Upon obtaining the non-normalized transaction data records, the server may select one of the non-normalized transaction data records, e.g., 2205. The server may parse the non-normalized transaction data record, e.g., 2206, and determine the fields present in the non-normalized transaction data record, e.g., 2207. For example, the server may utilize a procedure similar to one described below with reference to FIG. 332. The server may compare the fields from the non-normalized transaction data record with the fields extracted from the normalized transaction data record template. For example, the server may determine whether the field identifiers of fields in the non-normalized transaction data record match those of the normalized transaction data record template, (e.g., via a dictionary, thesaurus, etc.), are identical, are synonymous, are related, and/or the like. Based on the comparison, the server may generate a 1:1 mapping between fields of the non-normalized transaction data record match those of the normalized transaction data record template, e.g., 2209. The server may generate a copy of the normalized transaction data record template, e.g., 2210, and populate the fields of the template using values from the non-normalized transaction data record, e.g., 2211. The server may also change the value of the ‘norm_flag’ field to ‘true’ in the example above. The server may store the populated record in a database (for example, replacing the original version), e.g., 2212. The server may repeat the above procedure for each non-normalized transaction data record (see e.g., 2213), until all the non-normalized transaction data records have been normalized.

With reference to FIG. 22B, in some embodiments, the server may utilize metadata (e.g., easily configurable data) to drive an analytics and rule engine that may convert any structured data into a standardized XML format (“encryptmatics” XML). The encryptmatics XML may then be processed by an encryptmatics engine that is capable of parsing, transforming and analyzing data to generate decisions based on the results of the analysis. Accordingly, in some embodiments, the server may implement a metadata-based interpretation engine that parses structured data, including, but not limited to: web content (see e.g., 2221), graph databases (see e.g., 2222), micro blogs, images or software code (see e.g., 2224), and converts the structured data into commands in the encryptmatics XML file format. For example, the structured data may include, without limitation, software code, images, free text, relational database queries, graph queries, sensory inputs (see e.g., 2223, 2225), and/or the like. A metadata based interpretation engine engine, e.g., 2226, may populate a data/command object, e.g., 2227, based on a given record using configurable metadata, e.g., 2228. The configurable metadata may define an action for a given glyph or keyword contained within a data record. The engine may then process the object to export its data structure as a collection of encryptmatics vaults in a standard encryptmatics XML file format, e.g., 2229. The encryptmatics XML file may then be processed to provide various features by an encryptmatics engine, e.g., 2230.

In some embodiments, the server may obtain the structured data, and perform a standardization routine using the structured data as input (e.g., including script commands, for illustration). For example, the server may remove extra line breaks, spaces, tab spaces, etc. from the structured data, e.g. 2231. The server may determine and load a metadata library, e.g., 2232, using which the server may parse subroutines or functions within the script, based on the metadata, e.g., 2233-3134. In some embodiments, the server may pre-parse conditional statements based on the metadata, e.g., 2235-3136. The server may also parse data 2237 to populate a data/command object based on the metadata and prior parsing, e.g., 2238. Upon finalizing the data/command object, the server may export 2239 the data/command object as XML in standardized encryptmatics format.

FIG. 23 shows a logic flow diagram illustrating example aspects of recognizing data fields in normalized aggregated data records in some embodiments of the Ad-Track, e.g., a Data Field Recognition (“DFR”) component 2300. In some implementations, a server may recognize the type of data fields included in a data record, e.g, date, address, zipcode, name, user ID, email address, payment account number (PAN), CVV2 numbers, and/or the like. The server may select an unprocessed data record for processing, e.g., 2301. The server may parse the data record rule, and extract data fields from the data record, e.g., 2302. The server may query a database for data field templates, e.g., 2303. For example, the server may compare the format of the fields from the data record to the data record templates to identify a match between one of the data field templates and each field within the data record, thus identifying the type of each field within the data record. The server may thus select an extracted data field from the data record, e.g., 2304. The server may select a data field template for comparison with the selected data field, e.g., 2305, and compare the data field template with the selected data field, e.g., 2306, to determine whether format of extracted data field matches format of data field template, e.g., 2307. If the format of the selected extracted data field matches the format of the data field template, e.g., 2308, option “Yes,” the server may assign the type of data field template to the selected data field, e.g., 2309. If the format of the extracted data field does not match the format of the data field template, e.g., 2308, option “No,” the server may try another data field template until no more data field templates are available for comparison, see e.g., 2310. If no match is found, the server may assign “unknown” string as the type of the data field, e.g., 2311. The server may store the updated data record in the database, e.g., 2312. The server may perform such data field recognition for each data field in the data record (and also for each data record in the database), see e.g., 2313.

FIG. 24 shows a logic flow diagram illustrating example aspects of classifying entity types in some embodiments of the Ad-Track, e.g., an Entity Type Classification (“ETC”) component 2400. In some implementations, a server may apply one or more classification labels to each of the data records. For example, the server may classify the data records according to entity type, according to criteria such as, but not limited to: geo-political area, number of items purchased, and/or the like. The server may obtain transactions from a database that are unclassified, e.g., 2401, and obtain rules and labels for classifying the records, e.g., 2402. For example, the database may store classification rules, such as the exemplary illustrative XML-encoded classification rule provided below:

<rule>

<id>PURCHASE_44_45</id>
<name>Number of purchasers</name>
<inputs>num_purchasers</inputs>
<operations>

<1>label = ‘null’</1>
<2>IF (num_purchasers > 1) label = ‘household’</2>

</operations>
<outputs>label</outputs>

</rule>

The server may select an unclassified data record for processing, e.g., 2403. The server may also select a classification rule for processing the unclassified data record, e.g., 2404. The server may parse the classification rule, and determine the inputs required for the rule, e.g., 2405. Based on parsing the classification rule, the server may parse the normalized data record template, e.g., 2406, and extract the values for the fields required to be provided as inputs to the classification rule. The server may parse the classification rule, and extract the operations to be performed on the inputs provided for the rule processing, e.g., 2407. Upon determining the operations to be performed, the server may perform the rule-specified operations on the inputs provided for the classification rule, e.g., 2408. In some implementations, the rule may provide threshold values. For example, the rule may specify that if the number of products in the transaction, total value of the transaction, average luxury rating of the products sold in the transaction, etc. may need to cross a threshold in order for the label(s) associated with the rule to be applied to the transaction data record. The server may parse the classification rule to extract any threshold values required for the rule to apply, e.g., 2409. The server may compare the computed values with the rule thresholds, e.g., 2410. If the rule threshold(s) is crossed, e.g., 2411, option “Yes,” the server may apply one or more labels to the transaction data record as specified by the classification rule, e.g., 2412. For example, the server may apply a classification rule to an individual product within the transaction, and/or to the transaction as a whole. In some implementations, the server may process the transaction data record using each rule (see, e.g., 2413). Once all classification rules have been processed for the transaction record, e.g., 2413, option “No,” the server may store the transaction data record in a database, e.g., 2414. The server may perform such processing for each transaction data record until all transaction data records have been classified (see, e.g., 2415).

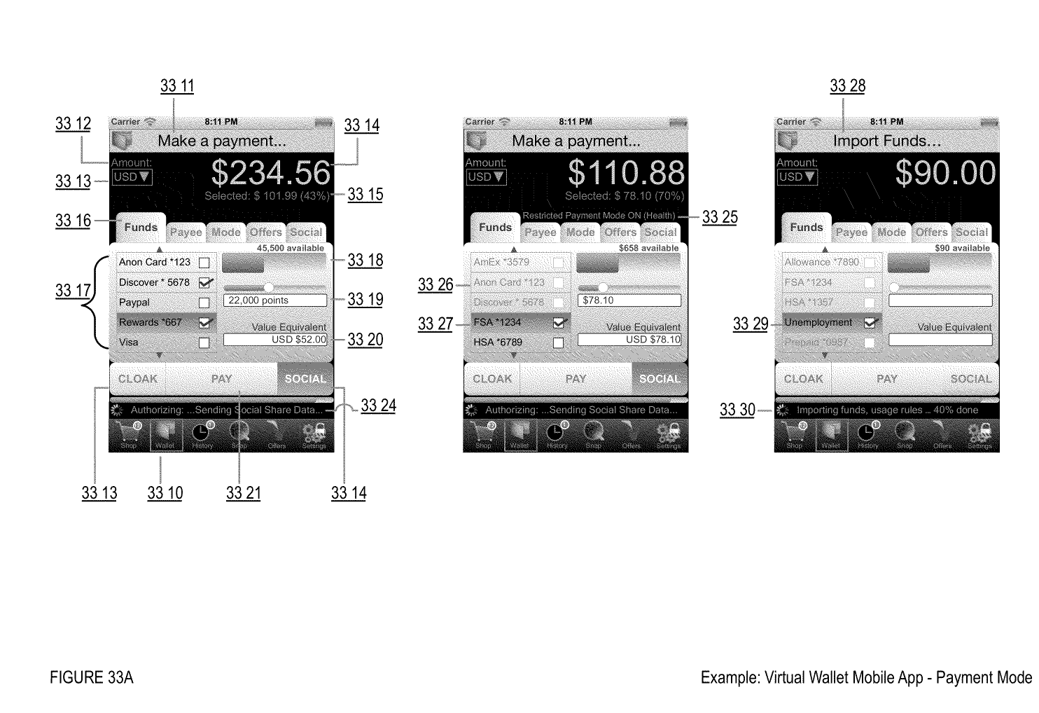

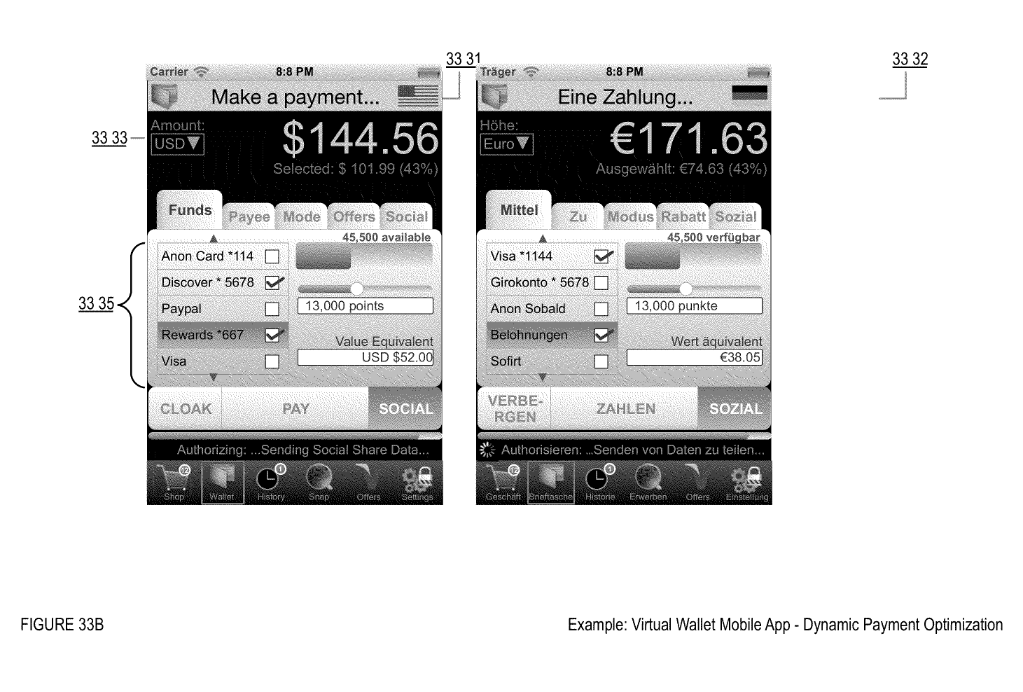

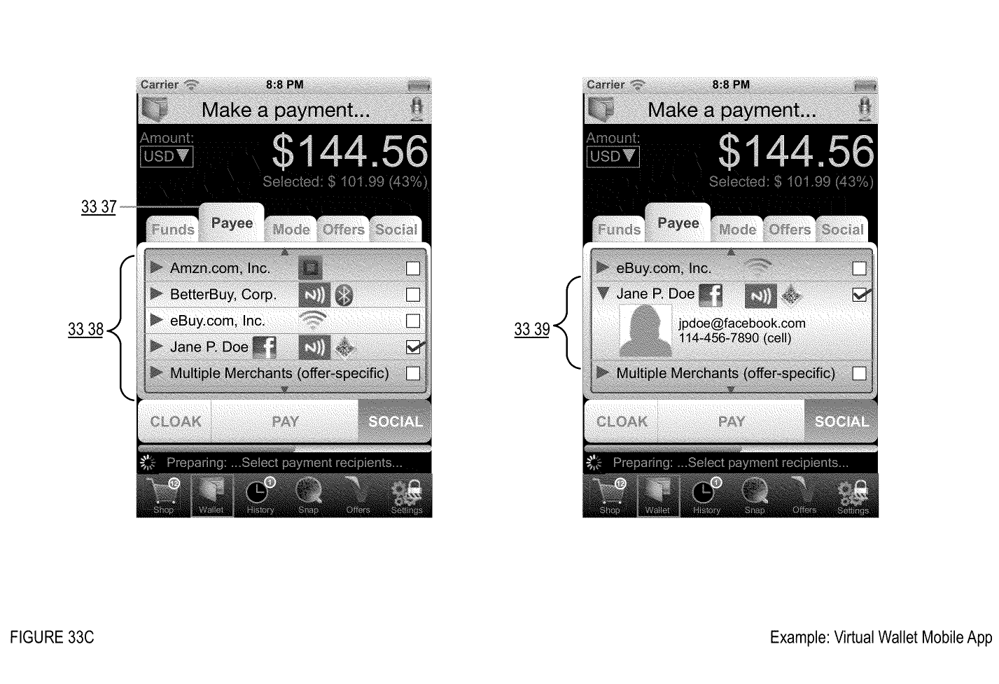

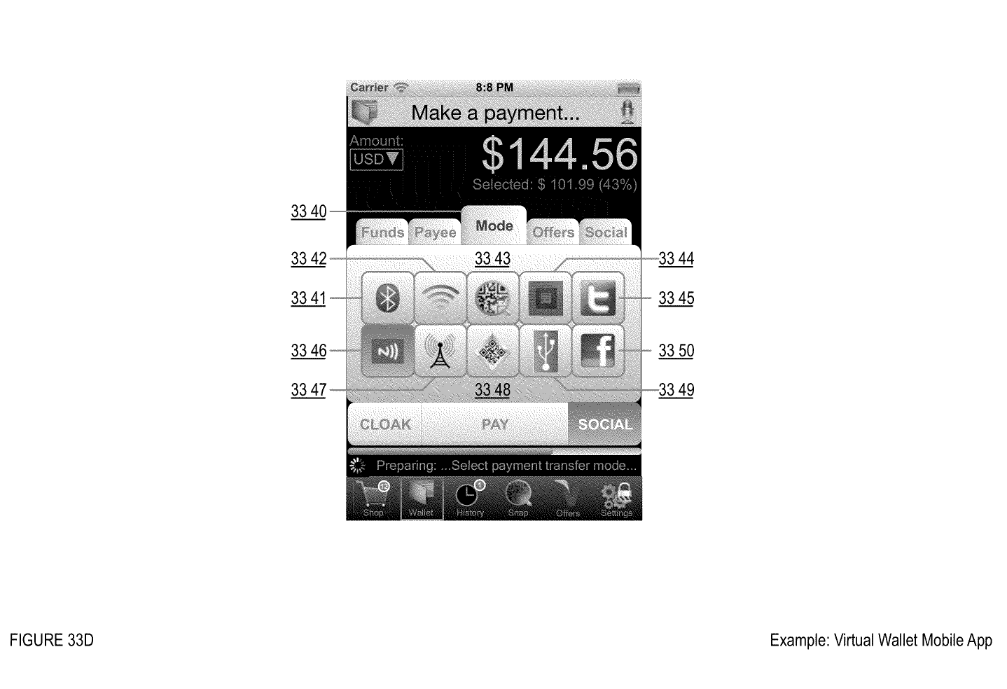

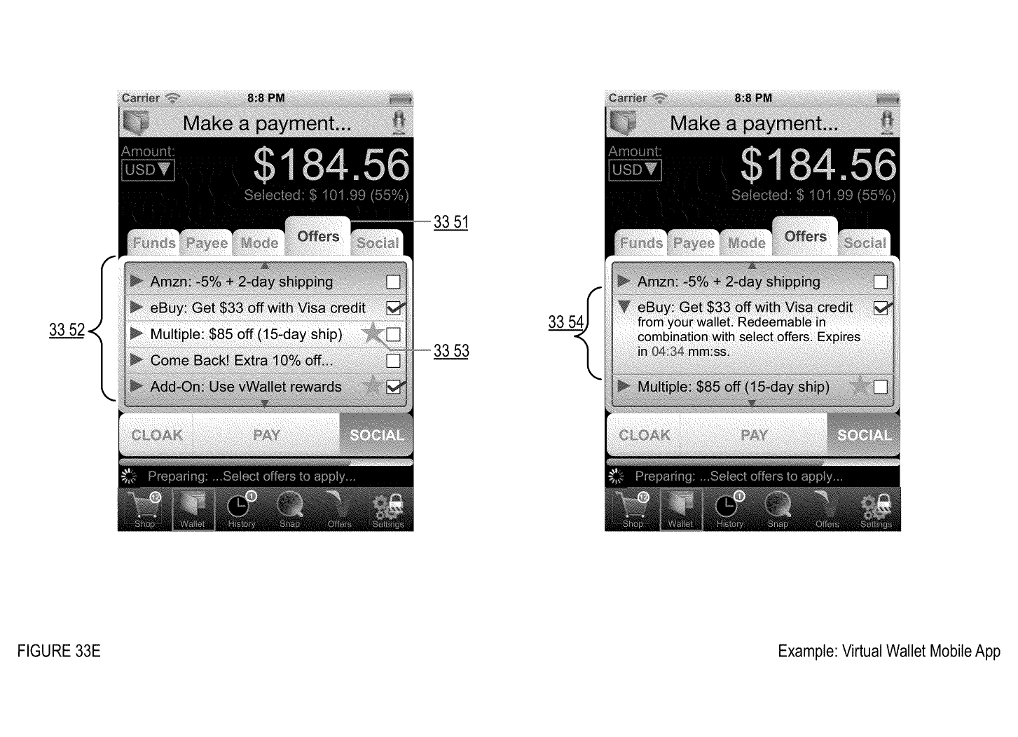

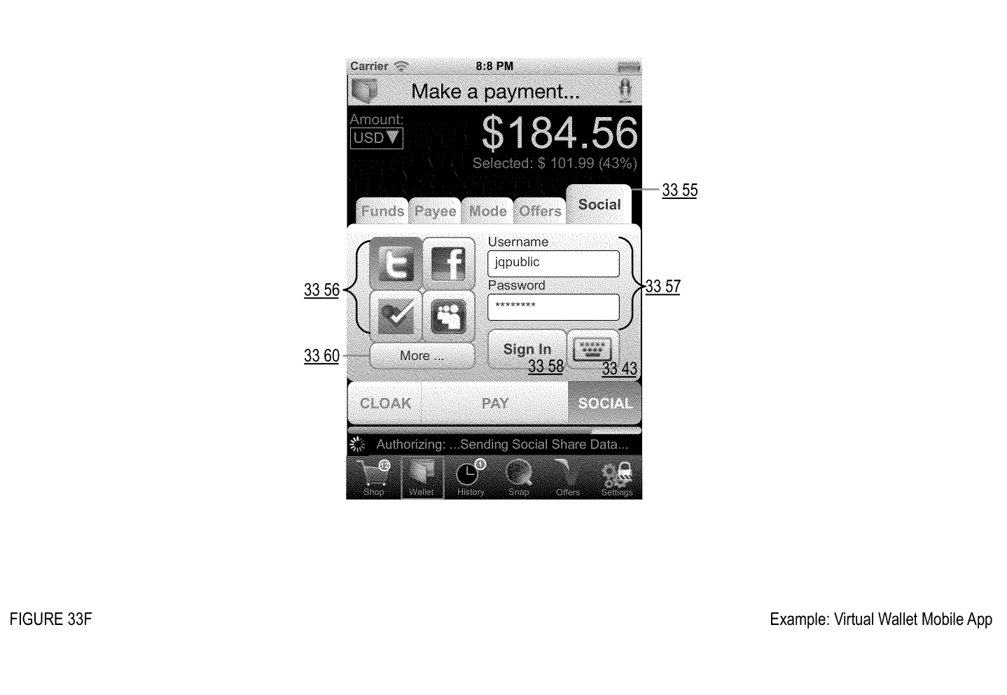

FIG. 25 shows a logic flow diagram illustrating example aspects of identifying cross-entity correlation in some embodiments of the Ad-Track, e.g., a Cross-Entity Correlation (“CEC”) component 2500. In some implementations, a server may recognize that two entities in the Ad-Track share common or related data fields, e.g, date, address, zipcode, name, user ID, email address, payment account number (PAN), CVV2 numbers, and/or the like, and thus identify the entities as being correlated. The server may select a data record for cross-entity correlation, e.g., 2501. The server may parse the data record rule, and extract data fields from the data record, e.g., 2502-3403. The server may select an extracted data field from the data record, e.g., 2504, and query a database for other data records having the same data field as the extracted data field, e.g., 2505. From the list of retrieved data records from the database query, the server may select a record for further analysis. The server may identify, e.g., 2507, an entity associated with the retrieved data record, e.g., using the ETC 3300 component discussed above in the description with reference to FIG. 33. The server may add a data field to the data record obtained for cross-entity correlation specifying the correlation to the retrieved selected data record, e.g., 2508. In some embodiments, the server may utilize each data field in the data record obtained for cross-entity correlation to identify correlated entities, see e.g., 2509. The server may add, once complete, a “correlated” flag to the data record obtained for cross-entity correlation, e.g., 2510, e.g., along with as timestamp specifying the time at which the cross-entity correlation was performed. For example, such a timestamp may be used to determine at a later time whether the data record should be processed again for cross-entity correlation. The server may store the updated data record in a database.

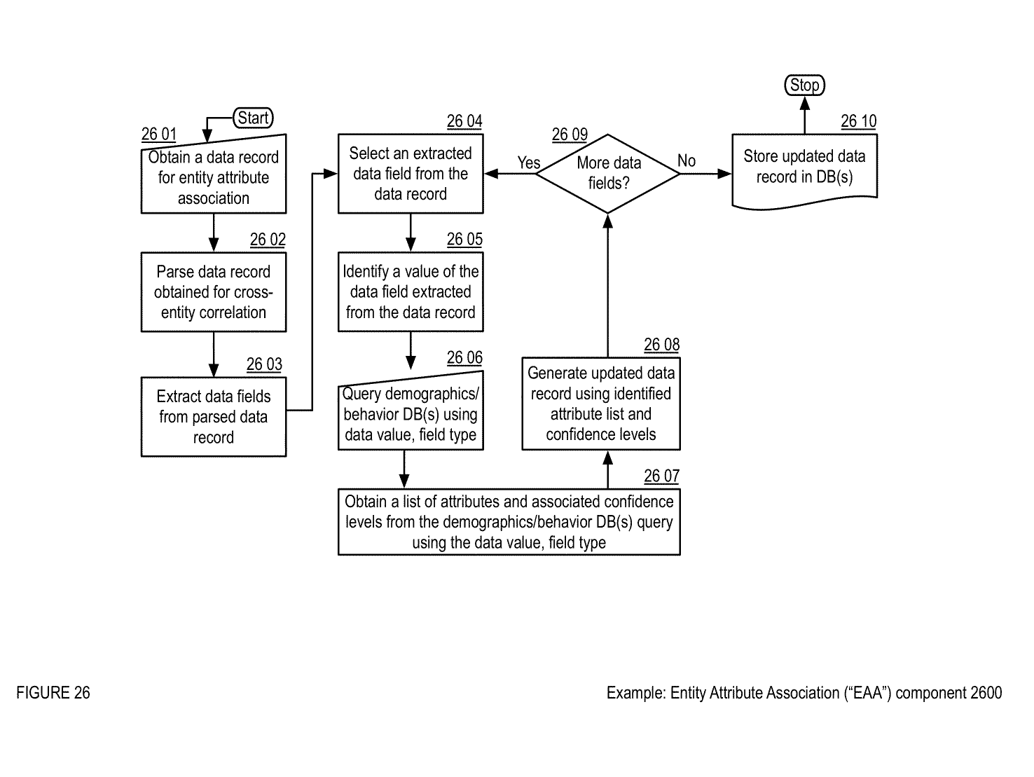

FIG. 26 shows a logic flow diagram illustrating example aspects of associating attributes to entities in some embodiments of the Ad-Track, e.g., an Entity Attribute Association (“EAA”) component 2600. In some implementations, a server may associate attributes to an entity, e.g., if the entity id a person, the server may identify a demographic (e.g., male/female), a spend character, a purchase preferences list, a merchants preference list, and/or the like, based on field values of data fields in data records that are related to the entity. In some implementations, a server may obtain a data record for entity attribute association, e.g., 2601. The server may parse the data record rule, and extract data fields from the data record, e.g., 2602-3503. The server may select an extracted data field from the data record, e.g., 2604, and identify a field value for the selected extracted data field from the data record, e.g., 2605. The server may query a database for demographic data, behavioral data, and/or the like, e.g., 2606, using the field value and field type. In response, the database may provide a list of potential attributes, as well as a confidence level in those attribute associations to the entity, see e.g., 2607. The server may add data fields to the data record obtained for entity attribute association specifying the potentially associated attributes and their associated confidence levels, e.g., 2608. In some embodiments, the server may utilize each data field in the data record obtained for cross-entity correlation to identify correlated entities, see e.g., 2609. The server may store the updated data record in a database, e.g., 2610.

FIG. 27 shows a logic flow diagram illustrating example aspects of updating entity profile-graphs in some embodiments of the Ad-Track, e.g., an Entity Profile-Graph Updating (“EPGU”) component 2700. In some implementations, a server may generate/update a profile for an entity whose data is stored within the Ad-Track. The server may obtain an entity profile record for updating, e.g., 2701. The server may parse the entity profile record, and extract an entity identifier data field from the data record, e.g., 2702. The server may query a database for other data records that are related to the same entity, e.g., 2703, using the value for the entity identifier data field. In response, the database may provide a list of other data records for further processing. The server may select one of the other data records to update the entity profile record, e.g., 2704. The server may parse the data record, and extract all correlations, associations, and new data from the other record, e.g., 2705. The server may compare the correlations, attributes, associations, etc., from the other data record with the correlations, associations and attributes from the entity profile. Based on this comparison, the server may identify any new correlations, associations, etc., and generate an updated entity profile record using the new correlations, associations; flag new correlations, associations for further processing, e.g., 2707. In some embodiments, the server may utilize each data record obtained for updating the entity profile record as well as its social graph (e.g., as given by the correlations and associations for the entity), see e.g., 2709. The server may store the updated entity profile record in a database, e.g., 2708.

FIG. 28 shows a logic flow diagram illustrating example aspects of generating search terms for profile-graph updating in some embodiments of the Ad-Track, e.g., a Search Term Generation (“STG”) component 2800. In some implementations, a server may generate/update a profile for an entity whose data is stored within the Ad-Track, by performing search for new data, e.g., across the Internet and social networking services. The server may obtain an entity profile record for updating, e.g., 2801. The server may parse the entity profile record, and extract data field types and field values from the entity profile record, e.g., 2802. The server may query a database for other data records that are related to the same entity, e.g., 2803, using the values for the extracted data fields. In response, the database may provide a list of other data records for further processing. The server may parse the data records, and extract all correlations, associations, and data from the data records, e.g., 2804. The server may aggregate all the data values from all the records and the entity profile record, e.g., 2805. Based on this, the server may return the aggregated data values as search terms to trigger search processes (see e.g., FIG. 20, 2001-2005), e.g., 2806.

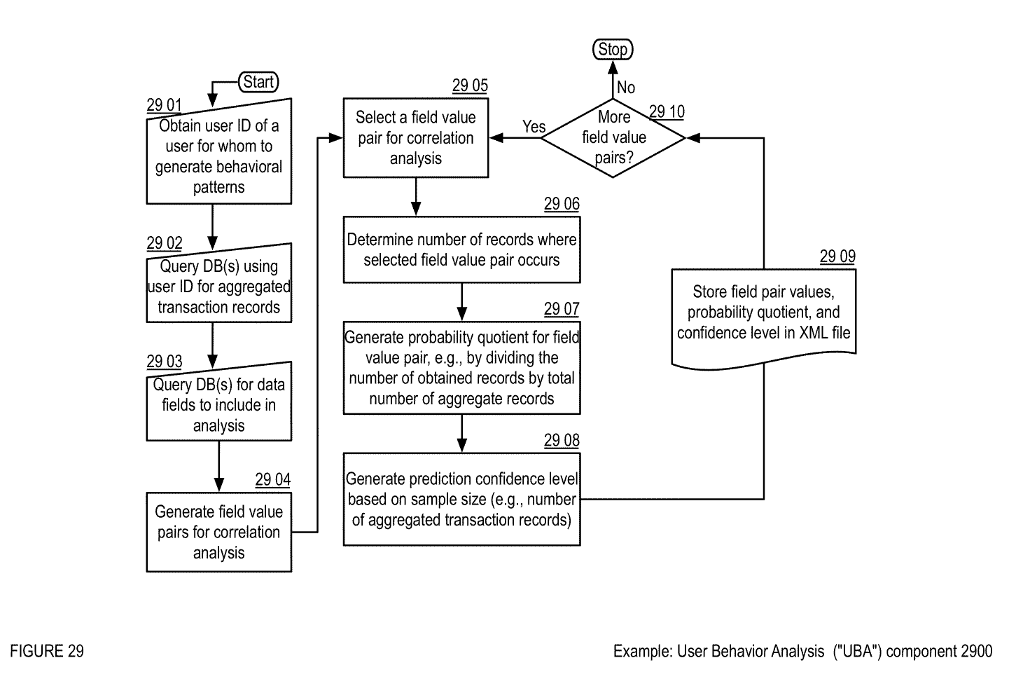

FIG. 29 shows a logic flow diagram illustrating example aspects of analyzing a user's behavior based on aggregated purchase transaction data in some embodiments of the Ad-Track, e.g., a User Behavior Analysis (“UBA”) component 2900. In some implementations, a pay network server (“server”) may obtain a user ID of a user for whom the server is required to generate user behavioral patterns, e.g., 2901. The server may query a database, e.g., a pay network database, for aggregated card transaction data records of the user, e.g., 2902. The server may also query, e.g., 2903, the pay network database for all possible field value that can be taken by each of the field values (e.g., AM/PM, zipcode, merchant_ID, merchant_name, transaction cost brackets, etc.). Using the field values of all the fields in the transaction data records, the server may generate field value pairs, for performing a correlation analysis on the field value pairs, e.g., 2904. An example field value pair is: ‘time’ is ‘AM’ and ‘merchant’ is ‘Walmart’. The server may then generate probability estimates for each field value pair occurring in the aggregated transaction data records. For example, the server may select a field value pair, e.g., 2905. The server may determine the number of records within the aggregated transaction data records where the field value pair occurs, e.g., 2906. The server may then calculate a probability quotient for the field value pair by dividing the number determined for the occurrences of the field value pair by the total number of aggregate transaction data records, e.g., 2907. The server may also assign a confidence level for the probability quotient based on the sample size, e.g., total number of records in the aggregated transaction data records, e.g., 2908. The server may generate and store an XML snippet, including the field value pair, the probability quotient, and the confidence level associated with the probability quotient, e.g., 2909. The server may perform such a computation for each field value pair (see 2910) generated in 2904.

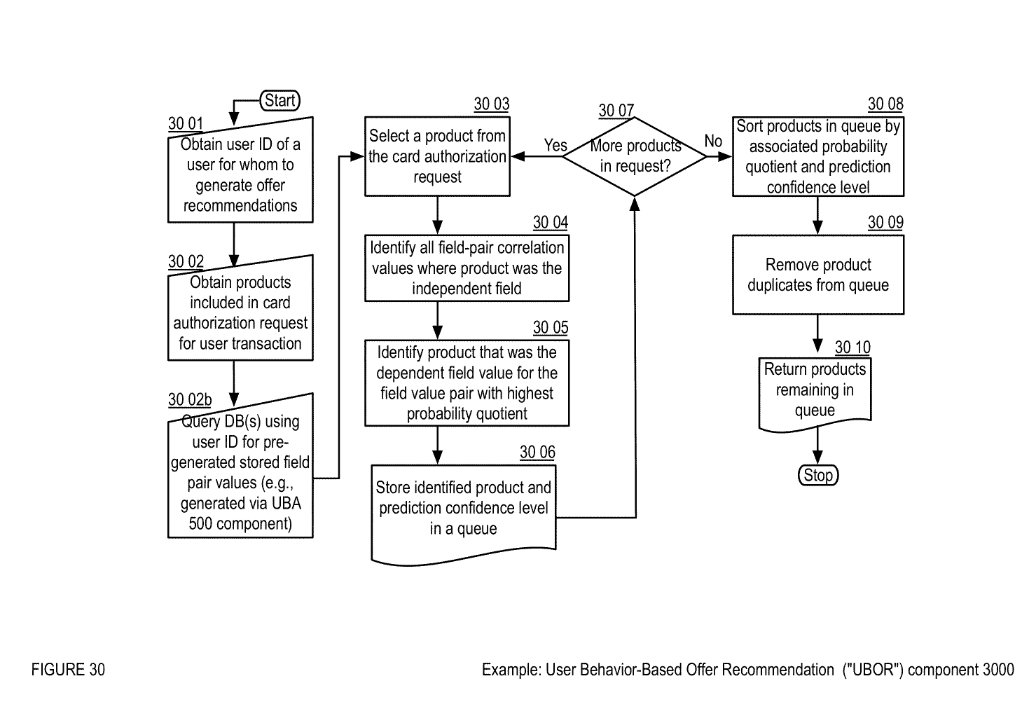

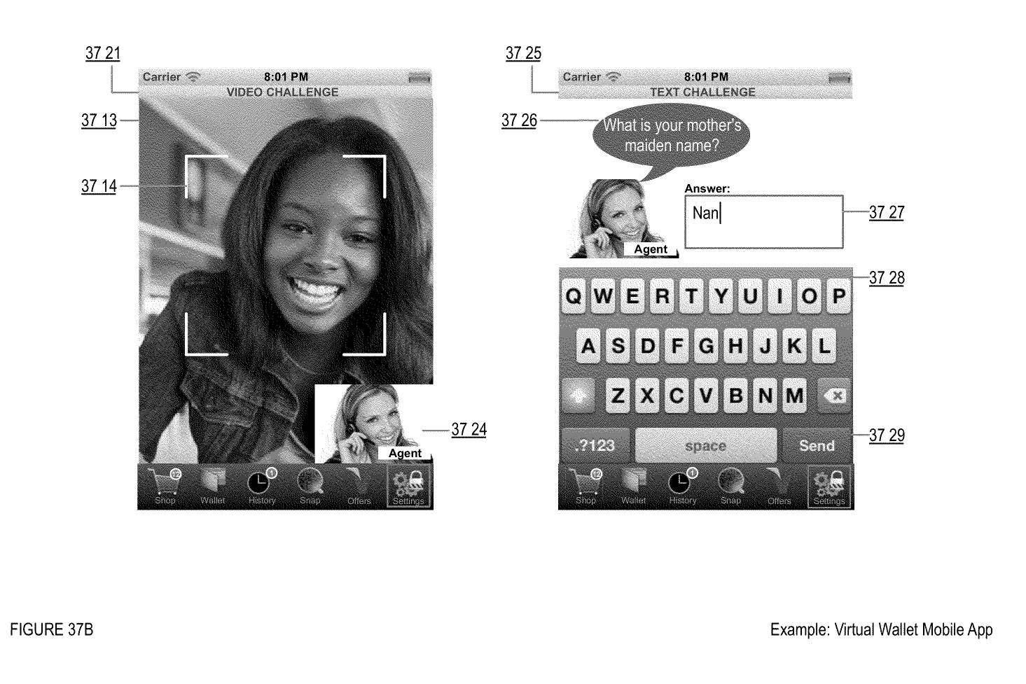

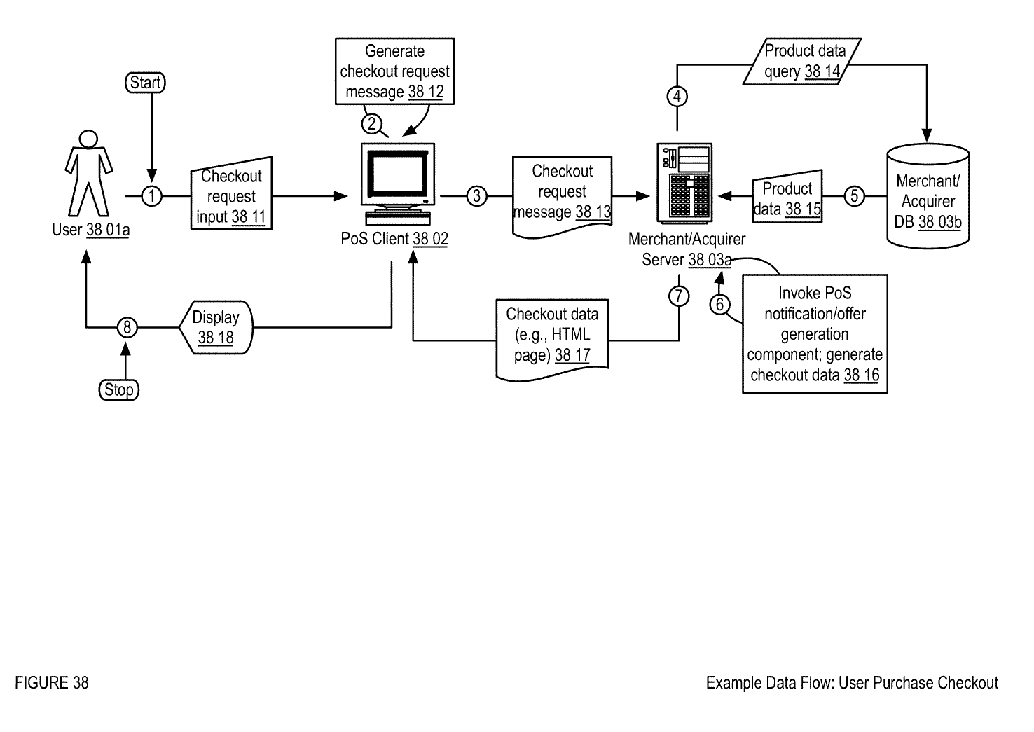

FIG. 30 shows a logic flow diagram illustrating example aspects of generating recommendations for a user based on the user's prior aggregate purchase transaction behavior in some embodiments of the Ad-Track, e.g., a User Behavior-Based Offer Recommendations (“UBOR”) component 3000. In some implementations, a pay network server (“server”) may obtain a user ID of a user for whom the server is required to generate offer recommendations, e.g., 3001. The server may obtain a list of products included in a card authorization request for processing the purchase transaction for the user, e.g., 3002. The server may also query a database for pre-generated pair-wise correlations of various user transaction-related variables, e.g., 3002b, such as those generated by the UBA 3800 component described above with reference to FIG. 38. The server may select a product from the list of products included in the card authorization request, e.g., 3003. The server may identify all field pair-correlation values where the selected product was the independent field into the field-pair correlation, e.g., 3004. The server may, e.g., 3005, from among the identified field-pair values, identify the product that was the dependent field value for the field value pair having the highest probability quotient (e.g., product most likely to be bought together with the product selected from the product list included in the card authorization request). The server may store the identified product, along with its associated prediction confidence level, in a queue of products for recommendation, e.g., 3006. The server may perform the analysis for each product included in the product list from the card authorization request, see e.g., 3007.

In some implementations, upon completing such an analysis for all the products in the card authorization request, the server may sort the queue according to their associated probability quotient and prediction confidence level, e.g., 3008. For example, if the prediction confidence level of a product is higher than a threshold, then it may be retained in the queue, but not if the prediction confidence level is lower than the threshold. Also, the retained products may be sorted in descending order of their associated probability quotients. In some implementations, the server may eliminate any duplicated products form the queue, e.g., 3009. The server may return the sorted queue of products for product offer recommendation, e.g., 3010.

FIG. 31 shows a user interface diagram illustrating an overview of example features of virtual wallet applications in some embodiments of the Ad-Track. FIG. 31 shows an illustration of various exemplary features of a virtual wallet mobile application 3100. Some of the features displayed include a wallet 3101, social integration via TWITTER, FACEBOOK, etc., offers and loyalty 3103, snap mobile purchase 3104, alerts 3105 and security, setting and analytics 3196. These features are explored in further detail below.

FIGS. 32A-G show user interface diagrams illustrating example features of virtual wallet applications in a shopping mode, in some embodiments of the Ad-Track. With reference to FIG. 32A, some embodiments of the virtual wallet mobile app facilitate and greatly enhance the shopping experience of consumers. A variety of shopping modes, as shown in FIG. 32A, may be available for a consumer to peruse. In one implementation, for example, a user may launch the shopping mode by selecting the shop icon 3210 at the bottom of the user interface. A user may type in an item in the search field 3212 to search and/or add an item to a cart 3211. A user may also use a voice activated shopping mode by saying the name or description of an item to be searched and/or added to the cart into a microphone 3213. In a further implementation, a user may also select other shopping options 3214 such as current items 3215, bills 3216, address book 3217, merchants 3218 and local proximity 3219.

In one embodiment, for example, a user may select the option current items 3215, as shown in the left most user interface of FIG. 32A. When the current items 3215 option is selected, the middle user interface may be displayed. As shown, the middle user interface may provide a current list of items 3215a-h in a user's shopping cart 3211. A user may select an item, for example item 3215a, to view product description 3215j of the selected item and/or other items from the same merchant. The price and total payable information may also be displayed, along with a QR code 3215k that captures the information necessary to effect a snap mobile purchase transaction.

With reference to FIG. 32B, in another embodiment, a user may select the bills 3216 option. Upon selecting the bills 3216 option, the user interface may display a list of bills and/or receipts 3216a-h from one or more merchants. Next to each of the bills, additional information such as date of visit, whether items from multiple stores are present, last bill payment date, auto-payment, number of items, and/or the like may be displayed. In one example, the wallet shop bill 3216a dated Jan. 20, 2011 may be selected. The wallet shop bill selection may display a user interface that provides a variety of information regarding the selected bill. For example, the user interface may display a list of items 3216k purchased, <<3216i>>, >, a total number of items and the corresponding value. For example, 7 items worth $102.54 were in the selected wallet shop bill. A user may now select any of the items and select buy again to add purchase the items. The user may also refresh offers 3216j to clear any invalid offers from last time and/or search for new offers that may be applicable for the current purchase. As shown in FIG. 32B, a user may select two items for repeat purchase. Upon addition, a message 3216l may be displayed to confirm the addition of the two items, which makes the total number of items in the cart 14.

With reference to FIG. 32C, in yet another embodiment, a user may select the address book option 3217 to view the address book 3217a which includes a list of contacts 3217b and make any money transfers or payments. In one embodiment, the address book may identify each contact using their names and available and/or preferred modes of payment. For example, a contact Amanda G. may be paid via social pay (e.g., via FACEBOOK) as indicated by the icon 3217c. In another example, money may be transferred to Brian S. via QR code as indicated by the QR code icon 3217d. In yet another example, Charles B. may accept payment via near field communication 3217e, Bluetooth 3217f and email 3217g. Payment may also be made via USB 3217h (e.g., by physically connecting two mobile devices) as well as other social channels such as TWITTER.

In one implementation, a user may select Joe P. for payment. Joe P., as shown in the user interface, has an email icon 3217g next to his name indicating that Joe P. accepts payment via email. When his name is selected, the user interface may display his contact information such as email, phone, etc. If a user wishes to make a payment to Joe P. by a method other than email, the user may add another transfer mode 3217j to his contact information and make a payment transfer. With reference to FIG. 32D, the user may be provided with a screen 3217k where the user can enter an amount to send Joe, as well as add other text to provide Joe with context for the payment transaction 32171. The user can choose modes (e.g., SMS, email, social networking) via which Joe may be contacted via graphical user interface elements, 3217m. As the user types, the text entered may be provided for review within a GUI element 3217n. When the user has completed entering in the necessary information, the user can press the send button 3217o to send the social message to Joe. If Joe also has a virtual wallet application, Joe may be able to review 3217p social pay message within the app, or directly at the website of the social network (e.g., for Twitter™, Facebook®, etc.). Messages may be aggregated from the various social networks and other sources (e.g., SMS, email). The method of redemption appropriate for each messaging mode may be indicated along with the social pay message. In the illustration in FIG. 32D, the SMS 3217q Joe received indicates that Joe can redeem the $5 obtained via SMS by replying to the SMS and entering the hash tag value ‘#1234’. In the same illustration, Joe has also received a message 3217r via Facebook®, which includes a URL link that Joe can activate to initiate redemption of the $25 payment.

With reference to FIG. 32E, in some other embodiments, a user may select merchants 3218 from the list of options in the shopping mode to view a select list of merchants 3218a-e. In one implementation, the merchants in the list may be affiliated to the wallet, or have affinity relationship with the wallet. In another implementation, the merchants may include a list of merchants meeting a user-defined or other criteria. For example, the list may be one that is curated by the user, merchants where the user most frequently shops or spends more than an x amount of sum or shopped for three consecutive months, and/or the like. In one implementation, the user may further select one of the merchants, Amazon 3218a for example. The user may then navigate through the merchant's listings to find items of interest such as 3218f-j. Directly through the wallet and without visiting the merchant site from a separate page, the user may make a selection of an item 3218j from the catalog of Amazon 3218a. As shown in the right most user interface of FIG. 32D, the selected item may then be added to cart. The message 3218k indicates that the selected item has been added to the cart, and updated number of items in the cart is now 13.

With reference to FIG. 32F, in one embodiment, there may be a local proximity option 3219 which may be selected by a user to view a list of merchants that are geographically in close proximity to the user. For example, the list of merchants 3219a-e may be the merchants that are located close to the user. In one implementation, the mobile application may further identify when the user in a store based on the user's location. For example, position icon 3219d may be displayed next to a store (e.g., Walgreens) when the user is in close proximity to the store. In one implementation, the mobile application may refresh its location periodically in case the user moved away from the store (e.g., Walgreens). In a further implementation, the user may navigate the offerings of the selected Walgreens store through the mobile application. For example, the user may navigate, using the mobile application, to items 3219f-j available on aisle 5 of Walgreens. In one implementation, the user may select corn 3219i from his or her mobile application to add to cart 3219k.

With reference to FIG. 32G, in another embodiment, the local proximity option 3219 may include a store map and a real time map features among others. For example, upon selecting the Walgreens store, the user may launch an aisle map 3219l which displays a map 3219m showing the organization of the store and the position of the user (indicated by a yellow circle). In one implementation, the user may easily configure the map to add one or more other users (e.g., user's kids) to share each other's location within the store. In another implementation, the user may have the option to launch a “store view” similar to street views in maps. The store view 3219n may display images/video of the user's surrounding. For example, if the user is about to enter aisle 5, the store view map may show the view of aisle 5. Further the user may manipulate the orientation of the map using the navigation tool 32190 to move the store view forwards, backwards, right, left as well clockwise and counterclockwise rotation

FIGS. 33A-F show user interface diagrams illustrating example features of virtual wallet applications in a payment mode, in some embodiments of the Ad-Track. With reference to FIG. 33A, in one embodiment, the wallet mobile application may provide a user with a number of options for paying for a transaction via the wallet mode 3310. In one implementation, an example user interface 3311 for making a payment is shown. The user interface may clearly identify the amount 3312 and the currency 3313 for the transaction. The amount may be the amount payable and the currency may include real currencies such as dollars and euros, as well as virtual currencies such as reward points. The amount of the transaction 3314 may also be prominently displayed on the user interface. The user may select the funds tab 3316 to select one or more forms of payment 3317, which may include various credit, debit, gift, rewards and/or prepaid cards. The user may also have the option of paying, wholly or in part, with reward points. For example, the graphical indicator 3318 on the user interface shows the number of points available, the graphical indicator 3319 shows the number of points to be used towards the amount due 234.56 and the equivalent 3320 of the number of points in a selected currency (USD, for example).

In one implementation, the user may combine funds from multiple sources to pay for the transaction. The amount 3315 displayed on the user interface may provide an indication of the amount of total funds covered so far by the selected forms of payment (e.g., Discover card and rewards points). The user may choose another form of payment or adjust the amount to be debited from one or more forms of payment until the amount 3315 matches the amount payable 3314. Once the amounts to be debited from one or more forms of payment are finalized by the user, payment authorization may begin.

In one implementation, the user may select a secure authorization of the transaction by selecting the cloak button 3322 to effectively cloak or anonymize some (e.g., pre-configured) or all identifying information such that when the user selects pay button 3321, the transaction authorization is conducted in a secure and anonymous manner. In another implementation, the user may select the pay button 3321 which may use standard authorization techniques for transaction processing. In yet another implementation, when the user selects the social button 3323, a message regarding the transaction may be communicated to one of more social networks (set up by the user) which may post or announce the purchase transaction in a social forum such as a wall post or a tweet. In one implementation, the user may select a social payment processing option 3323. The indicator 3324 may show the authorizing and sending social share data in progress.

In another implementation, a restricted payment mode 3325 may be activated for certain purchase activities such as prescription purchases. The mode may be activated in accordance with rules defined by issuers, insurers, merchants, payment processor and/or other entities to facilitate processing of specialized goods and services. In this mode, the user may scroll down the list of forms of payments 3326 under the funds tab to select specialized accounts such as a flexible spending account (FSA) 3327, health savings account (HAS), and/or the like and amounts to be debited to the selected accounts. In one implementation, such restricted payment mode 3325 processing may disable social sharing of purchase information.

In one embodiment, the wallet mobile application may facilitate importing of funds via the import funds user interface 3328. For example, a user who is unemployed may obtain unemployment benefit fund 3329 via the wallet mobile application. In one implementation, the entity providing the funds may also configure rules for using the fund as shown by the processing indicator message 3330. The wallet may read and apply the rules prior, and may reject any purchases with the unemployment funds that fail to meet the criteria set by the rules. Example criteria may include, for example, merchant category code (MCC), time of transaction, location of transaction, and/or the like. As an example, a transaction with a grocery merchant having MCC 5411 may be approved, while a transaction with a bar merchant having an MCC 5813 may be refused.

With reference to FIG. 33B, in one embodiment, the wallet mobile application may facilitate dynamic payment optimization based on factors such as user location, preferences and currency value preferences among others. For example, when a user is in the United States, the country indicator 3331 may display a flag of the United States and may set the currency 3333 to the United States. In a further implementation, the wallet mobile application may automatically rearrange the order in which the forms of payments 3335 are listed to reflect the popularity or acceptability of various forms of payment. In one implementation, the arrangement may reflect the user's preference, which may not be changed by the wallet mobile application.

Similarly, when a German user operates a wallet in Germany, the mobile wallet application user interface may be dynamically updated to reflect the country of operation 3332 and the currency 3334. In a further implementation, the wallet application may rearrange the order in which different forms of payment 3336 are listed based on their acceptance level in that country. Of course, the order of these forms of payments may be modified by the user to suit his or her own preferences.

With reference to FIG. 33C, in one embodiment, the payee tab 3337 in the wallet mobile application user interface may facilitate user selection of one or more payees receiving the funds selected in the funds tab. In one implementation, the user interface may show a list of all payees 3338 with whom the user has previously transacted or available to transact. The user may then select one or more payees. The payees 3338 may include larger merchants such as Amazon.com Inc., and individuals such as Jane P. Doe. Next to each payee name, a list of accepted payment modes for the payee may be displayed. In one implementation, the user may select the payee Jane P. Doe 3339 for receiving payment. Upon selection, the user interface may display additional identifying information relating to the payee.

With reference to FIG. 33D, in one embodiment, the mode tab 3340 may facilitate selection of a payment mode accepted by the payee. A number of payment modes may be available for selection. Example modes include, blue tooth 3341, wireless 3342, snap mobile by user-obtained QR code 3343, secure chip 3344, TWITTER 3345, near-field communication (NFC) 3346, cellular 3347, snap mobile by user-provided QR code 3348, USB 3349 and FACEBOOK 3350, among others. In one implementation, only the payment modes that are accepted by the payee may be selectable by the user. Other non-accepted payment modes may be disabled.

With reference to FIG. 33E, in one embodiment, the offers tab 3351 may provide real-time offers that are relevant to items in a user's cart for selection by the user. The user may select one or more offers from the list of applicable offers 3352 for redemption. In one implementation, some offers may be combined, while others may not. When the user selects an offer that may not be combined with another offer, the unselected offers may be disabled. In a further implementation, offers that are recommended by the wallet application's recommendation engine may be identified by an indicator, such as the one shown by 3353. In a further implementation, the user may read the details of the offer by expanding the offer row as shown by 3354 in the user interface.

With reference to FIG. 33F, in one embodiment, the social tab 3355 may facilitate integration of the wallet application with social channels 3356. In one implementation, a user may select one or more social channels 3356 and may sign in to the selected social channel from the wallet application by providing to the wallet application the social channel user name and password 3357 and signing in 3358. The user may then use the social button 3359 to send or receive money through the integrated social channels. In a further implementation, the user may send social share data such as purchase information or links through integrated social channels. In another embodiment, the user supplied login credentials may allow Ad-Track to engage in interception parsing.

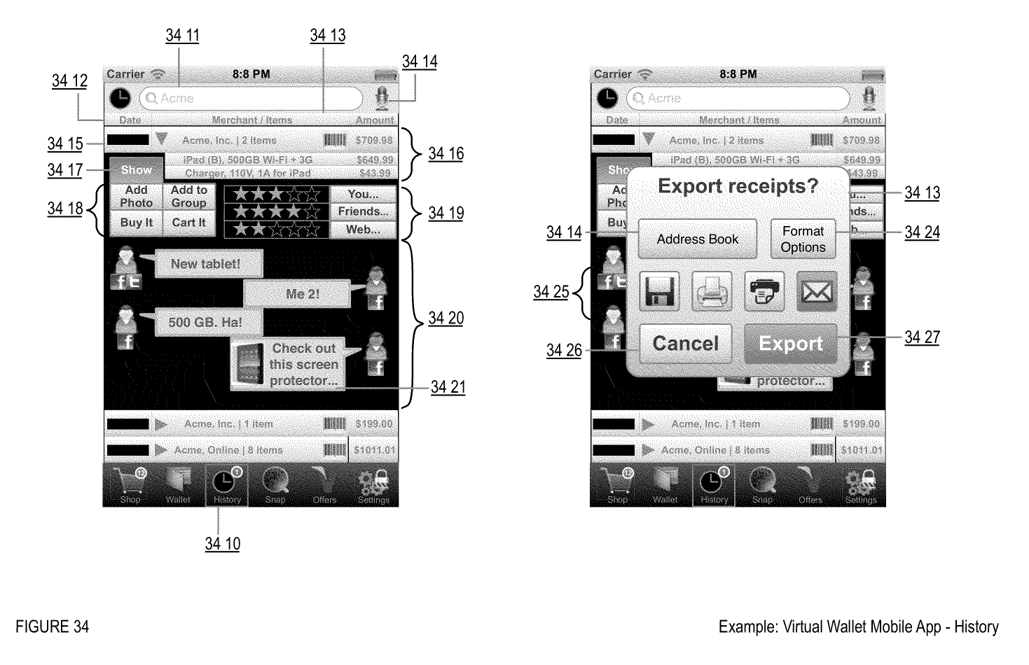

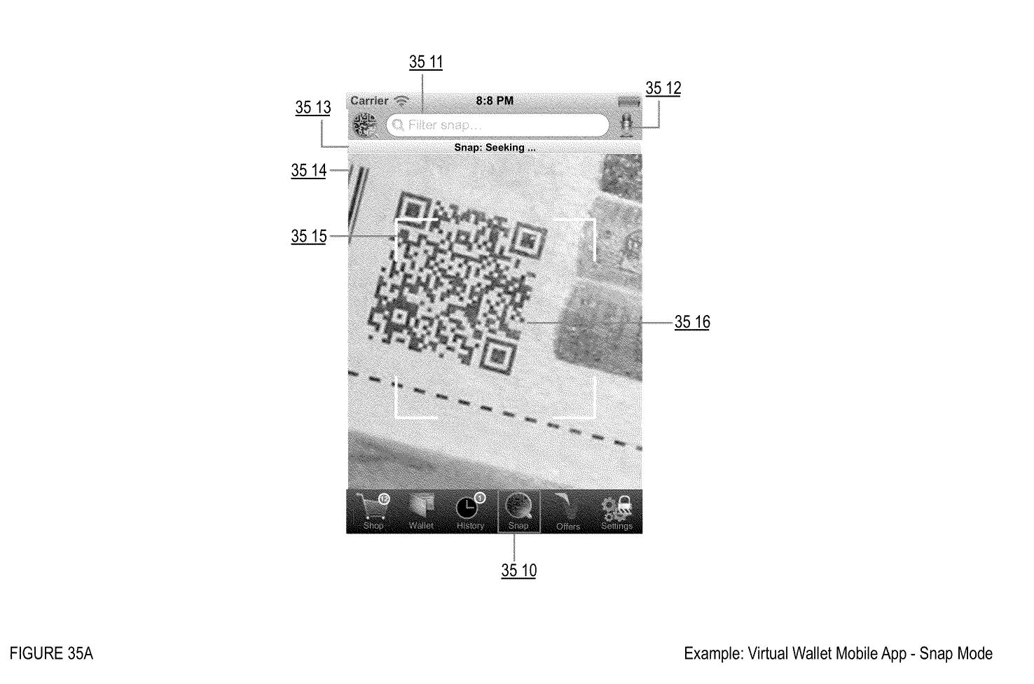

FIG. 34 shows a user interface diagram illustrating example features of virtual wallet applications, in a history mode, in some embodiments of the Ad-Track. In one embodiment, a user may select the history mode 3410 to view a history of prior purchases and perform various actions on those prior purchases. For example, a user may enter a merchant identifying information such as name, product, MCC, and/or the like in the search bar 3411. In another implementation, the user may use voice activated search feature by clicking on the microphone icon 3414. The wallet application may query the storage areas in the mobile device or elsewhere (e.g., one or more databases and/or tables remote from the mobile device) for transactions matching the search keywords. The user interface may then display the results of the query such as transaction 3415. The user interface may also identify the date 3412 of the transaction, the merchants and items 3413 relating to the transaction, a barcode of the receipt confirming that a transaction was made, the amount of the transaction and any other relevant information.

In one implementation, the user may select a transaction, for example transaction 3415, to view the details of the transaction. For example, the user may view the details of the items associated with the transaction and the amounts 3416 of each item. In a further implementation, the user may select the show option 3417 to view actions 3418 that the user may take in regards to the transaction or the items in the transaction. For example, the user may add a photo to the transaction (e.g., a picture of the user and the iPad the user bought). In a further implementation, if the user previously shared the purchase via social channels, a post including the photo may be generated and sent to the social channels for publishing. In one implementation, any sharing may be optional, and the user, who did not share the purchase via social channels, may still share the photo through one or more social channels of his or her choice directly from the history mode of the wallet application. In another implementation, the user may add the transaction to a group such as company expense, home expense, travel expense or other categories set up by the user. Such grouping may facilitate year-end accounting of expenses, submission of work expense reports, submission for value added tax (VAT) refunds, personal expenses, and/or the like. In yet another implementation, the user may buy one or more items purchased in the transaction. The user may then execute a transaction without going to the merchant catalog or site to find the items. In a further implementation, the user may also cart one or more items in the transaction for later purchase.

The history mode, in another embodiment, may offer facilities for obtaining and displaying ratings 3419 of the items in the transaction. The source of the ratings may be the user, the user's friends (e.g., from social channels, contacts, etc.), reviews aggregated from the web, and/or the like. The user interface in some implementations may also allow the user to post messages to other users of social channels (e.g., TWITTER or FACEBOOK). For example, the display area 3420 shows FACEBOOK message exchanges between two users. In one implementation, a user may share a link via a message 3421. Selection of such a message having embedded link to a product may allow the user to view a description of the product and/or purchase the product directly from the history mode.

In one embodiment, the history mode may also include facilities for exporting receipts. The export receipts pop up 3422 may provide a number of options for exporting the receipts of transactions in the history. For example, a user may use one or more of the options 3425, which include save (to local mobile memory, to server, to a cloud account, and/or the like), print to a printer, fax, email, and/or the like. The user may utilize his or her address book 3423 to look up email or fax number for exporting. The user may also specify format options 3424 for exporting receipts. Example format options may include, without limitation, text files (.doc, .txt, .rtf, iif, etc.), spreadsheet (.csv, .xls, etc.), image files (.jpg, .tff, .png, etc.), portable document format (.pdf), postscript (.ps), and/or the like. The user may then click or tap the export button 3427 to initiate export of receipts.

FIGS. 35A-E show user interface diagrams illustrating example features of virtual wallet applications in a snap mode, in some embodiments of the Ad-Track. With reference to FIG. 35A, in one embodiment, a user may select the snap mode 2110 to access its snap features. The snap mode may handle any machine-readable representation of data. Examples of such data may include linear and 2D bar codes such as UPC code and QR codes. These codes may be found on receipts, product packaging, and/or the like. The snap mode may also process and handle pictures of receipts, products, offers, credit cards or other payment devices, and/or the like. An example user interface in snap mode is shown in FIG. 35A. A user may use his or her mobile phone to take a picture of a QR code 3515 and/or a barcode 3514. In one implementation, the bar 3513 and snap frame 3515 may assist the user in snapping codes properly. For example, the snap frame 3515, as shown, does not capture the entirety of the code 3516. As such, the code captured in this view may not be resolvable as information in the code may be incomplete. This is indicated by the message on the bar 3513 that indicates that the snap mode is still seeking the code. When the code 3516 is completely framed by the snap frame 3515, the bar message may be updated to, for example, “snap found.” Upon finding the code, in one implementation, the user may initiate code capture using the mobile device camera. In another implementation, the snap mode may automatically snap the code using the mobile device camera.

With reference to FIG. 35B, in one embodiment, the snap mode may facilitate payment reallocation post transaction. For example, a user may buy grocery and prescription items from a retailer Acme Supermarket. The user may, inadvertently or for ease of checkout for example, use his or her Visa card to pay for both grocery and prescription items. However, the user may have an FSA account that could be used to pay for prescription items, and which would provide the user tax benefits. In such a situation, the user may use the snap mode to initiate transaction reallocation.

As shown, the user may enter a search term (e.g., bills) in the search bar 2121. The user may then identify in the tab 3522 the receipt 3523 the user wants to reallocate. Alternatively, the user may directly snap a picture of a barcode on a receipt, and the snap mode may generate and display a receipt 3523 using information from the barcode. The user may now reallocate 3525. In some implementations, the user may also dispute the transaction 3524 or archive the receipt 3526.

In one implementation, when the reallocate button 3525 is selected, the wallet application may perform optical character recognition (OCR) of the receipt. Each of the items in the receipt may then be examined to identify one or more items which could be charged to which payment device or account for tax or other benefits such as cash back, reward points, etc. In this example, there is a tax benefit if the prescription medication charged to the user's Visa card is charged to the user's FSA. The wallet application may then perform the reallocation as the back end. The reallocation process may include the wallet contacting the payment processor to credit the amount of the prescription medication to the Visa card and debit the same amount to the user's FSA account. In an alternate implementation, the payment processor (e.g., Visa or MasterCard) may obtain and OCR the receipt, identify items and payment accounts for reallocation and perform the reallocation. In one implementation, the wallet application may request the user to confirm reallocation of charges for the selected items to another payment account. The receipt 3527 may be generated after the completion of the reallocation process. As discussed, the receipt shows that some charges have been moved from the Visa account to the FSA.

With reference to FIG. 35C, in one embodiment, the snap mode may facilitate payment via pay code such as barcodes or QR codes. For example, a user may snap a QR code of a transaction that is not yet complete. The QR code may be displayed at a merchant POS terminal, a web site, or a web application and may be encoded with information identifying items for purchase, merchant details and other relevant information. When the user snaps such as a QR code, the snap mode may decode the information in the QR code and may use the decoded information to generate a receipt 3532. Once the QR code is identified, the navigation bar 3531 may indicate that the pay code is identified. The user may now have an option to add to cart 3533, pay with a default payment account 3534 or pay with wallet 3535.

In one implementation, the user may decide to pay with default 3534. The wallet application may then use the user's default method of payment, in this example the wallet, to complete the purchase transaction. Upon completion of the transaction, a receipt may be automatically generated for proof of purchase. The user interface may also be updated to provide other options for handling a completed transaction. Example options include social 3537 to share purchase information with others, reallocate 3538 as discussed with regard to FIG. 35B, and archive 3539 to store the receipt.

With reference to FIG. 35D, in one embodiment, the snap mode may also facilitate offer identification, application and storage for future use. For example, in one implementation, a user may snap an offer code 3541 (e.g., a bar code, a QR code, and/or the like). The wallet application may then generate an offer text 3542 from the information encoded in the offer code. The user may perform a number of actions on the offer code. For example, the user use the find button 3543 to find all merchants who accept the offer code, merchants in the proximity who accept the offer code, products from merchants that qualify for the offer code, and/or the like. The user may also apply the offer code to items that are currently in the cart using the add to cart button 3544. Furthermore, the user may also save the offer for future use by selecting the save button 3545.

In one implementation, after the offer or coupon 3546 is applied, the user may have the option to find qualifying merchants and/or products using find, the user may go to the wallet using 3548, and the user may also save the offer or coupon 3546 for later use.

With reference to FIG. 35E, in one embodiment, the snap mode may also offer facilities for adding a funding source to the wallet application. In one implementation, a pay card such as a credit card, debit card, pre-paid card, smart card and other pay accounts may have an associated code such as a bar code or QR code. Such a code may have encoded therein pay card information including, but not limited to, name, address, pay card type, pay card account details, balance amount, spending limit, rewards balance, and/or the like. In one implementation, the code may be found on a face of the physical pay card. In another implementation, the code may be obtained by accessing an associated online account or another secure location. In yet another implementation, the code may be printed on a letter accompanying the pay card. A user, in one implementation, may snap a picture of the code. The wallet application may identify the pay card 3551 and may display the textual information 3552 encoded in the pay card. The user may then perform verification of the information 3552 by selecting the verify button 3553. In one implementation, the verification may include contacting the issuer of the pay card for confirmation of the decoded information 3552 and any other relevant information. In one implementation, the user may add the pay card to the wallet by selecting the ‘add to wallet’ button 3554. The instruction to add the pay card to the wallet may cause the pay card to appear as one of the forms of payment under the funds tab 3316 discussed in FIG. 33A. The user may also cancel importing of the pay card as a funding source by selecting the cancel button 3555. When the pay card has been added to the wallet, the user interface may be updated to indicate that the importing is complete via the notification display 3556. The user may then access the wallet 3557 to begin using the added pay card as a funding source.

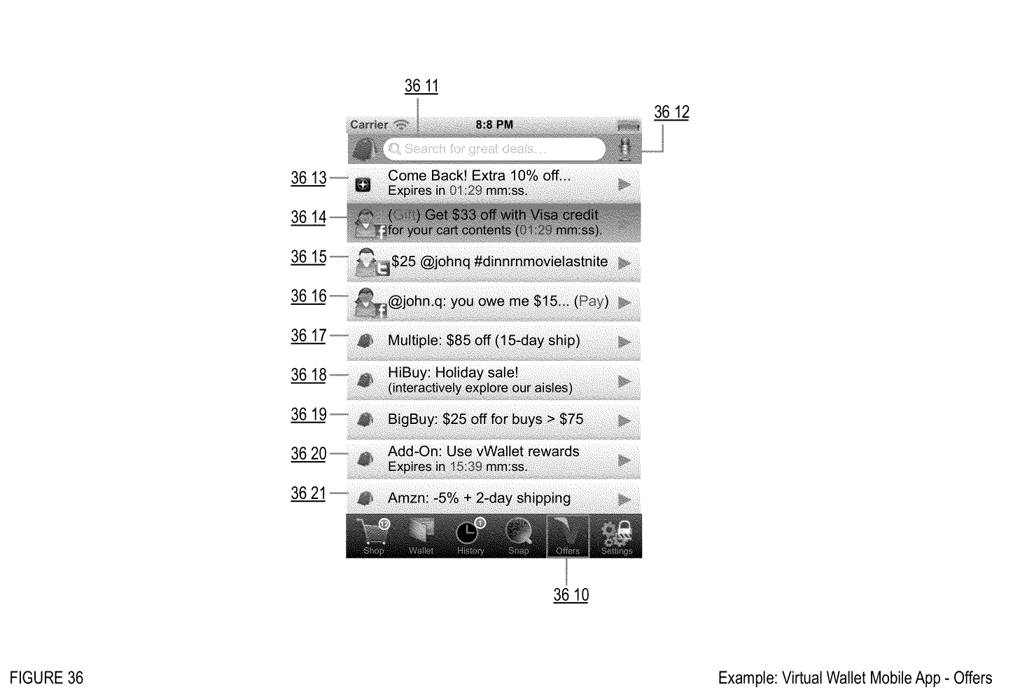

FIG. 36 shows a user interface diagram illustrating example features of virtual wallet applications, in an offers mode, in some embodiments of the Ad-Track. In some implementations, the Ad-Track may allow a user to search for offers for products and/or services from within the virtual wallet mobile application. For example, the user may enter text into a graphical user interface (“GUI”) element 3611, or issue voice commands by activating GUI element 3612 and speaking commands into the device. In some implementations, the Ad-Track may provide offers based on the user's prior behavior, demographics, current location, current cart selection or purchase items, and/or the like. For example, if a user is in a brick-and-mortar store, or an online shopping website, and leaves the (virtual) store, then the merchant associated with the store may desire to provide a sweetener deal to entice the consumer back into the (virtual) store. The merchant may provide such an offer 3613. For example, the offer may provide a discount, and may include an expiry time. In some implementations, other users may provide gifts (e.g., 3614) to the user, which the user may redeem. In some implementations, the offers section may include alerts as to payment of funds outstanding to other users (e.g., 3615). In some implementations, the offers section may include alerts as to requesting receipt of funds from other users (e.g., 3616). For example, such a feature may identify funds receivable from other applications (e.g., mail, calendar, tasks, notes, reminder programs, alarm, etc.), or by a manual entry by the user into the virtual wallet application. In some implementations, the offers section may provide offers from participating merchants in the Ad-Track, e.g., 3617-3619, 3620. These offers may sometimes be assembled using a combination of participating merchants, e.g., 3617. In some implementations, the Ad-Track itself may provide offers for users contingent on the user utilizing particular payment forms from within the virtual wallet application, e.g., 3620.

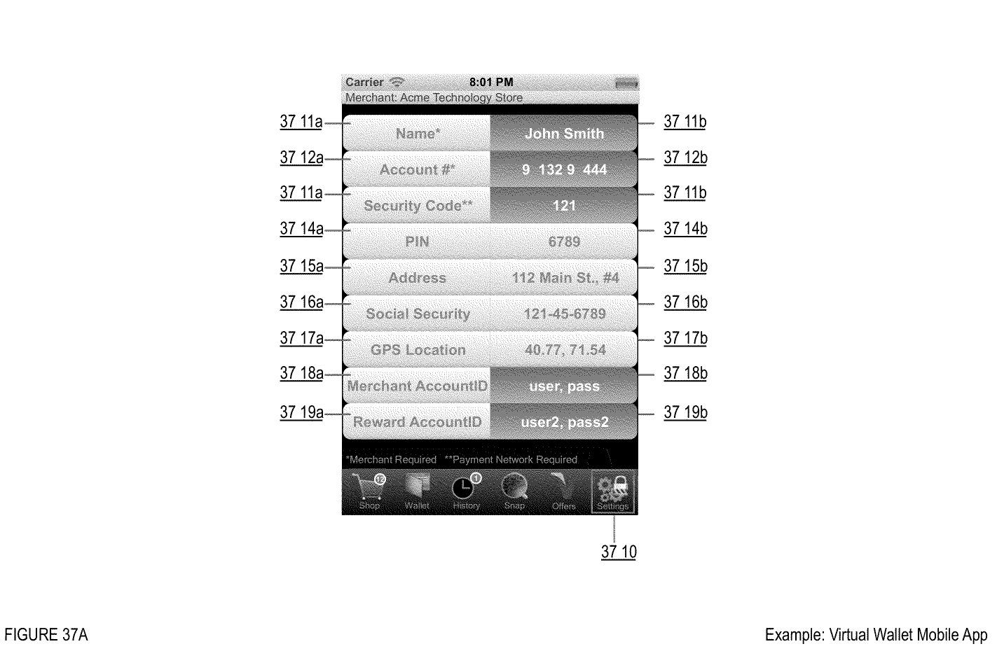

FIGS. 37A-B show user interface diagrams illustrating example features of virtual wallet applications, in a security and privacy mode, in some embodiments of the Ad-Track. With reference to FIG. 37A, in some implementations, the user may be able to view and/or modify the user profile and/or settings of the user, e.g., by activating a user interface element. For example, the user may be able to view/modify a user name (e.g., 3711a-b), account number (e.g., 3712a-b), user security access code (e.g., 3713-b), user pin (e.g., 3714-b), user address (e.g., 3715-b), social security number associated with the user (e.g., 3716-b), current device GPS location (e.g., 3717-b), user account of the merchant in whose store the user currently is (e.g., 3718-b), the user's rewards accounts (e.g., 3719-b), and/or the like. In some implementations, the user may be able to select which of the data fields and their associated values should be transmitted to facilitate the purchase transaction, thus providing enhanced data security for the user. For example, in the example illustration in FIG. 37A, the user has selected the name 3711a, account number 3712a, security code 3713a, merchant account ID 3718a and rewards account ID 3719a as the fields to be sent as part of the notification to process the purchase transaction. In some implementations, the user may toggle the fields and/or data values that are sent as part of the notification to process the purchase transactions. In some implementations, the app may provide multiple screens of data fields and/or associated values stored for the user to select as part of the purchase order transmission. In some implementations, the app may provide the Ad-Track with the GPS location of the user. Based on the GPS location of the user, the Ad-Track may determine the context of the user (e.g., whether the user is in a store, doctor's office, hospital, postal service office, etc.). Based on the context, the user app may present the appropriate fields to the user, from which the user may select fields and/or field values to send as part of the purchase order transmission.

For example, a user may go to doctor's office and desire to pay the co-pay for doctor's appointment. In addition to basic transactional information such as account number and name, the app may provide the user the ability to select to transfer medical records, health information, which may be provided to the medical provider, insurance company, as well as the transaction processor to reconcile payments between the parties. In some implementations, the records may be sent in a Health Insurance Portability and Accountability Act (HIPAA)-compliant data format and encrypted, and only the recipients who are authorized to view such records may have appropriate decryption keys to decrypt and view the private user information.

With reference to FIG. 37B, in some implementations, the app executing on the user's device may provide a “VerifyChat” feature for fraud prevention. For example, the Ad-Track may detect an unusual and/or suspicious transaction. The Ad-Track may utilize the VerifyChat feature to communicate with the user, and verify the authenticity of the originator of the purchase transaction. In various implementations, the Ad-Track may send electronic mail message, text (SMS) messages, Facebook® messages, Twitter™ tweets, text chat, voice chat, video chat (e.g., Apple FaceTime), and/or the like to communicate with the user. For example, the Ad-Track may initiate a video challenge for the user, e.g., 3721. For example, the user may need to present him/her-self via a video chat, e.g., 3722. In some implementations, a customer service representative, e.g., agent 3724, may manually determine the authenticity of the user using the video of the user. In some implementations, the Ad-Track may utilize face, biometric and/or like recognition (e.g., using pattern classification techniques) to determine the identity of the user. In some implementations, the app may provide reference marker (e.g., cross-hairs, target box, etc.), e.g., 3723, so that the user may the video to facilitate the Ad-Track's automated recognition of the user. In some implementations, the user may not have initiated the transaction, e.g., the transaction is fraudulent. In such implementations, the user may cancel the challenge. The Ad-Track may then cancel the transaction, and/or initiate fraud investigation procedures on behalf of the user.

In some implementations, the Ad-Track may utilize a text challenge procedure to verify the authenticity of the user, e.g., 3725. For example, the Ad-Track may communicate with the user via text chat, SMS messages, electronic mail, Facebook® messages, Twitter™ tweets, and/or the like. The Ad-Track may pose a challenge question, e.g., 3726, for the user. The app may provide a user input interface element(s) (e.g., virtual keyboard 3728) to answer the challenge question posed by the Ad-Track. In some implementations, the challenge question may be randomly selected by the Ad-Track automatically; in some implementations, a customer service representative may manually communicate with the user. In some implementations, the user may not have initiated the transaction, e.g., the transaction is fraudulent. In such implementations, the user may cancel the text challenge. The Ad-Track may cancel the transaction, and/or initiate fraud investigation on behalf of the user.

FIG. 38 shows a datagraph diagram illustrating example aspects of transforming a user checkout request input via a User Purchase Checkout (“UPC”) component into a checkout data display. In some embodiments, a user, e.g., 3801a, may desire to purchase a product, service, offering, and/or the like (“product”), from a merchant via a merchant online site or in the merchant's store. The user may communicate with a merchant/acquirer (“merchant”) server, e.g., 3803a, via a client such as, but not limited to: a personal computer, mobile device, television, point-of-sale terminal, kiosk, ATM, and/or the like (e.g., 3802). For example, the user may provide user input, e.g., checkout input 3811, into the client indicating the user's desire to purchase the product. In various embodiments, the user input may include, but not be limited to: a single tap (e.g., a one-tap mobile app purchasing embodiment) of a touchscreen interface, keyboard entry, card swipe, activating a RFID/NFC equipped hardware device (e.g., electronic card having multiple accounts, smartphone, tablet, etc.) within the user device, mouse clicks, depressing buttons on a joystick/game console, voice commands, single/multi-touch gestures on a touch-sensitive interface, touching user interface elements on a touch-sensitive display, and/or the like. As an example, a user in a merchant store may scan a product barcode of the product via a barcode scanner at a point-of-sale terminal. As another example, the user may select a product from a webpage catalog on the merchant's website, and add the product to a virtual shopping cart on the merchant's website. The user may then indicate the user's desire to checkout the items in the (virtual) shopping cart. For example, the user may activate a user interface element provided by the client to indicate the user's desire to complete the user purchase checkout. The client may generate a checkout request, e.g., 3812, and provide the checkout request, e.g., 3813, to the merchant server. For example, the client may provide a (Secure) Hypertext Transfer Protocol (“HTTP(S)”) POST message including the product details for the merchant server in the form of data formatted according to the eXtensible Markup Language (“XML”). An example listing of a checkout request 3812, substantially in the form of a HTTP(S) POST message including XML-formatted data, is provided below:

POST /checkoutrequest.php HTTP/1.1
Host: www.merchant.com
Content-Type: Application/XML
Content-Length: 667
<?XML version = “1.0” encoding = “UTF-8”?>
<checkout_request>

<session_ID>4NFU4RG94</session_ID>

<!--optional parameters-->

<timestamp>2011-02-22 15:22:41</timestamp>
<user_ID>john.q.public@gmail.com</user_ID>
<device_fingerprint>

<device_IP>192.168.23.126</device_IP>
<device_MAC>0123.4567.89ab</device_MAC>
<device_serial>312456768798765432</device_serial>
<device_ECID>00000AEBCDF12345</device_ECID>
<device_identifier>jqp_air</device_identifier>
<device_UDID>21343e34-14f4-8jn4-7yfe-124578632134</device_UDID>
<device_browser>firefox 2.2</device_browser>
<device_type>smartphone</device_type>
<device_model>HTC Hero</device_model>
<OS>Android 2.2</OS>
<wallet_app_installed_flag>true</wallet_app_installed_flag>

</device_fingerprint>

</checkout_request>

In some embodiments, the merchant server may obtain the checkout request from the client, and extract the checkout detail (e.g., XML data) from the checkout request. For example, the merchant server may utilize a parser such as the example parsers described below in the discussion with reference to FIG. 44. Based on parsing the checkout request 3812, the merchant server may extract product data (e.g., product identifiers), as well as available PoS client data, from the checkout request. In some embodiments, using the product data, the merchant server may query, e.g., 3814, a merchant/acquirer (“merchant”) database, e.g., 3803b, to obtain product data, e.g., 3815, such as product information, product pricing, sales tax, offers, discounts, rewards, and/or other information to process the purchase transaction and/or provide value-added services for the user. For example, the merchant database may be a relational database responsive to Structured Query Language (“SQL”) commands. The merchant server may execute a hypertext preprocessor (“PHP”) script including SQL commands to query a database table (such as FIG. 44, Products 4419l) for product data. An example product data query 3814, substantially in the form of PHP/SQL commands, is provided below:

<?PHP
header(′Content-Type: text/plain′);
mysql_connect(“254.93.179.112”,$DBserver,$password); // access
database server
mysql_select_db(“Ad-Track_DB.SQL”); // select database table to search
//create query
$query = “SELECT product_title product_attributes_list product_price

tax_info_list related_products_list offers_list discounts_list
rewards_list
merchants_list merchant_availability_list FROM ProductsTable
WHERE
product_ID LIKE ′%′ $prodID”;

$result = mysql_query($query); // perform the search query
mysql_close(“Ad-Track_DB.SQL”); // close database access
?>

In some embodiments, in response to obtaining the product data, the merchant server may generate, e.g., 3816, checkout data to provide for the PoS client. In some embodiments, such checkout data, e.g., 3817, may be embodied, in part, in a HyperText Markup Language (“HTML”) page including data for display, such as product detail, product pricing, total pricing, tax information, shipping information, offers, discounts, rewards, value-added service information, etc., and input fields to provide payment information to process the purchase transaction, such as account holder name, account number, billing address, shipping address, tip amount, etc. In some embodiments, the checkout data may be embodied, in part, in a Quick Response (“QR”) code image that the PoS client can display, so that the user may capture the QR code using a user's device to obtain merchant and/or product data for generating a purchase transaction processing request. In some embodiments, a user alert mechanism may be built into the checkout data. For example, the merchant server may embed a URL specific to the transaction into the checkout data. In some embodiments, the alerts URL may further be embedded into optional level 3 data in card authorization requests, such as those discussed further below with reference to FIGS. 40-41. The URL may point to a webpage, data file, executable script, etc., stored on the merchant's server dedicated to the transaction that is the subject of the card authorization request. For example, the object pointed to by the URL may include details on the purchase transaction, e.g., products being purchased, purchase cost, time expiry, status of order processing, and/or the like. Thus, the merchant server may provide to the payment network the details of the transaction by passing the URL of the webpage to the payment network. In some embodiments, the payment network may provide notifications to the user, such as a payment receipt, transaction authorization confirmation message, shipping notification and/or the like. In such messages, the payment network may provide the URL to the user device. The user may navigate to the URL on the user's device to obtain alerts regarding the user's purchase, as well as other information such as offers, coupons, related products, rewards notifications, and/or the like. An example listing of a checkout data 3817, substantially in the form of XML-formatted data, is provided below:

<?XML version = “1.0” encoding = “UTF-8”?>
<checkout_data>

<session_ID>4NFU4RG94</session_ID>
<!--optional data-->
<timestamp>2011-02-22 15:22:43</timestamp>
<expiry_lapse>00:00:30</expiry_lapse>
<total_cost>$121.49</total_cost>
<alerts_URL>www.merchant.com/shopcarts.php?sessionID=4NFU4RG94</alerts_URL>
<user_ID>john.q.public@gmail.com</user_ID>
<user_device_fingerprint>

<device_IP>192.168.23.126</device_IP>
<device_MAC>0123.4567.89ab</device_MAC>
<device_serial>312456768798765432</device_serial>
<device_ECID>00000AEBCDF12345</device_ECID>
<device_identifier>jqp_air</device_identifier>
<device_UDID>21343e34-14f4-8jn4-7yfe-124578632134</device_UDID>
<device_browser>firefox 2.2</device_browser>
<device_type>smartphone</device_type>
<device_model>HTC Hero</device_model>
<OS>Android 2.2</OS>
<wallet_app_installed_flag>true</wallet_app_installed_flag>

</user_device_fingerprint>
<purchase_detail>

<cart>

<product>

<merchant_params>

<merchant_id>54TBRELF8</merchant_id>
<merchant_name>BARNES, Inc.</merchant_name>
<merchant_auth_key>TMN45GER98</merchant_auth_key>

</merchant_params>
<product_type>book</product_type>
<product_params>

<product_title>XML for dummies</product_title>
<ISBN>938-2-14-168710-0</ISBN>
<edition>2nd ed.</edition>
<cover>hardbound</cover>

</product_params>
<quantity>2</quantity>
<unit_cost>$14.46</unit_cost>
<coupon_id>AY34567</coupon_id>

<social_flag>ON</social_flag>
<social_message>Look what I bought today!</social_message>
<social_networks>facebook twitter</social_networks>
</product>
<product>

<merchant_params>

<merchant_id>3FBCR4INC</merchant_id>
<merchant_name>Books, Inc.</merchant_name>
<merchant_auth_key>1N484MCP</merchant_auth_key>

</merchant_params>
<product_type>book</product_type>
<product_params>

<product_title>Sophie's World</product_title>
<ISBN>955-2-14-112310-0</ISBN>
<edition>NULL</edition>
<cover>hardbound</cover>

</product_params>
<quantity>1</quantity>
<unit_cost>$34.78</unit_cost>
<coupon_id>null</coupon_id>

<social_flag>OFF</social_flag>
</product>

</cart>
<cart>

<product>

<merchant_params>

<merchant_id>RFH5IB4FT</merchant_id>
<merchant_name>Amzn, Inc.</merchant_name>
<merchant_auth_key>44543DSJFG</merchant_auth_key>

</merchant_params>
<product_type>book</product_type>
<product_params>

<product_title>XML - a primer</product_title>
<ISBN>938-2-14-1436710-0</ISBN>
<edition>2nd ed.</edition>
<cover>hardbound</cover>

</product_params>
<quantity>1</quantity>
<unit_cost>$12.93</unit_cost>
<coupon_id>AY34567</coupon_id>

<social_flag>ON</social_flag>
<social_message>Look what I bought today!</social_message>
<social_networks>facebook twitter</social_networks>
</product>
<product>

<merchant_params>

<merchant_id>3FBCR4INC</merchant_id>
<merchant_name>BestBooks, Inc.</merchant_name>
<merchant_auth_key>1N484MCP</merchant_auth_key>

</merchant_params>
<product_type>book</product_type>
<product_params>

<product_title>Sophie's Choice</product_title>
<ISBN>938-2-14-168710-0</ISBN>
<edition>1st ed.</edition>

</product_params>
<quantity>1</quantity>
<unit_cost>$44.86</unit_cost>
<coupon_id>null</coupon_id>

<social_flag>OFF</social_flag>
</product>

</cart>

</purchase_detail>

<checkout_data>

Upon obtaining the checkout data, e.g., 3817, the PoS client may render and display, e.g., 3818, the checkout data for the user.

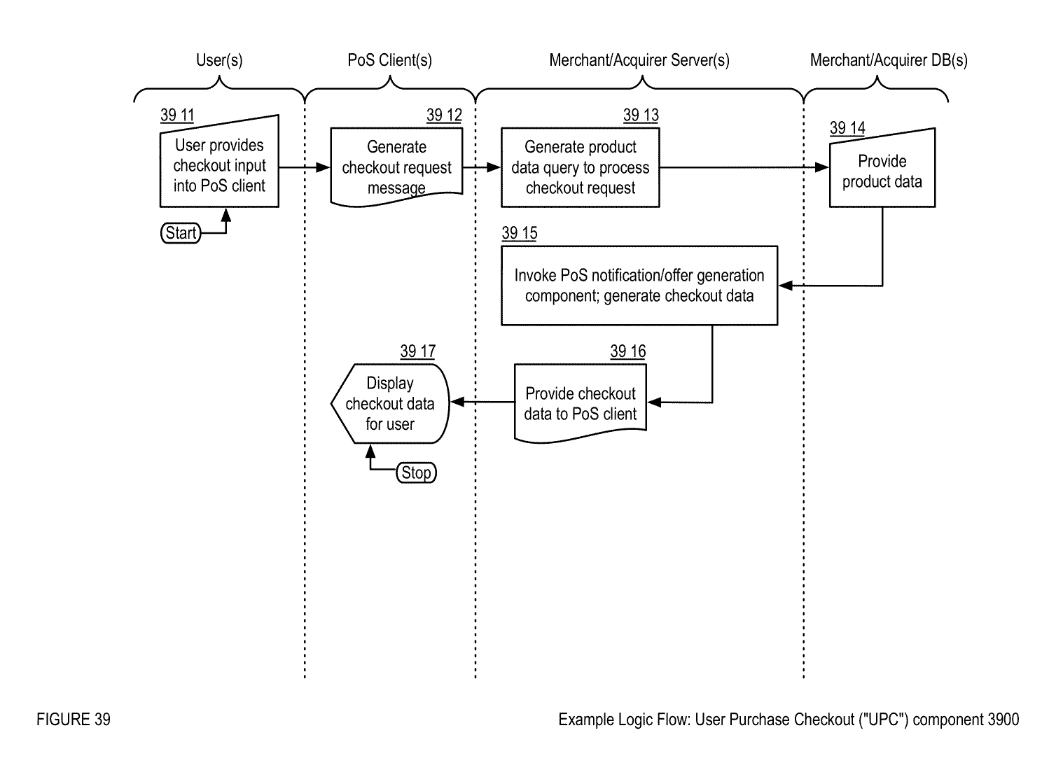

FIG. 39 shows a logic flow diagram illustrating example aspects of transforming a user checkout request input via a User Purchase Checkout (“UPC”) component into a checkout data display. In some embodiments, a user may desire to purchase a product, service, offering, and/or the like (“product”), from a merchant via a merchant online site or in the merchant's store. The user may communicate with a merchant/acquirer (“merchant”) server via a PoS client. For example, the user may provide user input, e.g., 3901, into the client indicating the user's desire to purchase the product. The client may generate a checkout request, e.g., 3902, and provide the checkout request to the merchant server. In some embodiments, the merchant server may obtain the checkout request from the client, and extract the checkout detail (e.g., XML data) from the checkout request. For example, the merchant server may utilize a parser such as the example parsers described below in the discussion with reference to FIG. 44. Based on parsing the checkout request, the merchant server may extract product data (e.g., product identifiers), as well as available PoS client data, from the checkout request. In some embodiments, using the product data, the merchant server may query, e.g., 3903, a merchant/acquirer (“merchant”) database to obtain product data, e.g., 3904, such as product information, product pricing, sales tax, offers, discounts, rewards, and/or other information to process the purchase transaction and/or provide value-added services for the user. In some embodiments, in response to obtaining the product data, the merchant server may generate, e.g., 3905, checkout data to provide, e.g., 3906, for the PoS client. Upon obtaining the checkout data, the PoS client may render and display, e.g., 3907, the checkout data for the user.

FIGS. 40A-B show datagraph diagrams illustrating example aspects of transforming a user virtual wallet access input via a Purchase Transaction Authorization (“PTA”) component into a purchase transaction receipt notification. With reference to FIG. 40A, in some embodiments, a user, e.g., 4001a, may wish to utilize a virtual wallet account to purchase a product, service, offering, and/or the like (“product”), from a merchant via a merchant online site or in the merchant's store. The user may utilize a physical card, or a user wallet device, e.g., 4001b, to access the user's virtual wallet account. For example, the user wallet device may be a personal/laptop computer, cellular telephone, smartphone, tablet, eBook reader, netbook, gaming console, and/or the like. The user may provide a wallet access input, e.g., 4011 into the user wallet device. In various embodiments, the user input may include, but not be limited to: a single tap (e.g., a one-tap mobile app purchasing embodiment) of a touchscreen interface, keyboard entry, card swipe, activating a RFID/NFC equipped hardware device (e.g., electronic card having multiple accounts, smartphone, tablet, etc.) within the user device, mouse clicks, depressing buttons on a joystick/game console, voice commands, single/multi-touch gestures on a touch-sensitive interface, touching user interface elements on a touch-sensitive display, and/or the like. In some embodiments, the user wallet device may authenticate the user based on the user's wallet access input, and provide virtual wallet features for the user.

In some embodiments, upon authenticating the user for access to virtual wallet features, the user wallet device may provide a transaction authorization input, e.g., 4014, to a point-of-sale (“PoS”) client, e.g., 4002. For example, the user wallet device may communicate with the PoS client via Bluetooth, Wi-Fi, cellular communication, one- or two-way near-field communication (“NFC”), and/or the like. In embodiments where the user utilizes a plastic card instead of the user wallet device, the user may swipe the plastic card at the PoS client to transfer information from the plastic card into the PoS client. For example, the PoS client may obtain, as transaction authorization input 4014, track 1 data from the user's plastic card (e.g., credit card, debit card, prepaid card, charge card, etc.), such as the example track 1 data provided below:

%B123456789012345\hat{ }PUBLIC/J.Q.\hat{ }99011200000000000000**901******?*
(wherein ‘123456789012345’ is the card number of ‘J.Q. Public’ and has a CVV

number of 901. ‘990112’ is a service code, and *** represents decimal digits
which change randomly each time the card is used.)

In embodiments where the user utilizes a user wallet device, the user wallet device may provide payment information to the PoS client, formatted according to a data formatting protocol appropriate to the communication mechanism employed in the communication between the user wallet device and the PoS client. An example listing of transaction authorization input 4014, substantially in the form of XML-formatted data, is provided below:

<?XML version = “1.0” encoding = “UTF-8”?>
<transaction_authorization_input>

<payment_data>

<account>

<charge_priority>1</charge_priority>
<charge_ratio>40%</charge_ratio>
<account_type>debit</account_type>
<value_exchange_symbol>USD</value_exchange_symbol>
<account_number>123456789012345</account_number>
<account_name>John Q. Public</account_name>
<bill_add>987 Green St #456, Chicago, IL 94652</bill_add>
<ship_add>987 Green St #456, Chicago, IL 94652</ship_add>
<CVV_type>dynamic<CVV_type>
<CVV>http://www.paynet.com/dcvv.php?sessionID=4NFU4RG94</CVV>
<cloak_flag>ON</cloak_flag>
<alert_rules>tar1 tar4 tar12</alert_rules>
<mode>NFC</mode>

</account>
<account>

<charge_priority>1</charge_priority>
<charge_ratio>60%</charge_ratio>
<account_type>rewards</account_type>
<value_exchange_symbol>VME</value_exchange_symbol>
<account_number>234567890123456</account_number>
<account_name>John Q. Public</account_name>
<bill_add>987 Green St #456, Chicago, IL 94652</bill_add>
<ship_add>987 Green St #456, Chicago, IL 94652</ship_add>
<CVV_type>static<CVV_type>
<CVV>173</CVV>
<cloak_flag>ON</cloak_flag>
<alert_rules>tar1 tar4 tar12</alert_rules>
<mode>Bluetooth</mode>

</account>
<account>

<charge_priority>2</charge_priority>
<charge_ratio>100%</charge_ratio>
<account_number>345678901234567</account_number>
<account_type>credit</account_type>
<value_exchange_symbol>USD</value_exchange_symbol>
<account_name>John Q. Public</account_name>
<bill_add>987 Green St #456, Chicago, IL 94652</bill_add>
<ship_add>987 Green St #456, Chicago, IL 94652</ship_add>
<CVV_type>static<CVV_type>
<CVV>173</CVV>
<cloak_flag>ON</cloak_flag>
<alert_rules>tar1 tar4 tar12</alert_rules>
<mode>NFC</mode>

</account>

</payment_data>
<!--optional data-->
<timestamp>2011-02-22 15:22:43</timestamp>
<expiry_lapse>00:00:30</expiry_lapse>
<secure_key>0445329070598623487956543322</secure_key>
<alerts_track_flag>TRUE</alerts_track_flag>
<device_fingerprint>

<device_IP>192.168.23.126</device_IP>
<device_MAC>0123.4567.89ab</device_MAC>
<device_serial>312456768798765432</device_serial>
<device_ECID>00000AEBCDF12345</device_ECID>
<device_identifier>jqp_air</device_identifier>
<device_UDID>21343e34-14f4-8jn4-7yfe-124578632134</device_UDID>
<device_browser>firefox 2.2</device_browser>
<device_type>smartphone</device_type>
<device_model>HTC Hero</device_model>
<OS>Android 2.2</OS>
<wallet_app_installed_flag>true</wallet_app_installed_flag>

</device_fingerprint>

</transaction_authorization_input>

In some embodiments, the PoS client may generate a card authorization request, e.g., 4015, using the obtained transaction authorization input from the user wallet device, and/or product/checkout data (see, e.g., FIG. 38, 3815-3817). An example listing of a card authorization request 4015-4016, substantially in the form of a HTTP(S) POST message including XML-formatted data, is provided below:

POST /authorizationrequests.php HTTP/1.1
Host: www.acquirer.com
Content-Type: Application/XML
Content-Length: 1306
<?XML version = “1.0” encoding = “UTF-8”?>
<card_authorization_request>

<session_ID>4NFU4RG94</order_ID>
<!--optional data-->
<timestamp>2011-02-22 15:22:43</timestamp>
<expiry>00:00:30</expiry>
<alerts_URL>www.merchant.com/shopcarts.php?sessionID=AEBB4356</alerts_URL>
<user_ID>john.q.public@gmail.com</user_ID>
<device_fingerprint>

<device_IP>192.168.23.126</device_IP>
<device_MAC>0123.4567.89ab</device_MAC>
<device_serial>312456768798765432</device_serial>
<device_ECID>00000AEBCDF12345</device_ECID>
<device_identifier>jqp_air</device_identifier>
<device_UDID>21343e34-14f4-8jn4-7yfe-124578632134</device_UDID>
<device_browser>firefox 2.2</device_browser>
<device_type>smartphone</device_type>
<device_model>HTC Hero</device_model>
<OS>Android 2.2</OS>
<wallet_app_installed_flag>true</wallet_app_installed_flag>

</device_fingerprint>
<purchase_details>

<total_cost>$121.49</total_cost>
<cart>

<product>

<merchant_params>

<merchant_id>54TBRELF8</merchant_id>
<merchant_name>BARNES, Inc.</merchant_name>
<merchant_auth_key>TMN45GER98</merchant_auth_key>

</merchant_params>
<product_type>book</product_type>
<product_params>

<product_title>XML for dummies</product_title>
<ISBN>938-2-14-168710-0</ISBN>
<edition>2nd ed.</edition>
<cover>hardbound</cover>

</product_params>
<quantity>2</quantity>
<unit_cost>$14.46</unit_cost>
<coupon_id>AY34567</coupon_id>

<social_flag>ON</social_flag>
<social_message>Look what I bought today!</social_message>
<social_networks>facebook twitter</social_networks>
</product>
<product>

<merchant_params>

<merchant_id>3FBCR4INC</merchant_id>
<merchant_name>Books, Inc.</merchant_name>
<merchant_auth_key>1N484MCP</merchant_auth_key>

</merchant_params>
<product_type>book</product_type>
<product_params>

<product_title>Sophie's World</product_title>
<ISBN>955-2-14-112310-0</ISBN>
<edition>NULL</edition>
<cover>hardbound</cover>

</product_params>
<quantity>1</quantity>
<unit_cost>$34.78</unit_cost>
<coupon_id>null</coupon_id>

<social_flag>OFF</social_flag>
</product>

</cart>
<cart>

<product>

<merchant_params>

<merchant_id>RFH5IB4FT</merchant_id>
<merchant_name>Amzn, Inc.</merchant_name>
<merchant_auth_key>44543DSJFG</merchant_auth_key>

</merchant_params>
<product_type>book</product_type>
<product_params>

<product_title>XML - a primer</product_title>
<ISBN>938-2-14-1436710-0</ISBN>
<edition>2nd ed.</edition>
<cover>hardbound</cover>

</product_params>
<quantity>1</quantity>
<unit_cost>$12.93</unit_cost>
<coupon_id>AY34567</coupon_id>

<social_flag>ON</social_flag>
<social_message>Look what I bought today!</social_message>
<social_networks>facebook twitter</social_networks>
</product>
<product>

<merchant_params>

<merchant_id>3FBCR4INC</merchant_id>
<merchant_name>BestBooks, Inc.</merchant_name>
<merchant_auth_key>1N484MCP</merchant_auth_key>

</merchant_params>
<product_type>book</product_type>
<product_params>

<product_title>Sophie's Choice</product_title>
<ISBN>938-2-14-168710-0</ISBN>
<edition>1st ed.</edition>

</product_params>
<quantity>1</quantity>
<unit_cost>$44.86</unit_cost>
<coupon_id>null</coupon_id>

<social_flag>OFF</social_flag>
</product>

</cart>

</purchase_details>
<account_params>

<account>

<charge_priority>1</charge_priority>
<charge_ratio>40%</charge_ratio>
<account_type>debit</account_type>
<value_exchange_symbol>USD</value_exchange_symbol>
<account_number>123456789012345</account_number>
<account_name>John Q. Public</account_name>
<bill_add>987 Green St #456, Chicago, IL 94652</bill_add>
<ship_add>987 Green St #456, Chicago, IL 94652</ship_add>
<CVV_type>dynamic<CVV_type>
<CVV>http://www.paynet.com/dcvv.php?sessionID=4NFU4RG94</CVV>
<cloak_flag>ON</cloak_flag>
<alert_rules>tar1 tar4 tar12</alert_rules>
<mode>NFC</mode>

</account>
<account>

<charge_priority>1</charge_priority>
<charge_ratio>60%</charge_ratio>
<account_type>rewards</account_type>
<value_exchange_symbol>VME</value_exchange_symbol>
<account_number>234567890123456</account_number>
<account_name>John Q. Public</account_name>
<bill_add>987 Green St #456, Chicago, IL 94652</bill_add>
<ship_add>987 Green St #456, Chicago, IL 94652</ship_add>
<CVV_type>static<CVV_type>
<CVV>173</CVV>
<cloak_flag>ON</cloak_flag>
<alert_rules>tar1 tar4 tar12</alert_rules>
<mode>Bluetooth</mode>

</account>
<account>

<charge_priority>2</charge_priority>
<charge_ratio>100%</charge_ratio>
<account_number>345678901234567</account_number>
<account_type>credit</account_type>
<value_exchange_symbol>USD</value_exchange_symbol>
<account_name>John Q. Public</account_name>
<bill_add>987 Green St #456, Chicago, IL 94652</bill_add>
<ship_add>987 Green St #456, Chicago, IL 94652</ship_add>
<CVV_type>static<CVV_type>
<CVV>173</CVV>
<cloak_flag>ON</cloak_flag>
<alert_rules>tar1 tar4 tar12</alert_rules>
<mode>NFC</mode>

</account>

</account_params>
<shipping_info>

<shipping_adress>#ref-ANON-123-45-678</shipping_address>
<ship_type>expedited</ship_type>
<ship_carrier>FedEx</ship_carrier>
<ship_account>ANON-123-45-678</ship_account>
<tracking_flag>true</tracking_flag>
<sign_flag>false</sign_flag>

</shipping_info>

</card_authorization_request>

In some embodiments, the card authorization request generated by the user device may include a minimum of information required to process the purchase transaction. For example, this may improve the efficiency of communicating the purchase transaction request, and may also advantageously improve the privacy protections provided to the user and/or merchant. For example, in some embodiments, the card authorization request may include at least a session ID for the user's shopping session with the merchant. The session ID may be utilized by any component and/or entity having the appropriate access authority to access a secure site on the merchant server to obtain alerts, reminders, and/or other data about the transaction(s) within that shopping session between the user and the merchant. In some embodiments, the PoS client may provide the generated card authorization request to the merchant server, e.g., 4016. The merchant server may forward the card authorization request to a pay gateway server, e.g., 4004a, for routing the card authorization request to the appropriate payment network for payment processing. For example, the pay gateway server may be able to select from payment networks, such as Visa, Mastercard, American Express, Paypal, etc., to process various types of transactions including, but not limited to: credit card, debit card, prepaid card, B2B and/or like transactions. In some embodiments, the merchant server may query a database, e.g., merchant/acquirer database 4003b, for a network address of the payment gateway server, for example by using a portion of a user payment card number, or a user ID (such as an email address) as a keyword for the database query. For example, the merchant server may issue PHP/SQL commands to query a database table (such as FIG. 44, Pay Gateways 4419h) for a URL of the pay gateway server. An example payment gateway address query 4017, substantially in the form of PHP/SQL commands, is provided below:

<?PHP
header(′Content-Type: text/plain′);
mysql_connect(“254.93.179.112”,$DBserver,$password); // access
database server
mysql_select_db(“Ad-Track_DB.SQL”); // select database table to search
//create query
$query = “SELECT paygate_id paygate_address paygate_URL
paygate_name FROM

PayGatewayTable WHERE card_num LIKE ′%′ $cardnum”;

$result = mysql_query($query); // perform the search query
mysql_close(“Ad-Track_DB.SQL”); // close database access
?>

In response, the merchant/acquirer database may provide the requested payment gateway address, e.g., 4018. The merchant server may forward the card authorization request to the pay gateway server using the provided address, e.g., 4019. In some embodiments, upon receiving the card authorization request from the merchant server, the pay gateway server may invoke a component to provide one or more services associated with purchase transaction authorization. For example, the pay gateway server may invoke components for fraud prevention, loyalty and/or rewards, and/or other services for which the user-merchant combination is authorized. The pay gateway server may forward the card authorization request to a pay network server, e.g., 4005a, for payment processing. For example, the pay gateway server may be able to select from payment networks, such as Visa, Mastercard, American Express, Paypal, etc., to process various types of transactions including, but not limited to: credit card, debit card, prepaid card, B2B and/or like transactions. In some embodiments, the pay gateway server may query a database, e.g., pay gateway database 4004b, for a network address of the payment network server, for example by using a portion of a user payment card number, or a user ID (such as an email address) as a keyword for the database query. For example, the pay gateway server may issue PHP/SQL commands to query a database table (such as FIG. 44, Pay Gateways 4419h) for a URL of the pay network server. An example payment network address query 4021, substantially in the form of PHP/SQL commands, is provided below:

<?PHP
header(′Content-Type: text/plain′);
mysql_connect(“254.93.179.112”,$DBserver,$password); // access
database server
mysql_select_db(“Ad-Track_DB.SQL”); // select database table to search
//create query
$query = “SELECT payNET_id payNET_address payNET_URL
payNET_name FROM

PayGatewayTable WHERE card_num LIKE ′%′ $cardnum”;

$result = mysql_query($query); // perform the search query
mysql_close(“Ad-Track_DB.SQL”); // close database access
?>

In response, the payment gateway database may provide the requested payment network address, e.g., 4022. The pay gateway server may forward the card authorization request to the pay network server using the provided address, e.g., 4023.

With reference to FIG. 40B, in some embodiments, the pay network server may process the transaction so as to transfer funds for the purchase into an account stored on an acquirer of the merchant. For example, the acquirer may be a financial institution maintaining an account of the merchant. For example, the proceeds of transactions processed by the merchant may be deposited into an account maintained by at a server of the acquirer.

In some embodiments, the pay network server may generate a query, e.g., 4024, for issuer server(s) corresponding to the user-selected payment options. For example, the user's account may be linked to one or more issuer financial institutions (“issuers”), such as banking institutions, which issued the account(s) for the user. For example, such accounts may include, but not be limited to: credit card, debit card, prepaid card, checking, savings, money market, certificates of deposit, stored (cash) value accounts and/or the like. Issuer server(s), e.g., 4006a, of the issuer(s) may maintain details of the user's account(s). In some embodiments, a database, e.g., pay network database 4005b, may store details of the issuer server(s) associated with the issuer(s). In some embodiments, the pay network server may query a database, e.g., pay network database 4005b, for a network address of the issuer(s) server(s), for example by using a portion of a user payment card number, or a user ID (such as an email address) as a keyword for the database query. For example, the merchant server may issue PHP/SQL commands to query a database table (such as FIG. 44, Issuers 4419f) for network address(es) of the issuer(s) server(s). An example issuer server address(es) query 4024, substantially in the form of PHP/SQL commands, is provided below:

<?PHP
header(′Content-Type: text/plain′);
mysql_connect(“254.93.179.112”,$DBserver,$password); // access
database server
mysql_select_db(“Ad-Track_DB.SQL”); // select database table to search
//create query
$query = “SELECT issuer_id issuer_address issuer_URL issuer_name
FROM

IssuersTable WHERE card_num LIKE ′%′ $cardnum”;

$result = mysql_query($query); // perform the search query
mysql_close(“Ad-Track_DB.SQL”); // close database access
?>

In response to obtaining the issuer server query, e.g., 4024, the pay network database may provide, e.g., 4025, the requested issuer server data to the pay network server. In some embodiments, the pay network server may utilize the issuer server data to generate funds authorization request(s), e.g., 4026, for each of the issuer server(s) selected based on the pre-defined payment settings associated with the user's virtual wallet, and/or the user's payment options input, and provide the funds authorization request(s) to the issuer server(s). In some embodiments, the funds authorization request(s) may include details such as, but not limited to: the costs to the user involved in the transaction, card account details of the user, user billing and/or shipping information, and/or the like. An example listing of a funds authorization request 4026, substantially in the form of a HTTP(S) POST message including XML-formatted data, is provided below:

POST /fundsauthorizationrequest.php HTTP/1.1
Host: www.issuer.com
Content-Type: Application/XML
Content-Length: 624
<?XML version = “1.0” encoding = “UTF-8”?>
<funds_authorization_request>

<request_ID>VNEI39FK</request_ID>
<timestamp>2011-02-22 15:22:44</timestamp>
<debit_amount>$72.89</debit_amount>
<account_params>

<account>

<account_type>debit</account_type>
<value_exchange_symbol>USD</value_exchange_symbol>
<account_number>123456789012345</account_number>
<account_name>John Q. Public</account_name>
<bill_add>987 Green St #456, Chicago, IL 94652</bill_add>
<ship_add>987 Green St #456, Chicago, IL 94652</ship_add>
<CVV>1234</CVV>

</account>

</account_params>
<!--optional parameters-->
<user_device_fingerprint>

<device_IP>192.168.23.126</device_IP>
<device_MAC>0123.4567.89ab</device_MAC>
<device_serial>312456768798765432</device_serial>
<device_ECID>00000AEBCDF12345</device_ECID>
<device_identifier>jqp_air</device_identifier>
<device_UDID>21343e34-14f4-8jn4-7yfe-124578632134</device_UDID>
<device_browser>firefox 2.2</device_browser>
<device_type>smartphone</device_type>
<device_model>HTC Hero</device_model>
<OS>Android 2.2</OS>
<wallet_app_installed_flag>true</wallet_app_installed_flag>

</user_device_fingerprint>

</funds_authorization_request>

In some embodiments, an issuer server may parse the authorization request(s), and based on the request details may query a database, e.g., user profile database 4006b, for data associated with an account linked to the user. For example, the merchant server may issue PHP/SQL commands to query a database table (such as FIG. 44, Accounts 4419d) for user account(s) data. An example user account(s) query 4027, substantially in the form of PHP/SQL commands, is provided below:

<?PHP
header(′Content-Type: text/plain′);
mysql_connect(“254.93.179.112”,$DBserver,$password); // access
database server
mysql_select_db(“Ad-Track_DB.SQL”); // select database table to search
//create query
$query = “SELECT issuer user_id user_name user_balance
account_type FROM

AccountsTable WHERE account_num LIKE ′%′ $accountnum”;

$result = mysql_query($query); // perform the search query
mysql_close(“Ad-Track_DB.SQL”); // close database access
?>

In some embodiments, on obtaining the user account(s) data, e.g., 4028, the issuer server may determine whether the user can pay for the transaction using funds available in the account, 4029. For example, the issuer server may determine whether the user has a sufficient balance remaining in the account, sufficient credit associated with the account, and/or the like. Based on the determination, the issuer server(s) may provide a funds authorization response, e.g., 4030, to the pay network server. For example, the issuer server(s) may provide a HTTP(S) POST message similar to the examples above. In some embodiments, if at least one issuer server determines that the user cannot pay for the transaction using the funds available in the account, the pay network server may request payment options again from the user (e.g., by providing an authorization fail message to the user device and requesting the user device to provide new payment options), and re-attempt authorization for the purchase transaction. In some embodiments, if the number of failed authorization attempts exceeds a threshold, the pay network server may abort the authorization process, and provide an “authorization fail” message to the merchant server, user device and/or client.

In some embodiments, the pay network server may obtain the funds authorization response including a notification of successful authorization, and parse the message to extract authorization details. Upon determining that the user possesses sufficient funds for the transaction, e.g., 4031, the pay network server may invoke a component to provide value-add services for the user.

In some embodiments, the pay network server may generate a transaction data record from the authorization request and/or authorization response, and store the details of the transaction and authorization relating to the transaction in a transactions database. For example, the pay network server may issue PHP/SQL commands to store the data to a database table (such as FIG. 44, Transactions 4419i). An example transaction store command, substantially in the form of PHP/SQL commands, is provided below:

<?PHP
header(′Content-Type: text/plain′);
mysql_connect(″254.92.185.103”,$DBserver,$password); // access
database server
mysql_select(″Ad-Track_DB.SQL″); // select database to append
mysql_query(“INSERT INTO TransactionsTable (PurchasesTable
(timestamp,

purchase_summary_list, num_products, product_summary,
product_quantity,
transaction_cost, account_params_list, account_name,
account_type,
account_num, billing_addres, zipcode, phone, sign,
merchant_params_list,
merchant_id, merchant_name, merchant_auth_key)

VALUES (time( ), $purchase_summary_list, $num_products,
$product_summary,

$product_quantity, $transaction_cost, $account_params_list,
$account_name,
$account_type, $account_num, $billing_addres, $zipcode,
$phone, $sign,
$merchant_params_list, $merchant_id, $merchant_name,
$merchant_auth_key)”);
// add data to table in database

mysql_close(″Ad-Track_DB.SQL″); // close connection to database
?>

In some embodiments, the pay network server may forward a transaction authorization response, e.g., 4032, to the user wallet device, PoS client, and/or merchant server. The merchant may obtain the transaction authorization response, and determine from it that the user possesses sufficient funds in the card account to conduct the transaction. The merchant server may add a record of the transaction for the user to a batch of transaction data relating to authorized transactions. For example, the merchant may append the XML data pertaining to the user transaction to an XML data file comprising XML data for transactions that have been authorized for various users, e.g., 4033, and store the XML data file, e.g., 4034, in a database, e.g., merchant database 404. For example, a batch XML data file may be structured similar to the example XML data structure template provided below:

<?XML version = “1.0” encoding = “UTF-8”?>
<merchant_data>

<merchant_id>3FBCR4INC</merchant_id>
<merchant_name>Books & Things, Inc.</merchant_name>
<merchant_auth_key>1NNF484MCP59CHB27365</merchant_auth_key>
<account_number>123456789</account_number>

</merchant_data>
<transaction_data>

<transaction 1>

...

</transaction 1>
<transaction 2>

...

</transaction 2>

.
.
.

<transaction n>

...

</transaction n>

</transaction_data>

In some embodiments, the server may also generate a purchase receipt, e.g., 4033, and provide the purchase receipt to the client, e.g., 4035. The client may render and display, e.g., 4036, the purchase receipt for the user. In some embodiments, the user's wallet device may also provide a notification of successful authorization to the user. For example, the PoS client/user device may render a webpage, electronic message, text/SMS message, buffer a voicemail, emit a ring tone, and/or play an audio message, etc., and provide output including, but not limited to: sounds, music, audio, video, images, tactile feedback, vibration alerts (e.g., on vibration-capable client devices such as a smartphone etc.), and/or the like.

FIGS. 41A-B show logic flow diagrams illustrating example aspects of transforming a user virtual wallet access input via a Purchase Transaction Authorization (“PTA”) component into a purchase transaction receipt notification. With reference to FIG. 41A, in some embodiments, a user may wish to utilize a virtual wallet account to purchase a product, service, offering, and/or the like (“product”), from a merchant via a merchant online site or in the merchant's store. The user may utilize a physical card, or a user wallet device to access the user's virtual wallet account. For example, the user wallet device may be a personal/laptop computer, cellular telephone, smartphone, tablet, eBook reader, netbook, gaming console, and/or the like. The user may provide a wallet access input, e.g., 4101, into the user wallet device. In various embodiments, the user input may include, but not be limited to: a single tap (e.g., a one-tap mobile app purchasing embodiment) of a touchscreen interface, keyboard entry, card swipe, activating a RFID/NFC equipped hardware device (e.g., electronic card having multiple accounts, smartphone, tablet, etc.) within the user device, mouse clicks, depressing buttons on a joystick/game console, voice commands, single/multi-touch gestures on a touch-sensitive interface, touching user interface elements on a touch-sensitive display, and/or the like. In some embodiments, the user wallet device may authenticate the user based on the user's wallet access input, and provide virtual wallet features for the user, e.g., 4102-4103.

In some embodiments, upon authenticating the user for access to virtual wallet features, the user wallet device may provide a transaction authorization input, e.g., 4104, to a point-of-sale (“PoS”) client. For example, the user wallet device may communicate with the PoS client via Bluetooth, Wi-Fi, cellular communication, one- or two-way near-field communication (“NFC”), and/or the like. In embodiments where the user utilizes a plastic card instead of the user wallet device, the user may swipe the plastic card at the PoS client to transfer information from the plastic card into the PoS client. In embodiments where the user utilizes a user wallet device, the user wallet device may provide payment information to the PoS client, formatted according to a data formatting protocol appropriate to the communication mechanism employed in the communication between the user wallet device and the PoS client.

In some embodiments, the PoS client may obtain the transaction authorization input, and parse the input to extract payment information from the transaction authorization input, e.g., 4105. For example, the PoS client may utilize a parser, such as the example parsers provided below in the discussion with reference to FIG. 44. The PoS client may generate a card authorization request, e.g., 4106, using the obtained transaction authorization input from the user wallet device, and/or product/checkout data (see, e.g., FIG. 38, 3815-3817).

In some embodiments, the PoS client may provide the generated card authorization request to the merchant server. The merchant server may forward the card authorization request to a pay gateway server, for routing the card authorization request to the appropriate payment network for payment processing. For example, the pay gateway server may be able to select from payment networks, such as Visa, Mastercard, American Express, Paypal, etc., to process various types of transactions including, but not limited to: credit card, debit card, prepaid card, B2B and/or like transactions. In some embodiments, the merchant server may query a database, e.g., 4108, for a network address of the payment gateway server, for example by using a portion of a user payment card number, or a user ID (such as an email address) as a keyword for the database query. In response, the merchant/acquirer database may provide the requested payment gateway address, e.g., 4110. The merchant server may forward the card authorization request to the pay gateway server using the provided address. In some embodiments, upon receiving the card authorization request from the merchant server, the pay gateway server may invoke a component to provide one or more service associated with purchase transaction authorization, e.g., 4111. For example, the pay gateway server may invoke components for fraud prevention (see e.g., VerifyChat, FIG. 3E), loyalty and/or rewards, and/or other services for which the user-merchant combination is authorized.

The pay gateway server may forward the card authorization request to a pay network server for payment processing, e.g., 4114. For example, the pay gateway server may be able to select from payment networks, such as Visa, Mastercard, American Express, Paypal, etc., to process various types of transactions including, but not limited to: credit card, debit card, prepaid card, B2B and/or like transactions. In some embodiments, the pay gateway server may query a database, e.g., 4112, for a network address of the payment network server, for example by using a portion of a user payment card number, or a user ID (such as an email address) as a keyword for the database query. In response, the payment gateway database may provide the requested payment network address, e.g., 4113. The pay gateway server may forward the card authorization request to the pay network server using the provided address, e.g., 4114.

With reference to FIG. 41B, in some embodiments, the pay network server may process the transaction so as to transfer funds for the purchase into an account stored on an acquirer of the merchant. For example, the acquirer may be a financial institution maintaining an account of the merchant. For example, the proceeds of transactions processed by the merchant may be deposited into an account maintained by at a server of the acquirer. In some embodiments, the pay network server may generate a query, e.g., 4115, for issuer server(s) corresponding to the user-selected payment options. For example, the user's account may be linked to one or more issuer financial institutions (“issuers”), such as banking institutions, which issued the account(s) for the user. For example, such accounts may include, but not be limited to: credit card, debit card, prepaid card, checking, savings, money market, certificates of deposit, stored (cash) value accounts and/or the like. Issuer server(s) of the issuer(s) may maintain details of the user's account(s). In some embodiments, a database, e.g., a pay network database, may store details of the issuer server(s) associated with the issuer(s). In some embodiments, the pay network server may query a database, e.g., 4115, for a network address of the issuer(s) server(s), for example by using a portion of a user payment card number, or a user ID (such as an email address) as a keyword for the database query.

In response to obtaining the issuer server query, the pay network database may provide, e.g., 4116, the requested issuer server data to the pay network server. In some embodiments, the pay network server may utilize the issuer server data to generate funds authorization request(s), e.g., 4117, for each of the issuer server(s) selected based on the pre-defined payment settings associated with the user's virtual wallet, and/or the user's payment options input, and provide the funds authorization request(s) to the issuer server(s). In some embodiments, the funds authorization request(s) may include details such as, but not limited to: the costs to the user involved in the transaction, card account details of the user, user billing and/or shipping information, and/or the like. In some embodiments, an issuer server may parse the authorization request(s), e.g., 4118, and based on the request details may query a database, e.g., 4119, for data associated with an account linked to the user.

In some embodiments, on obtaining the user account(s) data, e.g., 4120, the issuer server may determine whether the user can pay for the transaction using funds available in the account, e.g., 4121. For example, the issuer server may determine whether the user has a sufficient balance remaining in the account, sufficient credit associated with the account, and/or the like. Based on the determination, the issuer server(s) may provide a funds authorization response, e.g., 4122, to the pay network server. In some embodiments, if at least one issuer server determines that the user cannot pay for the transaction using the funds available in the account, the pay network server may request payment options again from the user (e.g., by providing an authorization fail message to the user device and requesting the user device to provide new payment options), and re-attempt authorization for the purchase transaction. In some embodiments, if the number of failed authorization attempts exceeds a threshold, the pay network server may abort the authorization process, and provide an “authorization fail” message to the merchant server, user device and/or client.

In some embodiments, the pay network server may obtain the funds authorization response including a notification of successful authorization, and parse the message to extract authorization details. Upon determining that the user possesses sufficient funds for the transaction, e.g., 4123, the pay network server may invoke a component to provide value-add services for the user, e.g., 4123.

In some embodiments, the pay network server may forward a transaction authorization response to the user wallet device, PoS client, and/or merchant server. The merchant may parse, e.g., 4124, the transaction authorization response, and determine from it that the user possesses sufficient funds in the card account to conduct the transaction, e.g., 4125, option“Yes.” The merchant server may add a record of the transaction for the user to a batch of transaction data relating to authorized transactions. For example, the merchant may append the XML data pertaining to the user transaction to an XML data file comprising XML data for transactions that have been authorized for various users, e.g., 4126, and store the XML data file, e.g., 4127, in a database. In some embodiments, the server may also generate a purchase receipt, e.g., 4128, and provide the purchase receipt to the client. The client may render and display, e.g., 4129, the purchase receipt for the user. In some embodiments, the user's wallet device may also provide a notification of successful authorization to the user. For example, the PoS client/user device may render a webpage, electronic message, text/SMS message, buffer a voicemail, emit a ring tone, and/or play an audio message, etc., and provide output including, but not limited to: sounds, music, audio, video, images, tactile feedback, vibration alerts (e.g., on vibration-capable client devices such as a smartphone etc.), and/or the like.

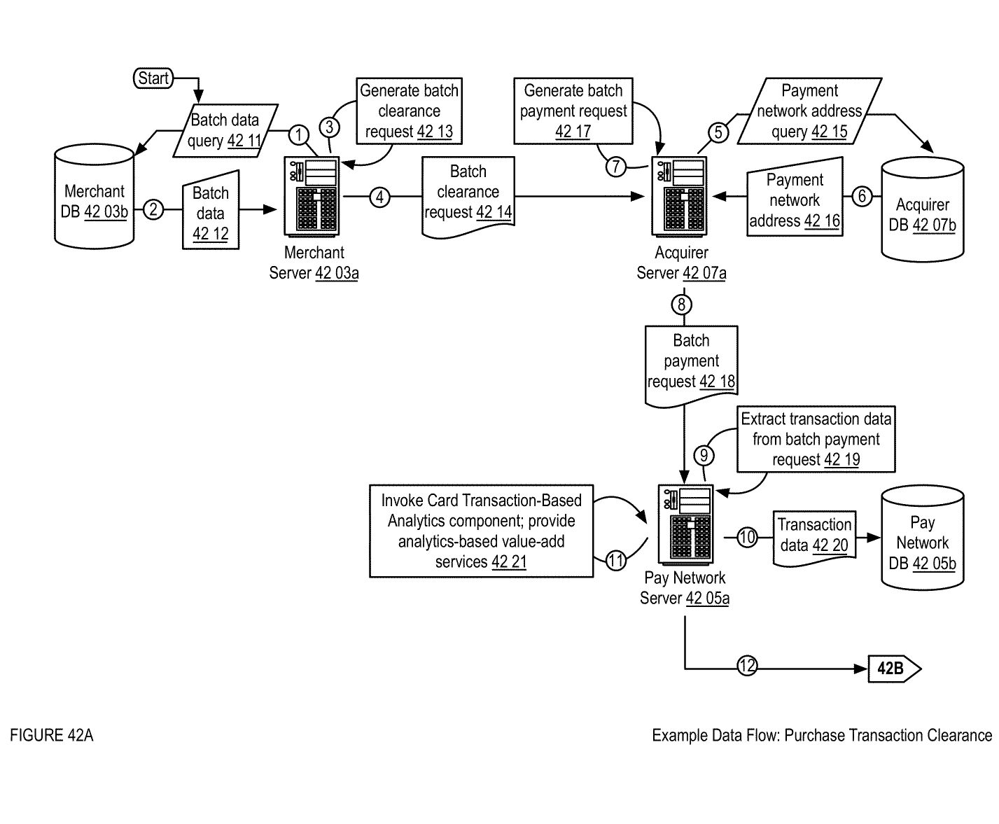

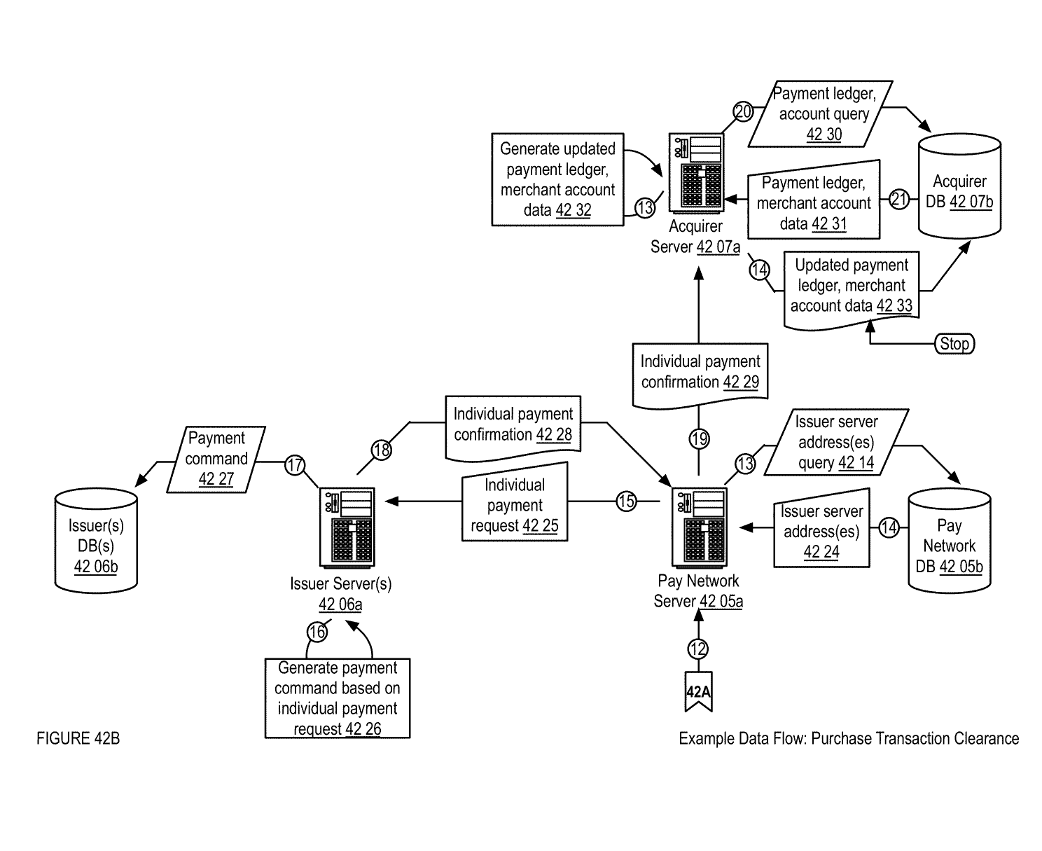

FIGS. 42A-B show data flow diagrams illustrating example aspects of transforming a merchant transaction batch data query via a Purchase Transaction Clearance (“PTC”) component into an updated payment ledger record. With reference to FIG. 42A, in some embodiments, a merchant server, e.g., 4203a, may initiate clearance of a batch of authorized transactions. For example, the merchant server may generate a batch data request, e.g., 4211, and provide the request, to a merchant database, e.g., 4203b. For example, the merchant server may utilize PHP/SQL commands similar to the examples provided above to query a relational database. In response to the batch data request, the database may provide the requested batch data, e.g., 4212. The server may generate a batch clearance request, e.g., 4213, using the batch data obtained from the database, and provide, e.g., 4214, the batch clearance request to an acquirer server, e.g., 4207a. For example, the merchant server may provide a HTTP(S) POST message including XML-formatted batch data in the message body for the acquirer server. The acquirer server may generate, e.g., 4215, a batch payment request using the obtained batch clearance request, and provide, e.g., 4218, the batch payment request to the pay network server, e.g., 4205a. The pay network server may parse the batch payment request, and extract the transaction data for each transaction stored in the batch payment request, e.g., 4219. The pay network server may store the transaction data, e.g., 4220, for each transaction in a database, e.g., pay network database 4205b. In some embodiments, the pay network server may invoke a component to provide value-add analytics services based on analysis of the transactions of the merchant for whom the Ad-Track is clearing purchase transactions. Thus, in some embodiments, the pay network server may provide analytics-based value-added services for the merchant and/or the merchant's users.

With reference to FIG. 42B, in some embodiments, for each extracted transaction, the pay network server may query, e.g., 4223, a database, e.g., pay network database 4205b, for an address of an issuer server. For example, the pay network server may utilize PHP/SQL commands similar to the examples provided above. The pay network server may generate an individual payment request, e.g., 4225, for each transaction for which it has extracted transaction data, and provide the individual payment request, e.g., 4225, to the issuer server, e.g., 4206a. For example, the pay network server may provide an individual payment request to the issuer server(s) as a HTTP(S) POST message including XML-formatted data. An example listing of an individual payment request 4225, substantially in the form of a HTTP(S) POST message including XML-formatted data, is provided below:

POST /paymentrequest.php HTTP/1.1
Host: www.issuer.com
Content-Type: Application/XML
Content-Length: 788
<?XML version = “1.0” encoding = “UTF-8”?>
<pay_request>

<request_ID>CNI4ICNW2</request_ID>
<timestamp>2011-02-22 17:00:01</timestamp>
<pay_amount>$72.89</pay_amount>
<account_params>

<account>

<account_type>debit</account_type>
<value_exchange_symbol>USD</value_exchange_symbol>
<account_number>123456789012345</account_number>
<account_name>John Q. Public</account_name>
<bill_add>987 Green St #456, Chicago, IL 94652</bill_add>
<ship_add>987 Green St #456, Chicago, IL 94652</ship_add>
<CVV>1234</CVV>

</account>

</account_params>

</pay_request>

In some embodiments, the issuer server may generate a payment command, e.g., 4227. For example, the issuer server may issue a command to deduct funds from the user's account (or add a charge to the user's credit card account). The issuer server may issue a payment command, e.g., 4227, to a database storing the user's account information, e.g., user profile database 4206b. The issuer server may provide an individual payment confirmation, e.g., 4228, to the pay network server, which may forward, e.g., 4229, the funds transfer message to the acquirer server. An example listing of an individual payment confirmation 4228, substantially in the form of a HTTP(S) POST message including XML-formatted data, is provided below:

POST /clearance.php HTTP/1.1
Host: www.acquirer.com
Content-Type: Application/XML
Content-Length: 206
<?XML version = “1.0” encoding = “UTF-8”?>
<deposit_ack>

<request_ID>CNI4ICNW2</request_ID>
<clear_flag>true</clear_flag>
<timestamp>2011-02-22 17:00:02</timestamp>
<deposit_amount>$72.89</deposit_amount>

</deposit_ack>

In some embodiments, the acquirer server may parse the individual payment confirmation, and correlate the transaction (e.g., using the request_ID field in the example above) to the merchant. The acquirer server may then transfer the funds specified in the funds transfer message to an account of the merchant. For example, the acquirer server may query, e.g. 4230, an acquirer database 4207b for payment ledger and/or merchant account data, e.g., 4231. The acquirer server may utilize payment ledger and/or merchant account data from the acquirer database, along with the individual payment confirmation, to generate updated payment ledger and/or merchant account data, e.g., 4232. The acquirer server may then store, e.g., 4233, the updated payment ledger and/or merchant account data to the acquire database.

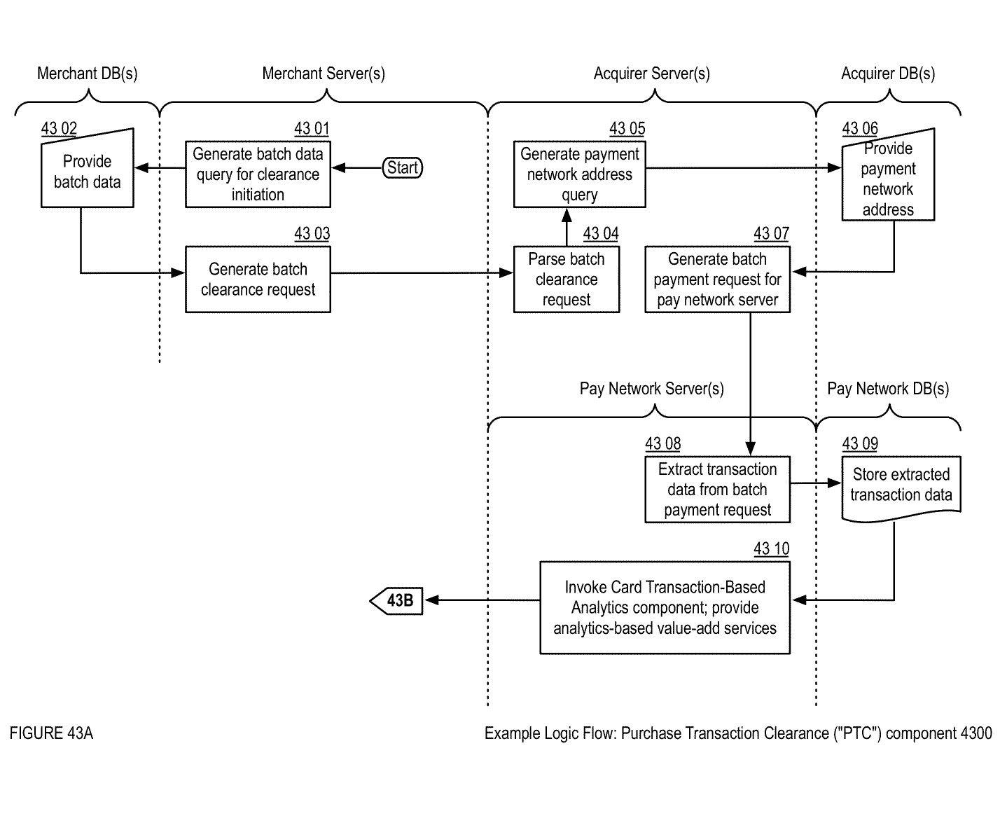

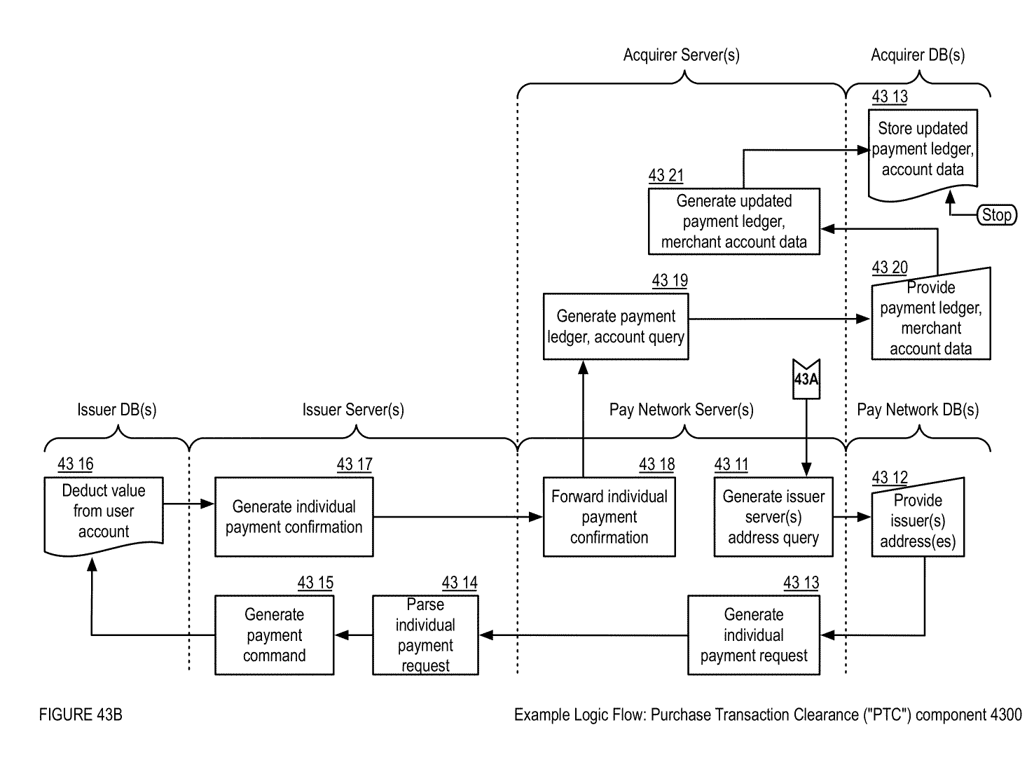

FIGS. 43A-B show logic flow diagrams illustrating example aspects of transforming a merchant transaction batch data query via a Purchase Transaction Clearance (“PTC”) component into an updated payment ledger record. With reference to FIG. 43A, in some embodiments, a merchant server may initiate clearance of a batch of authorized transactions. For example, the merchant server may generate a batch data request, e.g., 4301, and provide the request to a merchant database. In response to the batch data request, the database may provide the requested batch data, e.g., 4302. The server may generate a batch clearance request, e.g., 4303, using the batch data obtained from the database, and provide the batch clearance request to an acquirer server. The acquirer server may parse, e.g., 4304, the obtained batch clearance request, and generate, e.g., 4307, a batch payment request using the obtained batch clearance request to provide, the batch payment request to a pay network server. For example, the acquirer server may query, e.g., 4305, an acquirer database for an address of a payment network server, and utilize the obtained address, e.g., 4306, to forward the generated batch payment request to the pay network server.

The pay network server may parse the batch payment request obtained from the acquirer server, and extract the transaction data for each transaction stored in the batch payment request, e.g., 4308. The pay network server may store the transaction data, e.g., 4309, for each transaction in a pay network database. In some embodiments, the pay network server may invoke a component, e.g., 4310, to provide analytics based on the transactions of the merchant for whom purchase transaction are being cleared.

With reference to FIG. 43B, in some embodiments, for each extracted transaction, the pay network server may query, e.g., 4311, a pay network database for an address of an issuer server. The pay network server may generate an individual payment request, e.g., 4313, for each transaction for which it has extracted transaction data, and provide the individual payment request to the issuer server. In some embodiments, the issuer server may parse the individual payment request, e.g., 4314, and generate a payment command, e.g., 4315, based on the parsed individual payment request. For example, the issuer server may issue a command to deduct funds from the user's account (or add a charge to the user's credit card account). The issuer server may issue a payment command, e.g., 4315, to a database storing the user's account information, e.g., a user profile database. The issuer server may provide an individual payment confirmation, e.g., 4317, to the pay network server, which may forward, e.g., 4318, the individual payment confirmation to the acquirer server.

In some embodiments, the acquirer server may parse the individual payment confirmation, and correlate the transaction (e.g., using the request_ID field in the example above) to the merchant. The acquirer server may then transfer the funds specified in the funds transfer message to an account of the merchant. For example, the acquirer server may query, e.g. 4319, an acquirer database for payment ledger and/or merchant account data, e.g., 4320. The acquirer server may utilize payment ledger and/or merchant account data from the acquirer database, along with the individual payment confirmation, to generate updated payment ledger and/or merchant account data, e.g., 4321. The acquirer server may then store, e.g., 4322, the updated payment ledger and/or merchant account data to the acquire database.

### Ad-Track Controller

FIG. 44 shows a block diagram illustrating example aspects of a Ad-Track controller 4401. In this embodiment, the Ad-Track controller 4401 may serve to aggregate, process, store, search, serve, identify, instruct, generate, match, and/or facilitate interactions with a computer through various technologies, and/or other related data.

Users, e.g., 4433a, which may be people and/or other systems, may engage information technology systems (e.g., computers) to facilitate information processing. In turn, computers employ processors to process information; such processors 4403 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 4429 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the Ad-Track controller 4401 may be connected to and/or communicate with entities such as, but not limited to: one or more users from user input devices 4411; peripheral devices 4412; an optional cryptographic processor device 4428; and/or a communications network 4413. For example, the Ad-Track controller 4401 may be connected to and/or communicate with users, e.g., 4433a, operating client device(s), e.g., 4433b, including, but not limited to, personal computer(s), server(s) and/or various mobile device(s) including, but not limited to, cellular telephone(s), smartphone(s) (e.g., iPhone®, Blackberry®, Android OS-based phones etc.), tablet computer(s) (e.g., Apple iPad™, HP Slate™, Motorola Xoom™, etc.), eBook reader(s) (e.g., Amazon Kindle™, Barnes and Noble's Nook™ eReader, etc.), laptop computer(s), notebook(s), netbook(s), gaming console(s) (e.g., XBOX Live™, Nintendo® DS, Sony PlayStation® Portable, etc.), portable scanner(s), and/or the like.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The Ad-Track controller 4401 may be based on computer systems that may comprise, but are not limited to, components such as: a computer systemization 4402 connected to memory 4429.

### Computer Systemization

A computer systemization 4402 may comprise a clock 4430, central processing unit (“CPU(s)” and/or “processor(s)” (these terms are used interchangeably throughout the disclosure unless noted to the contrary)) 4403, a memory 4429 (e.g., a read only memory (ROM) 4406, a random access memory (RAM) 4405, etc.), and/or an interface bus 4407, and most frequently, although not necessarily, are all interconnected and/or communicating through a system bus 4404 on one or more (mother)board(s) 4402 having conductive and/or otherwise transportive circuit pathways through which instructions (e.g., binary encoded signals) may travel to effectuate communications, operations, storage, etc. The computer systemization may be connected to a power source 4486; e.g., optionally the power source may be internal. Optionally, a cryptographic processor 4426 and/or transceivers (e.g., ICs) 4474 may be connected to the system bus. In another embodiment, the cryptographic processor and/or transceivers may be connected as either internal and/or external peripheral devices 4412 via the interface bus I/O. In turn, the transceivers may be connected to antenna(s) 4475, thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing Ad-Track controller to determine its location)); Broadcom BCM4329FKUBG transceiver chip (e.g., providing 802.11n, Bluetooth 2.1+EDR, FM, etc.), BCM28150 (HSPA+) and BCM2076 (Bluetooth 4.0, GPS, etc.); a Broadcom BCM4750IUB8 receiver chip (e.g., GPS); an Infineon Technologies X-Gold 618-PMB9800 (e.g., providing 2G/3G HSDPA/HSUPA communications); Intel's XMM 7160 (LTE & DC-HSPA), Qualcom's CDMA(2000), Mobile Data/Station Modem, Snapdragon; and/or the like. The system clock may have a crystal oscillator and generates a base signal through the computer systemization's circuit pathways. The clock may be coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be referred to as communications. These communicative instructions may further be transmitted, received, and the cause of return and/or reply communications beyond the instant computer systemization to: communications networks, input devices, other computer systemizations, peripheral devices, and/or the like. It should be understood that in alternative embodiments, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: floating point units, integer processing units, integrated system (bus) controllers, logic operating units, memory management control units, etc., and even specialized processing sub-units like graphics processing units, digital signal processing units, and/or the like. Additionally, processors may include internal fast access addressable memory, and be capable of mapping and addressing memory 4429 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state/value. The CPU may be a microprocessor such as: AMD's Athlon, Duron and/or Opteron; ARM's classic (e.g., ARM7/9/11), embedded (Coretx-M/R), application (Cortex-A), embedded and secure processors; IBM and/or Motorola's DragonBall and PowerPC; IBM's and Sony's Cell processor; Intel's Atom, Celeron (Mobile), Core (2/Duo/i3/i5/i7), Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code). Such instruction passing facilitates communication within the Ad-Track controller and beyond through various interfaces. Should processing requirements dictate a greater amount speed and/or capacity, distributed processors (e.g., Distributed Ad-Track), mainframe, multi-core, parallel, and/or super-computer architectures may similarly be employed. Alternatively, should deployment requirements dictate greater portability, smaller mobile devices (e.g., smartphones, Personal Digital Assistants (PDAs), etc.) may be employed.

Depending on the particular implementation, features of the Ad-Track may be achieved by implementing a microcontroller such as CAST's R8051XC2 microcontroller; Intel's MCS 51 (i.e., 8051 microcontroller); and/or the like. Also, to implement certain features of the Ad-Track, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the Ad-Track component collection (distributed or otherwise) and/or features may be implemented via the microprocessor and/or via embedded components; e.g., via ASIC, coprocessor, DSP, FPGA, and/or the like. Alternately, some implementations of the Ad-Track may be implemented with embedded components that are configured and used to achieve a variety of features or signal processing.

Depending on the particular implementation, the embedded components may include software solutions, hardware solutions, and/or some combination of both hardware/software solutions. For example, Ad-Track features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the Ad-Track features. A hierarchy of programmable interconnects allow logic blocks to be interconnected as needed by the Ad-Track system designer/administrator, somewhat like a one-chip programmable breadboard. An FPGA's logic blocks can be programmed to perform the operation of basic logic gates such as AND, and XOR, or more complex combinational operators such as decoders or simple mathematical operations. In most FPGAs, the logic blocks also include memory elements, which may be circuit flip-flops or more complete blocks of memory. In some circumstances, the Ad-Track may be developed on regular FPGAs and then migrated into a fixed version that more resembles ASIC implementations. Alternate or coordinating implementations may migrate Ad-Track controller features to a final ASIC instead of or in addition to FPGAs. Depending on the implementation all of the aforementioned embedded components and microprocessors may be considered the “CPU” and/or “processor” for the Ad-Track.

### Power Source

The power source 4486 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 4486 is connected to at least one of the interconnected subsequent components of the Ad-Track thereby providing an electric current to all the interconnected components. In one example, the power source 4486 is connected to the system bus component 4404. In an alternative embodiment, an outside power source 4486 is provided through a connection across the I/O 4408 interface. For example, a USB and/or IEEE 1394 connection carries both data and power across the connection and is therefore a suitable source of power.

### Interface Adapters

Interface bus(ses) 4407 may accept, connect, and/or communicate to a number of interface adapters, frequently, although not necessarily in the form of adapter cards, such as but not limited to: input output interfaces (I/O) 4408, storage interfaces 4409, network interfaces 4410, and/or the like. Optionally, cryptographic processor interfaces 4427 similarly may be connected to the interface bus. The interface bus provides for the communications of interface adapters with one another as well as with other components of the computer systemization. Interface adapters are adapted for a compatible interface bus. Interface adapters may connect to the interface bus via expansion and/or slot architecture. Various expansion and/or slot architectures may be employed, such as, but not limited to: Accelerated Graphics Port (AGP), Card Bus, ExpressCard, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), Thunderbolt, and/or the like.

Storage interfaces 4409 may accept, communicate, and/or connect to a number of storage devices such as, but not limited to: storage devices 4414, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, Ethernet, fiber channel, Small Computer Systems Interface (SCSI), Thunderbolt, Universal Serial Bus (USB), and/or the like.

Network interfaces 4410 may accept, communicate, and/or connect to a communications network 4413. Through a communications network 4413, the Ad-Track controller is accessible through remote clients 4433b (e.g., computers with web browsers) by users 4433a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed Ad-Track), architectures may similarly be employed to pool, load balance, and/or otherwise increase the communicative bandwidth required by the Ad-Track controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 4410 may be used to engage with various communications network types 4413. For example, multiple network interfaces may be employed to allow for the communication over broadcast, multicast, and/or unicast networks.

Input Output interfaces (I/O) 4408 may accept, communicate, and/or connect to user input devices 4411, peripheral devices 4412, cryptographic processor devices 4428, and/or the like. I/O may employ connection protocols such as, but not limited to: audio: analog, digital, monaural, RCA, stereo, and/or the like; data: Apple Desktop Bus (ADB), Bluetooth, IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, DisplayPort, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One output device may be a video display, which may take the form of a Cathode Ray Tube (CRT), Liquid Crystal Display (LCD), Light Emitting Diode (LED), Organic Light Emitting Diode (OLED), Plasma, and/or the like based monitor with an interface (e.g., VGA, DVI circuitry and cable) that accepts signals from a video interface. The video interface composites information generated by a computer systemization and generates video signals based on the composited information in a video memory frame. Another output device is a television set, which accepts signals from a video interface. Often, the video interface provides the composited video information through a video connection interface that accepts a video display interface (e.g., an RCA composite video connector accepting an RCA composite video cable; a DVI connector accepting a DVI display cable, HDMI, etc.).

User input devices 4411 often are a type of peripheral device 4412 (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices 4412 may be connected and/or communicate to I/O and/or other facilities of the like such as network interfaces, storage interfaces, directly to the interface bus, system bus, the CPU, and/or the like. Peripheral devices may be external, internal and/or part of the Ad-Track controller. Peripheral devices may include: antenna, audio devices (e.g., line-in, line-out, microphone input, speakers, etc.), cameras (e.g., still, video, webcam, etc.), dongles (e.g., for copy protection, ensuring secure transactions with a digital signature, and/or the like), external processors (for added capabilities; e.g., crypto devices 4428), force-feedback devices (e.g., vibrating motors), near field communication (NFC) devices, network interfaces, printers, radio frequency identifiers (RFIDs), scanners, storage devices, transceivers (e.g., cellular, GPS, etc.), video devices (e.g., goggles, monitors, etc.), video sources, visors, and/or the like. Peripheral devices often include types of input devices (e.g., microphones, cameras, etc.).

It should be noted that although user input devices and peripheral devices may be employed, the Ad-Track controller may be embodied as an embedded, dedicated, and/or monitor-less (i.e., headless) device, wherein access would be provided over a network interface connection.

Cryptographic units such as, but not limited to, microcontrollers, processors 4426, interfaces 4427, and/or devices 4428 may be attached, and/or communicate with the Ad-Track controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of the CPU. Equivalent microcontrollers and/or processors may also be used. Other commercially available specialized cryptographic processors include: the Broadcom's CryptoNetX and other Security Processors; nCipher's nShield (e.g., Solo, Connect, etc.), SafeNet's Luna PCI (e.g., 7100) series; Semaphore Communications' 40 MHz Roadrunner 184; sMIP's (e.g., 208956); Sun's Cryptographic Accelerators (e.g., Accelerator 6000 PCIe Board, Accelerator 500 Daughtercard); Via Nano Processor (e.g., L2100, L2200, U2400) line, which is capable of performing 500+ MB/s of cryptographic instructions; VLSI Technology's 33 MHz 6868; and/or the like.

### Memory

Generally, any mechanization and/or embodiment allowing a processor to affect the storage and/or retrieval of information is regarded as memory 4429. However, memory is a fungible technology and resource, thus, any number of memory embodiments may be employed in lieu of or in concert with one another. It is to be understood that the Ad-Track controller and/or a computer systemization may employ various forms of memory 4429. For example, a computer systemization may be configured wherein the operation of on-chip CPU memory (e.g., registers), RAM, ROM, and any other storage devices are provided by a paper punch tape or paper punch card mechanism; however, such an embodiment would result in an extremely slow rate of operation. In one configuration, memory 4429 may include ROM 4406, RAM 4405, and a storage device 4414. A storage device 4414 may employ any number of computer storage devices/systems. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 4429 may contain a collection of program and/or database components and/or data such as, but not limited to: operating system component(s) 4415 (operating system); information server component(s) 4416 (information server); user interface component(s) 4417 (user interface); Web browser component(s) 4418 (Web browser); database(s) 4419; mail server component(s) 4421; mail client component(s) 4422; cryptographic server component(s) 4420 (cryptographic server); the Ad-Track component(s) 4435; and/or the like (i.e., collectively a component collection). These components may be stored and accessed from the storage devices and/or from storage devices accessible through an interface bus. Although non-conventional program components such as those in the component collection may be stored in a local storage device 4414, they may also be loaded and/or stored in memory such as: peripheral devices, RAM, remote storage facilities through a communications network, ROM, various forms of memory, and/or the like.

### Operating System

The operating system component 4415 is an executable program component facilitating the operation of the Ad-Track controller. The operating system may facilitate access of I/O, network interfaces, peripheral devices, storage devices, and/or the like. The operating system may be a highly fault tolerant, scalable, and secure system such as: Apple Macintosh OS X (Server); AT&T Nan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and/or the like. In addition, emobile operating systems such as Apple's iOS, Google's Android, Hewlett Packard's WebOS, Microsofts Windows Mobile, and/or the like may be employed. Any of these operating systems may be embedded within the hardware of the NICK controller, and/or stored/loaded into memory/storage. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the Ad-Track controller to communicate with other entities through a communications network 4413. Various communication protocols may be used by the Ad-Track controller as a subcarrier transport mechanism for interaction, such as, but not limited to: multicast, TCP/IP, UDP, unicast, and/or the like.

### Information Server

An information server component 4416 is a stored program component that is executed by a CPU. The information server may be an Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Apple's iMessage, Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the Ad-Track controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the Ad-Track database 4419, operating systems, other program components, user interfaces, Web browsers, and/or the like.

Access to the Ad-Track database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the Ad-Track. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the Ad-Track as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua and iOS's Cocoa Touch, IBM's OS/2, Google's Android Mobile UI, Microsoft's Windows 2000/2003/3.1/95/98/CE/Millenium/CPAM: Mobile/NT/XP/Vista/7/8 (i.e., Aero, Metro), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 4417 is a stored program component that is executed by a CPU. The user interface may be a graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 4418 is a stored program component that is executed by a CPU. The Web browser may be a hypertext viewing application such as Goofle's (Mobile) Chrome, Microsoft Internet Explorer, Netscape Navigator, Apple's (Mobile) Safari, embedded web browser objects such as through Apple's Cocoa (Touch) object class, and/or the like. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., Chrome, FireFox, Internet Explorer, Safari Plug-in, and/or the like APIs), and/or the like. Web browsers and like information access tools may be integrated into PDAs, cellular telephones, smartphones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Also, in place of a Web browser and information server, a combined application may be developed to perform similar operations of both. The combined application would similarly effect the obtaining and the provision of information to users, user agents, and/or the like from the Ad-Track equipped nodes. The combined application may be nugatory on systems employing standard Web browsers.

### Mail Server

A mail server component 4421 is a stored program component that is executed by a CPU 4403. The mail server may be an Internet mail server such as, but not limited to Apple's Mail Server (3), dovect, sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the Ad-Track.

Access to the Ad-Track mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 4422 is a stored program component that is executed by a CPU 4403. The mail client may be a mail viewing application such as Apple (Mobile) Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 4420 is a stored program component that is executed by a CPU 4403, cryptographic processor 4426, cryptographic processor interface 4427, cryptographic processor device 4428, and/or the like. Cryptographic processor interfaces will allow for expedition of encryption and/or decryption requests by the cryptographic component; however, the cryptographic component, alternatively, may run on a CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash operation), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the Ad-Track may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the Ad-Track component to engage in secure transactions if so desired. The cryptographic component facilitates the secure accessing of resources on the Ad-Track and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The Ad-Track Database

The Ad-Track database component 4419 may be embodied in a database and its stored data. The database is a stored program component, which is executed by the CPU; the stored program component portion configuring the CPU to process the stored data. The database may be any of a number of fault tolerant, relational, scalable, secure databases, such as DB2, MySQL, Oracle, Sybase, and/or the like. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the Ad-Track database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of capabilities encapsulated within a given object. If the Ad-Track database is implemented as a data-structure, the use of the Ad-Track database 4419 may be integrated into another component such as the Ad-Track component 4435. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 4419 includes several tables 4419a-s. A Users table 4419a may include fields such as, but not limited to: user_id, ssn, dob, first_name, last_name, age, state, address_firstline, address_secondline, zipcode, devices_list, contact_info, contact_type, alt contact_info, alt_contact_type, and/or the like. The Users table may support and/or track multiple entity accounts on a Ad-Track. A Devices table 4419b may include fields such as, but not limited to: device_ID, device_name, device_IP, device_GPS, device_MAC, device_serial, device_ECID, device_UDID, device_browser, device_type, device_model, device_version, device_OS, device_apps_list, device_securekey, wallet_app_installed_flag, and/or the like. An Apps table 4419c may include fields such as, but not limited to: app_ID, app_name, app_type, app dependencies, app access code, user_pin, and/or the like. An Accounts table 4419d may include fields such as, but not limited to: account_number, account_security_code, account_name, issuer_acquirer_flag, issuer_name, acquirer_name, account_address, routing_number, access_API_call, linked_wallets_list, and/or the like. A Merchants table 4419e may include fields such as, but not limited to: merchant_id, merchant_name, merchant_address, store_id, ip_address, mac_address, auth_key, port_num, security_settings_list, and/or the like. An Issuers table 4419f may include fields such as, but not limited to: issuer_id, issuer_name, issuer_address, ip_address, mac_address, auth_key, port_num, security_settings_list, and/or the like. An Acquirers table 4419g may include fields such as, but not limited to: account_firstname, account_lastname, account_type, account_num, account_balance_list, billingaddress_line1, billingaddress_line2, billing_zipcode, billing_state, shipping_preferences, shippingaddress_line1, shippingaddress_line2, shipping_zipcode, shipping_state, and/or the like. A Pay Gateways table 4419h may include fields such as, but not limited to: gateway_ID, gateway_IP, gateway_MAC, gateway_secure_key, gateway_access_list, gateway_API_call_list, gateway_services_list, and/or the like. A Shop Sessions table 4419i may include fields such as, but not limited to: user_id, session_id, alerts_URL, timestamp, expiry_lapse, merchant_id, store_id, device_type, device_ID, device_IP, device_MAC, device_browser, device_serial, device_ECID, device_model, device_OS, wallet_app_installed, total_cost, cart_ID_list, product_params_list, social_flag, social_message, social_networks_list, coupon_lists, accounts_list, CVV2_lists, charge_ratio_list, charge_priority_list, value_exchange_symbols_list, bill_address, ship_address, cloak_flag, pay_mode, alerts_rules_list, and/or the like. A Transactions table 4419j may include fields such as, but not limited to: order_id, user_id, timestamp, transaction_cost, purchase_details_list, num_products, products_list, product_type, product_params_list, product_title, product_summary, quantity, user_id, client_id, client_ip, client_type, client_model, operating_system, os_version, app_installed_flag, user_id, account_firstname, account_lastname, account_type, account_num, account_priority_account_ratio, billingaddress_line1, billingaddress_line2, billing_zipcode, billing_state, shipping_preferences, shippingaddress_line1, shippingaddress_line2, shipping_zipcode, shipping_state, merchant_id, merchant_name, merchant_auth_key, and/or the like. A Batches table 4419k may include fields such as, but not limited to: batch_id, transaction_id_list, timestamp_list, cleared_flag_list, clearance_trigger settings, and/or the like. A Ledgers table 4419l may include fields such as, but not limited to: request_id, timestamp, deposit_amount, batch_id, transaction_id, clear_flag, deposit_account, transaction_summary, payor_name, payor_account, and/or the like. A Products table 4419m may include fields such as, but not limited to: product_ID, product_title, product_attributes_list, product_price, tax_info_list, related_products_list, offers_list, discounts_list, rewards_list, merchants_list, merchant_availability_list, and/or the like. An Offers table 4419n may include fields such as, but not limited to: offer_ID, offer_title, offer_attributes_list, offer_price, offer_expiry, related_products_list, discounts_list, rewards_list, merchants_list, merchant_availability_list, and/or the like. A Behavior Data table 4419o may include fields such as, but not limited to: user_id, timestamp, activity_type, activity_location, activity_attribute_list, activity_attribute_values_list, and/or the like. An Analytics table 4419p may include fields such as, but not limited to: report_id, user_id, report_type, report_algorithm_id, report destination address, and/or the like. A Market Data table 4419q may include fields such as, but not limited to: market_data_feed_ID, asset_ID, asset_symbol, asset_name, spot_price, bid_price, ask_price, and/or the like; in one embodiment, the market data table is populated through a market data feed (e.g., Bloomberg's PhatPipe, Dun & Bradstreet, Reuter's Tib, Triarch, etc.), for example, through Microsoft's Active Template Library and Dealing Object Technology's real-time toolkit Rtt.Multi. A correlation rule table 4419r may include fields such as, but not limited to: rule_id, rule_name, rule_sponsor, rule_merchant_id, rule_product_id, rule_termination, rule_period, rule_fee_percentage, rule_weekly_purchase, rule_purchase_interval, rule_event, and/or the like. An ads table 4419s may include fields such as, but not limited to: ad_id, ad_name, ad_template, ad_data, ad_product_id, ad_merchant_id, ad_complementary_product_id, ad_complementary_merchant_id, and/or the like.

In one embodiment, the Ad-Track database may interact with other database systems. For example, employing a distributed database system, queries and data access by search Ad-Track component may treat the combination of the Ad-Track database, an integrated data security layer database as a single database entity.

In one embodiment, user programs may contain various user interface primitives, which may serve to update the Ad-Track. Also, various accounts may require custom database tables depending upon the environments and the types of clients the Ad-Track may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 4419a-s. The Ad-Track may be configured to keep track of various settings, inputs, and parameters via database controllers.

The Ad-Track database may communicate to and/or with other components in a component collection, including itself, and/or facilities of the like. Most frequently, the Ad-Track database communicates with the Ad-Track component, other program components, and/or the like. The database may contain, retain, and provide information regarding other nodes and data.

### The Ad-Tracks

The Ad-Track component 4435 is a stored program component that is executed by a CPU. In one embodiment, the Ad-Track component incorporates any and/or all combinations of the aspects of the Ad-Track discussed in the previous figures. As such, the Ad-Track affects accessing, obtaining and the provision of information, services, transactions, and/or the like across various communications networks. The features and embodiments of the Ad-Track discussed herein increase network efficiency by reducing data transfer requirements the use of more efficient data structures and mechanisms for their transfer and storage. As a consequence, more data may be transferred in less time, and latencies with regard to transactions, are also reduced. In many cases, such reduction in storage, transfer time, bandwidth requirements, latencies, etc., will reduce the capacity and structural infrastructure requirements to support the Ad-Track's features and facilities, and in many cases reduce the costs, energy consumption/requirements, and extend the life of Ad-Track's underlying infrastructure; this has the added benefit of making the Ad-Track more reliable. Similarly, many of the features and mechanisms are designed to be easier for users to use and access, thereby broadening the audience that may enjoy/employ and exploit the feature sets of the Ad-Track; such ease of use also helps to increase the reliability of the Ad-Track. In addition, the feature sets include heightened security as noted via the Cryptographic components 4420, 4426, 4428 and throughout, making access to the features and data more reliable and secure.

The Ad-Track component may transform consumer activity data via Ad-Track components into ad revenue sharing, and/or the like and use of the Ad-Track. In one embodiment, the Ad-Track component 4435 takes inputs (e.g., consumer activity 215, checkout request 3811; product data 3815; wallet access input 4011; transaction authorization input 4014; payment gateway address 4018; payment network address 4022; issuer server address(es) 4025; funds authorization request(s) 4026; user(s) account(s) data 4028; batch data 4212; payment network address 4216; issuer server address(es) 4224; individual payment request 4225; payment ledger, merchant account data 4231; and/or the like) etc., and transforms the inputs via various components (e.g., UPC 4441; PTA 4442; PTC 4443; STG 4444; EPGU 4445; EAA 4446; CEC 4447; ETC 4448; DFR 4449; ADRN 4450; VASE 4451; SDA 4452; TDA 4453; CTDA 4454; SRA 4455; UBA 4456; UBOR 4457; SPE 4458; SPT 4459; WSS 4460; SMCB 4461; VWSC 4462; ORE 4463; QRCP 4464; SMPE 4465; PCS 4466; UST 4467; STRS 4468; USTG 4469; and/or the like), into outputs (e.g., advertisement revenue sharing payment 237, consumer/merchant transaction record 223, checkout request message 3813; checkout data 3817; card authorization request 4016, 4023; funds authorization response(s) 4030; transaction authorization response 4032; batch append data 4034; purchase receipt 4035; batch clearance request 4214; batch payment request 4218; transaction data 4220; individual payment confirmation 4228, 4229; updated payment ledger, merchant account data 4233; and/or the like).

The Ad-Track component enabling access of information between nodes may be developed by employing standard development tools and languages such as, but not limited to: Apache components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the Ad-Track server employs a cryptographic server to encrypt and decrypt communications. The Ad-Track component may communicate to and/or with other components in a component collection, including itself, and/or facilities of the like. Most frequently, the Ad-Track component communicates with the Ad-Track database, operating systems, other program components, and/or the like. The Ad-Track may contain, communicate, generate, obtain, and/or provide program component, system, user, and/or data communications, requests, and/or responses.

### Distributed Ad-Tracks

The structure and/or operation of any of the Ad-Track node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the Ad-Track controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation (JSON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTTP post command, e.g.:
w3c-post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the Ad-Track controller may be executing a PHP script implementing a Secure Sockets Layer (“SSL”) socket server via the information server, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database, is provided below:

<?PHP
header(′Content-Type: text/plain′);
// set ip address and port to listen to for incoming data
$address = ‘192.168.0.100’;
$port = 255;
// create a server-side SSL socket, listen for/accept incoming
communication
$sock = socket_create(AF_INET, SOCK_STREAM, 0);
socket_bind($sock, $address, $port) or die(‘Could not bind to address’);
socket_listen($sock);
$client = socket_accept($sock);
// read input data from client device in 1024 byte blocks until end of
message
do {

$input = “”;
$input = socket_read($client, 1024);
$data .= $input;

} while($input != “”);
// parse data to extract variables
$obj = json_decode($data, true);
// store input data in a database
mysql_connect(″201.408.185.132″,$DBserver,$password); // access
database server
mysql_select(″CLIENT_DB.SQL″); // select database to append
mysql_query(“INSERT INTO UserTable (transmission)
VALUES ($data)”); // add data to UserTable table in a CLIENT database
mysql_close(″CLIENT_DB.SQL″); // close connection to database
?>

Also, the following resources may be used to provide example embodiments regarding SOAP parser implementation:

http://www.xav.com/perl/site/lib/SOAP/Parser.html
http://publib.boulder.ibm.com/infocenter/tivihelp/v2r1/index.jsp?topic=/com.ibm

.IBMDI.doc/referenceguide295.htm

and other parser implementations:

http://publib.boulder.ibm.com/infocenter/tivihelp/v2r1/index.jsp?topic=/com.ibm

.IBMDI.doc/referenceguide259.htm

all of which are hereby expressly incorporated by reference herein.

Additional implementations of the Ad-Track may include:

21. A processor-implemented advertising revenue sharing system, comprising:

a memory;

a processor disposed in communication with said memory, and configured to issue a plurality of processing instructions stored in the memory, wherein the processor issues instructions to:

obtain consumer activity information indicative of consumer informational exposure to a product;

receive an indication of consumer purchasing transaction of the product;

establish a correlation between the consumer purchasing transaction and the obtained consumer informational exposure;

identify an advertising channel related to the obtained consumer informational exposure based on the correlation; and

distribute an advertisement revenue sharing fee to the advertising channel.

22. The system of embodiment 21, wherein the advertising channel comprises an Internet website.

23. The system of embodiment 21, wherein the advertising channel comprises a social media platform.

24. The system of embodiment 21, wherein the advertising channel comprises a retail store.

25. The system of embodiment 21, wherein the consumer activity information includes social media feeds.

26. The system of embodiment 21, wherein the consumer activity information includes transaction information.

27. The system of embodiment 21, wherein the consumer activity information includes consumer browsing history.

28. The system of embodiment 21, wherein the consumer activity information includes consumer store injection data.

29. The system of embodiment 21, wherein the consumer activity information includes global positioning system-based location information of a consumer.

30. The system of embodiment 21, wherein the consumer activity information is obtained via a browser component instantiated on a consumer device.

31. The system of embodiment 21, wherein the consumer activity information is obtained from a centralized personal information aggregation platform 32. The system of embodiment 21, wherein the consumer informational exposure includes consumer viewing an advertisement.

33. The system of embodiment 21, wherein the consumer informational exposure includes consumer visiting a physical merchant store.

34. The system of embodiment 21, wherein the correlation is established based on whether the consumer purchasing transaction is a result of the consumer informational exposure.

35. The system of embodiment 21, wherein the correlation is established when a consumer has not purchased the product for at least 6 months.

36. The system of embodiment 21, wherein the advertisement revenue sharing fee is distributed to a consumer as an incentive reward.

37. The system of embodiment 21, wherein the advertisement revenue sharing fee is determined by a merchant.

38. The system of embodiment 21, wherein the obtaining consumer activity information further comprises:

providing a social transaction history feed of consumer item interest indications and dynamic consumer item interest indications to social transaction history feed trackers subject to social transaction history access controls, wherein social transaction history feed trackers may be any of social network clients and other consumer's virtual wallet.

39. The system of embodiment 21, wherein obtaining consumer activity information further comprises:

determining a consumer purchasing pattern; and

designing consumer targeted advertising schedule based on the consumer purchasing pattern.

40. The system of embodiment 39, wherein the processor further issues instructions to:

exclude an advertisement from a consumer's advertising schedule for a period of time when the consumer has already purchased the product.

41. A advertising revenue sharing processor-readable non-transitory medium storing instructions executable by a processor to:

obtain consumer activity information indicative of consumer informational exposure to a product;

receive an indication of consumer purchasing transaction of the product;

establish a correlation between the consumer purchasing transaction and the obtained consumer informational exposure;

identify an advertising channel related to the obtained consumer informational exposure based on the correlation; and

distribute an advertisement revenue sharing fee to the advertising channel.

42. The medium of embodiment 21, wherein the advertising channel comprises an Internet website.

43. The medium of embodiment 21, wherein the advertising channel comprises a social media platform.

44. The medium of embodiment 21, wherein the advertising channel comprises a retail store.

45. The medium of embodiment 21, wherein the consumer activity information includes social media feeds.

46. The medium of embodiment 21, wherein the consumer activity information includes transaction information.

47. The medium of embodiment 21, wherein the consumer activity information includes consumer browsing history.

48. The medium of embodiment 21, wherein the consumer activity information includes consumer store injection data.

49. The medium of embodiment 21, wherein the consumer activity information includes global positioning medium-based location information of a consumer.

50. The medium of embodiment 21, wherein the consumer activity information is obtained via a browser component instantiated on a consumer device.

51. The medium of embodiment 21, wherein the consumer activity information is obtained from a centralized personal information aggregation platform

52. The medium of embodiment 21, wherein the consumer informational exposure includes consumer viewing an advertisement.

53. The medium of embodiment 21, wherein the consumer informational exposure includes consumer visiting a physical merchant store.

54. The medium of embodiment 21, wherein the correlation is established based on whether the consumer purchasing transaction is a result of the consumer informational exposure.

55. The medium of embodiment 21, wherein the correlation is established when a consumer has not purchased the product for at least 6 months.

56. The medium of embodiment 21, wherein the advertisement revenue sharing fee is distributed to a consumer as an incentive reward.

57. The medium of embodiment 21, wherein the advertisement revenue sharing fee is determined by a merchant.

58. The medium of embodiment 21, wherein the obtaining consumer activity information further comprises:

providing a social transaction history feed of consumer item interest indications and dynamic consumer item interest indications to social transaction history feed trackers subject to social transaction history access controls, wherein social transaction history feed trackers may be any of social network clients and other consumer's virtual wallet.

59. The medium of embodiment 21, wherein obtaining consumer activity information further comprises:

determining a consumer purchasing pattern; and

designing consumer targeted advertising schedule based on the consumer purchasing pattern.

60. The medium of embodiment 39, wherein the processor further issues instructions to:

exclude an advertisement from a consumer's advertising schedule for a period of time when the consumer has already purchased the product.

61. A processor-implemented advertising incentive method, comprising:

instantiating a remote tracking component on a user device;

receiving a consumer trigger event with regard to a product via the remote tracking component;

determining a related merchant based on the trigger event, the merchant providing the product; and

providing an advertisement component advertising the merchant via the remote tracking component to the consumer.

62. A processor-implemented advertising incentive method, comprising:

receiving an indication of purchase of an advertised product made by a consumer;

determining whether the purchase is eligible for merchant affiliated payment based on pre-agreed rules;

when eligible, receiving an affiliate payment from the merchant and

dedicating a portion of the affiliate payment to the consumer.

63. A processor-implemented advertising incentive method, comprising:

instantiating a remote tracking component on a user device;

receiving a consumer trigger event with regard to a product via the remote tracking component;

determining a related merchant based on the trigger event, the merchant providing the product;

providing an advertisement component advertising the merchant via the remote tracking component to the consumer;

receiving an indication of purchase of the advertised product made by the consumer;

determining whether the purchase is eligible for merchant affiliated payment based on pre-agreed rules;

when eligible, receiving an affiliate payment from the merchant and

dedicating a portion of the affiliate payment to the consumer.

61. The method of embodiment 1, further comprising:

wherein the indication of consumer purchasing transaction of the product is provided to an ad network to seize further provision of advertising of the product to the purchasing consumer.

62. The method of embodiment 1, wherein an advertisement featuring a complementary product to the purchased product is provided to the consumer.

63. The system of embodiment 21, wherein the indication of consumer purchasing transaction of the product is provided to an ad network to seize further provision of advertising of the product to the purchasing consumer.

64, The system of embodiment 21, wherein an advertisement featuring a complementary product to the purchased product is provided to the consumer.

65. The medium of embodiment 41, wherein the indication of consumer purchasing transaction of the product is provided to an ad network to seize further provision of advertising of the product to the purchasing consumer.

66. The medium of embodiment 41, wherein an advertisement featuring a complementary product to the purchased product is provided to the consumer.

In order to address various issues and advance the art, the entirety of this application for BIDIRECTIONAL BANDWIDTH REDUCING NOTIFICATIONS AND TARGETED INCENTIVE PLATFORM APPARATUSES, METHODS AND SYSTEMS (including the Cover Page, Title, Headings, Field, Background, Summary, Brief Description of the Drawings, Detailed Description, Claims, Abstract, Figures, Appendices and/or otherwise) shows by way of illustration various example embodiments in which the claimed innovations may be practiced. The advantages and features of the application are of a representative sample of embodiments only, and are not exhaustive and/or exclusive. They are presented only to assist in understanding and teach the claimed principles. It should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any data flow sequence(s), program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, processors, services, servers, and/or the like that may execute asynchronously, concurrently, in parallel, simultaneously, synchronously, and/or the like are also contemplated by the disclosure. As such, some of these features may be mutually contradictory, in that they cannot be simultaneously present in a single embodiment. Similarly, some features are applicable to one aspect of the innovations, and inapplicable to others. In addition, the disclosure includes other innovations not presently claimed. Applicant reserves all rights in those presently unclaimed innovations, including the right to claim such innovations, file additional applications, continuations, continuations-in-part, divisions, and/or the like thereof. As such, it should be understood that advantages, embodiments, examples, functional, features, logical, operational, organizational, structural, topological, and/or other aspects of the disclosure are not to be considered limitations on the disclosure as defined by the claims or limitations on equivalents to the claims. It is to be understood that, depending on the particular needs and/or characteristics of a Ad-Track individual and/or enterprise user, database configuration and/or relational model, data type, data transmission and/or network framework, syntax structure, and/or the like, various embodiments of the Ad-Track may be implemented that allow a great deal of flexibility and customization. For example, aspects of the Ad-Track may be adapted for offer targeting. While various embodiments and discussions of the Ad-Track have been directed to online advertising, however, it is to be understood that the embodiments described herein may be readily configured and/or customized for a wide variety of other applications and/or implementations.

What is claimed is:

1. A processor-implemented advertising revenue sharing method of improving network data transmission efficiency and reducing network bandwidth usage, comprising:
obtaining consumer activity information indicative of consumer informational exposure to a product,
wherein the consumer activity information includes consumer browsing history and consumer store injection data;
receiving an indication of consumer purchasing transaction of the product;
establishing a correlation between the consumer purchasing transaction and the obtained consumer informational exposure;
identifying an advertising channel related to the obtained consumer informational exposure based on the correlation; and
distributing an advertisement revenue sharing fee to the advertising channel,
wherein the indication of consumer purchasing transaction of the product is provided to an ad network to seize further provision of advertising of the product to the purchasing consumer,
wherein an advertisement featuring a complementary product to the purchased product is provided to the consumer, and
wherein the further provision of advertising of the product reduces a volume of excessive ad message transmission and saves network bandwidth.

2. A processor-implemented advertising revenue sharing method, comprising:
obtaining consumer activity information indicative of consumer informational exposure to a product;
receiving an indication of consumer purchasing transaction of the product;
establishing a correlation between the consumer purchasing transaction and the obtained consumer informational exposure;
identifying an advertising channel related to the obtained consumer informational exposure based on the correlation; and
distributing an advertisement revenue sharing fee to the advertising channel.

3. The method of claim 1, wherein the advertising channel comprises a social media platform.

4. The method of claim 1, wherein the advertising channel comprises a retail store.

5. The method of claim 1, wherein the consumer activity information includes social media feeds.

6. The method of claim 1, wherein the consumer activity information includes transaction information.

7. The method of claim 1, wherein the consumer activity information includes consumer browsing history.

8. The method of claim 1, wherein the consumer activity information includes consumer store injection data.

9. The method of claim 1, wherein the consumer activity information includes global positioning system-based location information of a consumer.

10. The method of claim 1, wherein the consumer activity information is obtained via a browser component instantiated on a consumer device.

11. The method of claim 1, wherein the consumer activity information is obtained from a centralized personal information aggregation platform

12. The method of claim 1, wherein the consumer informational exposure includes consumer viewing an advertisement.

13. The method of claim 1, wherein the consumer informational exposure includes consumer visiting a physical merchant store.

14. The method of claim 1, wherein the correlation is established based on whether the consumer purchasing transaction is a result of the consumer informational exposure.

15. The method of claim 1, wherein the correlation is established when a consumer has not purchased the product for at least 6 months.

16. The method of claim 1, wherein the advertisement revenue sharing fee is distributed to a consumer as an incentive reward.

17. The method of claim 1, wherein the advertisement revenue sharing fee is determined by a merchant.

18. The method of claim 1, wherein the obtaining consumer activity information further comprises:
providing a social transaction history feed of consumer item interest indications and dynamic consumer item interest indications to social transaction history feed trackers subject to social transaction history access controls, wherein social transaction history feed trackers may be any of social network clients and other consumer's virtual wallet.

19. The method of claim 1, wherein obtaining consumer activity information further comprises:
determining a consumer purchasing pattern; and
designing consumer targeted advertising schedule based on the consumer purchasing pattern.

20. A processor-implemented advertising revenue sharing system, comprising:
a memory;
a processor disposed in communication with said memory, and configured to issue a plurality of processing instructions stored in the memory, wherein the processor issues instructions to:
obtain consumer activity information indicative of consumer informational exposure to a product;
receive an indication of consumer purchasing transaction of the product;
establish a correlation between the consumer purchasing transaction and the obtained consumer informational exposure;
identify an advertising channel related to the obtained consumer informational exposure based on the correlation; and
distribute an advertisement revenue sharing fee to the advertising channel.
